(19) United States
(12) Patent Application Publication
(10) Pub. No.: US 2026/0169261 A1
(43) Pub. Date: Jun. 18, 2026

(54) OPTICAL SYSTEMS FOR WIDE, MAIN AND TELE IMAGING

(71) Applicant: Lumenuity, Inc., Cabin John, MD (US)

(72) Inventors: Akira YABE, Saitama (JP); Benjamin Shapiro, Redondo Beach, CA (US)

(73) Assignee: Lumenuity, Inc., Cabin John, MD (US)

(21) Appl. No.: 19/439,709

(22) Filed: Jan. 5, 2026

Related U.S. Application Data
(63) Continuation-in-part of application No. 19/268,902, filed on Jul. 14, 2025, now abandoned.
(60) Provisional application No. 63/670,530, filed on Jul. 12, 2024.

(51) Int. Cl. G02B 9/64; G02B 13/00; G02B 13/06; G02B 15/14; G02B 23/08

(52) U.S. Cl. CPC G02B 9/64; G02B 13/0045; G02B 13/0065; G02B 13/06; G02B 15/143107; G02B 23/08

(57) ABSTRACT

Disclosed is a small imaging optical system with a reduced number of cameras, without sacrificing camera module functionality. The imaging optical system is a small camera having a function for switching between multiple modes and fields of view.

### CROSS-REFERENCE TO RELATED APPLICATIONS

This patent application is a continuation-in-part of co-pending U.S. patent application Ser. No. 19/268,902, filed Jul. 14, 2025. This patent application claims the benefit of U.S. Provisional Patent Application No. 63/670,530 filed Jul. 12, 2024, which is incorporated by reference.

### FIELD

This disclosure generally relates to an imaging optical system built into an electronic device such as a smartphone, and particularly relates to an imaging optical system capable of photographing at different fields of view (FOVs), such as standard (main or primary) photography, tele (zoom) photography, and/or wide-angle photography.

### BACKGROUND

Digital cameras are widely used in mobile devices, for example in smartphones. Since such electronic devices have limited space, there is a demand for camera modules that can achieve high functionality in a small volume.

Smartphones can include a plurality of cameras in a camera module. For example, three cameras: a wide-angle camera, a main camera, and a telephoto camera have been put into practical use, so that a user can take photographs and videos at a plurality of desired fields of view (for example: wide-angle, main field-of-view, and zoom images).

### SUMMARY

In mobile devices (e.g. smartphones), changing from a wide angle to a telephoto magnification field-of-view is usually enabled by multiple cameras. For example: a wide-angle camera, a main camera, and a telephoto camera. Such a three-camera module can enable shooting at a field of view desired by the user.

However, when the number of cameras in the electronic device increases in this manner, there is less space left in the mobile device for other functions, and also costs increase (each camera has an associated cost). Thus there is need to reduce the number of cameras without sacrificing functionality.

Furthermore, this problem is not limited to phones and also occurs in the same manner in other systems where size, weight, and/or cost are at a premium, such as in drones, satellites, and vehicles. For example, when a plurality of cameras is mounted on a drone, the size, weight, and cost dedicated to camera function increases, and hence there can be less size, weight, and cost available for other (non-camera) functions such as engines, electronics, battery, and payload.

Disclosed are imaging optical systems (e.g. camera modules), that contain less cameras, without sacrificing photography and videography functionality. Sample embodiments include a function for switching between at least a first field of view and a second field of view.

According to such a configuration, two cameras having different fields of view are integrated into one camera. The resulting camera module can then have a smaller number of cameras, thus realizing a smaller and/or cheaper imaging optical system.

For example, for main and ultra-wide operation, it is possible that the first field of view (FOV) is between 60 and 100 degrees and that the second field of view is approximately between 100 and 140 degrees. Alternatively, the first FOV may be between 70 and 95 degrees and the second FOV may be between 105 and 135 degrees. For main and telephoto operation, it is possible that the first FOV is less than 60 degrees and the second FOV is between 60 and 100 degrees. Alternatively, the first FOV is less than 70 degrees and the second FOV may be between 70 and 95 degrees.

Furthermore, at least a portion of the lenses can have a D-cut parallel to the longitudinal direction of the imaging element. This can allow the camera to be thinner.

Furthermore, arrangement in a periscope format (optical axis bending) can be provided. Optical axis bending can refer to bending the optical axis such that the subject direction and the lateral direction of the imaging element are parallel. Such bending can, for example, be achieved by a turning mirror or a turning prism. Optical axis bending can be selected to be other than a 90 degree bend. For example, the optical axis can be bent by more than 90 degrees, so that the periscope arm of the camera is tiled up, as illustrated in FIGS. 5A-5B, 7A-7B, 9A-9B, 11A-11B and others. This can be enabled either by including a turning mirror that is tilted more than 45 degrees, or by using an internally-reflecting turning prism whose angled face is tilted by more than 45 degrees. The exit face of the prism can be tilted away from vertical, e.g. to retain axial symmetry along the path of light, or to minimize aberrations. Such a tilted-arm periscope design can enable a larger sensor to be used, without having the bottom of that sensor extend outside the thickness of the phone. A larger sensor can be advantageous for collecting more light and decreasing signal-to-noise ratio (SNR).

Furthermore, the prism or mirror may be moved, in such a way as to switch from one set of entry lens or lenses to another. For example, there may be two entry lenses on one side of the phone, for main and ultra-wide or for main and tele operation. For a mirror, it may also be moved and turned (flipped) to accept light from two entry lenses on the front and one entry lens on the back (e.g. selfie camera).

The optical axis in the periscope arm may be straight or tilted (as illustrated in FIGS. 13A-13B). If the optical axis is tilted, the prism (or mirror) can be shifted along this (tilted) optical axis, or it may be shifted straight (e.g. in a direction parallel to the sides of the smartphone). In the latter case it is understood that the angles of the reflecting surfaces and the faces of the prism will still remain as described above for a tilted optical axis, since translating a prism or mirror without rotating it does not change these angles. Further, the prism faces or mirror size can be selected to be large enough so as to allow light rays, even at the edge of the formed image, to reflect and reach the sensor, in both the first and second prism or mirror positions.

According to various embodiments, two (or more) cameras having different fields of view can be replaced by one camera, and therefore, a smaller and/or lower cost imaging optical system can be realized without sacrificing camera functionality.

The disclosed embodiments include lens systems for forming a photographic image (e.g. a photograph, digital image, scene capture, frame, etc.) or for taking videos (e.g. a video stream, motion picture, captured video, video sequence, frame sequence, digital video, etc.). Such a lens, imaging or camera system may include an entry aperture or entry lens, a turning optic (an angled mirror, reflecting surface, prism, reflective prism, beam deflector, beam folding element, optical wedge, etc.), a plurality of lenses arranged into groups, and may include actuators (mechanical, piezo, coil and magnetic, etc.) to move a group of lenses, and may include a sensor. The lens system may be arranged in a periscope format. This can also be referred to as a periscope arm, folded optics, a folded optical system, a mirror or prism-based lens system, a beam-folding optical system, an angled path configuration, etc. In some embodiments, such a fold may place the arm optical axis at a right-angle (90 degrees), in some embodiments the fold angle may be other than 90 degrees (a tilted optical axis in the arm). For a first placement of at least one lens group, such a lens system can operate at one field-of-view. For a second placement of the lens group, the lens system can operate at a second larger field-of-view. In some embodiments, the number of lenses may vary from 6 to 18, or from 7 to 16, or from 7 to 14, or from 8 to 12. In some embodiments, there may be from zero to 3 lenses placed before the turning optic. In some embodiments there may be one, two, or three moving groups of lenses. One or more of such moving groups can also be used for auto-focus. Groups of lenses can have various focusing powers, sometimes also referred to as optical power, focal power, focusing strength, etc. In some embodiments, the number of apertures or entry lenses can be greater than one for the lens system. In some embodiments, two or three entry apertures or lenses can be present, and the turning optic can be positioned to address each of them individually. For use with a smartphone or other mobile device, such entry ports can be on the same side of the device, or can be on opposite side, for example two on one side for main and ultra-wide or tele operation, and one on the other side for selfie mode.

### BRIEF DESCRIPTION OF DRAWINGS

FIGS. 1A and 1B show lens shapes and placement, from side and top view, as well as sample light rays, for embodiment #1 operating in main mode.

FIG. 2A is an MTF performance diagram versus field height, for the system of FIGS. 1A and 1B, for an object plane located away at infinity.

FIG. 2B is an MTF performance diagram versus field height for the system of FIGS. 1A and 1B, for an object plane located at 1 meter.

FIG. 2C is an MTF performance diagram versus defocus position, for the system of FIGS. 1A and 1B, for an object plane located away at infinity.

FIG. 2D is an MTF performance diagram versus field defocus position for the system of FIGS. 1A and 1B, for an object plane located at 1 meter.

FIGS. 3A and 3B show lens shapes and placement, from side and top view, as well as sample light rays, for embodiment #1 operating in ultra-wide mode.

FIG. 4A is an MTF performance diagram for the system of FIGS. 3A and 3B, for an object plane located away at infinity.

FIG. 4B is an MTF performance diagram for the system of FIGS. 3A and 3B, for an object plane located at 10 centimeters.

FIG. 4C is an MTF performance diagram versus defocus position, for the system of FIGS. 1A and 1B, for an object plane located away at infinity.

FIG. 4D is an MTF performance diagram versus field defocus position for the system of FIGS. 1A and 1B, for an object plane located at 10 centimeters.

FIGS. 5A and 5B show lens shapes and placement for embodiment #2, in main mode.

FIGS. 6A-6D shows MTFs for FIGS. 5A and 5B.

FIGS. 7A and 7B show lens shapes for embodiment #2, ultra-wide mode.

FIGS. 8A-8D shows MTFs for FIGS. 7A and 7B.

FIGS. 9A and 9B show lens shapes and placement for embodiment #3, in main mode.

FIGS. 10A-10D shows MTFs for FIGS. 9A and 9B.

FIGS. 11A and 11B show lens placement for embodiment #3, in ultra-wide mode.

FIGS. 12A-12D shows MTFs for FIGS. 11A and 11B.

FIGS. 13A and 13B show lens shapes and placement for embodiment #4, in main mode.

FIGS. 14A-14D shows MTFs for FIGS. 13A and 13B.

FIGS. 15A and 15B show lens placement for embodiment #4, in ultra-wide mode.

FIGS. 16A-16D shows MTFs for FIGS. 15A and 15B.

FIGS. 17A and 17B show lens shapes and placement for embodiment #5, in main mode.

FIGS. 18A-18D shows MTFs for FIGS. 17A and 17B.

FIGS. 19A and 19B show lens placement for embodiment #5, in ultra-wide mode.

FIGS. 20A-20D shows MTFs for FIGS. 19A and 19B.

FIGS. 21A and 21B show lens shapes and placement for embodiment #6, in main mode.

FIGS. 22A-22D shows MTFs for FIGS. 21A and 21B.

FIGS. 23A and 23B show lens placement for embodiment #6, in ultra-wide mode.

FIGS. 24A-24D shows MTFs for FIGS. 23A and 23B.

FIGS. 25A and 25B show lens shapes and placement for embodiment #7, in main mode.

FIGS. 26A-26D shows MTFs for FIGS. 25A and 25B.

FIGS. 27A and 27B show lens placement for embodiment #7, in ultra-wide mode.

FIGS. 28A-28D shows MTFs for FIGS. 27A and 27B.

FIGS. 29A and 29B show lens shapes and placement for embodiment #8, in main mode.

FIGS. 30A-30D shows MTFs for FIGS. 29A and 29B.

FIGS. 31A and 31B show lens placement for embodiment #8, in ultra-wide mode.

FIGS. 32A-32D shows MTFs for FIGS. 31A and 31B.

FIGS. 33A and 33B show lens shapes and placement for embodiment #9, in main mode.

FIGS. 34A-34D shows MTFs for FIGS. 33A and 33B.

FIGS. 35A and 35B show lens placement for embodiment #9, in ultra-wide mode.

FIGS. 36A-36D shows MTFs for FIGS. 35A and 35B.

FIGS. 37A and 37B show lens shapes and placement for embodiment #10, in main mode.

FIGS. 38A-38D shows MTFs for FIGS. 37A and 37B.

FIGS. 39A and 39B show lens placement for embodiment #10, in ultra-wide mode.

FIGS. 40A-40D shows MTFs for FIGS. 39A and 39B.

FIGS. 41A and 41B show lens shapes and placement for embodiment #11, in main mode.

FIGS. 42A-42D shows MTFs for FIGS. 41A and 41B.

FIGS. 43A and 43B show lens placement for embodiment #11, in ultra-wide mode.

FIGS. 44A-44D shows MTFs for FIGS. 43A and 43B.

FIGS. 45A and 45B shows len shapes and placement for embodiment #12, in main mode.

FIGS. 46A-46D shows MTFs for FIGS. 45A and 45B.

FIGS. 47A and 47B show lens placement for embodiment #12, in ultra-wide mode.

FIGS. 48A-48D shows MTFs for FIGS. 47A and 47B.

FIGS. 49A and 49B show lens shapes and placement for embodiment #13, in main mode.

FIGS. 50A-50D show MTFs for FIGS. 49A and 49B.

FIGS. 51A and 51B show lens placement for embodiment #13, in ultra-wide mode.

FIGS. 52A-52D show MTFs for FIGS. 51A and 51B.

FIGS. 53A and 53B show lens shapes and placement for embodiment #14, in main mode.

FIGS. 54A-54D show MTFs for FIGS. 53A and 53B. In this example, additional spatial frequency curves have been shown in some of the MTFs.

FIGS. 55A and 55B show lens placement for embodiment #14, in ultra-wide mode.

FIGS. 56A-56D show MTFs for FIGS. 55A and 55B. In this example, additional spatial frequency curves have been shown in some of the MTFs. And the distance to object is selected at-infinity and at 20 centimeters.

FIGS. 57A and 57B show lens shapes and placement for embodiment #15, in main mode.

FIGS. 58A-58D show MTFs for FIGS. 57A and 57B.

FIGS. 59A and 59B show lens placement for embodiment #15, in ultra-wide mode.

FIGS. 60A-60D show MTFs for FIGS. 59A and 59B.

FIGS. 61A and 61B show lens shapes and placement for embodiment #16, in main mode.

FIGS. 62A-62D show MTFs for FIGS. 61A and 61B.

FIGS. 63A and 63B show lens placement for embodiment #16, in ultra-wide mode.

FIGS. 64A-64D show MTFs for FIGS. 63A and 63B.

FIGS. 65A and 65B show lens shapes and placement for embodiment #17, in main mode. Sample light rays show that in such an example embodiment, an intermediate image can be found between the prism and the sensor.

FIGS. 66A-66D show MTFs for FIGS. 65A and 65B.

FIGS. 67A and 67B show lens placement for embodiment #17, in ultra-wide mode. Sample light rays show that in such an example embodiment, an intermediate image can be found between the prism and the sensor.

FIGS. 68A-68D show MTFs for FIGS. 67A and 67B.

FIGS. 69A and 69B show lens shapes and placement for embodiment #18, in main mode.

FIGS. 70A-70D show MTFs for FIGS. 69A and 69B.

FIGS. 71A and 71B show lens placement for embodiment #18, in ultra-wide mode.

FIGS. 72A-72D show MTFs for FIGS. 71A and 71B.

FIGS. 73A-73B show an imaging optical system according to embodiment #19.

FIGS. 74A-74C show an imaging optical system according to embodiment #20.

### DETAILED DESCRIPTION

The imaging optical system will now be described more fully with reference to the accompanying tables and drawings in which preferred embodiments of the invention are shown. This system may, however, be embodied in many different forms and should not be construed as being limited to the embodiment set forth herein.

Disclosed are embodiments where two modes of operation can be possible. In one mode, an embodiment can have a certain field-of-view, for example corresponding to a main camera in a smartphone. In a second mode, the embodiment may have a second field-of-view, for example corresponding to an ultra-wide or tele (zoom) camera. Embodiments may include lens groups, and placement of one or more lens groups in one location can correspond to a first mode, and placement in a second location can correspond to a second mode. Movement of one or more lens groups may also be used for auto-focus.

### Embodiment #1

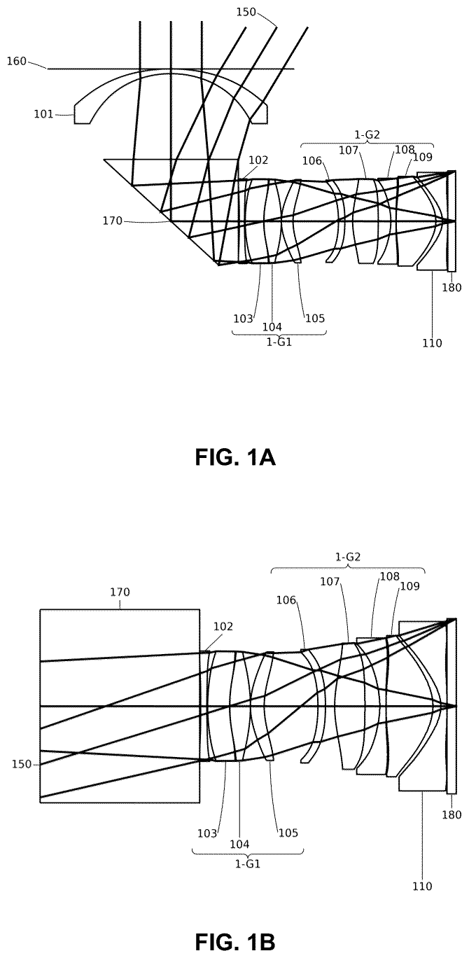

This embodiment (FIGS. 1A-4D) can have a periscope arrangement, with a turning optic that may be a mirror or a prism. The total size of the optics can be approximately 14.6 mm (X length)×6.2 mm (Y width)×8.5 mm (Z height).

The embodiment can have 10 lenses (10 aspherical and 0 spherical). The turning optic may be positioned after the first lens, before the remaining lenses in the periscope arm. There may be two moving lens groups, with three lenses in the first group, and four lenses in the second group. The power of these groups may be positive and positive, respectively. The motion of the first lens group may also be used for auto-focusing.

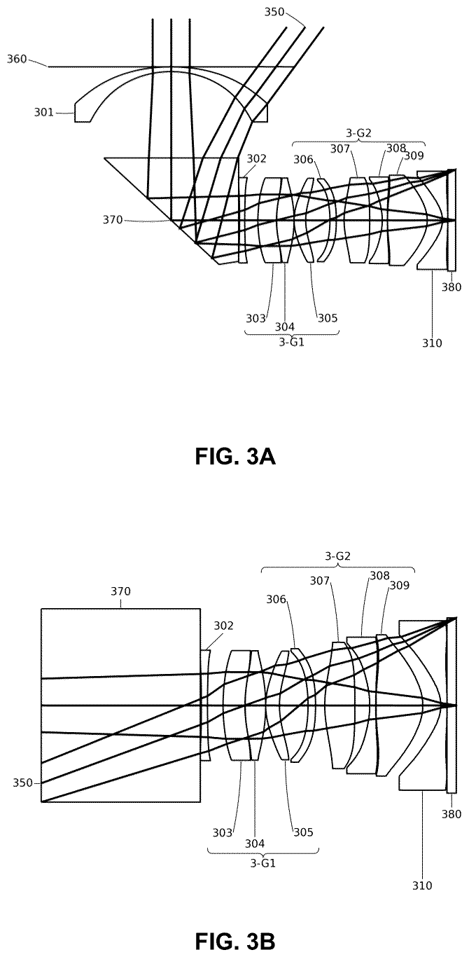

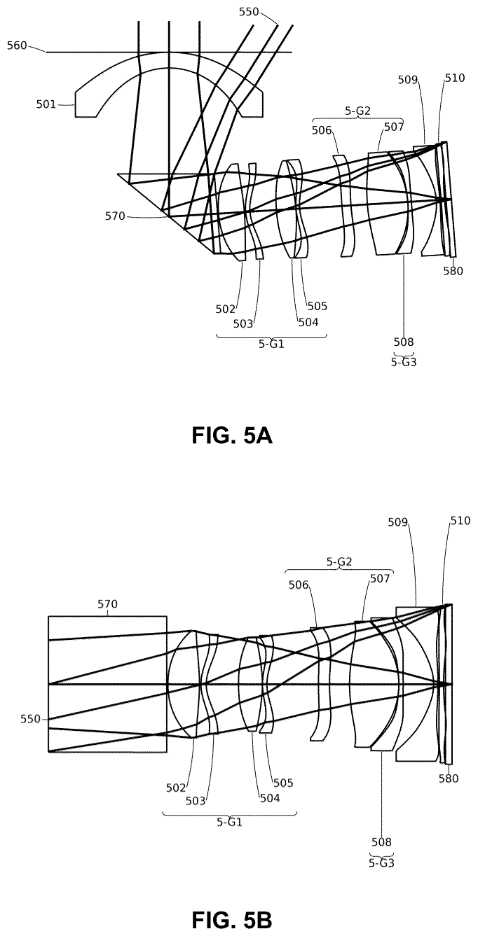

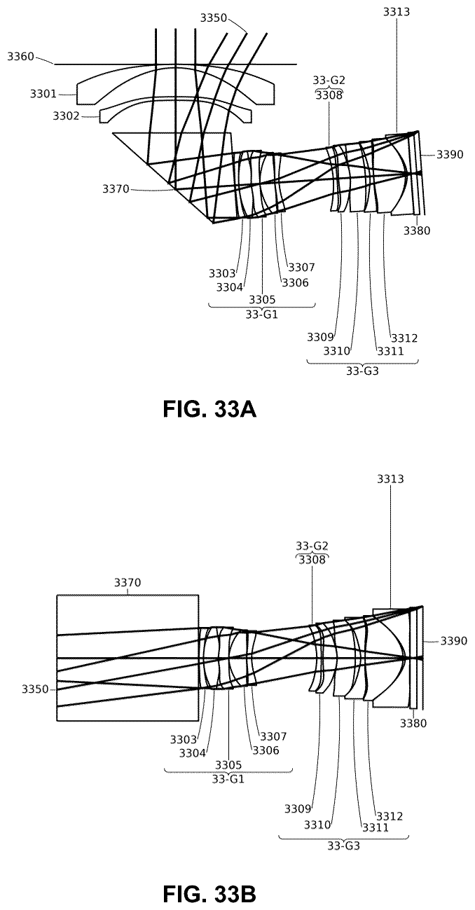

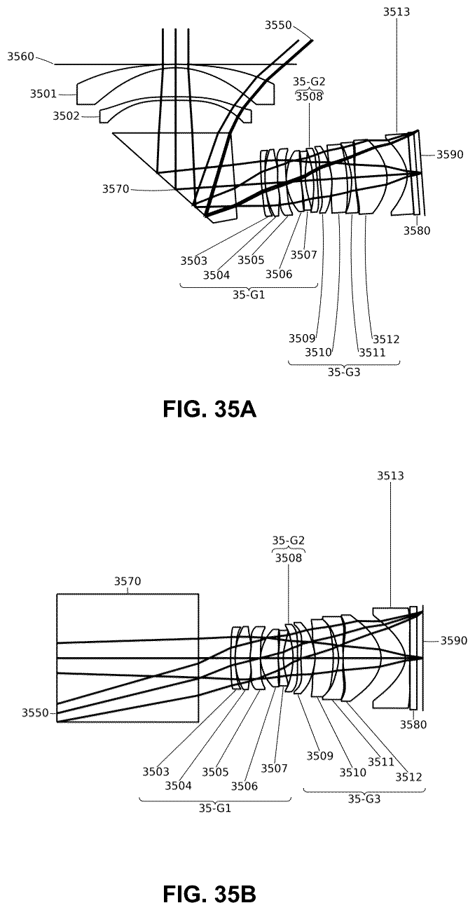

Referring now to FIG. 1A which is a side-view and FIG. 1B which is a top-view of this embodiment. Lenses are labeled as 101, 102, 103, . . . 110. In the top-view FIG. 1B, the first lens 101 is above the prism, its curvature shape would not be visible from the top, and hence this first lens is not shown in this top view. In general, comparing lens labeling for side and top views illustrates which if any lens is not shown in the top view. Lens moving groups are labeled as 1-G1 for the first moving group, 1-G2 for the second moving group, etc. Each moving group contains the lenses marked by the curly bracket above their label numbers. For example, in FIG. 1A, the second moving group (1-G2) includes lenses 106, 107, 108, and 109. The camera aperture is labeled as 160. The turning optic (here shown for example as a prism) is labeled as 170. The turning optic bends the optical axis, for example by 90 degrees in FIG. 1A, and after the turning optic lenses 102-110 are positioned along the cornered or folded optical axis (this can be referred to as a periscope format, and lenses 102-110 can be referred to as in the arm of the periscope). An infra-red (IR) cut filter or layer is marked as 180. Sample light rays are marked as 150. These rays form an in-focus image on the image plane or sensor surface. FIGS. 3A and 3B show the same embodiment, but operating in the other field-of-view mode and the labeling scheme is the same, except for FIGS. 3A and 3B each label starts with 3 instead of with 1, e.g. 301, 302, etc, for the lenses. Comparing FIGS. 3A and 3B to FIGS. 1A and 1B, the repositioning of two groups of lenses (1-G1 and 1-G2) to switch modes is apparent. This repositioning can be used to change the embodiment from one field-of-view (FOV) to another FOV, and one or more of the moving groups can also be used for auto-focus. Figures for subsequent embodiments are labeled according to the same scheme, except the labels for FIGS. 3A and 3B have 301, 302, etc. numbering, labels for FIGS. 5A and 5B have 501, 502, etc. numbering, and so forth. In most embodiments, the image plane (or sensor surface) is adjacent to the end of the IR cut filter. But in some embodiments, e.g. those shown in FIGS. 33A-33B, 35A-35B, 41A-41B, 43A-43B, 49A-49B, 51A-51B, 57A-57B and 59A-59B, there can be a gap between the end of the IR cut filter and the image plane or surface of the sensor. In such cases, the image plane is labeled as 3390 in FIGS. 33A and 33B, as 3590 in FIGS. 35A and 35B, etc.

A lens or lenses may also be referred to as optical elements, optical components, refractive elements, optical unit, focusing element, focusing surface, among other terms. The turning optic could be referred to as a prism or an angled mirror, reflecting surface, reflective prism, beam deflector, beam folding element, optical wedge, among other terms. A periscope format can be referred to as a periscope arm, folded optics, a folded optical system, a mirror or prism-based lens system, a beam-folding optical system, an angled path configuration, among other terms.

Table 1 states possible lens shapes and placement for this embodiment, for both modes of operation (for main and for ultra-wide mode). The columns in the table are: lens number (e.g. 1st, 2nd, 3rd, etc.); lens radius (stated in units of millimeters); lens thickness (mm); lens material index of refraction (Nd); lens material Abbe number (Vd); conic constant (K); and (even) polynomial coefficients (of orders 6, 8, 10, . . . 16). Each row (but one) is for each lens. Each lens has a top and a bottom surface. Material constants (like index of refraction and Abbe number), which are relevant for the whole lens, are listed once per row. Parameters related to the shape of the surface of the lens have two listings: one for the top lens surface and one for the bottom lens surface. For the thickness column: the top value in each lens row is the thickness of that lens at its center; the bottom value is the air gap (along the camera centerline) between that lens to the next one down. The row that does not contain curvature information (e.g. the row between lenses 1 and 2 in Table 1), that row gives information on the size and location of the turning prism.

TABLE 1
Lens shape parameters. (These are the parameters that mathematically
define the lens shapes of this embodiment.)

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 5.985 | 0.200 | 1.53 | 55.75 | −3.93E+00 | 3.78E−03 | −9.76E−05 |
| | 3.518 | 3.575 | | | −2.01E−01 | 2.13E−03 | −3.16E−05 |
| | | 5.160 | 1.52 | 64.20 | | | |
| | | 0.033 | | | | | |
| 2 | −58.100 | 0.200 | 1.63 | 23.43 | −7.79E+00 | −6.96E−03 | −2.93E−03 |
| | 23.102 | 0.026 | | | −7.98E+00 | −5.62E−03 | −4.14E−03 |
| 3 | 5.797 | 0.710 | 1.53 | 55.75 | 3.39E+00 | −1.45E−02 | 7.54E−03 |
| | 4.475 | 0.007 | | | −7.80E−02 | 2.98E−02 | −7.41E−02 |
| 4 | 6.228 | 0.666 | 1.55 | 71.69 | −3.15E+00 | 7.53E−02 | −9.91E−02 |
| | −4.708 | 0.000 | | | 3.12E+00 | 1.76E−02 | −2.88E−03 |
| 5 | 2.140 | 0.446 | 1.50 | 81.56 | −9.56E−01 | −4.37E−02 | 1.61E−02 |
| | 2.601 | 1.737 | | | −1.87E+00 | −3.68E−02 | 1.13E−02 |
| 6 | −4.915 | 0.243 | 1.57 | 37.67 | −1.31E+00 | −1.29E−02 | −8.96E−03 |
| | −6.966 | 0.298 | | | −4.17E+00 | −5.19E−02 | 1.60E−02 |
| 7 | 3.481 | 0.979 | 1.53 | 55.75 | −3.13E+00 | −3.68E−02 | 1.33E−02 |
| | −17.164 | 0.480 | | | −2.82E+00 | 1.14E−02 | −1.68E−02 |
| 8 | −2.612 | 0.200 | 1.63 | 23.43 | −1.75E+00 | 5.04E−02 | −2.68E−02 |
| | −318.007 | 0.002 | | | 3.10E+00 | 5.12E−02 | −3.41E−02 |
| 9 | 9.140 | 1.518 | 1.50 | 81.56 | −3.53E−01 | 2.05E−02 | −2.97E−02 |
| | −1.512 | 0.254 | | | −3.21E+00 | −2.57E−02 | 1.10E−02 |
| 10 | −1.104 | 0.200 | 1.57 | 37.67 | −2.68E+00 | −2.84E−02 | 2.54E−02 |
| | −16.397 | 0.000 | | | 2.18E+01 | −6.81E−03 | 1.10E−02 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | 1.98E−05 | −1.71E−06 | 5.06E−08 | −5.06E−10 | 0.00E+00 |
| | 3.67E−05 | −3.97E−07 | −1.22E−07 | 4.91E−09 | 0.00E+00 |
| 2 | 5.25E−03 | −2.17E−03 | 4.37E−04 | −3.66E−05 | 0.00E+00 |
| | 8.17E−03 | −3.93E−03 | 9.31E−04 | −9.01E−05 | 0.00E+00 |
| 3 | −1.27E−03 | −3.83E−04 | 2.26E−04 | −3.05E−05 | 0.00E+00 |
| | 5.21E−02 | −2.05E−02 | 4.20E−03 | −3.43E−04 | 0.00E+00 |
| 4 | 6.39E−02 | −2.46E−02 | 4.97E−03 | −3.87E−04 | 0.00E+00 |
| | 3.61E−04 | 7.68E−05 | −8.82E−05 | 3.21E−05 | 0.00E+00 |
| 5 | −7.96E−03 | 2.83E−03 | −4.75E−04 | 3.20E−05 | 0.00E+00 |
| | −5.87E−03 | 1.84E−03 | −2.94E−04 | 2.08E−05 | 0.00E+00 |
| 6 | 8.92E−03 | −6.01E−03 | 1.50E−03 | −1.16E−04 | 0.00E+00 |
| | −1.58E−03 | −2.25E−03 | 7.74E−04 | −6.36E−05 | 0.00E+00 |
| 7 | −3.19E−03 | 3.13E−04 | 4.05E−06 | −1.37E−06 | 0.00E+00 |
| | 7.20E−03 | −2.16E−03 | 3.20E−04 | −1.62E−05 | 0.00E+00 |
| 8 | 4.53E−03 | −4.49E−04 | 5.12E−05 | −3.16E−06 | 0.00E+00 |
| | 1.03E−02 | −1.76E−03 | 1.58E−04 | −5.47E−06 | 0.00E+00 |
| 9 | 1.18E−02 | −2.37E−03 | 2.31E−04 | −8.38E−06 | 0.00E+00 |
| | −3.99E−03 | 7.76E−04 | −6.64E−05 | 2.03E−06 | 0.00E+00 |
| 10 | −1.07E−02 | 2.05E−03 | −1.80E−04 | 5.85E−06 | 0.00E+00 |
| | −2.93E−03 | 3.31E−04 | −1.70E−05 | 3.23E−07 | 0.00E+00 |

FIGS. 1A and 1B show lens shapes and placement for this embodiment, when it is operating in a main mode (in the phone industry, this is also sometimes referred to as primary mode, or wide mode). FIG. 1A shows a side view of the embodiment. FIG. 1B shows a top view. Both figures also show sample light rays through the embodiment for this mode. In the main mode, the field-of-view (FOV) is approximately 85.5 degrees, the F-number is approximately 1.6, and the effective focal length (EFL) is approximately 3.78 mm.

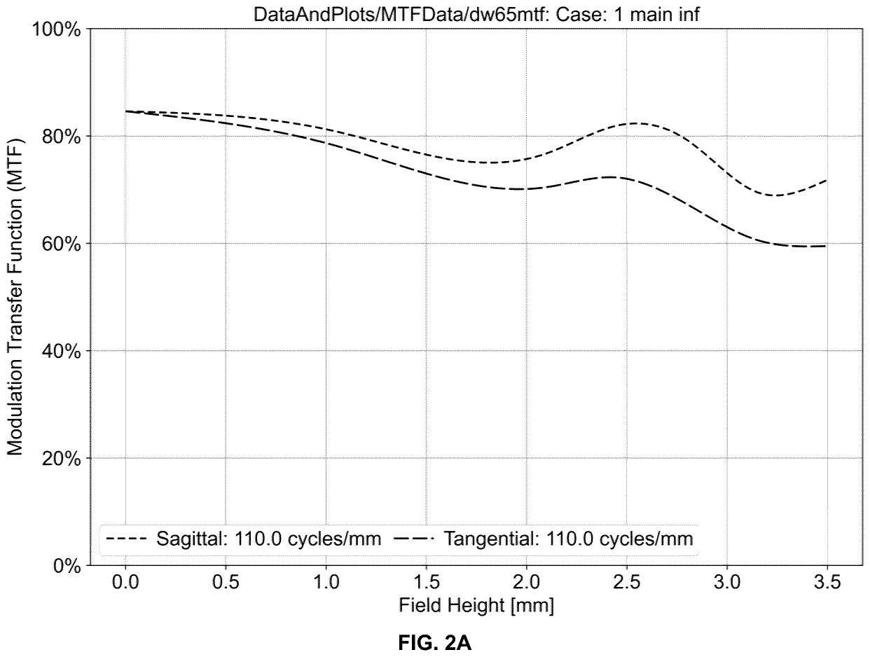

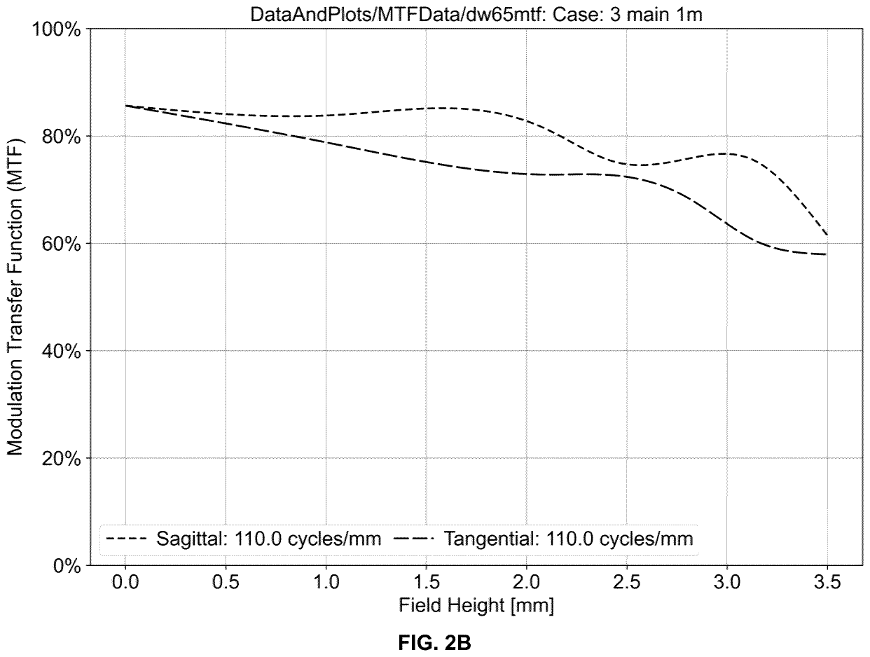

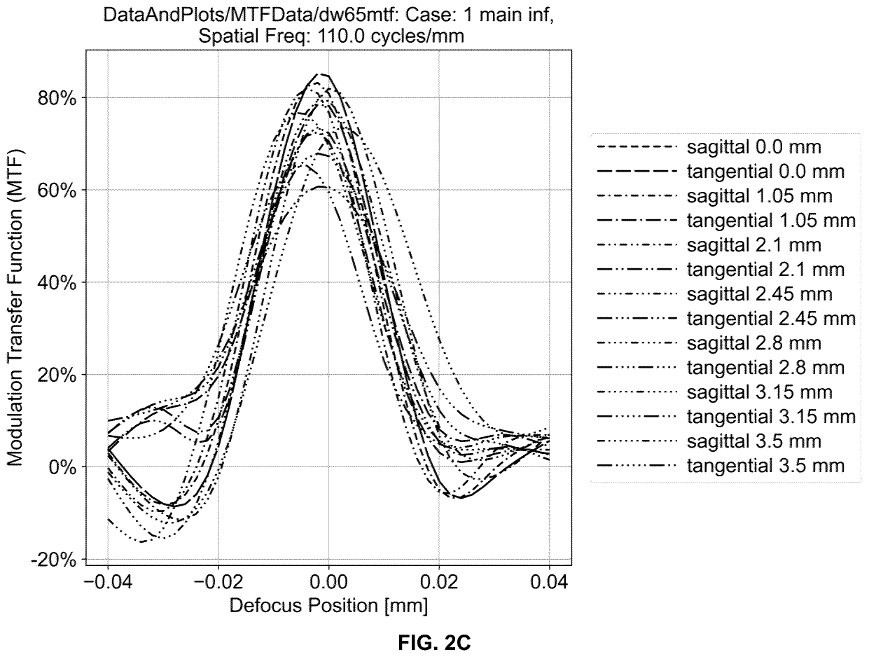

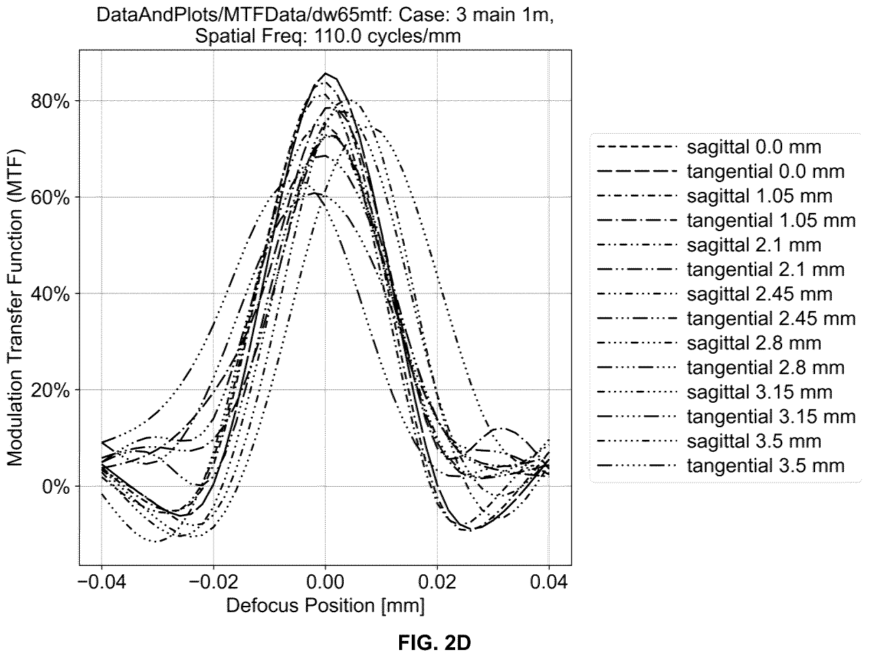

For the main mode, FIG. 2A is an MTF (modulation transfer function) performance diagram versus field height for this embodiment, for an object plane located away at infinity. FIG. 2B is an MTF performance diagram versus field height, for an object plane located at 1 meter. FIG. 2C is an MTF versus defocus position, for an object plane located at infinity. FIG. 2D is an MTF versus defocus position, for an object plane at 10 centimeters.

FIGS. 3A and 3B show lens placement for this embodiment, when it is operating in an ultra-wide mode. It also shows sample light rays through the embodiment for this mode. In the ultra-wide mode, the field-of-view (FOV) is approximately 115 degrees, the F-number is approximately 2.2, and the effective focal length (EFL) is approximately 3.12 mm.

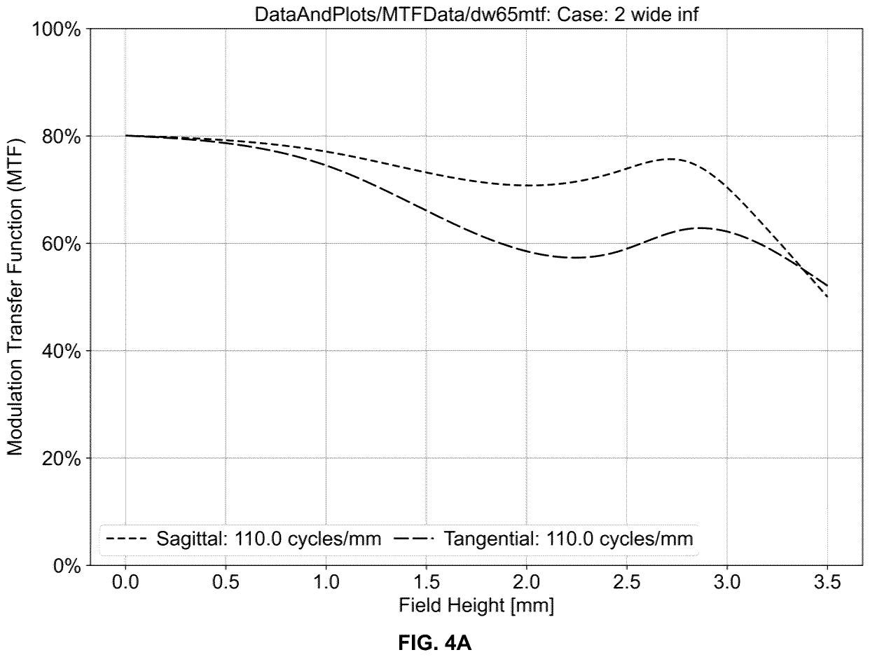

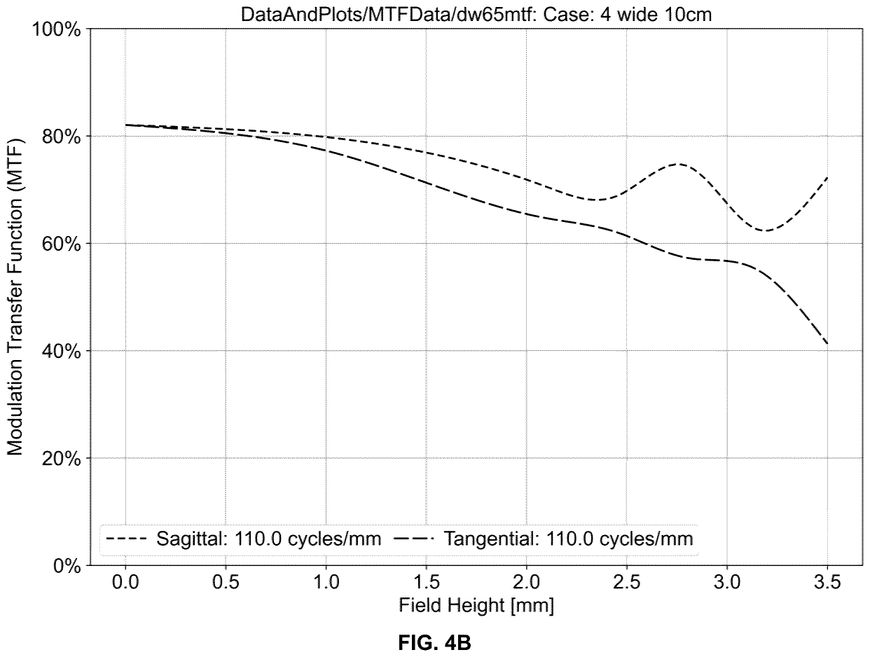

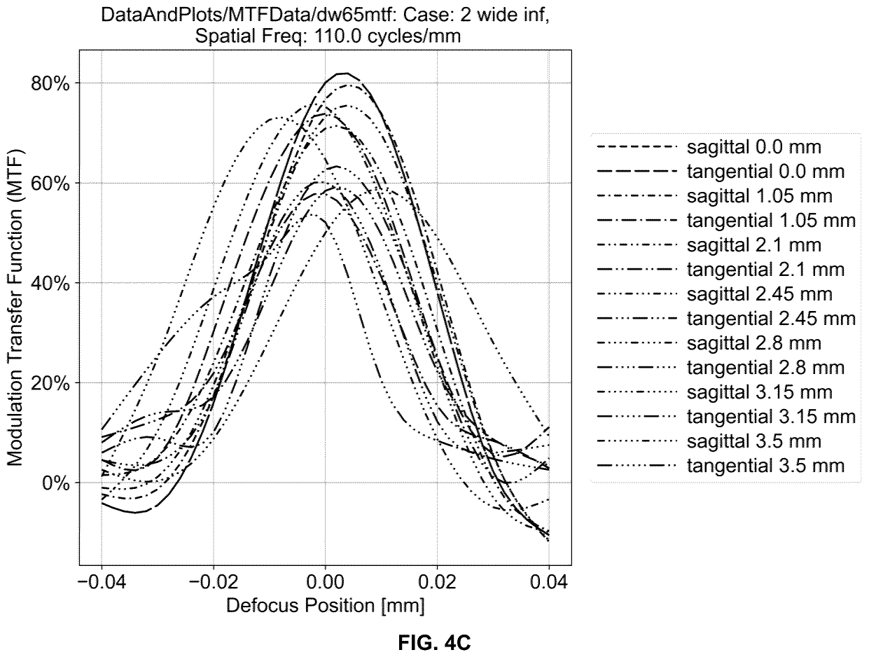

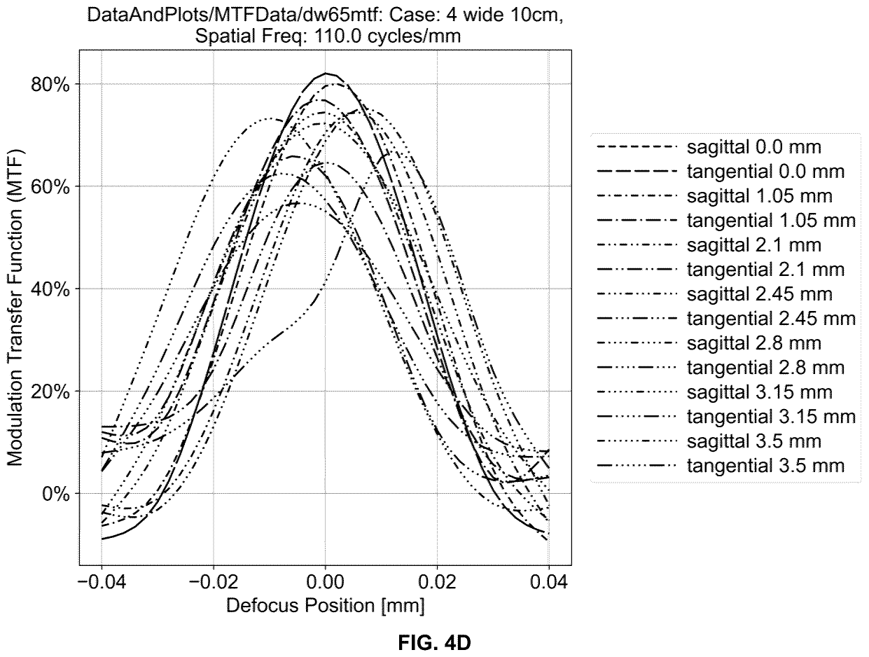

For the ultra-wide mode, FIG. 4A is an MTF performance diagram for this embodiment versus field height, for an object plane located away at infinity. FIG. 4B is an MTF performance diagram versus field height, for an object plane located at 10 centimeters. FIG. 4C is an MTF versus defocus position, for an object plane located at infinity. And FIG. 4D is an MTF versus defocus position, for an object plane at 10 centimeters.

### Embodiment #2

This embodiment (FIGS. 5A-8D) can have a periscope arrangement, with a turning optic that may be a mirror or a prism. The total size of the optics can be approximately 13.2 mm (X length)×10 mm (Y width)×23.24 mm (Z height).

The embodiment can have 10 lenses (10 aspherical and 0 spherical). The turning optic may be positioned before the second lens, before the remaining lenses in the periscope arm. There may be 3 moving lens groups, with 4 lenses in the first group, and 2 lenses in the second group, and 1 lens in the third group. The power of these groups may be positive, positive, and negative, respectively. The motion of the first lens group may also be used for auto-focusing.

Table 2 states possible lens shapes and placement for this embodiment, for both

TABLE 2
Lens shape parameters for embodiment #2.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 5.863 | 1.009 | 1.50 | 81.56 | −6.36E−01 | 6.84E−04 | −5.96E−05 | 2.87E−06 |
| | 3.529 | 6.767 | | | −1.43E+00 | 4.33E−03 | −2.68E−04 | 3.85E−05 |
| | | 5.468 | 1.52 | 64.20 | | | | |
| | | 0.056 | | | | | | |
| 2 | 6.549 | 1.460 | 1.50 | 81.56 | 1.55E+00 | 1.28E−03 | −3.44E−04 | 1.18E−04 |
| | −14.657 | 0.070 | | | −4.59E+00 | 5.29E−03 | −1.24E−03 | 2.69E−04 |
| 3 | 3.528 | 0.245 | 1.63 | 23.43 | −9.91E−01 | −1.91E−02 | 3.24E−03 | −1.02E−03 |
| | 2.974 | 1.492 | | | −1.09E+00 | −2.35E−02 | 4.94E−03 | −1.56E−03 |
| 4 | 12.792 | 1.103 | 1.50 | 81.56 | −5.21E+00 | 2.90E−03 | 1.16E−04 | −1.57E−04 |
| | −9.943 | 0.004 | | | −1.01E+01 | 3.99E−03 | −1.07E−03 | 1.16E−04 |
| 5 | 4.508 | 0.205 | 1.57 | 37.67 | −1.53E+01 | −7.93E−03 | −4.15E−04 | −2.01E−04 |
| | 3.505 | 2.387 | | | −1.03E+01 | −3.86E−03 | −1.41E−03 | 3.44E−04 |
| 6 | 28.318 | 0.508 | 1.59 | 29.90 | −1.65E+01 | −5.57E−03 | 1.21E−03 | −4.74E−04 |
| | 14.332 | 0.927 | | | −2.82E+01 | −6.48E−03 | 1.84E−03 | −5.81E−04 |
| 7 | 11.796 | 2.281 | 1.53 | 55.75 | −1.23E+01 | −2.56E−03 | 4.62E−04 | 1.62E−05 |
| | −5.774 | 0.001 | | | −6.85E+00 | 2.21E−03 | −2.82E−03 | 6.50E−04 |
| 8 | −6.604 | 0.200 | 1.63 | 23.43 | 9.79E−01 | 2.52E−02 | −8.78E−03 | 1.29E−03 |
| | −29.724 | 1.409 | | | −1.87E+00 | 1.66E−02 | −5.69E−03 | 8.09E−04 |
| 9 | −3.868 | 0.200 | 1.53 | 55.75 | −3.24E+00 | −3.56E−04 | 1.07E−03 | −2.52E−04 |
| | −23.419 | 0.065 | | | 9.46E+00 | 8.85E−05 | 5.47E−04 | −5.62E−05 |
| 10 | −44.345 | 0.200 | 1.59 | 29.90 | −1.19E+01 | 1.21E−03 | 3.53E−04 | −1.05E−04 |
| | 72.597 | 0.080 | | | −1.13E+01 | 1.29E−02 | −3.33E−03 | 3.43E−04 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | −9.20E−08 | 1.48E−09 | −1.06E−11 | 8.67E−15 | 2.65E−16 | −9.70E−19 |
| | −3.44E−06 | 2.05E−07 | −7.57E−09 | 1.58E−10 | −1.70E−12 | 7.36E−15 |
| 2 | −3.04E−05 | 5.24E−06 | −5.78E−07 | 3.88E−08 | −1.43E−09 | 2.21E−11 |
| | −4.86E−05 | 7.06E−06 | −7.47E−07 | 5.13E−08 | −1.98E−09 | 3.18E−11 |
| 3 | 2.27E−04 | −3.23E−05 | 2.95E−06 | −1.65E−07 | 5.10E−09 | −6.61E−11 |
| | 3.60E−04 | −5.64E−05 | 5.88E−06 | −3.88E−07 | 1.46E−08 | −2.36E−10 |
| 4 | 6.19E−05 | −1.41E−05 | 1.87E−06 | −1.44E−07 | 5.90E−09 | −9.88E−11 |
| | 3.70E−05 | −1.53E−05 | 2.32E−06 | −1.80E−07 | 7.04E−09 | −1.11E−10 |
| 5 | 1.43E−04 | −3.55E−05 | 4.60E−06 | −3.25E−07 | 1.18E−08 | −1.73E−10 |
| | −3.54E−05 | −3.01E−08 | 3.96E−07 | −3.97E−08 | 1.62E−09 | −2.43E−11 |
| 6 | 9.83E−05 | −1.19E−05 | 8.60E−07 | −3.65E−08 | 8.46E−10 | −8.23E−12 |
| | 9.84E−05 | −9.84E−06 | 5.90E−07 | −2.07E−08 | 3.89E−10 | −3.04E−12 |
| 7 | −1.70E−05 | 2.35E−06 | −1.59E−07 | 5.75E−09 | −1.06E−10 | 7.85E−13 |
| | −7.87E−05 | 5.66E−06 | −2.48E−07 | 6.51E−09 | −9.33E−11 | 5.60E−13 |
| 8 | −1.00E−04 | 4.20E−06 | −7.75E−08 | −3.08E−10 | 3.31E−11 | −3.50E−13 |
| | −6.53E−05 | 3.23E−06 | −9.96E−08 | 1.86E−09 | −1.90E−11 | 8.20E−14 |
| 9 | 2.35E−05 | −1.17E−06 | 3.37E−08 | −5.73E−10 | 5.27E−12 | −2.03E−14 |
| | 2.83E−06 | −9.31E−08 | 1.86E−09 | −1.86E−11 | 5.73E−14 | 1.68E−16 |
| 10 | 1.10E−05 | −5.84E−07 | 1.69E−08 | −2.71E−10 | 2.26E−12 | −7.59E−15 |
| | −1.91E−05 | 6.40E−07 | −1.32E−08 | 1.66E−10 | −1.15E−12 | 3.42E−15 |

FIGS. 5A and 5B show lens shapes and placement for this embodiment, when it is operating in a main mode. It also shows sample light rays through the embodiment for this mode. In the main mode, the field-of-view (FOV) is approximately 85.5 degrees, the F-number is approximately 1.6, and the effective focal length (EFL) is approximately 6.69 mm.

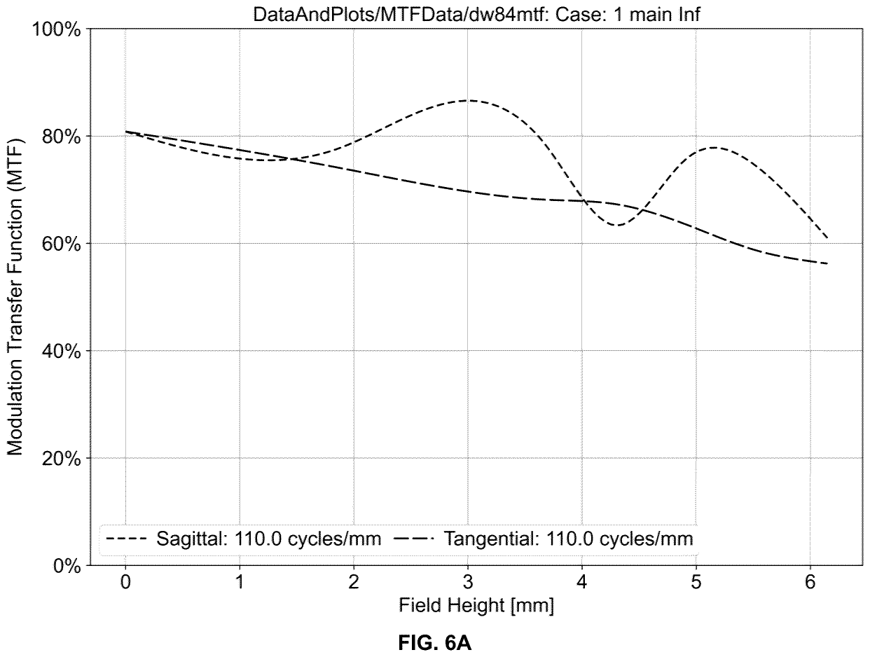

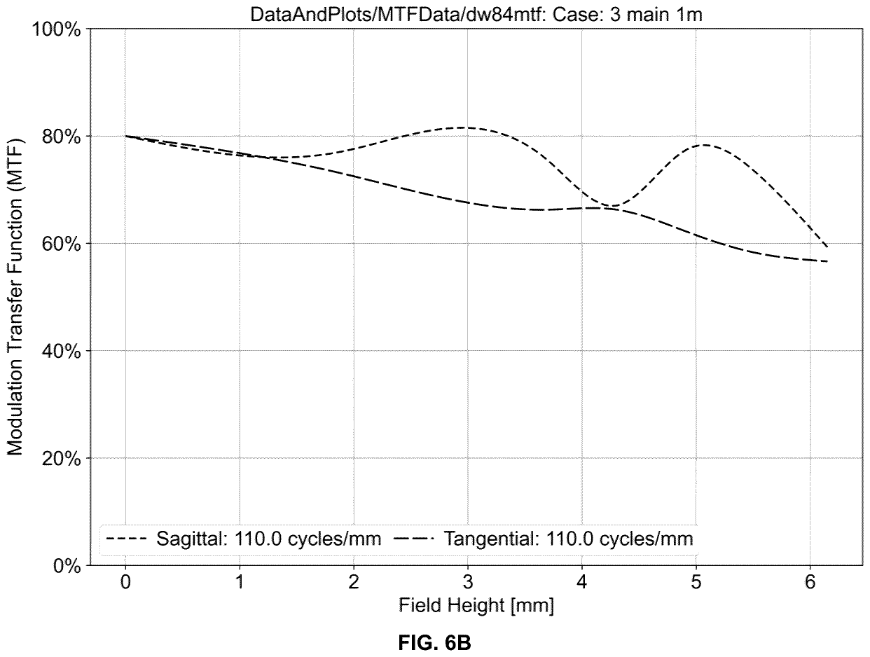

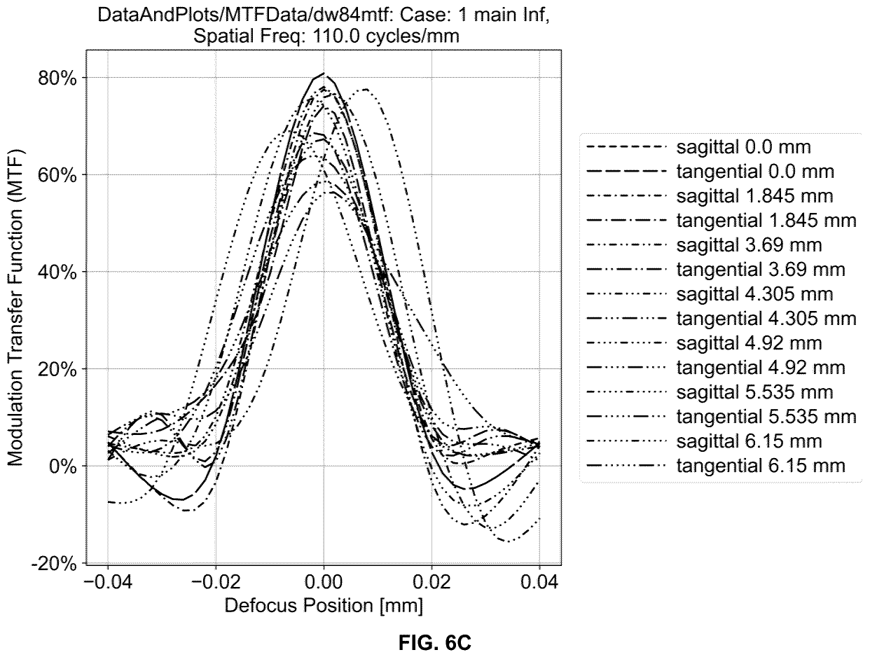

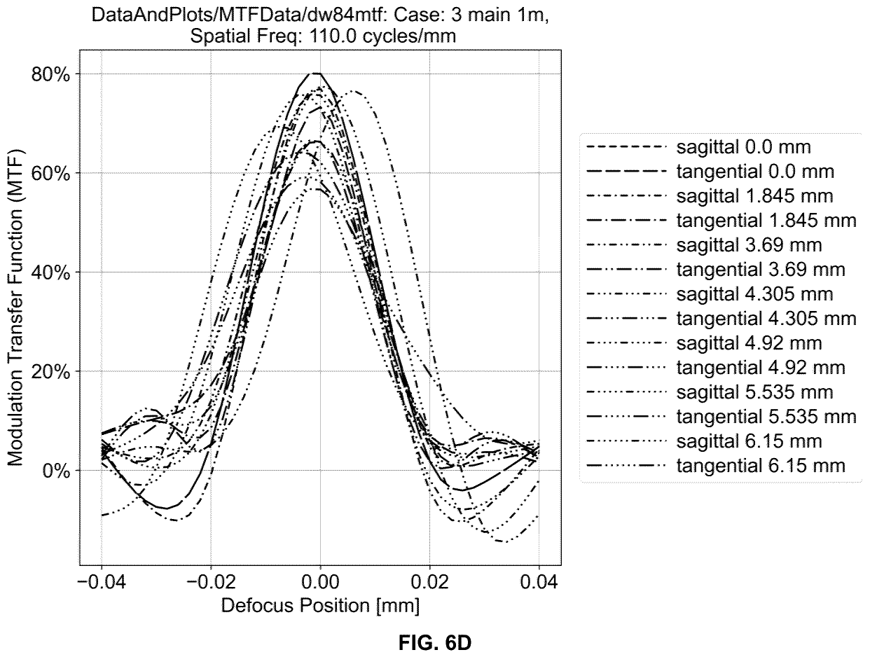

For the main mode, FIG. 6A is an MTF (modulation transfer function) performance diagram versus field height for this embodiment, for an object plane located away at infinity. FIG. 6B is an MTF performance diagram versus field height, for an object plane located at 1 meter. FIG. 6C is an MTF versus defocus position, for an object plane located at infinity. And FIG. 6D is an MTF versus defocus position, for an object plane at 10 centimeters.

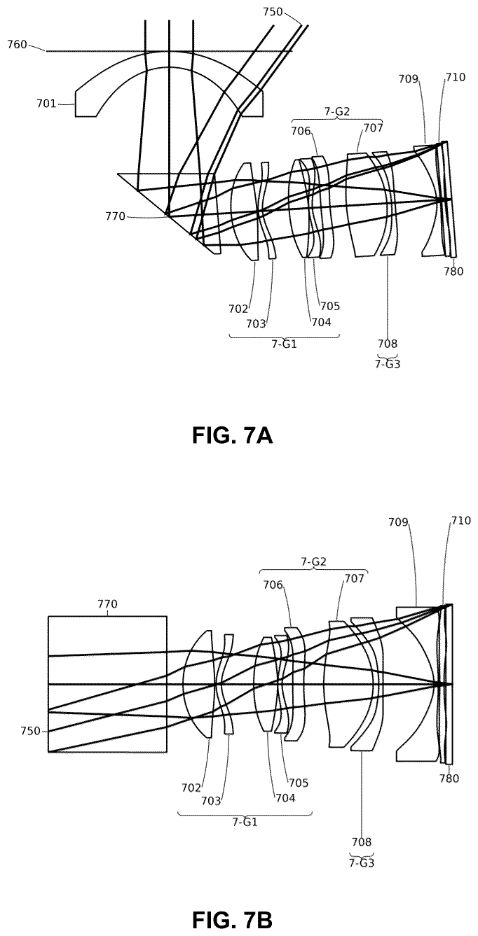

FIGS. 7A and 7B show lens placement for this embodiment, when it is operating in an ultra-wide mode. It also shows sample light rays through the embodiment for this mode. In the ultra-wide mode, the field-of-view (FOV) is approximately 115 degrees, the F-number is approximately 2.2, and the effective focal length (EFL) is approximately 5.93 mm.

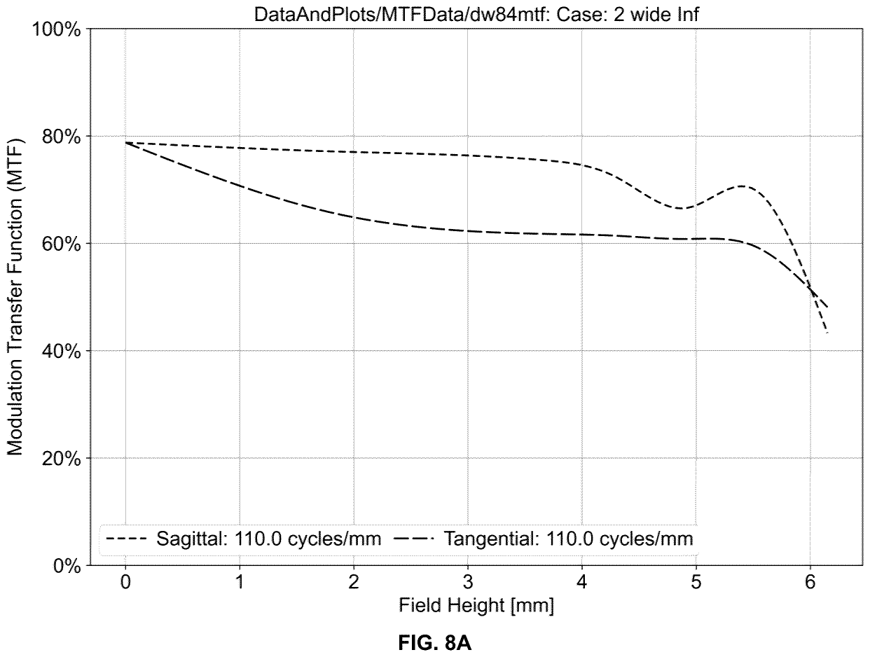

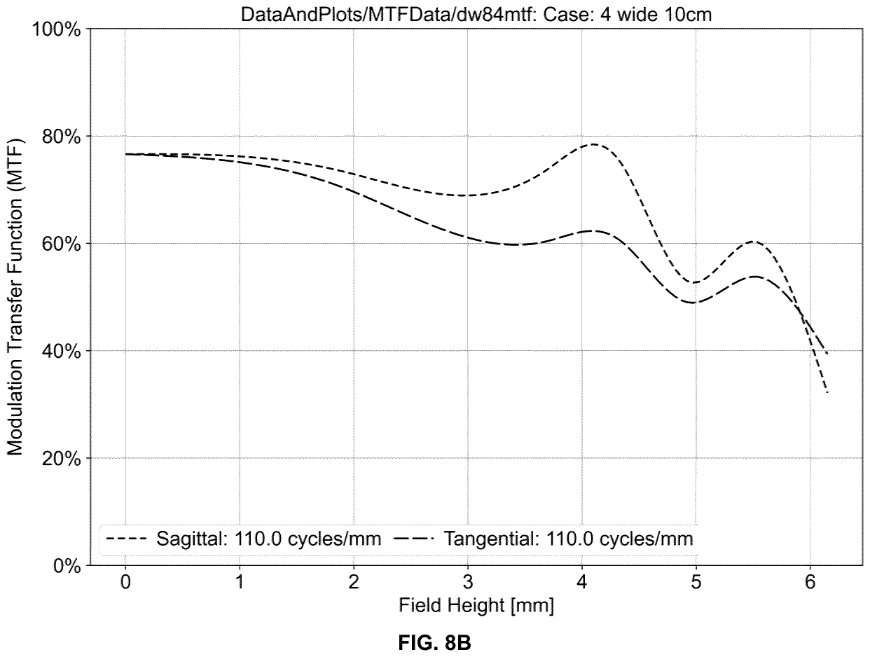

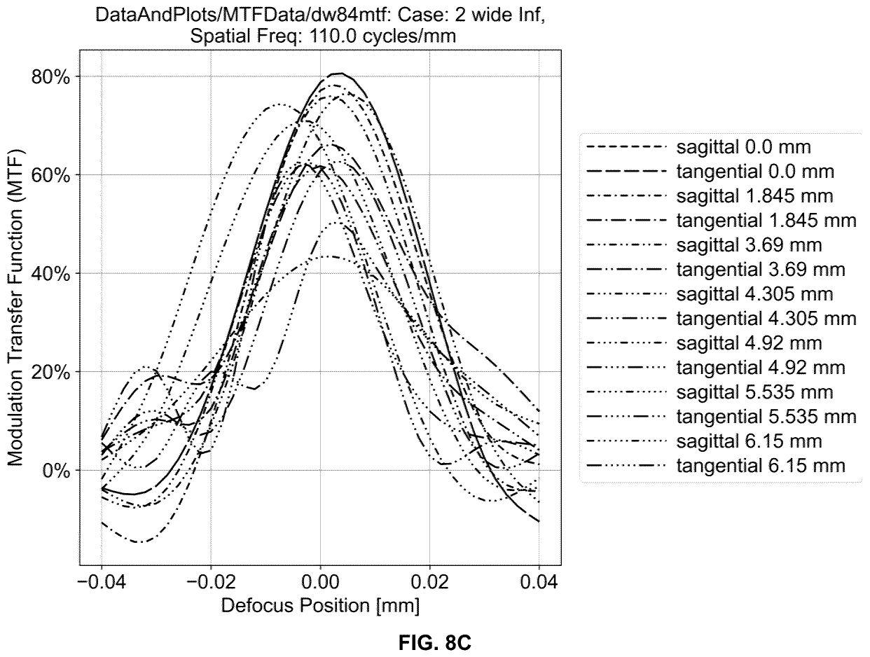

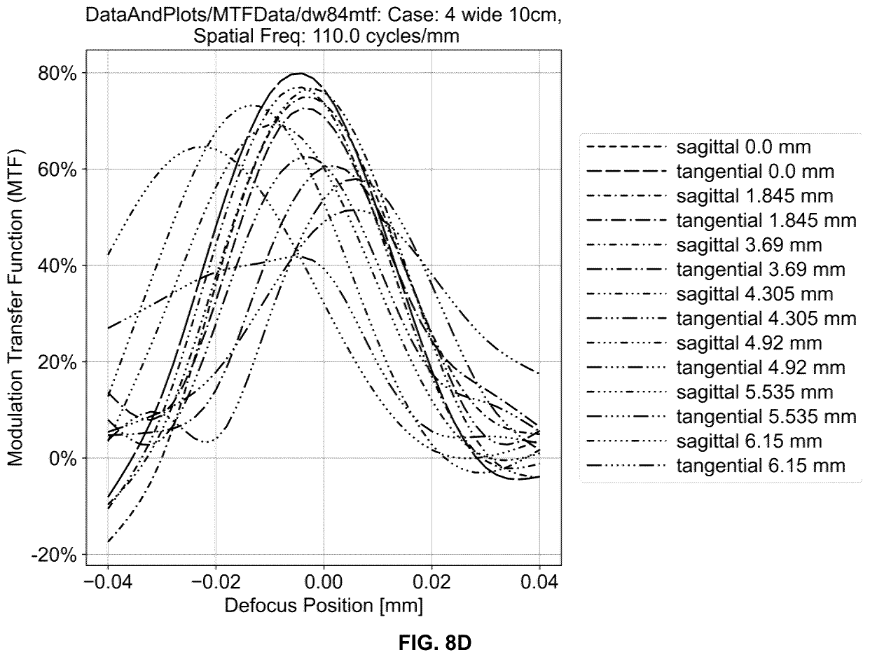

For the ultra-wide mode, FIG. 8A is an MTF performance diagram for this embodiment versus field height, for an object plane located away at infinity. FIG. 8B is an MTF performance diagram versus field height, for an object plane located at 10 centimeters. FIG. 8C is an MTF versus defocus position, for an object plane located at infinity. And FIG. 8D is an MTF versus defocus position, for an object plane at 10 centimeters.

### Embodiment #3

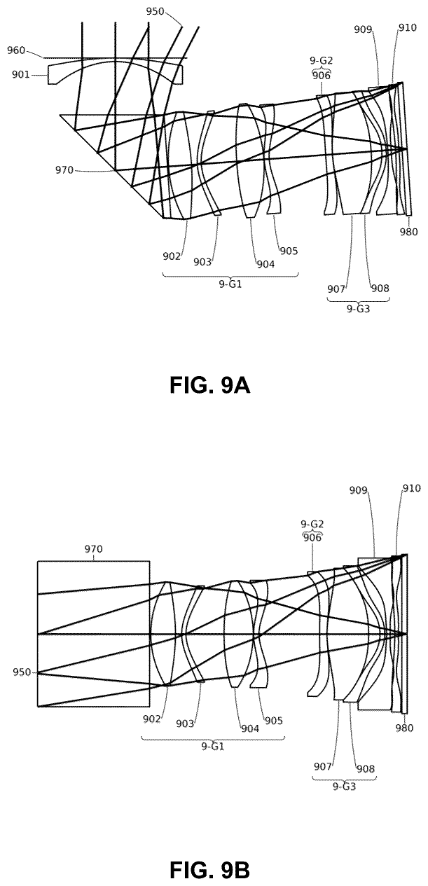

This embodiment (FIGS. 9A-12D) can have a periscope arrangement, with a turning optic that may be a mirror or a prism. The total size of the optics can be approximately 21.31 mm (X length)×10 mm (Y width)×8.87 mm (Z height).

The embodiment can have 10 lenses (10 aspherical and 0 spherical). The turning optic may be positioned before the second lens, before the remaining lenses in the periscope arm. There may be 3 moving lens groups, with 4 lenses in the first group, and 1 lens in the second group, and 2 lenses in the third group. The power of these groups may be positive, negative, and positive. The motion of the first lens group may also be used for auto-focusing.

Table 3 states possible lens shapes and placement for this embodiment, for both

TABLE 3
Lens shape parameters for embodiment #3.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 14.008 | 0.200 | 1.50 | 81.56 | 1.94E+00 | −8.26E−04 | 2.33E−05 | −1.45E−06 |
| | 4.996 | 2.950 | | | −1.96E+00 | 1.27E−03 | −3.79E−05 | 6.15E−06 |
| | | 6.150 | 1.52 | 64.20 | | | | |
| | | 0.065 | | | | | | |
| 2 | 6.833 | 1.352 | 1.50 | 81.56 | −4.10E−02 | 7.51E−04 | −1.13E−04 | 7.91E−06 |
| | −11.698 | 0.342 | | | −4.41E+00 | 1.96E−03 | 3.26E−04 | −2.60E−04 |
| 3 | 3.031 | 0.236 | 1.63 | 23.43 | −7.29E−01 | −1.99E−02 | 4.61E−03 | −1.38E−03 |
| | 2.611 | 2.088 | | | −1.08E+00 | −2.09E−02 | 5.17E−03 | −1.44E−03 |
| 4 | 19.044 | 1.603 | 1.50 | 81.56 | −6.19E+00 | 2.53E−03 | −5.66E−04 | 1.44E−04 |
| | −5.814 | 0.017 | | | −1.86E+01 | 8.01E−04 | −2.45E−03 | 7.74E−04 |
| 5 | 3.611 | 0.297 | 1.57 | 37.67 | −1.59E+01 | 2.48E−03 | −4.81E−03 | 1.13E−03 |
| | 2.590 | 3.329 | | | −8.53E+00 | 3.20E−03 | −3.61E−03 | 8.29E−04 |
| 6 | 63.557 | 0.402 | 1.63 | 23.43 | −1.67E+01 | −7.39E−04 | −2.15E−03 | 7.70E−04 |
| | 8.167 | 0.000 | | | −2.96E+01 | −4.34E−03 | −1.16E−03 | 5.46E−04 |
| 7 | 6.048 | 2.281 | 1.53 | 55.75 | −1.38E+01 | −5.23E−03 | 7.92E−04 | −4.39E−05 |
| | −9.920 | 0.627 | | | −5.23E+00 | −3.57E−03 | −4.38E−04 | 1.12E−04 |
| 8 | −2.950 | 0.263 | 1.63 | 23.43 | −1.33E+00 | −2.90E−02 | 1.00E−02 | −1.41E−03 |
| | −3.082 | 0.093 | | | −5.16E+00 | −3.90E−02 | 1.13E−02 | −1.49E−03 |
| 9 | −9.256 | 0.200 | 1.53 | 55.75 | −6.64E−01 | 1.69E−02 | −7.00E−03 | 1.08E−03 |
| | −28.629 | 0.257 | | | 2.02E+01 | 5.11E−02 | −1.40E−02 | 1.70E−03 |
| 10 | −16.141 | 0.200 | 1.53 | 55.75 | −9.34E+00 | 3.32E−03 | −7.02E−04 | 9.95E−05 |
| | 36.403 | 0.181 | | | −1.16E+01 | −2.67E−02 | 6.51E−03 | −6.67E−04 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | 5.25E−08 | −1.24E−09 | 1.92E−11 | −1.83E−13 | 8.99E−16 | −1.60E−18 |
| | −6.99E−07 | 4.26E−08 | −1.59E−09 | 3.60E−11 | −4.39E−13 | 2.19E−15 |
| 2 | 2.52E−06 | −1.13E−06 | 1.91E−07 | −1.69E−08 | 7.58E−10 | −1.33E−11 |
| | 7.52E−05 | −1.29E−05 | 1.39E−06 | −9.08E−08 | 3.29E−09 | −4.96E−11 |
| 3 | 3.13E−04 | −4.88E−05 | 5.01E−06 | −3.18E−07 | 1.12E−08 | −1.66E−10 |
| | 3.17E−04 | −4.82E−05 | 4.81E−06 | −2.96E−07 | 9.90E−09 | −1.36E−10 |
| 4 | −2.79E−05 | 3.74E−06 | −3.24E−07 | 1.72E−08 | −4.90E−10 | 5.49E−12 |
| | −1.52E−04 | 1.95E−05 | −1.64E−06 | 8.61E−08 | −2.55E−09 | 3.20E−11 |
| 5 | −1.72E−04 | 1.76E−05 | −1.24E−06 | 5.81E−08 | −1.67E−09 | 2.16E−11 |
| | −1.18E−04 | 1.13E−05 | −7.15E−07 | 2.89E−08 | −6.72E−10 | 6.78E−12 |
| 6 | −1.51E−04 | 1.72E−05 | −1.18E−06 | 4.71E−08 | −1.01E−09 | 8.78E−12 |
| | −1.06E−04 | 1.11E−05 | −6.94E−07 | 2.52E−08 | −4.86E−10 | 3.84E−12 |
| 7 | −3.27E−06 | 6.88E−07 | −4.88E−08 | 1.75E−09 | −3.13E−11 | 2.21E−13 |
| | −5.96E−06 | −3.51E−07 | 5.25E−08 | −2.34E−09 | 4.64E−11 | −3.50E−13 |
| 8 | 1.18E−04 | −6.64E−06 | 2.55E−07 | −6.34E−09 | 9.02E−11 | −5.51E−13 |
| | 1.15E−04 | −5.56E−06 | 1.70E−07 | −3.18E−09 | 3.30E−11 | −1.45E−13 |
| 9 | −9.40E−05 | 5.00E−06 | −1.65E−07 | 3.30E−09 | −3.64E−11 | 1.70E−13 |
| | −1.12E−04 | 4.39E−06 | −1.05E−07 | 1.49E−09 | −1.15E−11 | 3.74E−14 |
| 10 | −7.04E−06 | 2.66E−07 | −5.65E−09 | 6.88E−11 | −4.51E−13 | 1.25E−15 |
| | 3.70E−05 | −1.22E−06 | 2.45E−08 | −2.93E−10 | 1.93E−12 | −5.33E−15 |

FIGS. 9A and 9B show lens shapes and placement for this embodiment, when it is operating in main mode. It also shows sample light rays through the embodiment for this mode. In main mode, the field-of-view (FOV) is approximately 85.5 degrees, the F-number is approximately 1.6, and the effective focal length (EFL) is approximately 6.69 mm.

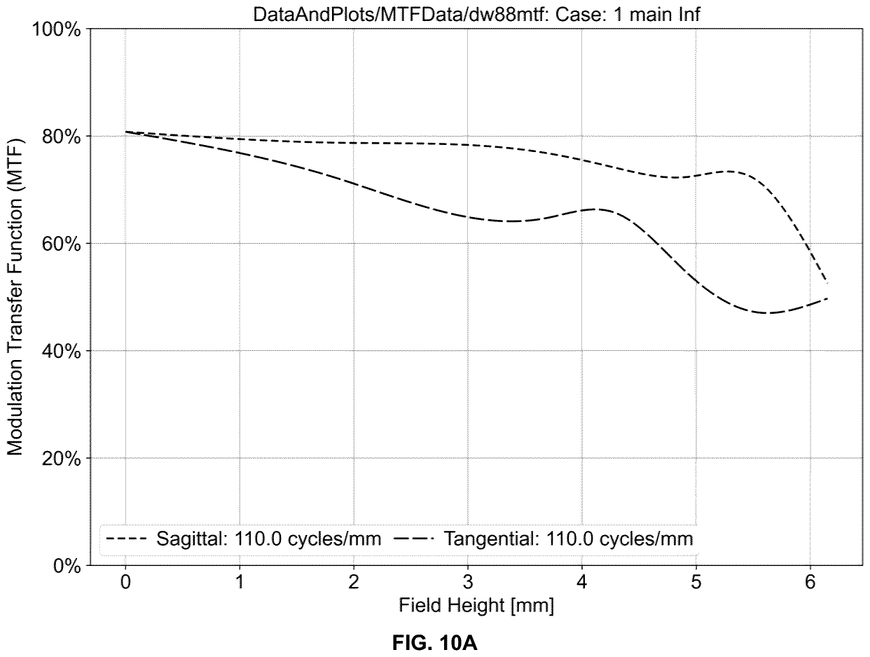

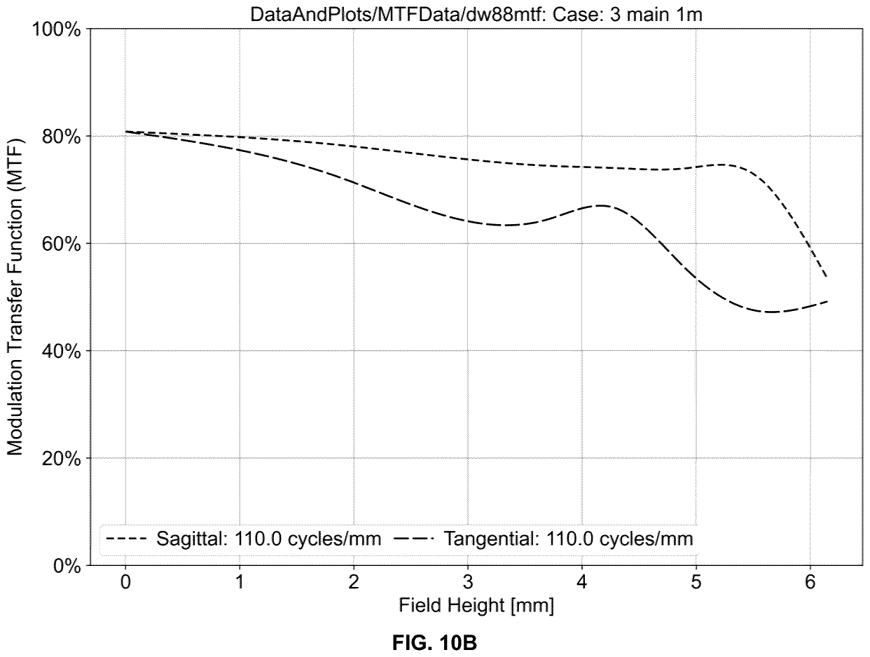

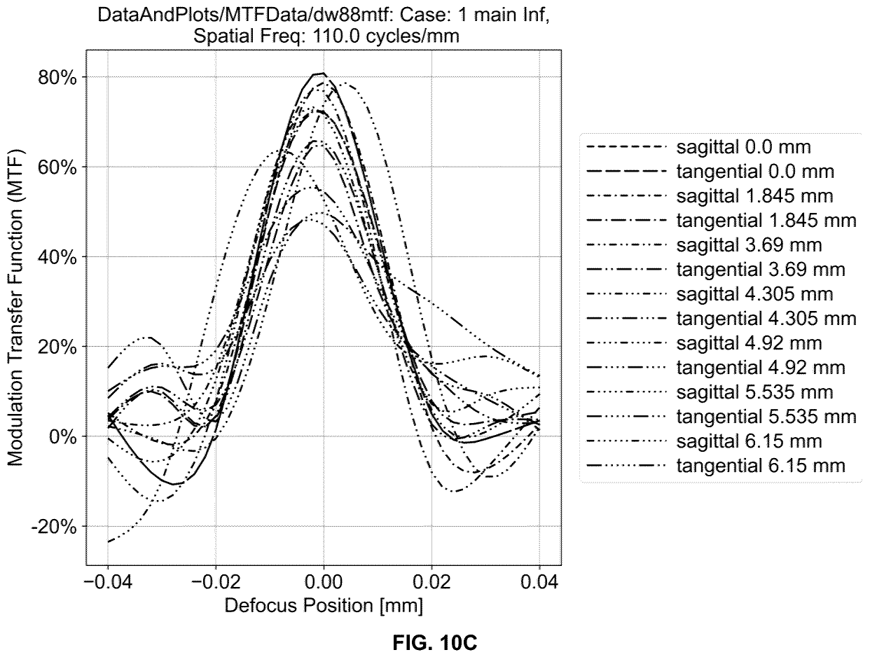

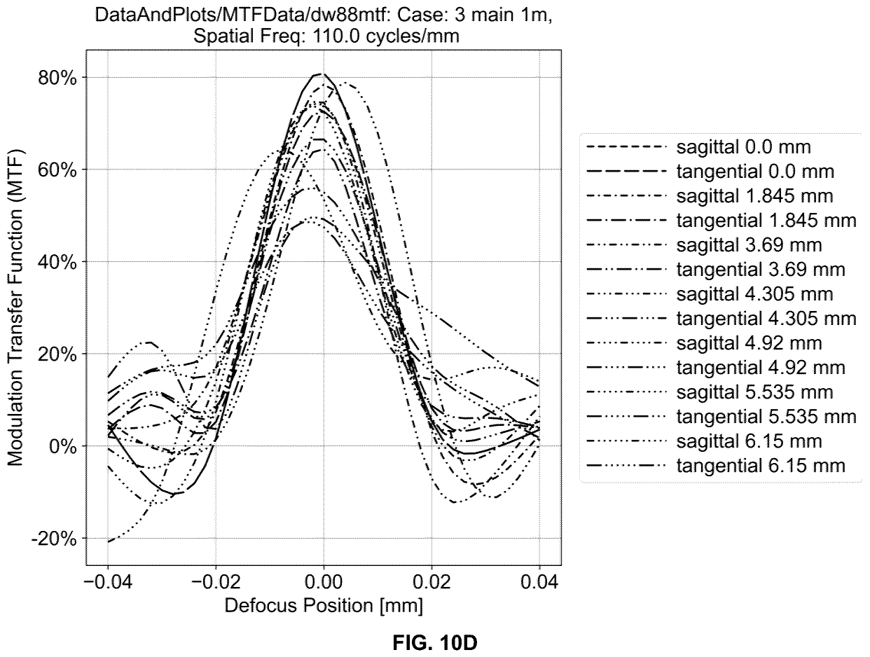

For main mode, FIG. 10A is an MTF (modulation transfer function) performance diagram versus field height for this embodiment, for an object plane located away at infinity. FIG. 10B is an MTF performance diagram versus field height, for an object plane located at 1 meter. FIG. 10C is an MTF versus defocus position, for an object plane located at infinity. And FIG. 10D is an MTF versus defocus position, for an object plane at 10 centimeters.

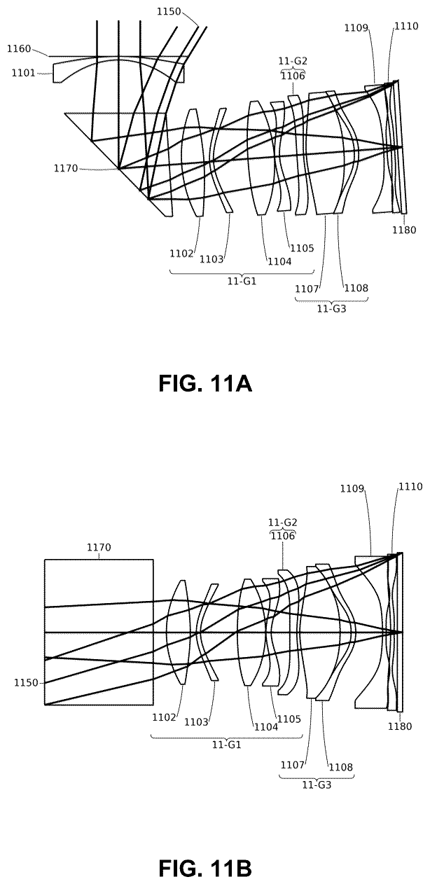

FIGS. 11A and 11B show lens placement for this embodiment, when it is operating in ultra-wide mode. It also shows sample light rays through the embodiment for this mode. In ultra-wide mode, the field-of-view (FOV) is approximately 115 degrees, the F-number is approximately 2.2, and the effective focal length (EFL) is approximately 5.76 mm.

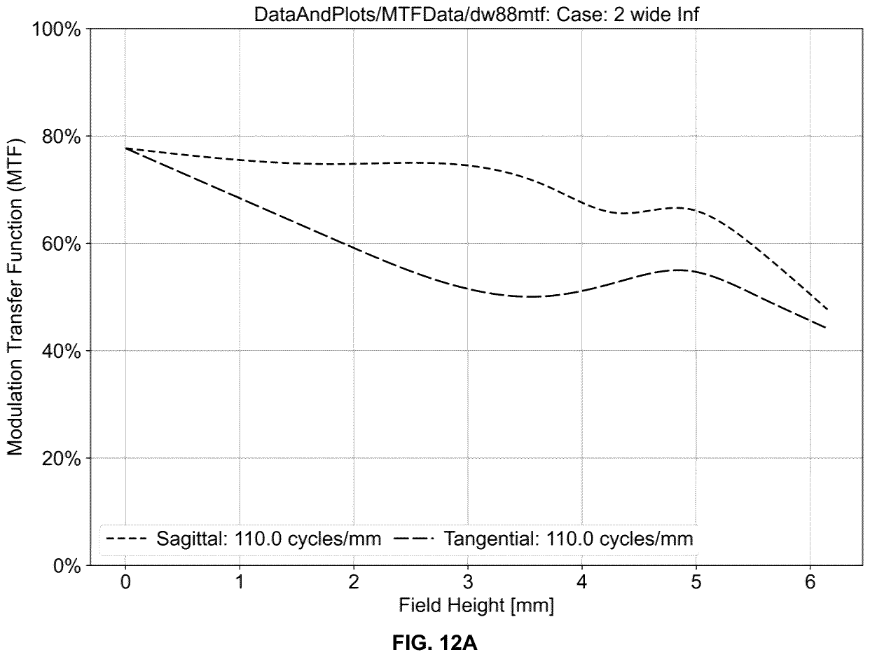

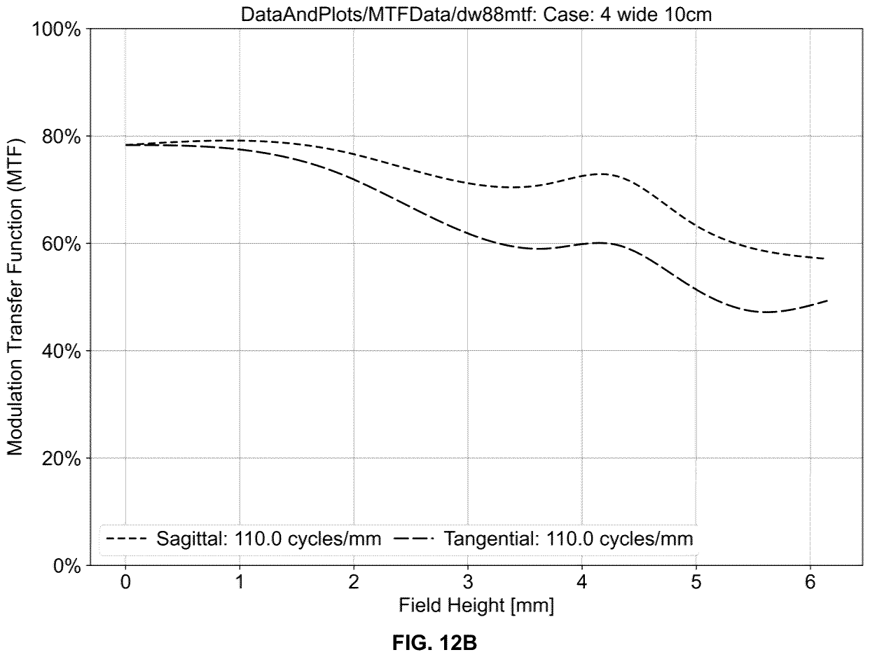

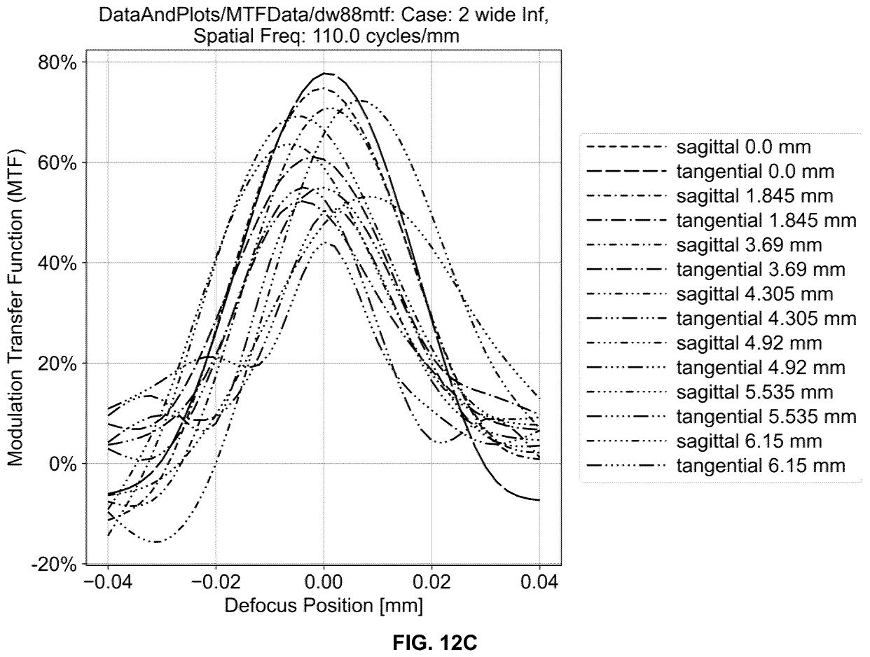

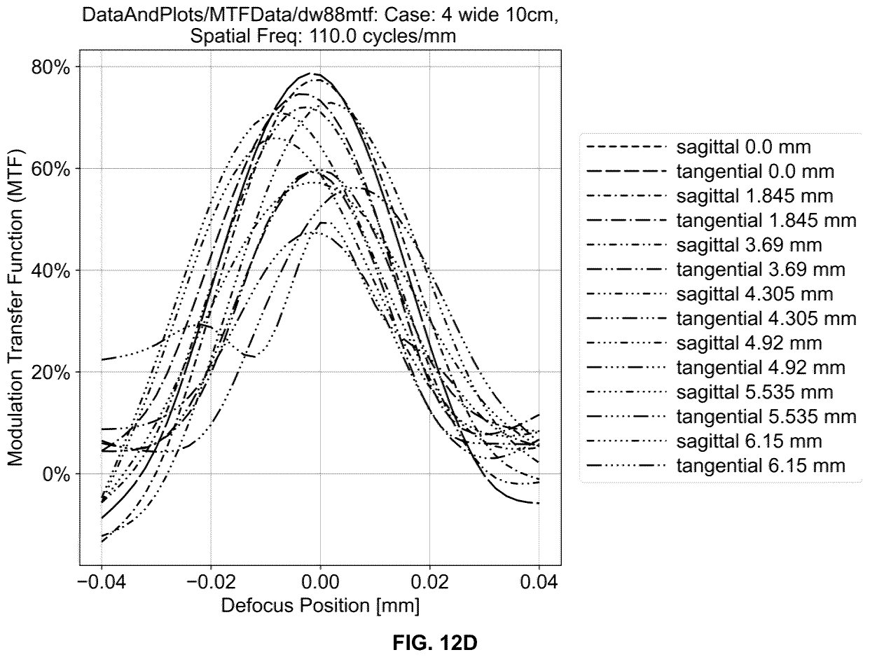

For ultra-wide mode, FIG. 12A is an MTF performance diagram for this embodiment versus field height, for an object plane located away at infinity. FIG. 12B is an MTF performance diagram versus field height, for an object plane located at 10 centimeters. FIG. 12C is an MTF versus defocus position, for an object plane located at infinity. And FIG. 12D is an MTF versus defocus position, for an object plane at 10 centimeters.

### Embodiment #4

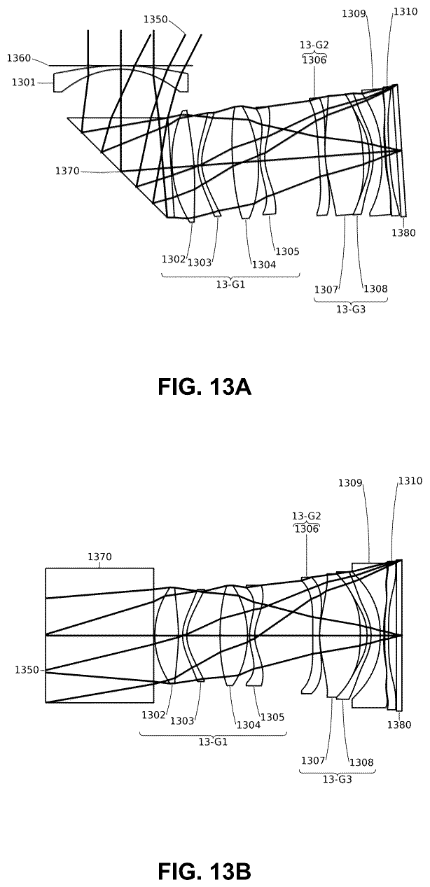

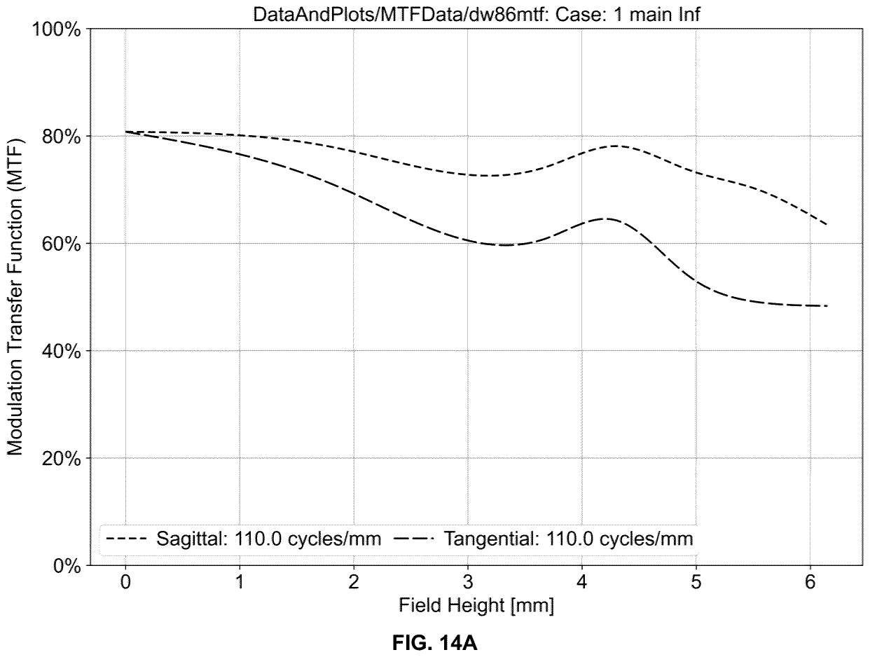

This embodiment (FIGS. 13A-16D) can have a periscope arrangement, with a turning optic that may be a mirror or a prism. The total size of the optics can be approximately 21.04 mm (X length)×10 mm (Y width)×8.02 mm (Z height).

The embodiment can have 10 lenses (10 aspherical and 0 spherical). The turning optic may be positioned before the second lens, before the remaining lenses in the periscope arm. There may be 3 moving lens groups, with 4 lenses in the first group, and 1 lens in the second group, and 2 lenses in the third group. The power of these groups may be positive, negative, and positive. The motion of the first lens group may also be used for auto-focusing.

Table 4 states possible lens shapes and placement for this embodiment, for both

TABLE 4
Lens shape parameters for embodiment #4.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 14.785 | 0.200 | 1.4971 | 81.56 | 2.48E+00 | −4.20E−04 | 2.98E−06 | −1.26E−06 |
| | 5.186 | 2.708 | | | −2.48E+00 | 1.92E−03 | −3.61E−05 | 2.36E−06 |
| | | 5.987 | 1.5168 | 64.2 | | | | |
| | | 0.068 | | | | | | |
| 2 | 6.574 | 1.302 | 1.4971 | 81.56 | −1.53E−02 | 1.46E−03 | −4.10E−04 | 1.42E−04 |
| | −12.570 | 0.233 | | | −4.36E+00 | 3.87E−03 | −4.58E−04 | 3.93E−05 |
| 3 | 2.970 | 0.232 | 1.6322 | 23.43 | −7.43E−01 | −2.04E−02 | 3.93E−03 | −9.63E−04 |
| | 2.561 | 1.842 | | | −1.05E+00 | −2.29E−02 | 5.02E−03 | −1.21E−03 |
| 4 | 22.242 | 1.523 | 1.4971 | 81.56 | −5.93E+00 | 2.76E−03 | −4.17E−04 | 6.68E−05 |
| | −5.911 | 0.114 | | | −1.99E+01 | −3.73E−04 | −1.42E−03 | 3.88E−04 |
| 5 | 3.616 | 0.284 | 1.5731 | 37.67 | −1.42E+01 | 2.08E−03 | −4.34E−03 | 9.09E−04 |
| | 2.654 | 3.211 | | | −8.01E+00 | 2.00E−03 | −3.10E−03 | 6.35E−04 |
| 6 | 64.600 | 0.385 | 1.6322 | 23.43 | −1.67E+01 | −4.34E−03 | −4.59E−04 | 2.54E−04 |
| | 8.245 | 0.000 | | | −2.91E+01 | −5.81E−03 | −3.16E−04 | 2.39E−04 |
| 7 | 5.985 | 2.254 | 1.5311 | 55.75 | −1.29E+01 | −3.55E−03 | 3.27E−04 | 8.36E−06 |
| | −15.763 | 0.373 | | | −3.68E+00 | −6.21E−03 | −5.53E−04 | 2.55E−04 |
| 8 | −4.375 | 0.222 | 1.6322 | 23.43 | −5.92E−01 | −1.53E−02 | 4.57E−03 | −4.57E−04 |
| | −4.062 | 0.507 | | | −7.42E+00 | −2.22E−02 | 6.50E−03 | −8.53E−04 |
| 9 | −11.006 | 0.200 | 1.5311 | 55.75 | 1.71E+00 | −1.25E−02 | 2.44E−03 | −2.86E−04 |
| | −35.029 | 0.058 | | | 1.93E+01 | 3.41E−02 | −8.78E−03 | 1.00E−03 |
| 10 | −26.683 | 0.200 | 1.5311 | 55.75 | −8.85E+00 | 2.53E−02 | −5.92E−03 | 6.26E−04 |
| | 30.487 | 0.449 | | | −1.12E+01 | −1.58E−03 | 1.23E−03 | −1.73E−04 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | 6.67E−08 | −1.84E−09 | 3.00E−11 | −2.86E−13 | 1.40E−15 | −2.49E−18 |
| | −4.32E−07 | 3.08E−08 | −1.20E−09 | 2.73E−11 | −3.29E−13 | 1.61E−15 |
| 2 | −3.43E−05 | 5.33E−06 | −5.21E−07 | 3.02E−08 | −9.25E−10 | 1.14E−11 |
| | −4.95E−07 | −5.45E−07 | 1.02E−07 | −9.82E−09 | 5.03E−10 | −1.01E−11 |
| 3 | 1.85E−04 | −2.56E−05 | 2.40E−06 | −1.43E−07 | 4.78E−09 | −6.84E−11 |
| | 2.31E−04 | −3.14E−05 | 2.86E−06 | −1.63E−07 | 5.08E−09 | −6.55E−11 |
| 4 | −9.74E−06 | 1.17E−06 | −9.52E−08 | 4.86E−09 | −1.34E−10 | 1.36E−12 |
| | −6.90E−05 | 8.27E−06 | −6.52E−07 | 3.24E−08 | −9.06E−10 | 1.07E−11 |
| 5 | −1.29E−04 | 1.28E−05 | −8.71E−07 | 3.79E−08 | −9.37E−10 | 9.58E−12 |
| | −7.99E−05 | 6.86E−06 | −4.01E−07 | 1.52E−08 | −3.31E−10 | 3.06E−12 |
| 6 | −5.42E−05 | 6.32E−06 | −4.35E−07 | 1.72E−08 | −3.54E−10 | 2.95E−12 |
| | −4.79E−05 | 5.09E−06 | −3.19E−07 | 1.17E−08 | −2.25E−10 | 1.76E−12 |
| 7 | −5.85E−06 | 6.83E−07 | −4.18E−08 | 1.41E−09 | −2.44E−11 | 1.69E−13 |
| | −3.35E−05 | 2.30E−06 | −9.12E−08 | 2.10E−09 | −2.62E−11 | 1.36E−13 |
| 8 | 1.71E−05 | 2.94E−07 | −4.90E−08 | 1.77E−09 | −2.88E−11 | 1.81E−13 |
| | 6.35E−05 | −2.90E−06 | 8.27E−08 | −1.43E−09 | 1.36E−11 | −5.51E−14 |
| 9 | 1.97E−05 | −8.35E−07 | 2.24E−08 | −3.70E−10 | 3.42E−12 | −1.32E−14 |
| | −6.16E−05 | 2.23E−06 | −4.88E−08 | 6.39E−10 | −4.61E−12 | 1.41E−14 |
| 10 | −3.55E−05 | 1.17E−06 | −2.28E−08 | 2.62E−10 | −1.64E−12 | 4.34E−15 |
| | 1.11E−05 | −4.02E−07 | 8.60E−09 | −1.08E−10 | 7.38E−13 | −2.10E−15 |

FIGS. 13A and 13B show lens shapes and placement for this embodiment, when it is operating in main mode. It also shows sample light rays through the embodiment for this mode. In main mode, the field-of-view (FOV) is approximately 85.5 degrees, the F-number is approximately 1.6, and the effective focal length (EFL) is approximately 6.9 mm.

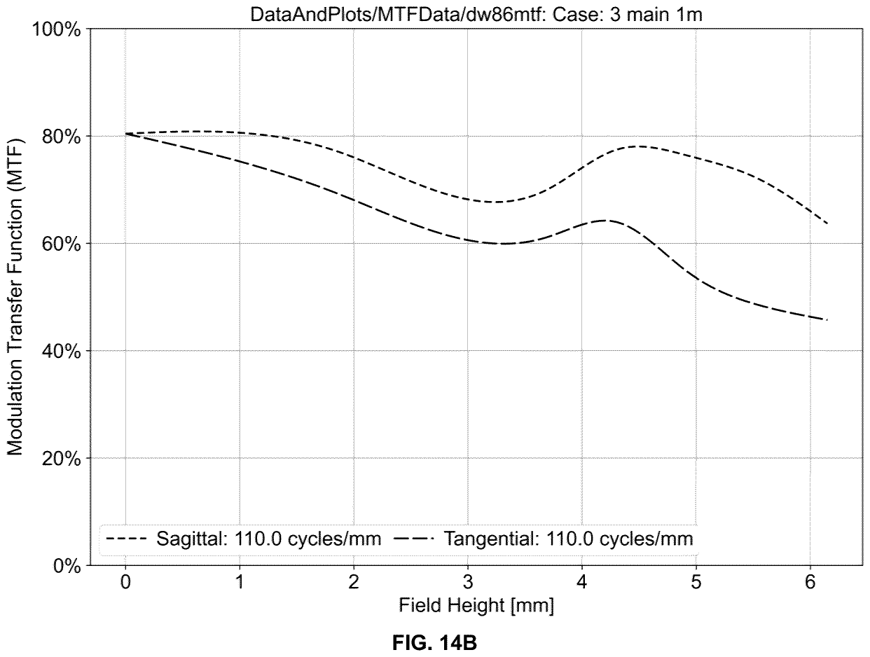

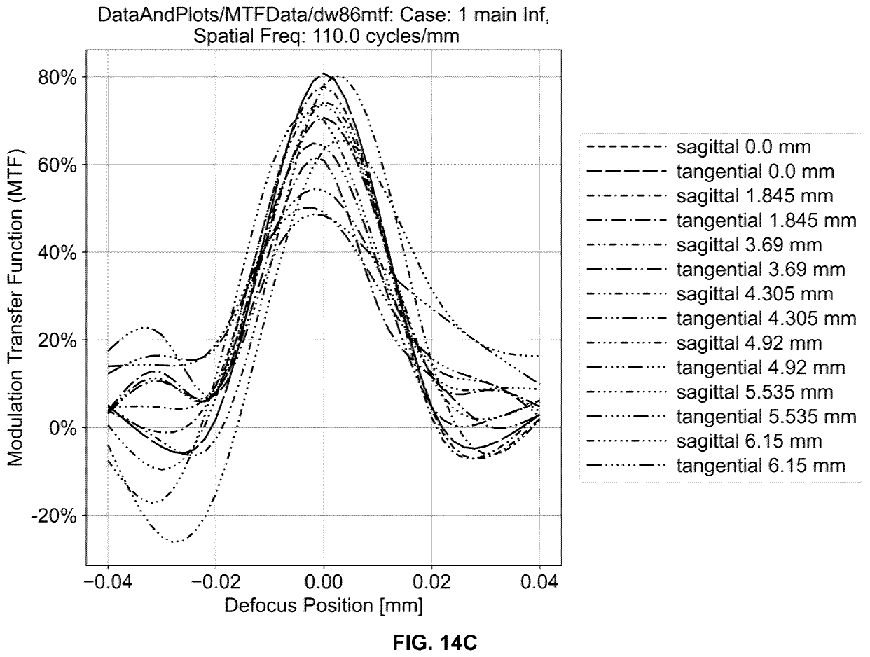

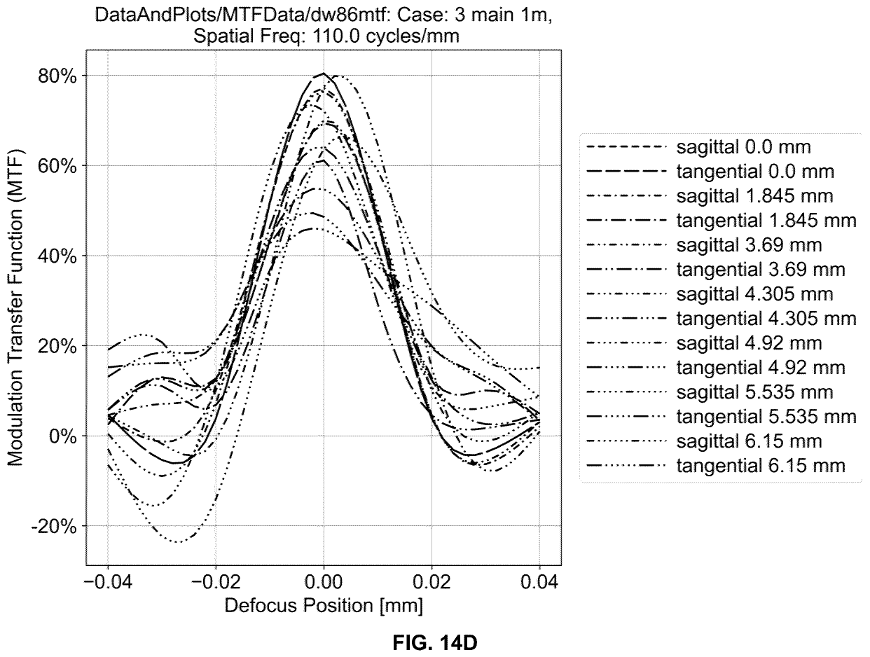

For main mode, FIG. 14A is an MTF (modulation transfer function) performance diagram versus field height for this embodiment, for an object plane located away at infinity. FIG. 14B is an MTF performance diagram versus field height, for an object plane located at 1 meter. FIG. 14C is an MTF versus defocus position, for an object plane located at infinity. And FIG. 14D is an MTF versus defocus position, for an object plane at 10 centimeters.

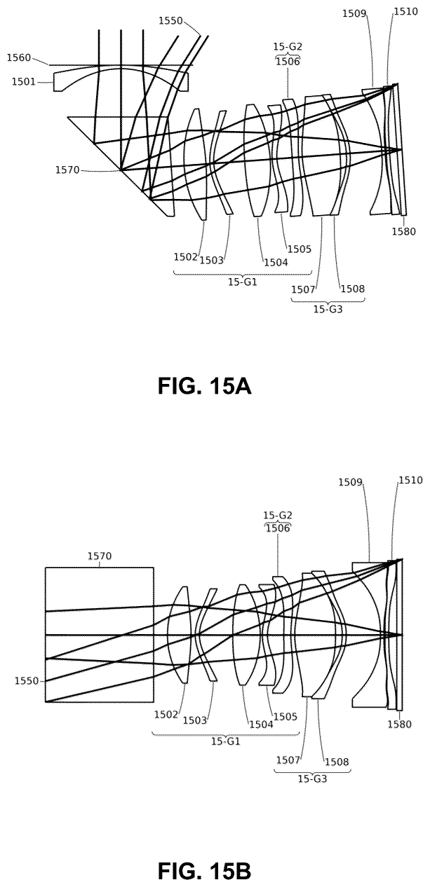

FIGS. 15A and 15B show lens placement for this embodiment, when it is operating in ultra-wide mode. It also shows sample light rays through the embodiment for this mode. In ultra-wide mode, the field-of-view (FOV) is approximately 115 degrees, the F-number is approximately 2.2, and the effective focal length (EFL) is approximately 5.76 mm.

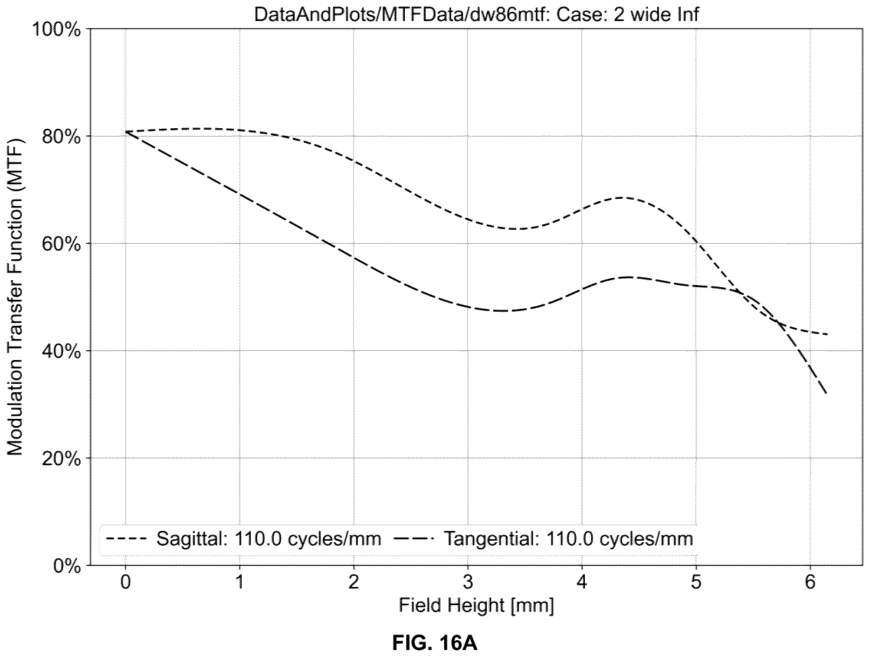

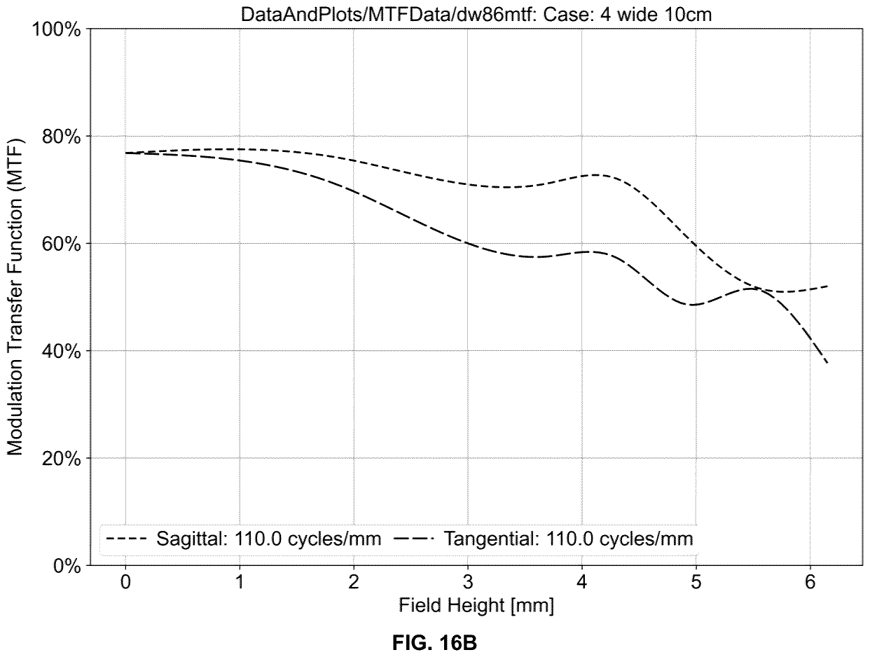

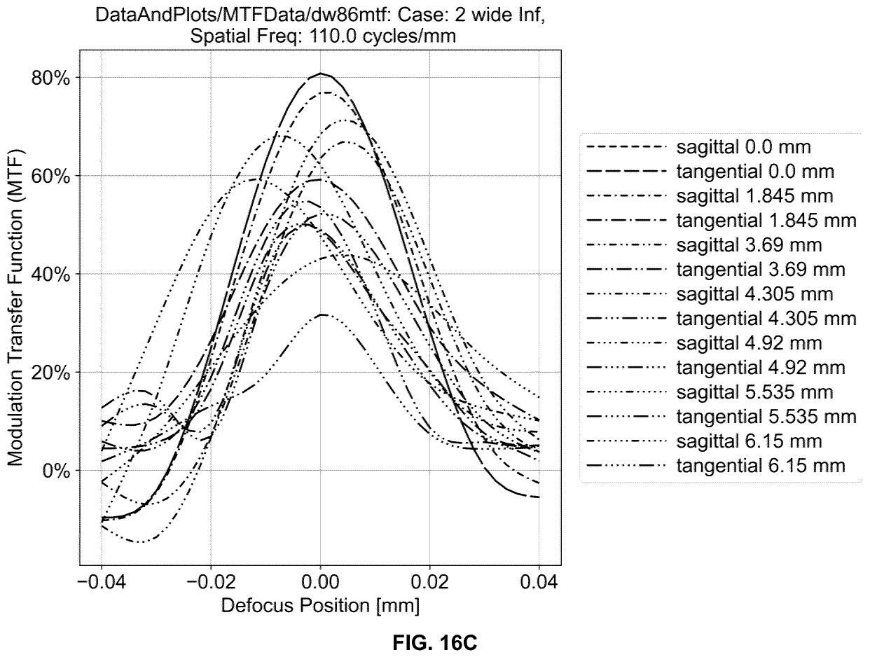

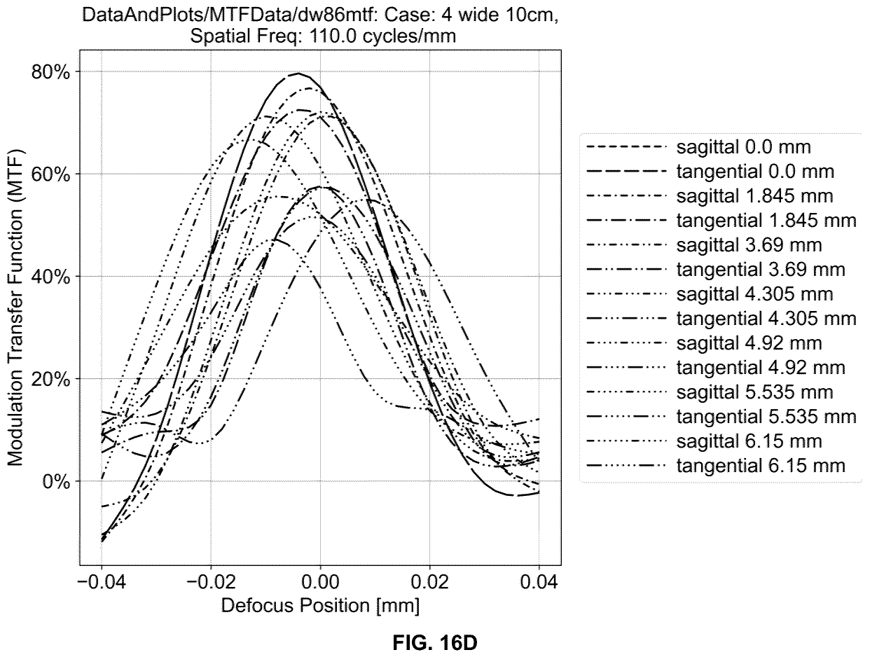

For ultra-wide mode, FIG. 16A is an MTF performance diagram for this embodiment versus field height, for an object plane located away at infinity. FIG. 16B is an MTF performance diagram versus field height, for an object plane located at 10 centimeters. FIG. 16C is an MTF versus defocus position, for an object plane located at infinity. And FIG. 16D is an MTF versus defocus position, for an object plane at 10 centimeters.

### Embodiment #5

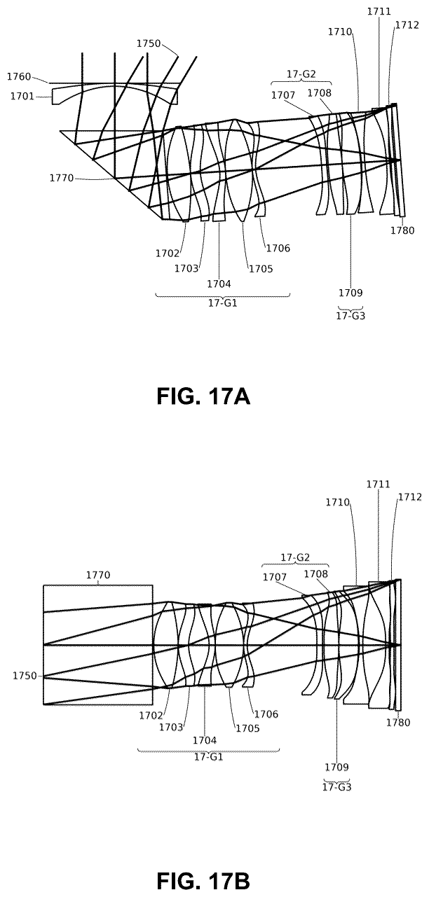

This embodiment (FIGS. 17A-20D) can have a periscope arrangement, with a turning optic that may be a mirror or a prism. The total size of the optics can be approximately 21.31 mm (X length)×10 mm (Y width)×8.87 mm (Z height).

The embodiment can have 12 lenses (12 aspherical and 0 spherical). The turning optic may be positioned before the second lens, before the remaining lenses in the periscope arm. There may be 3 moving lens groups, with 5 lenses in the first group, and 2 lenses in the second group, and 1 lens in the third group. The power of these groups may be positive, positive, and positive. The motion of the first lens group may also be used for auto-focusing.

Table 5 states possible lens shapes and placement for this embodiment, for both

TABLE 5
Lens shape parameters for embodiment #5.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 14.215 | 0.200 | 1.4971 | 81.56 | 2.07E+00 | −7.68E−04 | 5.50E−06 | −1.59E−07 |
| | 4.902 | 2.896 | | | −2.99E+00 | 2.26E−03 | −5.50E−05 | −1.30E−06 |
| | | 6.203 | 1.5168 | 64.2 | | | | |
| | | 0.066 | | | | | | |
| 2 | 7.231 | 1.384 | 1.4971 | 81.56 | −1.57E+00 | 2.00E−03 | −1.69E−04 | 1.70E−05 |
| | −10.121 | 0.006 | | | −4.33E+00 | 5.69E−03 | −1.69E−03 | 4.04E−04 |
| 3 | 4.732 | 0.590 | 1.6161 | 25.79 | −3.17E−01 | −6.69E−03 | 4.90E−05 | −1.03E−04 |
| | 4.094 | 1.164 | | | −1.75E+00 | −1.24E−02 | 1.93E−03 | −7.81E−04 |
| 4 | −3.646 | 0.349 | 1.8514 | 40.1 | −8.02E+00 | −6.37E−03 | 4.18E−03 | −1.16E−03 |
| | −4.794 | 0.000 | | | −9.47E+00 | 2.48E−03 | 2.26E−03 | −5.51E−04 |
| 5 | 11.099 | 1.608 | 1.4971 | 81.56 | −4.78E+00 | 1.24E−03 | 1.41E−03 | −5.08E−04 |
| | −6.657 | 0.001 | | | −9.46E+00 | −1.55E−03 | 7.24E−04 | −3.58E−04 |
| 6 | 4.279 | 0.206 | 1.6322 | 23.43 | −1.31E+01 | −2.65E−03 | 9.03E−04 | −7.59E−04 |
| | 3.502 | 3.957 | | | −8.21E+00 | −3.28E−03 | 1.37E−03 | −7.68E−04 |
| 7 | −53.374 | 0.314 | 1.6161 | 25.79 | −1.71E+01 | −1.13E−02 | 1.75E−03 | −2.29E−04 |
| | 31.993 | 0.090 | | | −2.73E+01 | −7.39E−03 | 9.22E−04 | −1.74E−04 |
| 8 | 40.644 | 0.840 | 1.4971 | 81.56 | −4.18E−1 | 7.27E−03 | −1.04E−03 | 5.86E−05 |
| | −17.791 | 0.000 | | | −4.20E+00 | 2.13E−03 | −2.58E−05 | −1.66E−05 |
| 9 | 11.574 | 1.114 | 1.5311 | 55.75 | −2.34E+01 | 1.03E−03 | −7.65E−04 | 6.83E−05 |
| | −17.064 | 0.046 | | | −1.46E+01 | 2.19E−03 | −1.75E−03 | 3.57E−04 |
| 10 | −11.162 | 0.203 | 1.5311 | 55.75 | 3.36E+00 | 1.99E−03 | −6.94E−04 | 2.20E−04 |
| | 20.755 | 1.299 | | | −1.15E+00 | −1.84E−04 | 3.63E−04 | −6.04E−05 |
| 11 | −22.441 | 0.200 | 1.5311 | 55.75 | 5.40E+00 | −9.58E−03 | 1.09E−03 | −8.17E−05 |
| | −24.978 | 0.071 | | | 1.55E+01 | 3.03E−02 | −8.26E−03 | 1.01E−03 |
| 12 | −16.572 | 0.201 | 1.5311 | 55.75 | −1.11E+01 | 1.69E−02 | −3.55E−03 | 3.58E−04 |
| | 76.246 | 0.088 | | | −1.12E+01 | −8.27E−03 | 2.61E−03 | −3.18E−04 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | 2.93E−09 | −7.05E−11 | 2.25E−12 | −4.42E−14 | 3.85E−16 | −1.23E−18 |
| | 2.89E−07 | −2.08E−08 | 7.78E−10 | −1.57E−11 | 1.61E−13 | −6.70E−16 |
| 2 | −1.94E−06 | 1.91E−07 | −2.34E−08 | 1.75E−09 | −6.47E−11 | 9.53E−13 |
| | −7.08E−05 | 8.33E−06 | −6.41E−07 | 3.08E−08 | −8.30E−10 | 9.50E−12 |
| 3 | 4.62E−05 | −1.04E−05 | 1.24E−06 | −7.98E−08 | 2.62E−09 | −3.45E−11 |
| | 2.21E−04 | −4.01E−05 | 4.49E−06 | −2.92E−07 | 9.98E−09 | −1.39E−10 |
| 4 | 2.26E−04 | −3.33E−05 | 3.47E−06 | −2.25E−07 | 7.85E−09 | −1.12E−10 |
| | 6.80E−05 | −6.48E−06 | 5.78E−07 | −3.97E−08 | 1.51E−09 | −2.27E−11 |
| 5 | 9.99E−05 | −1.29E−05 | 1.09E−06 | −5.61E−08 | 1.55E−09 | −1.76E−11 |
| | 9.39E−05 | −1.48E−05 | 1.40E−06 | −7.69E−08 | 2.21E−09 | −2.59E−11 |
| 6 | 1.65E−04 | −2.05E−05 | 1.62E−06 | −7.91E−08 | 2.14E−09 | −2.42E−11 |
| | 1.57E−04 | −1.79E−05 | 1.24E−06 | −5.19E−08 | 1.19E−09 | −1.12E−11 |
| 7 | 2.19E−05 | −1.29E−06 | 2.10E−08 | 1.40E−09 | −6.69E−11 | 8.28E−13 |
| | 2.21E−05 | −1.55E−06 | 4.83E−08 | −1.26E−10 | −2.28E−11 | 3.31E−13 |
| 8 | 4.68E−06 | −1.22E−06 | 9.20E−08 | −3.30E−09 | 5.79E−11 | −3.99E−13 |
| | 7.56E−06 | −1.30E−06 | 9.61E−08 | −3.46E−09 | 6.08E−11 | −4.18E−13 |
| 9 | −4.94E−06 | 3.48E−07 | −1.80E−08 | 5.58E−10 | −8.95E−12 | 5.64E−14 |
| | −4.50E−05 | 3.37E−06 | −1.47E−07 | 3.72E−09 | −4.98E−11 | 2.74E−13 |
| 10 | −3.11E−05 | 2.14E−06 | −7.98E−08 | 1.64E−09 | −1.76E−11 | 7.68E−14 |
| | 4.42E−06 | −1.97E−07 | 5.67E−09 | −9.91E−11 | 9.32E−13 | −3.58E−15 |
| 11 | 5.01E−06 | −2.21E−07 | 6.29E−09 | −1.08E−10 | 9.87E−13 | −3.70E−15 |
| | −6.78E−05 | 2.67E−06 | −6.36E−08 | 9.02E−10 | −6.99E−12 | 2.28E−14 |
| 12 | −2.00E−05 | 6.52E−07 | −1.28E−08 | 1.49E−10 | −9.63E−13 | 2.69E−15 |
| | 1.98E−05 | −7.07E−07 | 1.51E−08 | −1.91E−10 | 1.32E−12 | −3.82E−15 |

FIGS. 17A and 17B show lens shapes and placement for this embodiment, when it is operating in main mode. It also shows sample light rays through the embodiment for this mode. In main mode, the field-of-view (FOV) is approximately 85.5 degrees, the F-number is approximately 1.6, and the effective focal length (EFL) is approximately 6.69 mm.

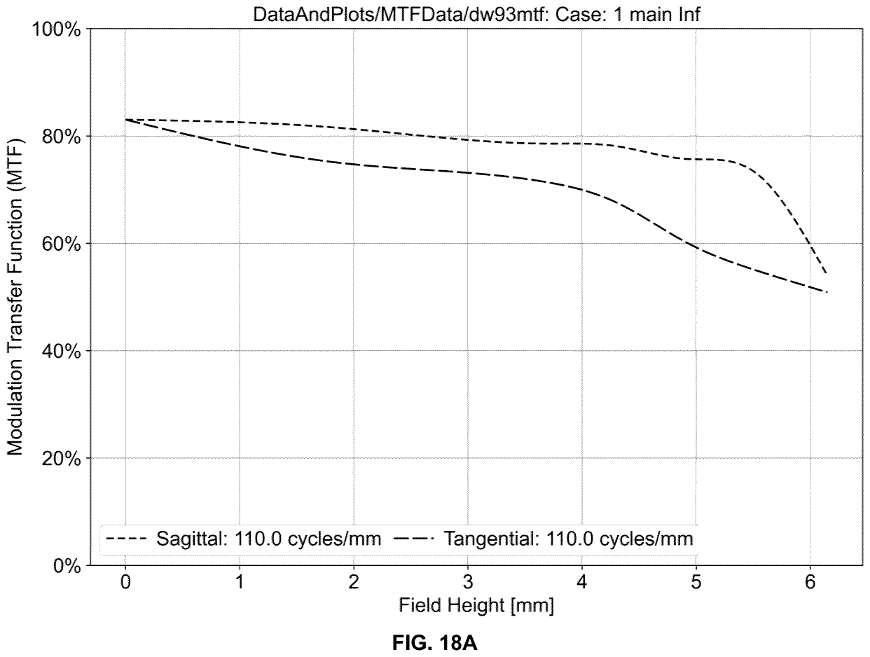

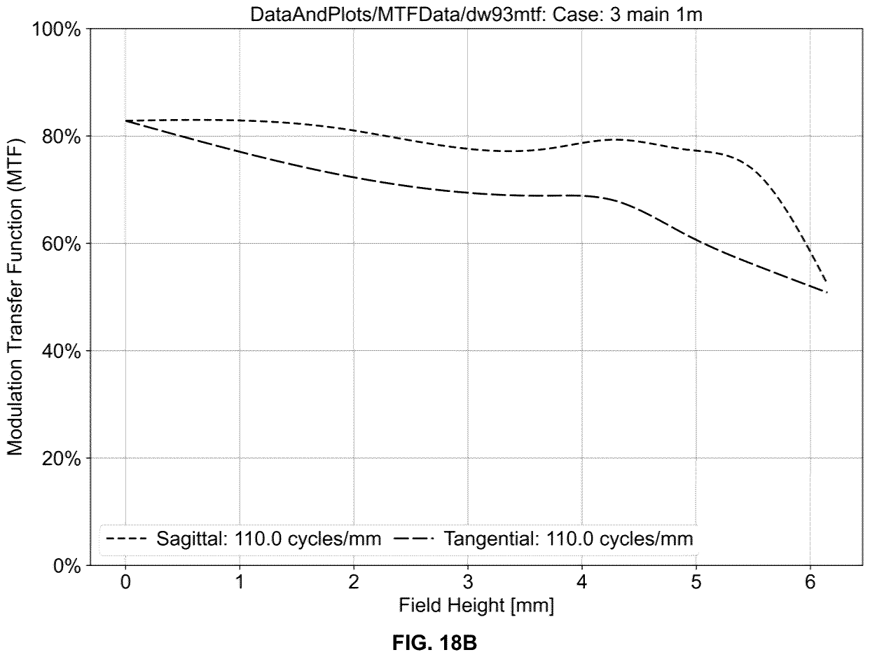

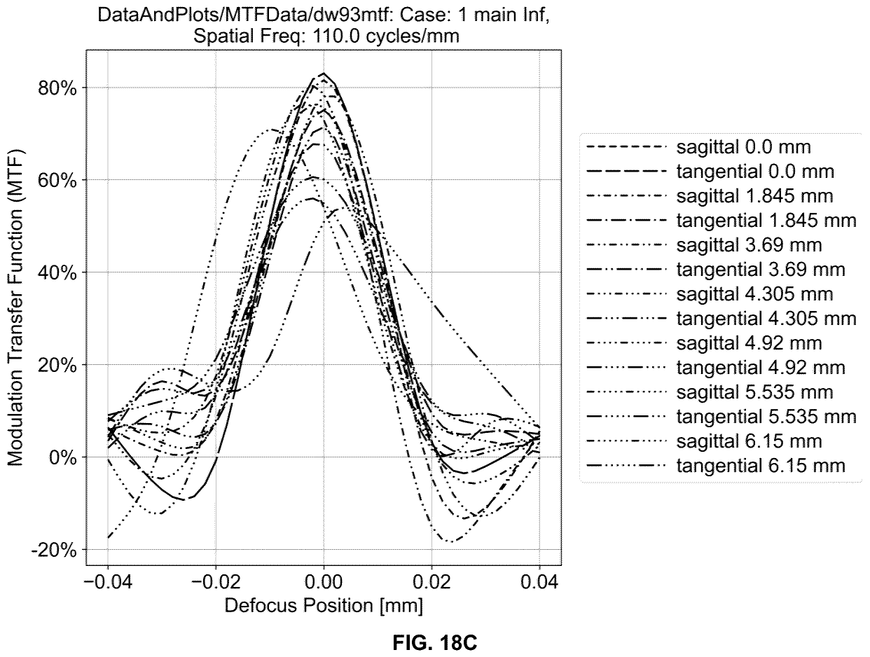

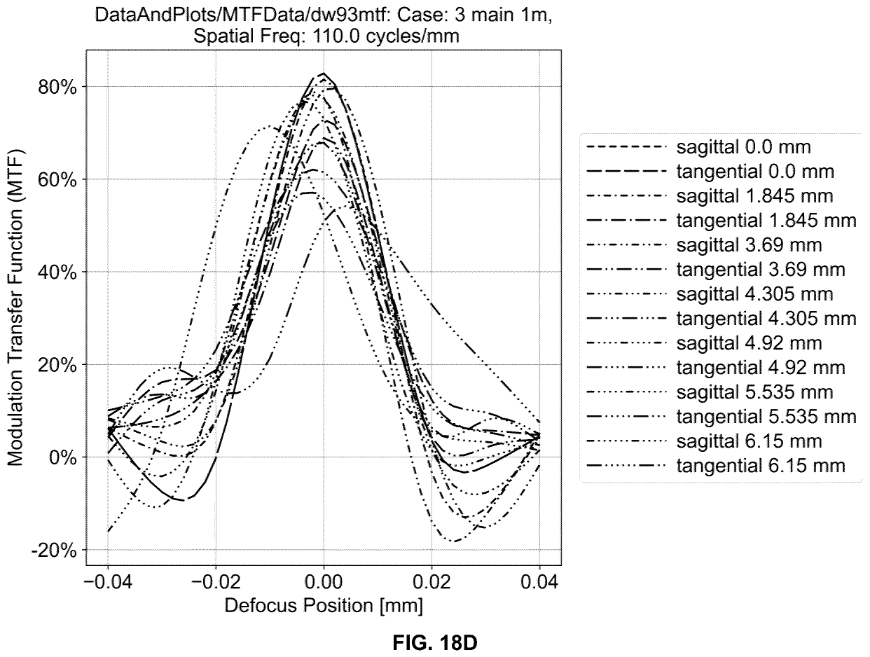

For main mode, FIG. 18A is an MTF (modulation transfer function) performance diagram versus field height for this embodiment, for an object plane located away at infinity. FIG. 18B is an MTF performance diagram versus field height, for an object plane located at 1 meter. FIG. 18C is an MTF versus defocus position, for an object plane located at infinity. And FIG. 18D is an MTF versus defocus position, for an object plane at 10 centimeters.

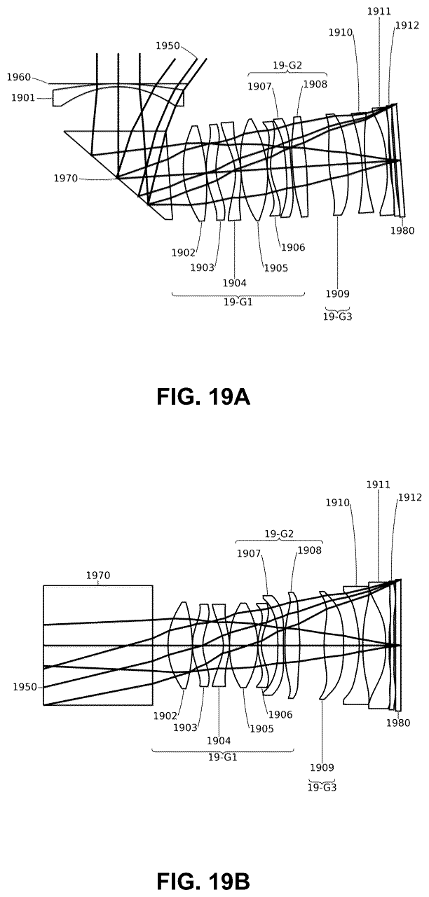

FIGS. 19A and 19B show lens placement for this embodiment, when it is operating in ultra-wide mode. It also shows sample light rays through the embodiment for this mode. In ultra-wide mode, the field-of-view (FOV) is approximately 115 degrees, the F-number is approximately 2.2, and the effective focal length (EFL) is approximately 2.2 mm.

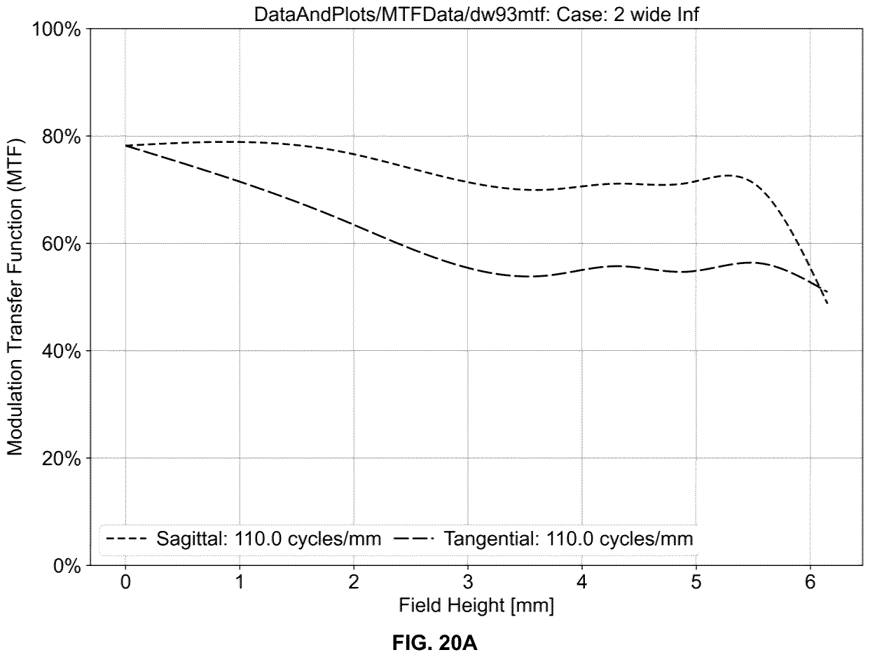

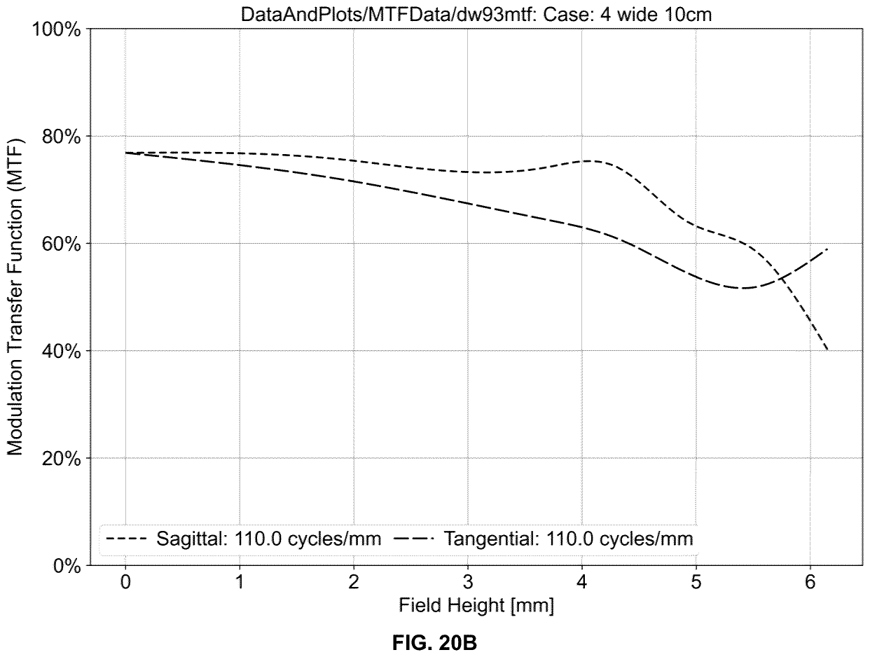

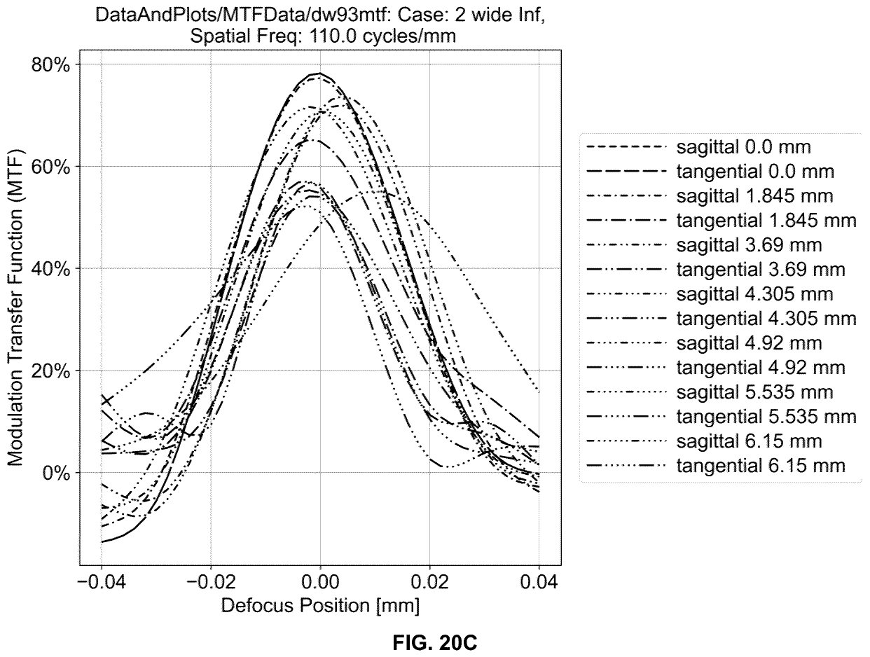

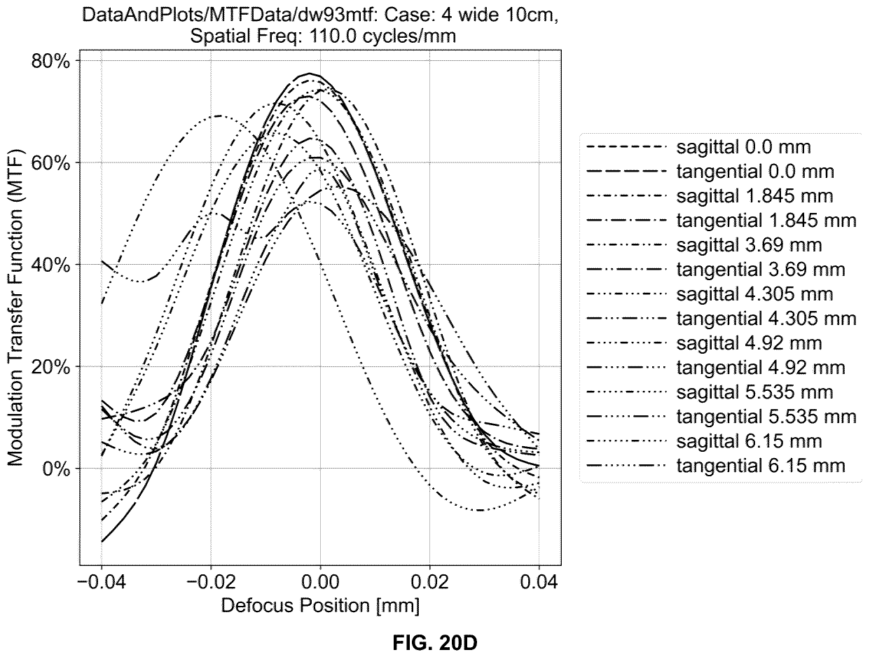

For ultra-wide mode, FIG. 20A is an MTF performance diagram for this embodiment versus field height, for an object plane located away at infinity. FIG. 20B is an MTF performance diagram versus field height, for an object plane located at 10 centimeters. FIG. 20C is an MTF versus defocus position, for an object plane located at infinity. And FIG. 20D is an MTF versus defocus position, for an object plane at 10 centimeters.

### Embodiment #6

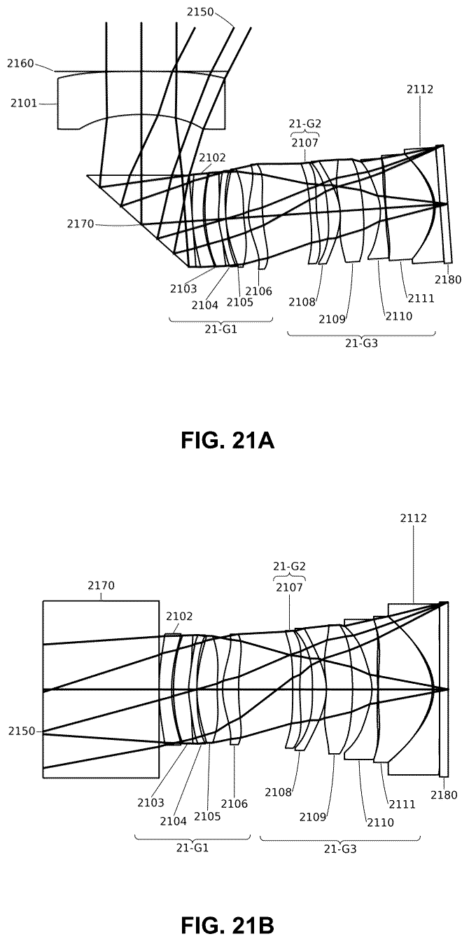

This embodiment (FIGS. 21A-24D) can have a periscope arrangement, with a turning optic that may be a mirror or a prism. The total size of the optics can be approximately 15.9 mm (X length)×6.4 mm (Y width)×7.84 mm (Z height).

The embodiment can have 12 lenses (12 aspherical and 0 spherical). The turning optic may be positioned before the second lens, before the remaining lenses in the periscope arm. There may be 3 moving lens groups, with 4 lenses in the first group, and 1 lens in the second group, and 4 lenses in the third group. The power of these groups may be positive, negative, and positive. The motion of the first lens group may also be used for auto-focusing.

Table 6 states possible lens shapes and placement for this embodiment, for both

TABLE 6
Lens shape parameters for embodiment #6.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 69.167 | 1.753 | 1.53 | 55.75 | −4.03E+01 | 2.44E−03 | −5.09E−05 | −1.70E−06 |
| | 7.112 | 2.466 | | | −6.28E+00 | 6.99E−03 | −1.63E−04 | 6.67E−05 |
| | | 4.000 | 1.52 | 64.20 | | | | |
| | | 0.000 | | | | | | |
| 2 | 8.194 | 0.435 | 1.63 | 23.43 | 9.71E+00 | −2.92E−03 | −1.08E−03 | 1.36E−04 |
| | 5.581 | 0.064 | | | 4.68E+00 | −3.53E−03 | −2.15E−03 | 1.18E−03 |
| 3 | 6.338 | 0.521 | 1.53 | 55.75 | 5.94E+00 | −1.14E−02 | 5.04E−03 | −2.56E−03 |
| | 2.411 | 0.003 | | | 8.82E−02 | −1.94E−01 | 1.07E−01 | −5.25E−02 |
| 4 | 2.658 | 0.282 | 1.53 | 55.75 | −4.41E+00 | −1.31E−01 | 1.24E−01 | −8.34E−02 |
| | 21.504 | 0.000 | | | 3.02E+01 | 2.50E−02 | −1.55E−02 | 2.24E−02 |
| 5 | 4.110 | 0.700 | 1.50 | 81.56 | −4.96E−01 | −3.48E−03 | −4.99E−02 | 6.54E−02 |
| | 6.850 | 0.186 | | | −5.33E+00 | −7.01E−02 | 2.02E−02 | −1.33E−03 |
| 6 | 2.566 | 0.551 | 1.50 | 81.56 | −9.95E+00 | 1.40E−02 | −2.51E−02 | 1.78E−02 |
| | 9.991 | 1.864 | | | −6.16E+00 | 1.09E−02 | −1.02E−02 | 2.26E−03 |
| 7 | −50.834 | 0.246 | 1.53 | 55.75 | −3.80E+00 | −1.40E−02 | −2.31E−03 | 2.46E−03 |
| | 9.308 | 0.435 | | | −1.32E+00 | −1.77E−02 | −1.89E−03 | 8.54E−04 |
| 8 | −23.692 | 0.480 | 1.77 | 49.46 | 1.08E+00 | −4.05E−02 | −1.27E−02 | 2.06E−02 |
| | −1.986 | 0.001 | | | −4.04E+00 | 4.60E−02 | −5.74E−02 | 3.37E−02 |
| 9 | −2.847 | 0.899 | 1.53 | 55.75 | −7.08E+00 | 1.33E−01 | −6.39E−02 | 2.00E−02 |
| | −11.504 | 0.669 | | | 1.57E+01 | −2.43E−02 | 3.54E−02 | −2.35E−02 |
| 10 | −1.847 | 0.200 | 1.63 | 23.43 | −2.65E+00 | 6.67E−02 | −1.68E−02 | −6.00E−03 |
| | −6.188 | 0.023 | | | −6.02 E+00 | 9.79E−02 | −5.21E−02 | 1.60E−02 |
| 11 | 18.153 | 1.859 | 1.50 | 81.56 | 3.10E+00 | 1.31E−02 | −1.87E−02 | 7.61E−03 |
| | −1.887 | 0.052 | | | −1.71E+00 | 1.92E−02 | −7.15E−03 | 1.32E−03 |
| 12 | −1.858 | 0.200 | 1.57 | 37.67 | −1.58E+00 | 1.84E−02 | −1.56E−02 | 7.14E−03 |
| | −19.367 | 0.000 | | | 2.30E+01 | 4.31E−02 | −2.58E−02 | 7.47E−03 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | 2.03E−07 | −9.52E−09 | 2.43E−10 | −3.47E−12 | 2.63E−14 | −8.30E−17 |
| | −1.47E−05 | 1.90E−06 | −1.38E−07 | 5.51E−09 | −1.14E−10 | 9.74E−13 |
| 2 | −7.04E−05 | 2.49E−05 | −5.13E−06 | 5.83E−07 | −4.46E−08 | 1.58E−09 |
| | −8.79E−04 | 4.00E−04 | −1.07E−04 | 1.62E−05 | −1.29E−06 | 4.13E−08 |
| 3 | 1.01E−03 | −1.72E−04 | −8.95E−06 | 6.41E−06 | −8.09E−07 | 3.50E−08 |
| | 2.35E−02 | −8.19E−03 | 1.89E−03 | −2.66E−04 | 2.04E−05 | −6.53E−07 |
| 4 | 4.07E−02 | −1.37E−02 | 3.01E−03 | −4.00E−04 | 2.92E−05 | −8.96E−07 |
| | −1.92E−02 | 8.85E−03 | −2.36E−03 | 3.66E−04 | −3.01E−05 | 1.02E−06 |
| 5 | −4.18E−02 | 1.57E−02 | −3.62E−03 | 4.97E−04 | −3.71E−05 | 1.16E−06 |
| | −1.97E−03 | 1.01E−03 | −2.41E−04 | 2.98E−05 | −1.71E−06 | 3.33E−08 |
| 6 | −9.36E−03 | 3.20E−03 | −6.82E−04 | 8.58E−05 | −5.71E−06 | 1.56E−07 |
| | −6.70E−04 | 1.97E−04 | −3.45E−05 | 2.17E−06 | 7.94E−08 | −8.53E−09 |
| 7 | −1.07E−03 | 3.06E−04 | −5.44E−05 | 5.57E−06 | −2.90E−07 | 6.05E−09 |
| | −3.07E−04 | 5.25E−05 | −7.07E−06 | 1.28E−06 | −1.31E−07 | 4.53E−09 |
| 8 | −1.04E−02 | 3.03E−03 | −5.57E−04 | 6.28E−05 | −3.86E−06 | 9.80E−08 |
| | −1.16E−02 | 2.59E−03 | −3.80E−04 | 3.51E−05 | −1.81E−06 | 3.91E−08 |
| 9 | −4.29E−03 | 6.15E−04 | −5.76E−05 | 3.40E−06 | −1.16E−07 | 1.74E−09 |
| | 8.60E−03 | −1.91E−03 | 2.63E−04 | −2.14E−05 | 9.45E−07 | −1.73E−08 |
| 10 | 4.21E−03 | −1.10E−03 | 1.60E−04 | −1.33E−05 | 5.83E−07 | −1.06E−08 |
| | −3.32E−03 | 4.65E−04 | −4.27E−05 | 2.46E−06 | −7.93E−08 | 1.08E−09 |
| 11 | −1.84E−03 | 2.81E−04 | −2.68E−05 | 1.55E−06 | −4.96E−08 | 6.70E−10 |
| | −3.27E−04 | 7.70E−05 | −1.06E−05 | 7.89E−07 | −2.96E−08 | 4.38E−10 |
| 12 | −1.98E−03 | 3.33E−04 | −3.38E−05 | 2.01E−06 | −6.37E−08 | 8.32E−10 |
| | −1.19E−03 | 1.12E−04 | −6.38E−06 | 2.15E−07 | −3.96E−09 | 3.06E−11 |

FIGS. 21A and 21B show lens shapes and placement for this embodiment, when it is operating in main mode. It also shows sample light rays through the embodiment for this mode. In main mode, the field-of-view (FOV) is approximately 80 degrees, the F-number is approximately 1.7, and the effective focal length (EFL) is approximately 4.81 mm.

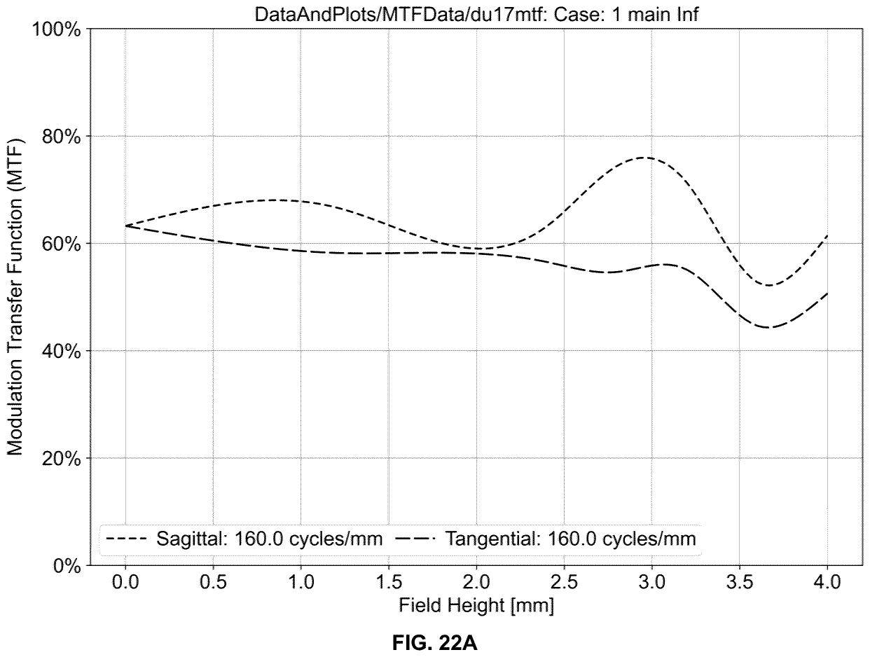

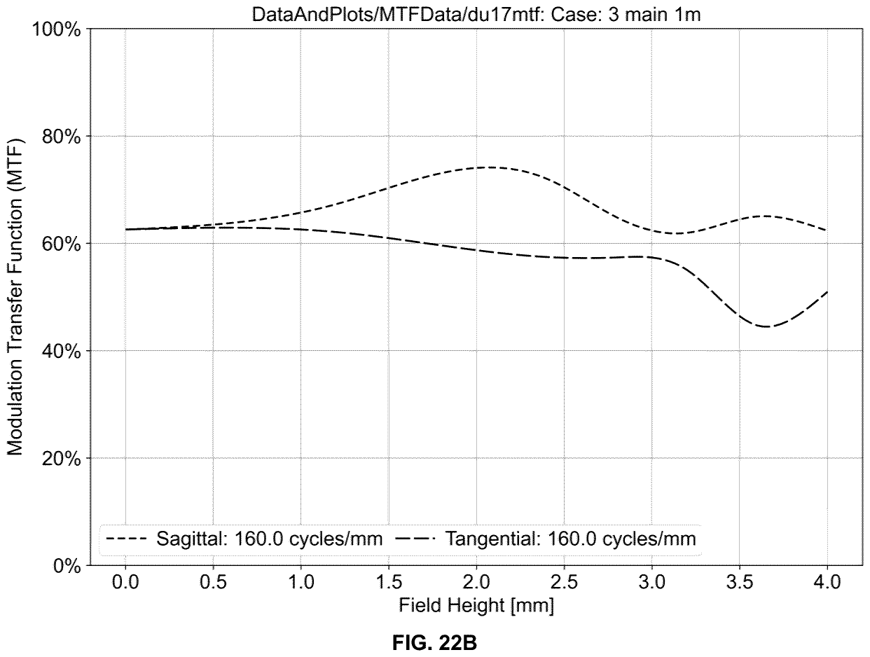

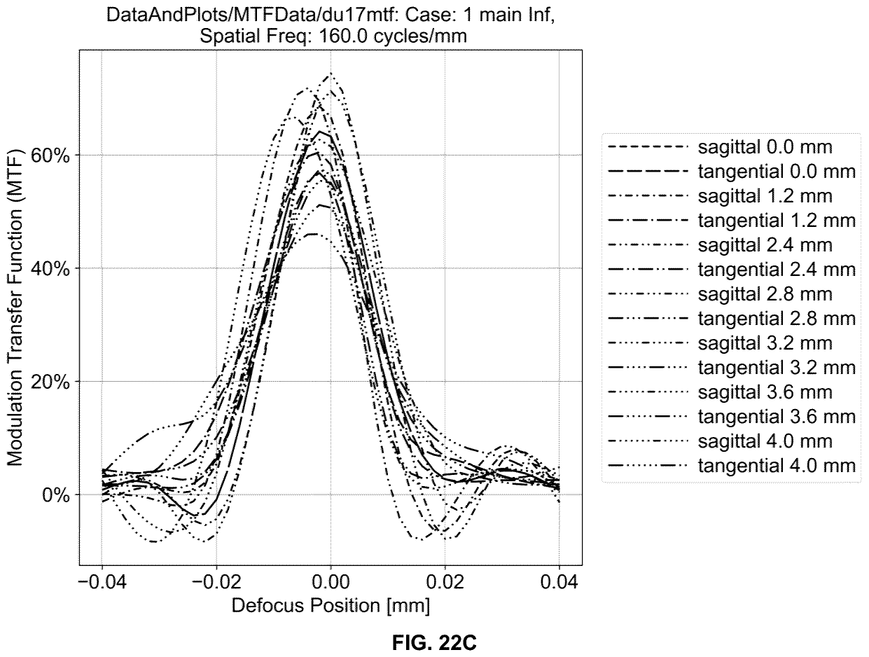

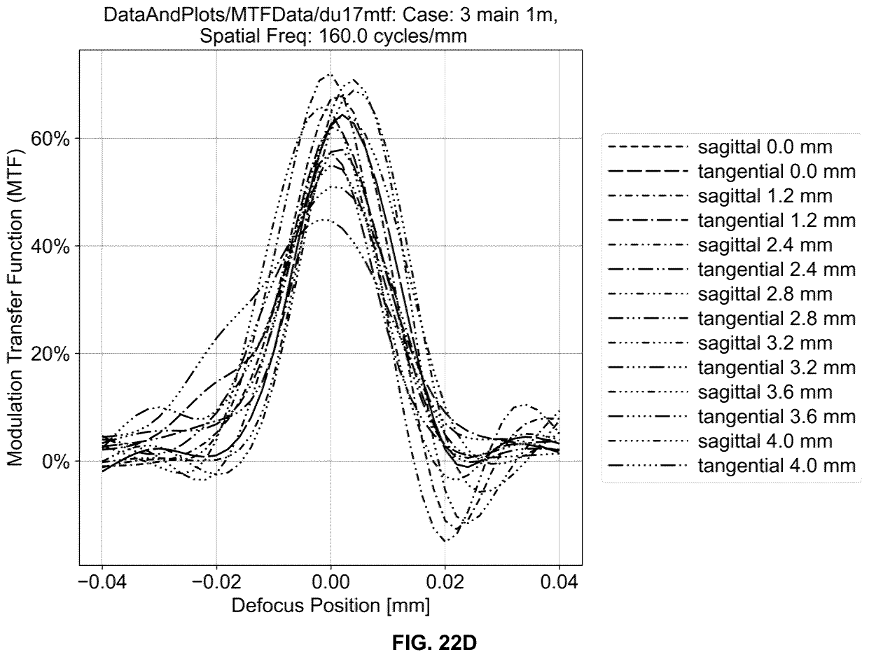

For main mode, FIG. 22A is an MTF (modulation transfer function) performance diagram versus field height for this embodiment, for an object plane located away at infinity. FIG. 22B is an MTF performance diagram versus field height, for an object plane located at 1 meter. FIG. 22C is an MTF versus defocus position, for an object plane located at infinity. And FIG. 22D is an MTF versus defocus position, for an object plane at 10 centimeters.

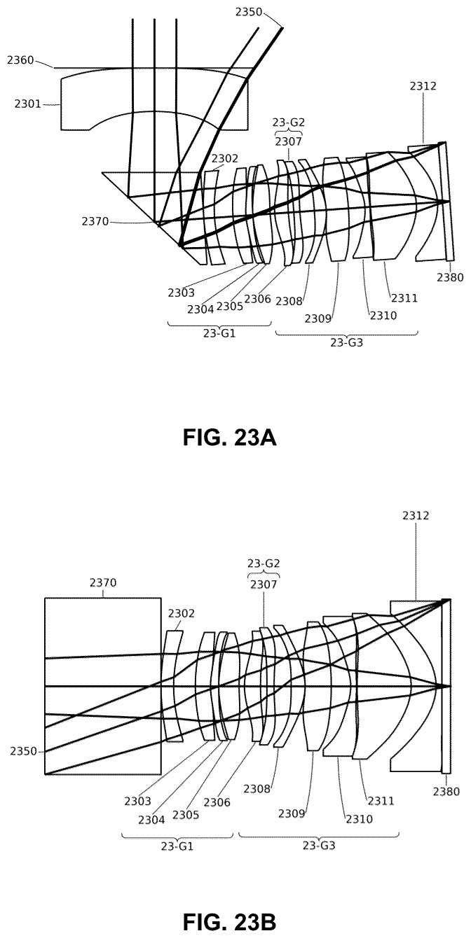

FIGS. 23A and 23B show lens placement for this embodiment, when it is operating in ultra-wide mode. It also shows sample light rays through the embodiment for this mode. In ultra-wide mode, the field-of-view (FOV) is approximately 126 degrees, the F-number is approximately 2, and the effective focal length (EFL) is approximately 3.54 mm.

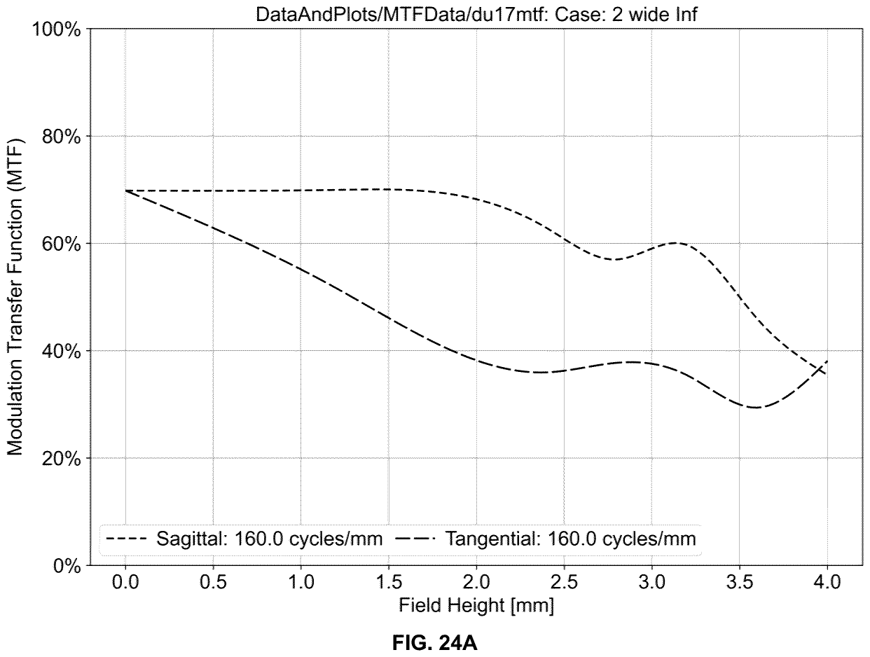

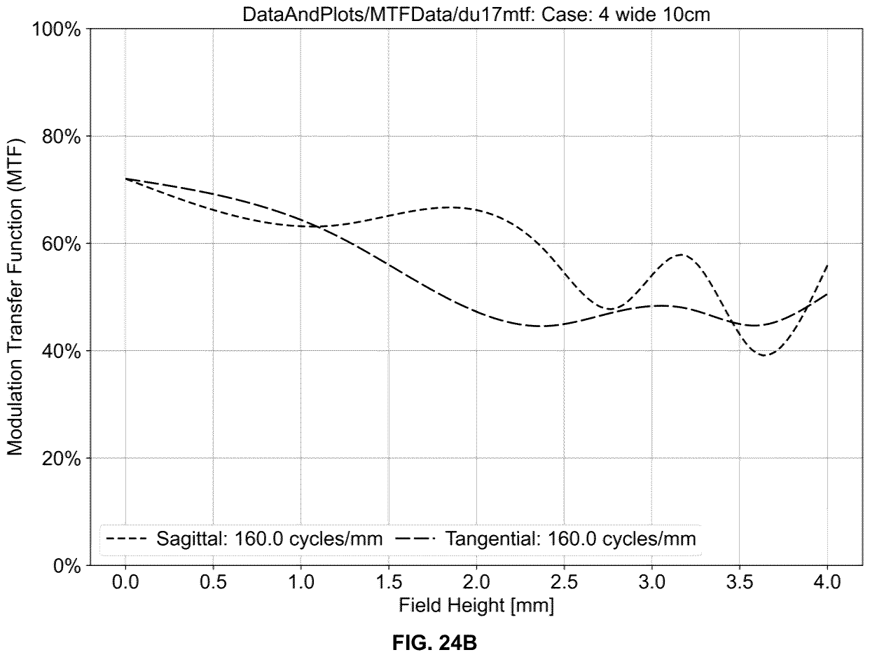

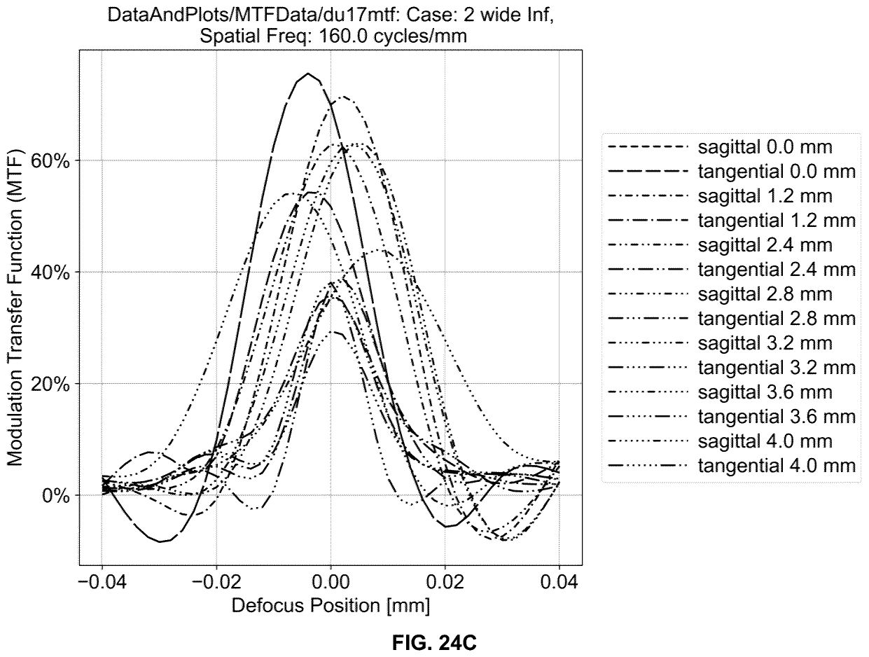

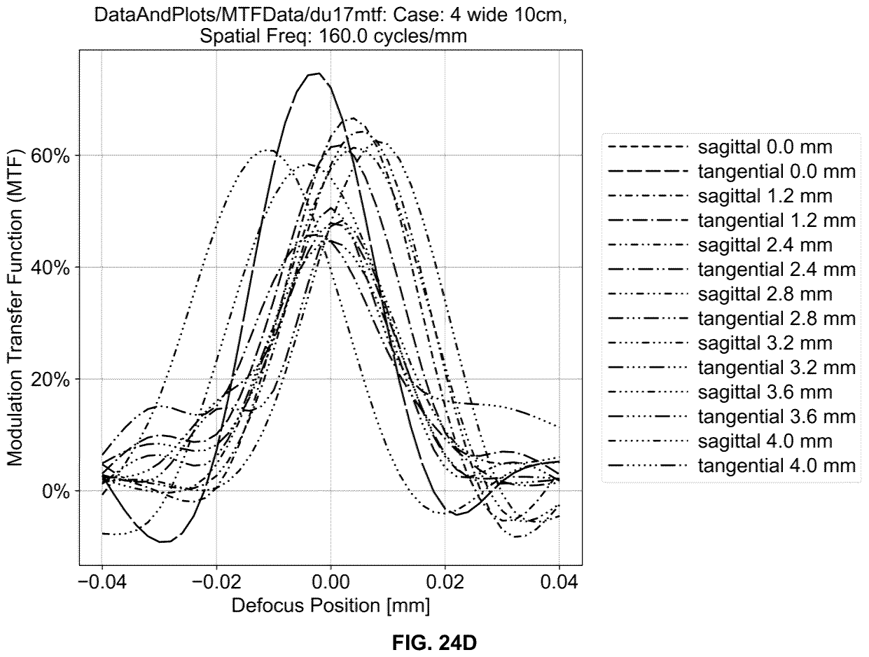

For ultra-wide mode, FIG. 24A is an MTF performance diagram for this embodiment versus field height, for an object plane located away at infinity. FIG. 24B is an MTF performance diagram versus field height, for an object plane located at 10 centimeters. FIG. 24C is an MTF versus defocus position, for an object plane located at infinity. And FIG. 24D is an MTF versus defocus position, for an object plane at 10 centimeters.

### Embodiment #7

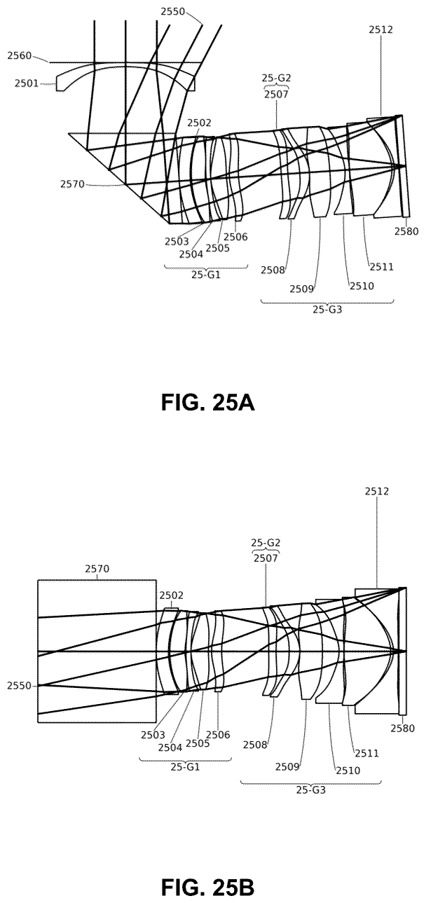

This embodiment (FIGS. 25A-28D) can have a periscope arrangement, with a turning optic that may be a mirror or a prism. The total size of the optics can be approximately 15.99 mm (X length)×6.4 mm (Y width)×7.25 mm (Z height).

The embodiment can have 12 lenses (12 aspherical and 0 spherical). The turning optic may be positioned before the second lens, before the remaining lenses in the periscope arm. There may be 3 moving lens groups, with 4 lenses in the first group, and 1 lens in the second group, and 4 lenses in the third group. The power of these groups may be positive, negative, and positive. The motion of the first lens group may also be used for auto-focusing.

Table 7 states possible lens shapes and placement for this embodiment, for both

TABLE 7
Lens shape parameters for embodiment #7.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 31.349 | 0.200 | 1.5311 | 55.75 | −4.02E+01 | 1.39E−02 | −1.52E−03 | 1.06E−04 |
| | 6.778 | 3.150 | | | −6.66E+00 | 1.83E−02 | −1.57E−03 | 1.71E−04 |
| | | 4.843 | 1.5168 | 64.2 | | | | |
| | | 0.000 | | | | | | |
| 2 | 6.525 | 0.501 | 1.6322 | 23.43 | 5.30E+00 | −1.75E−03 | −5.98E−04 | 1.38E−04 |
| | 5.037 | 0.055 | | | 3.41E+00 | −2.96E−03 | −7.17E−04 | 2.37E−04 |
| 3 | 5.001 | 0.623 | 1.5311 | 55.75 | 4.15E+00 | −1.82E−02 | 8.37E−03 | −3.81E−03 |
| | 3.018 | 0.035 | | | 9.34E−01 | −1.32E−01 | 6.56E−02 | −4.83E−02 |
| 4 | 7.742 | 0.209 | 1.5731 | 37.67 | −4.94E+00 | −3.69E−02 | 5.64E−02 | −6.19E−02 |
| | 12.382 | 0.000 | | | 2.99E+01 | 6.88E−03 | 2.29E−02 | −2.97E−02 |
| 5 | 2.368 | 0.712 | 1.4971 | 81.56 | −3.22E+00 | −3.44E−02 | 7.01E−03 | −3.84E−04 |
| | 7.406 | 0.129 | | | −4.79E+00 | −8.14E−02 | 5.09E−02 | −2.96E−02 |
| 6 | 2.692 | 0.412 | 1.4971 | 81.56 | −9.87E+00 | −3.30E−02 | 5.94E−03 | −1.51E−03 |
| | 5.897 | 1.926 | | | −6.11E+00 | −7.12E−03 | −1.58E−02 | 1.11E−02 |
| 7 | 46.262 | 0.301 | 1.5311 | 55.75 | −3.80E+00 | −1.62E−02 | 9.68E−04 | −7.27E−04 |
| | 10.723 | 0.534 | | | −1.10E+00 | −2.38E−02 | 4.65E−03 | −3.78E−03 |
| 8 | −7.334 | 0.439 | 1.729 | 54.04 | 1.07E+00 | −8.14E−02 | −8.86E−03 | 3.35E−02 |
| | −1.829 | 0.000 | | | −3.26E+00 | −7.39E−03 | −3.40E−02 | 2.70E−02 |
| 9 | −3.637 | 0.920 | 1.5311 | 55.75 | −7.64E+00 | 1.10E−01 | −4.73E−02 | 1.20E−02 |
| | −17.984 | 0.684 | | | 1.52E+01 | −1.16E−02 | 6.04E−03 | −5.10E−03 |
| 10 | −2.003 | 0.200 | 1.6322 | 23.43 | −3.06E+00 | 4.68E−02 | −1.19E−02 | −2.91E−03 |
| | −7.966 | 0.006 | | | −6.31E+00 | 6.30E−02 | −2.72E−02 | 7.55E−03 |
| 11 | 10.968 | 1.907 | 1.4971 | 81.56 | 3.05E+00 | 5.92E−03 | −1.35E−02 | 6.02E−03 |
| | −1.893 | 0.110 | | | −2.18E+00 | 3.01E−02 | −1.74E−02 | 5.51E−03 |
| 12 | −1.786 | 0.200 | 1.5311 | 55.75 | −1.55E+00 | 2.02E−02 | −1.45E−02 | 6.29E−03 |
| | −19.387 | 0.027 | | | 2.31E+01 | 2.09E−02 | −1.12E−02 | 3.49E−03 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | −5.47E−06 | 1.97E−07 | −4.74E−09 | 7.20E−11 | −6.18E−13 | 2.27E−15 |
| | −2.32E−05 | 2.50E−06 | −1.69E−07 | 6.55E−09 | −1.32E−10 | 1.08E−12 |
| 2 | −2.00E−04 | 9.12E−05 | −2.18E−05 | 2.87E−06 | −2.05E−07 | 5.99E−09 |
| | −4.63E−04 | 2.63E−04 | −7.56E−05 | 1.14E−05 | −8.97E−07 | 2.81E−08 |
| 3 | 1.56E−03 | −5.12E−04 | 1.19E−04 | −1.79E−05 | 1.46E−06 | −4.73E−08 |
| | 3.04E−02 | −1.20E−02 | 2.82E−03 | −3.87E−04 | 2.84E−05 | −8.61E−07 |
| 4 | 3.56E−02 | −1.11E−02 | 1.86E−03 | −1.54E−04 | 4.09E−06 | 8.79E−08 |
| | 1.23E−02 | −9.19E−04 | −7.00E−04 | 2.13E−04 | −2.31E−05 | 8.98E−07 |
| 5 | −1.55E−03 | 1.44E−03 | −5.27E−04 | 9.22E−05 | −7.62E−06 | 2.39E−07 |
| | 1.30E−02 | −3.95E−03 | 7.91E−04 | −1.00E−04 | 7.22E−06 | −2.21E−07 |
| 6 | 9.91E−04 | −4.65E−04 | 1.11E−04 | −1.37E−05 | 8.36E−07 | −1.63E−08 |
| | −4.86E−03 | 1.35E−03 | −2.41E−04 | 2.62E−05 | −1.55E−06 | 3.99E−08 |
| 7 | 2.58E−04 | −1.21E−04 | 4.75E−05 | −8.80E−06 | 7.51E−07 | −2.38E−08 |
| | 1.79E−03 | −5.91E−04 | 1.24E−04 | −1.46E−05 | 8.89E−07 | −2.21E−08 |
| 8 | −1.65E−02 | 4.36E−03 | −7.23E−04 | 7.49E−05 | −4.34E−06 | 1.06E−07 |
| | −8.01E−03 | 1.17E−03 | −8.71E−05 | 2.67E−06 | 2.81E−08 | −3.04E−09 |
| 9 | −1.77E−03 | 8.47E−05 | 1.44E−05 | −2.49E−06 | 1.44E−07 | −3.02E−09 |
| | 2.25E−03 | −5.84E−04 | 9.00E−05 | −7.89E−06 | 3.60E−07 | −6.63E−09 |
| 10 | 2.17E−03 | −6.01E−04 | 9.47E−05 | −8.51E−06 | 4.01E−07 | −7.76E−09 |
| | −1.60E−03 | 2.42E−04 | −2.45E−05 | 1.53E−06 | −5.31E−08 | 7.60E−10 |
| 11 | −1.68E−03 | 2.96E−04 | −3.20E−05 | 2.04E−06 | −7.05E−08 | 1.01E−09 |
| | −1.28E−03 | 1.97E−04 | −1.86E−05 | 1.04E−06 | −3.08E−08 | 3.73E−10 |
| 12 | −1.68E−03 | 2.75E−04 | −2.76E−05 | 1.63E−06 | −5.15E−08 | 6.74E−10 |
| | −5.87E−04 | 5.67E−05 | −3.26E−06 | 1.10E−07 | −2.03E−09 | 1.57E−11 |

FIGS. 25A and 25B show lens shapes and placement for this embodiment, when it is operating in main mode. It also shows sample light rays through the embodiment for this mode. In main mode, the field-of-view (FOV) is approximately 80 degrees, the F-number is approximately 1.7, and the effective focal length (EFL) is approximately 4.78 mm.

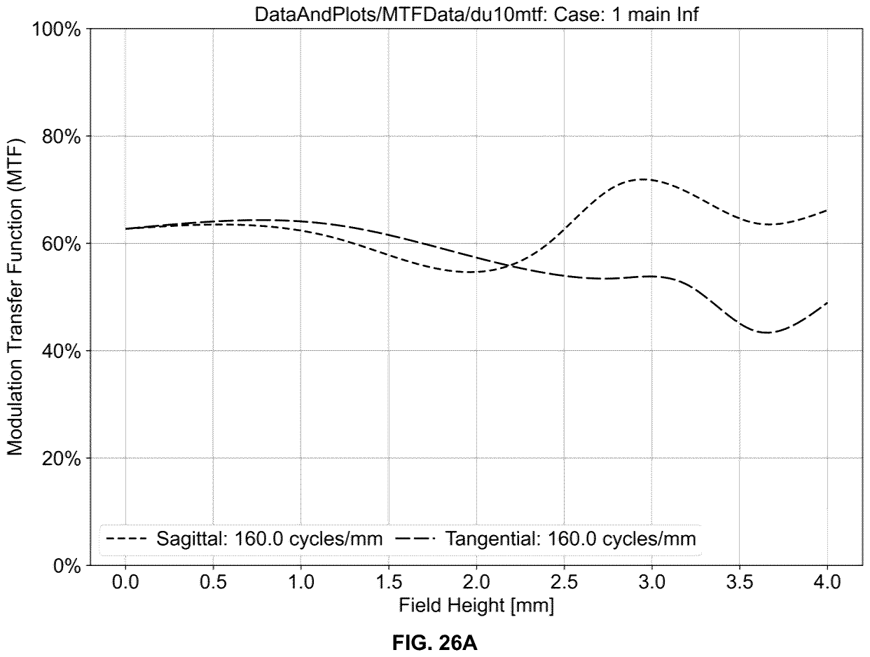

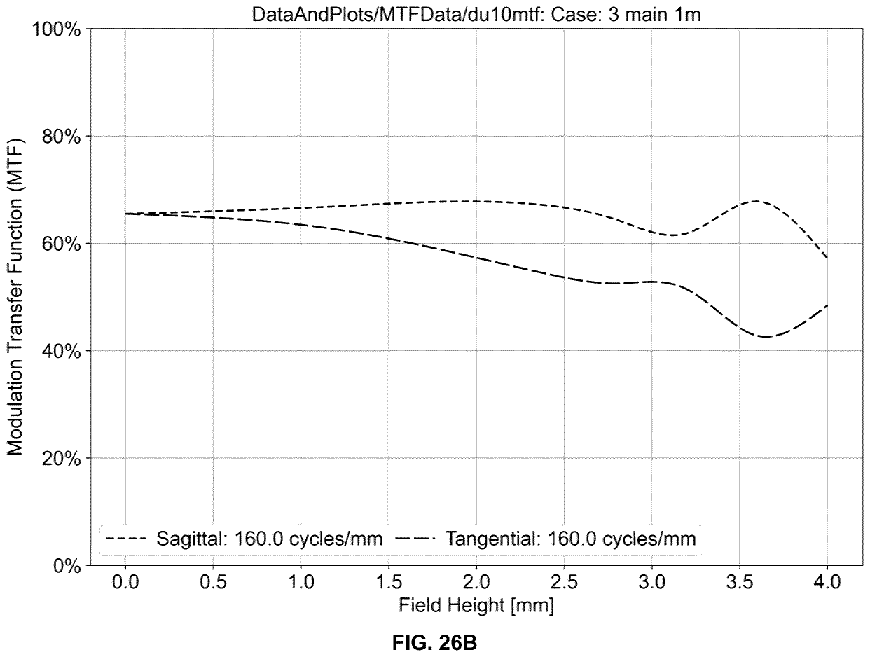

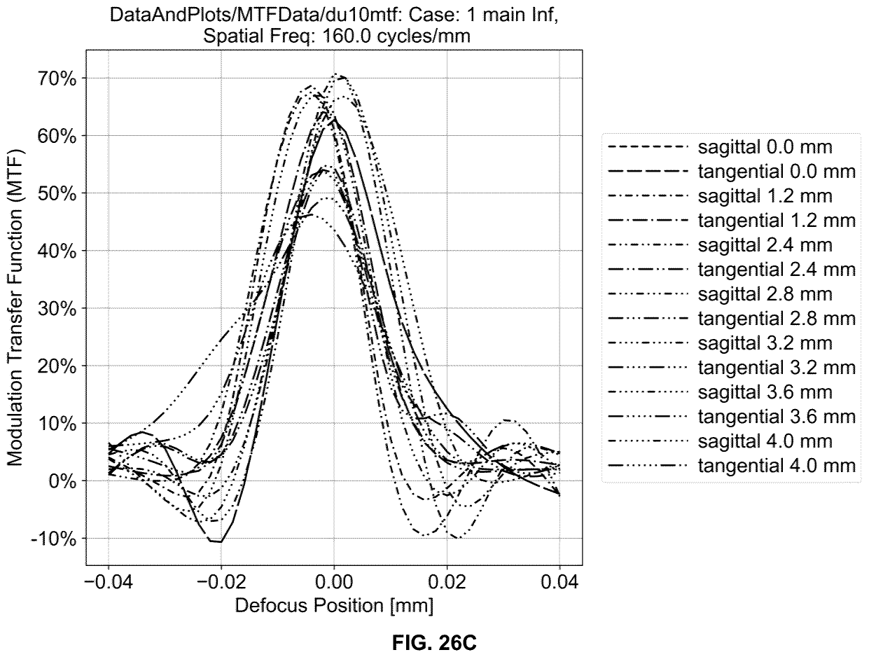

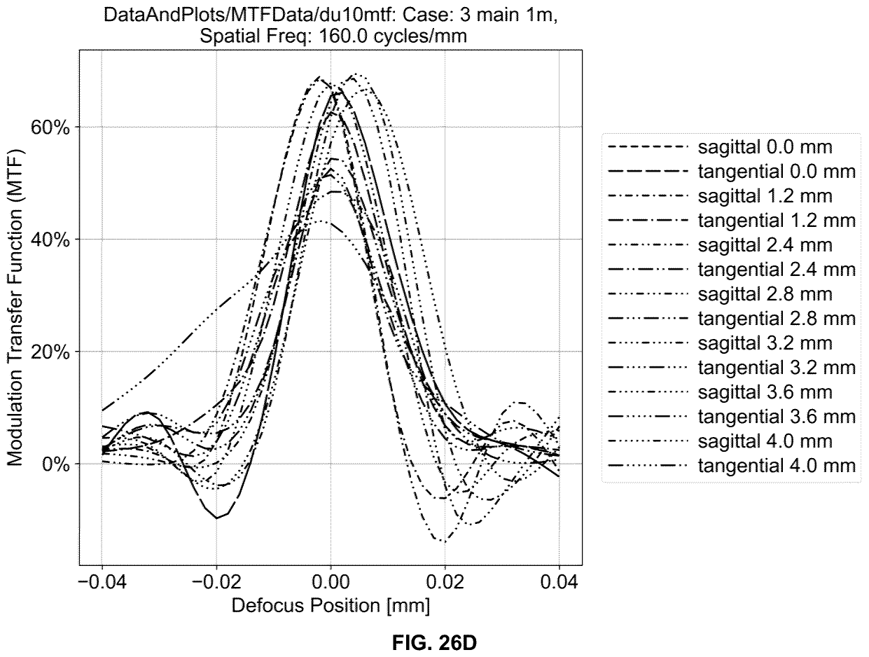

For main mode, FIG. 26A is an MTF (modulation transfer function) performance diagram versus field height for this embodiment, for an object plane located away at infinity. FIG. 26B is an MTF performance diagram versus field height, for an object plane located at 1 meter. FIG. 26C is an MTF versus defocus position, for an object plane located at infinity. And FIG. 26D is an MTF versus defocus position, for an object plane at 10 centimeters.

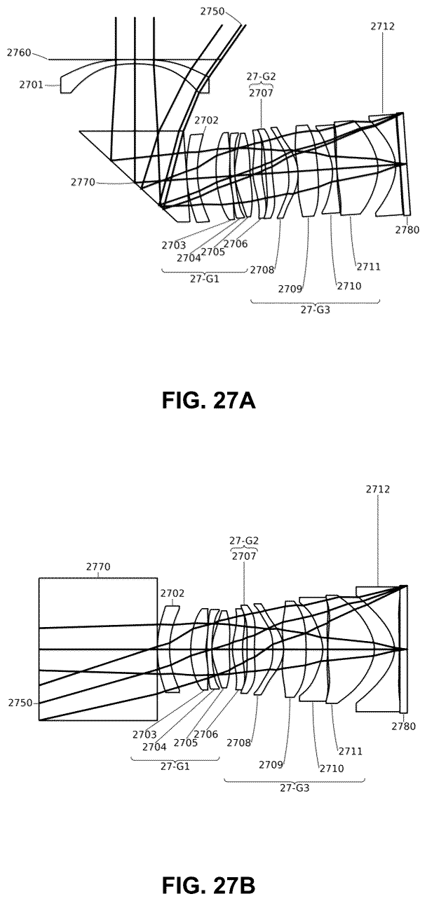

FIGS. 27A and 27B shows lens placement for this embodiment, when it is operating in ultra-wide mode. It also shows sample light rays through the embodiment for this mode. In ultra-wide mode, the field-of-view (FOV) is approximately 126 degrees, the F-number is approximately 2, and the effective focal length (EFL) is approximately 3.54 mm.

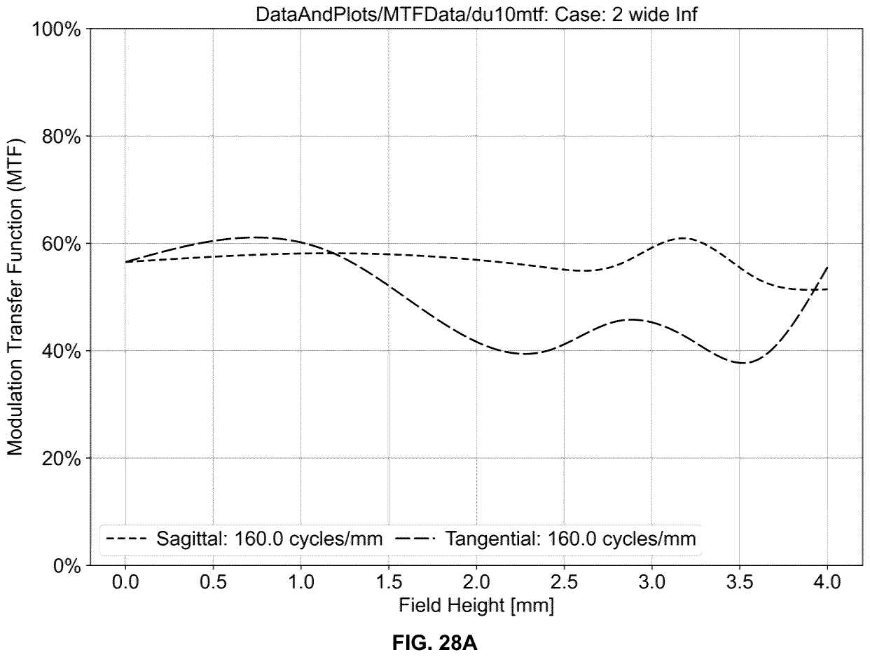

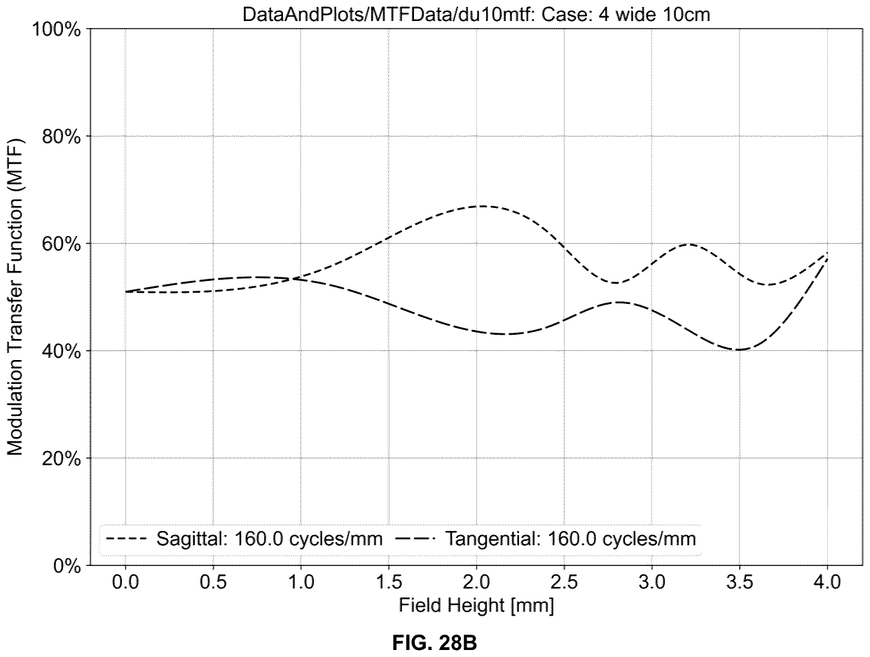

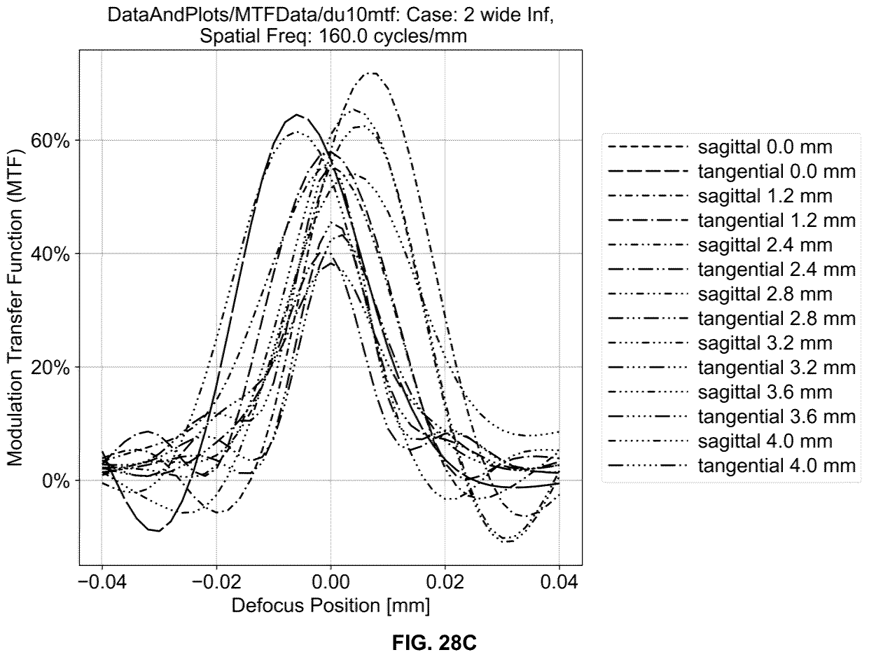

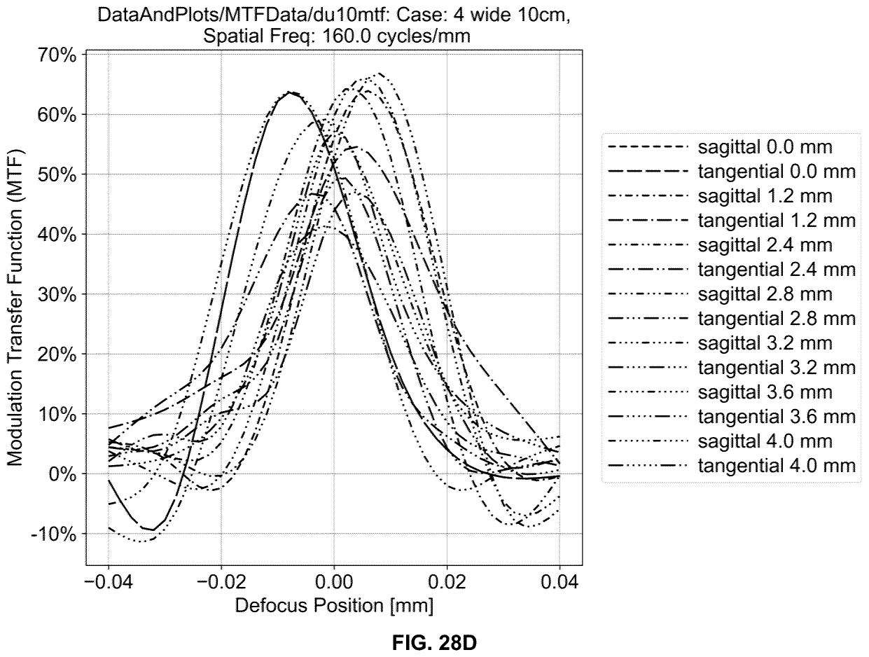

For ultra-wide mode, FIG. 28A is an MTF performance diagram for this embodiment versus field height, for an object plane located away at infinity. FIG. 28B is an MTF performance diagram versus field height, for an object plane located at 10 centimeters. FIG. 28C is an MTF versus defocus position, for an object plane located at infinity. And FIG. 28D is an MTF versus defocus position, for an object plane at 10 centimeters.

### Embodiment #8

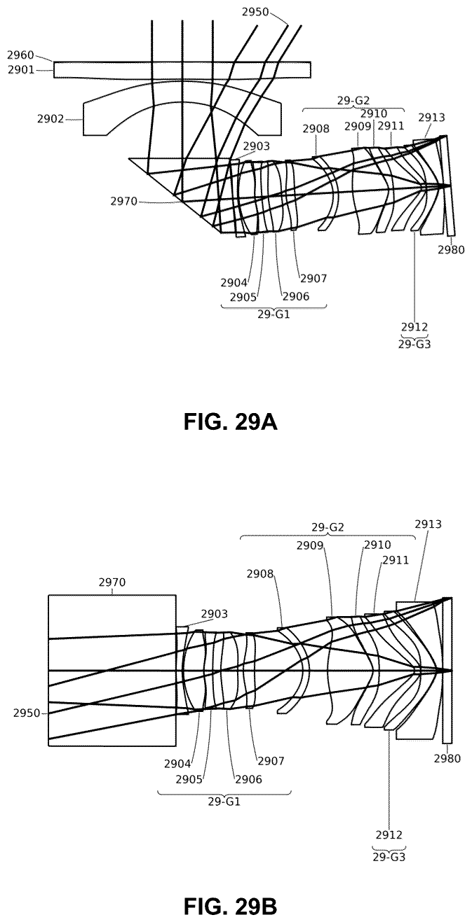

This embodiment (FIGS. 29A-32D) can have a periscope arrangement, with a turning optic that may be a mirror or a prism. The total size of the optics can be approximately 15.95 mm (X length)×14.5 mm (Y width)×8.29 mm (Z height).

The embodiment can have 13 lenses (13 aspherical and 0 spherical). The turning optic may be positioned before the third lens, before the remaining lenses in the periscope arm. There may be 3 moving lens groups, with 4 lenses in the first group, and 4 lenses in the second group, and 1 lens in the third group. The power of these groups may be positive, negative, and positive. The motion of the first lens group may also be used for auto-focusing.

Table 8 states possible lens shapes and placement for this embodiment, for both

TABLE 8
Lens shape parameters for embodiment #8.

| | Radius | Thickness | | | | AS4 | AS6 |
|---|---|---|---|---|---|---|---|
| | [mm] | [mm] | Nd | Abbe | K | [1/mm\hat{ }3] | [[1/mm\hat{ }5] |
| 1 | 38.395 | 0.829 | 1.82 | 24.06 | 3.77E+00 | −1.57E−03 | 6.83E−05 |
| | 48.852 | 0.100 | | | 4.49E+00 | −1.93E−03 | 9.42E−05 |
| 2 | 7.096 | 0.999 | 1.53 | 55.75 | −4.06E+01 | 7.79E−03 | −6.39E−04 |
| | 3.619 | 2.693 | | | −6.47E+00 | 1.37E−02 | −2.38E−04 |
| | | 4.157 | 1.52 | 64.20 | | | |
| | | 0.008 | | | | | |
| 3 | 9.853 | 0.201 | 1.62 | 25.79 | 1.58E+01 | −3.00E−02 | 4.32E−03 |
| | 5.103 | 0.041 | | | 4.29E+00 | −3.07E−02 | 4.04E−03 |
| 4 | 4.489 | 0.661 | 1.53 | 55.75 | 3.52E+00 | −2.61E−03 | −1.95E−03 |
| | 2.454 | 0.007 | | | 4.32E−01 | −2.78E−01 | 1.52E−01 |
| 5 | 2.248 | 0.286 | 1.53 | 55.75 | −1.05E+00 | −2.60E−01 | 1.53E−01 |
| | 15.565 | 0.264 | | | 3.05E+01 | −2.35E−02 | 3.06E−02 |
| 6 | 5.101 | 0.551 | 1.50 | 81.56 | 4.21E+00 | −6.81E−02 | 4.60E−02 |
| | 8.382 | 0.184 | | | −1.90E+00 | −1.24E−01 | 6.42E−02 |
| 7 | 3.098 | 0.365 | 1.50 | 81.56 | −6.28E−01 | −7.88E−02 | 1.76E−02 |
| | 15.165 | 1.574 | | | −5.57E+00 | 6.11E−03 | −2.56E−02 |
| 8 | −2.036 | 0.216 | 1.57 | 37.67 | −1.73E−01 | 1.18E−02 | 2.91E−03 |
| | −2.714 | 0.591 | | | −3.75E+00 | −2.87E−02 | 6.47E−03 |
| 9 | 4.783 | 1.484 | 1.55 | 71.69 | 1.10E+00 | −1.81E−02 | 7.85E−04 |
| | −0.687 | 0.000 | | | −5.26E+00 | 2.18E−02 | −8.96E−03 |
| 10 | −0.757 | 0.200 | 1.53 | 55.75 | −6.65E+00 | −2.25E−03 | −9.22E−04 |
| | −10.961 | 1.157 | | | 8.58E+00 | −5.27E−02 | 9.43E−03 |
| 11 | −0.245 | 0.200 | 1.63 | 23.43 | −2.30E+00 | −1.07E−02 | 1.84E−02 |
| | −0.525 | 0.001 | | | −2.19E+00 | 4.36E−02 | −8.47E−03 |
| 12 | −9.295 | 0.513 | 1.88 | 40.81 | 8.65E−01 | −1.04E−01 | 2.80E−02 |
| | −0.474 | 0.000 | | | −7.68E+00 | −5.65E−02 | 1.90E−02 |
| 13 | −0.879 | 0.200 | 1.63 | 23.43 | −4.48E+00 | −3.55E−03 | 5.43E−04 |
| | −16.933 | 0.000 | | | 1.07E+01 | −1.39E−02 | 5.70E−03 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | −1.27E−06 | 1.24E−08 | 6.31E−11 | 1.37E−13 | 0.00E+00 |
| | −2.03E−06 | 2.33E−08 | 1.38E−10 | 3.35E−13 | 0.00E+00 |
| 2 | 2.49E−05 | −5.20E−07 | 5.56E−09 | −2.37E−11 | 0.00E+00 |
| | −1.04E−04 | 1.02E−05 | −3.61E−07 | 4.75E−09 | 0.00E+00 |
| 3 | 2.33E−04 | −2.38E−04 | 4.03E−05 | −2.81E−06 | 0.00E+00 |
| | 4.14E−04 | −3.09E−04 | 5.01E−05 | −4.83E−06 | 0.00E+00 |
| 4 | 1.29E−03 | −6.31E−04 | 1.40E−04 | −1.34E−05 | 0.00E+00 |
| | −5.52E−02 | 1.20E−02 | −1.36E−03 | 5.64E−05 | 0.00E+00 |
| 5 | −5.72E−02 | 1.32E−02 | −1.56E−03 | 7.28E−05 | 0.00E+00 |
| | −1.77E−02 | 5.54E−03 | −8.31E−04 | 5.58E−05 | 0.00E+00 |
| 6 | −2.35E−02 | 6.72E−03 | −1.14E−03 | 8.67E−05 | 0.00E+00 |
| | −2.54E−02 | 6.28E−03 | −9.29E−04 | 6.19E−05 | 0.00E+00 |
| 7 | −1.38E−03 | −1.62E−03 | 6.18E−04 | −5.74E−05 | 0.00E+00 |
| | 1.30E−02 | −4.50E−03 | 8.48E−04 | −5.94E−05 | 0.00E+00 |
| 8 | −1.52E−03 | 1.00E−04 | 1.88E−05 | 2.75E−06 | 0.00E+00 |
| | −1.01E−03 | −1.22E−04 | 4.10E−05 | −2.47E−06 | 0.00E+00 |
| 9 | −3.95E−04 | −1.40E−04 | 3.13E−05 | −1.22E−06 | 0.00E+00 |
| | 1.87E−03 | −3.95E−04 | 4.02E−05 | −1.28E−06 | 0.00E+00 |
| 10 | 1.84E−03 | −4.30E−04 | 3.78E−05 | −1.20E−06 | 0.00E+00 |
| | 7.93E−04 | −3.57E−04 | 3.42E−05 | −1.16E−06 | 0.00E+00 |
| 11 | −5.53E−03 | 7.66E−04 | −5.29E−05 | 1.29E−06 | 0.00E+00 |
| | 1.39E−03 | −1.84E−04 | 1.26E−05 | −3.09E−07 | 0.00E+00 |
| 12 | −3.76E−03 | 2.84E−04 | −1.08E−05 | 1.47E−07 | 0.00E+00 |
| | −3.01E−03 | 2.25E−04 | −7.48E−06 | 1.01E−07 | 0.00E+00 |
| 13 | 2.99E−04 | −1.05E−04 | 8.71E−06 | −1.75E−07 | 0.00E+00 |
| | −8.85E−04 | 6.38E−05 | −2.19E−06 | 2.95E−08 | 0.00E+00 |

FIGS. 29A and 29B show lens shapes and placement for this embodiment, when it is operating in main mode. It also shows sample light rays through the embodiment for this mode. In main mode, the field-of-view (FOV) is approximately 80 degrees, the F-number is approximately 1.7, and the effective focal length (EFL) is approximately 4.47 mm.

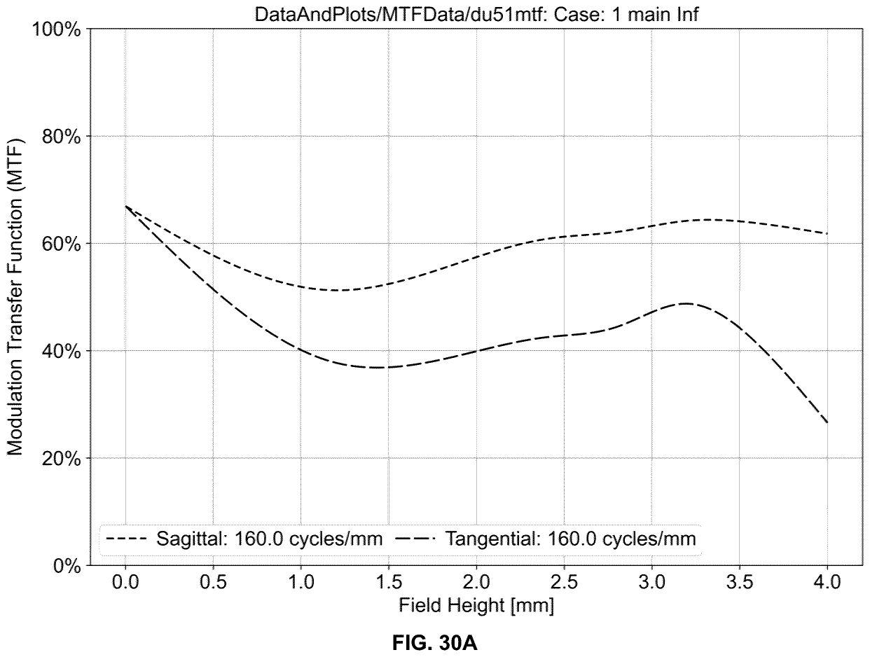

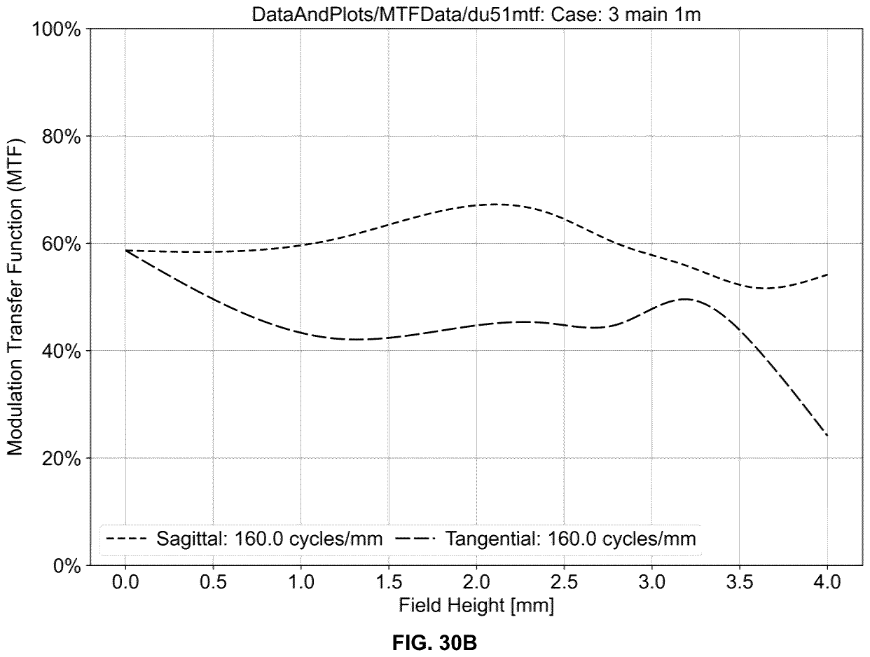

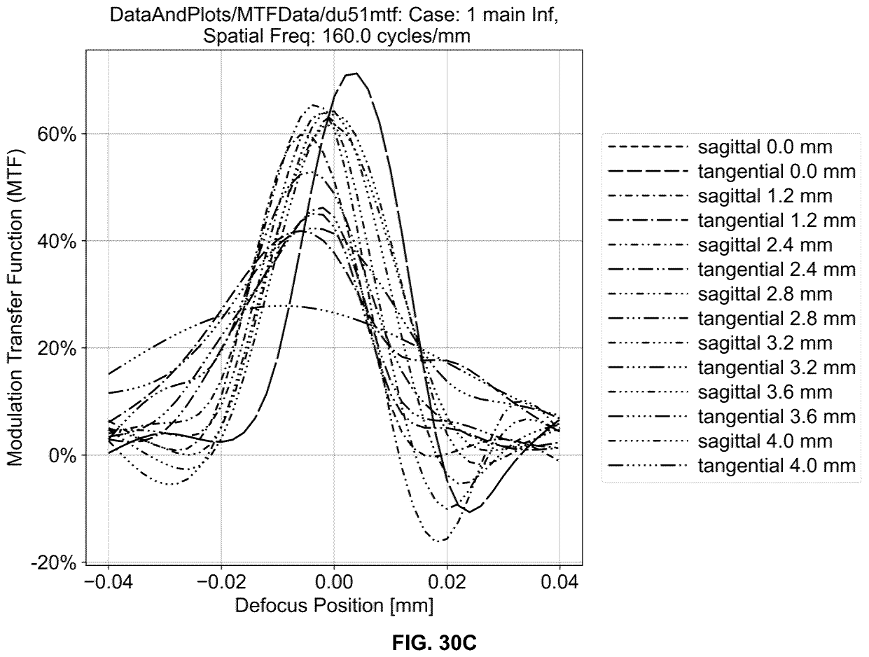

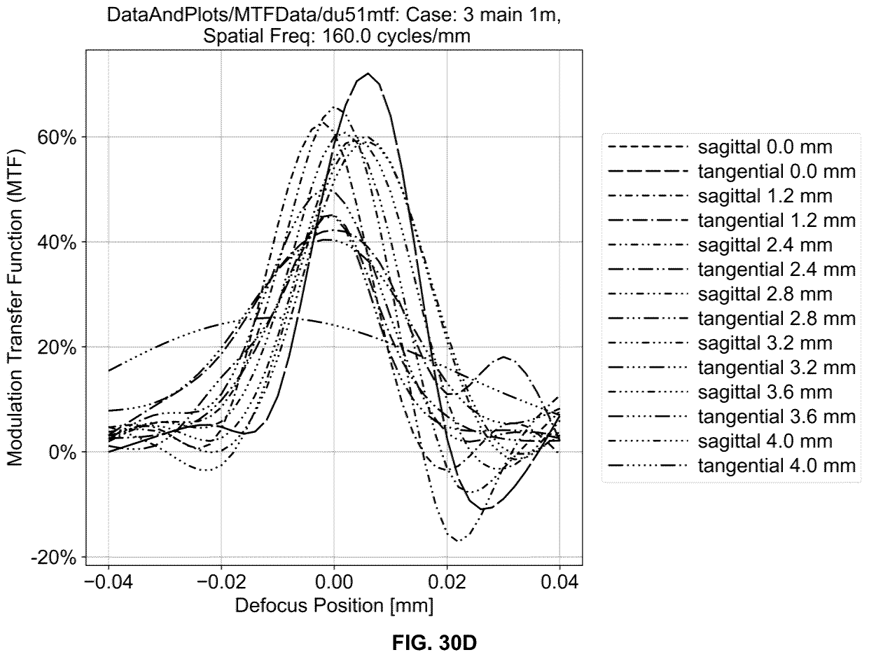

For main mode, FIG. 30A is an MTF (modulation transfer function) performance diagram versus field height for this embodiment, for an object plane located away at infinity. FIG. 30B is an MTF performance diagram versus field height, for an object plane located at 1 meter. FIG. 30C is an MTF versus defocus position, for an object plane located at infinity. And FIG. 30D is an MTF versus defocus position, for an object plane at 10 centimeters.

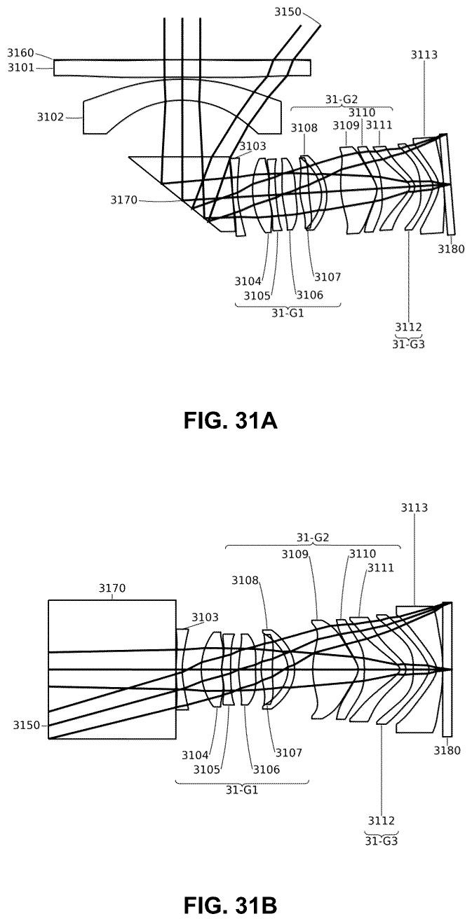

FIGS. 31A and 31B show lens placement for this embodiment, when it is operating in ultra-wide mode. It also shows sample light rays through the embodiment for this mode. In ultra-wide mode, the field-of-view (FOV) is approximately 126 degrees, the F-number is approximately 2, and the effective focal length (EFL) is approximately 2.23 mm.

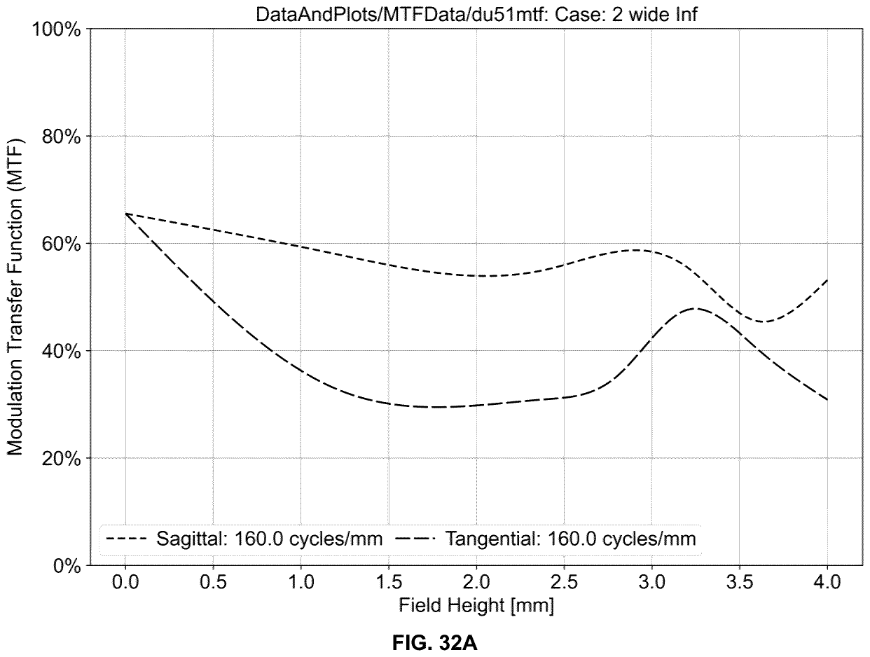

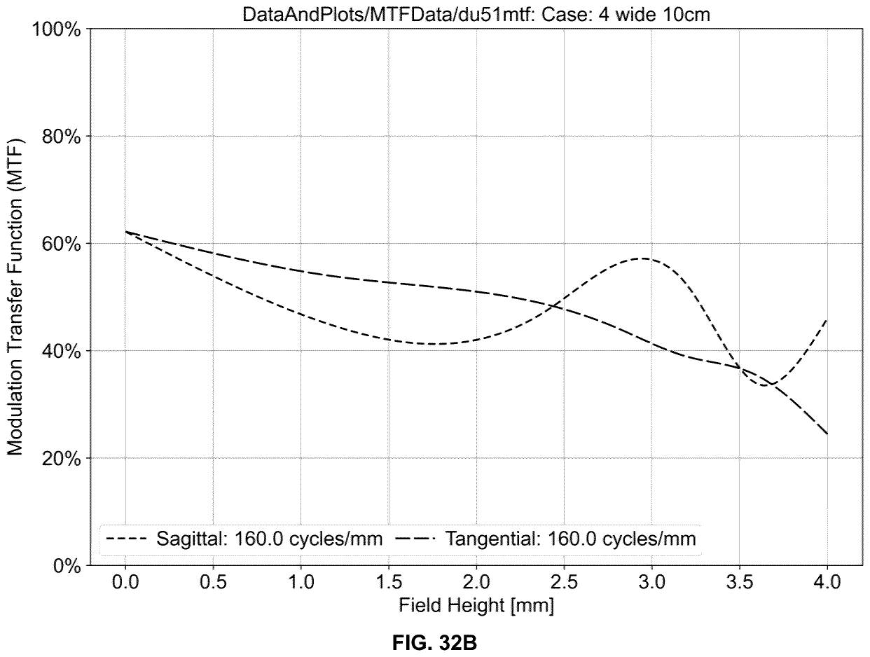

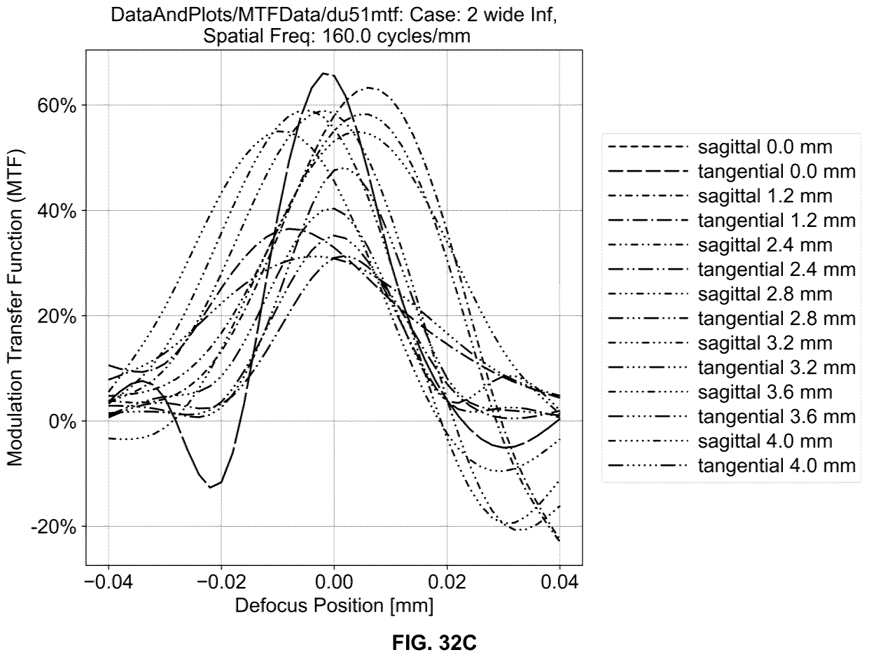

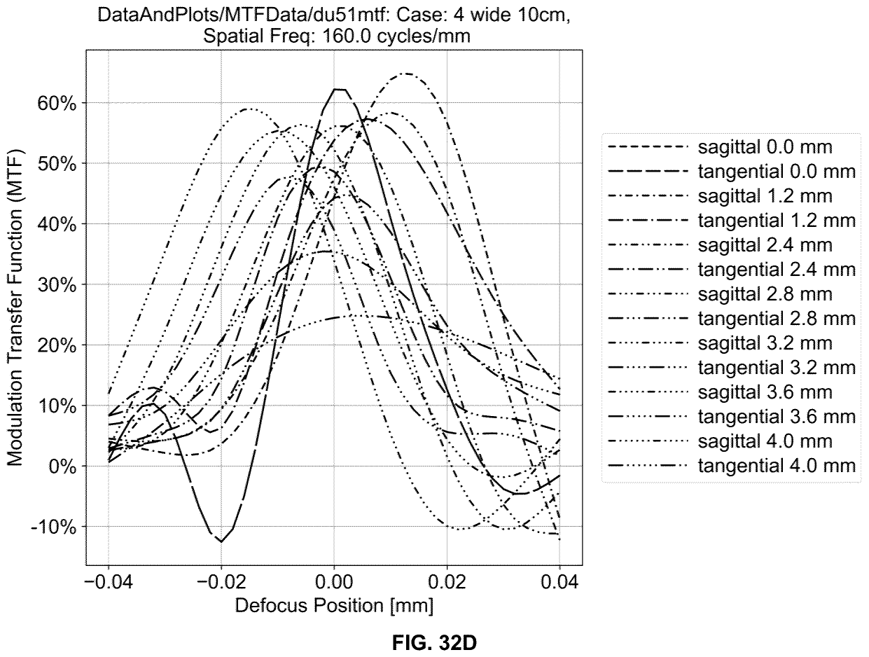

For ultra-wide mode, FIG. 32A is an MTF performance diagram for this embodiment versus field height, for an object plane located away at infinity. FIG. 32B is an MTF performance diagram versus field height, for an object plane located at 10 centimeters. FIG. 32C is an MTF versus defocus position, for an object plane located at infinity. And FIG. 32D is an MTF versus defocus position, for an object plane at 10 centimeters.

### Embodiment #9

This embodiment (FIGS. 33A-36D) can have a periscope arrangement, with a turning optic that may be a mirror or a prism. The total size of the optics can be approximately 18.11 mm (X length)×11.62 mm (Y width)×8.65 mm (Z height).

The embodiment can have 13 lenses (13 aspherical and 0 spherical). The turning optic may be positioned before the third lens, before the remaining lenses in the periscope arm. There may be 3 moving lens groups, with 5 lenses in the first group, and 1 lens in the second group, and 4 lenses in the third group. The power of these groups may be positive, negative, and positive. The motion of the first lens group may also be used for auto-focusing.

Table 9 states possible lens shapes and placement for this embodiment, for both

TABLE 9
Lens shape parameters for embodiment #9.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 14.495 | 0.200 | 1.55 | 71.69 | 1.30E+00 | −8.25E−04 | 1.21E−04 |
| | 4.375 | 1.614 | | | −1.75E+00 | 8.08E−04 | −1.45E−04 |
| 2 | 49.348 | 0.200 | 1.53 | 55.75 | −4.08E+01 | 8.06E−03 | −4.70E−04 |
| | 47.025 | 1.815 | | | −5.64E+00 | 1.01E−02 | −3.12E−04 |
| | | 6.302 | 1.52 | 64.20 | | | |
| | | 0.024 | | | | | |
| 3 | 8.462 | 0.201 | 1.63 | 23.43 | 1.29E+01 | −5.44E−02 | 2.74E−02 |
| | 4.567 | 0.000 | | | 4.34E+00 | −9.68E−02 | 6.21E−02 |
| 4 | 5.020 | 0.665 | 1.53 | 55.75 | 5.10E+00 | −3.28E−02 | 3.52E−02 |
| | 2.658 | 0.000 | | | 3.86E−01 | −3.04E−01 | 1.74E−01 |
| 5 | 2.501 | 0.463 | 1.53 | 55.75 | −1.76E+00 | −2.50E−01 | 1.43E−01 |
| | 22.048 | 0.000 | | | 2.96E+01 | −7.25E−03 | 3.82E−03 |
| 6 | 2.191 | 0.787 | 1.50 | 81.56 | −1.61E+00 | −5.76E−02 | 3.11E−02 |
| | 4.857 | 0.008 | | | −3.07E−01 | −1.96E−01 | 1.48E−01 |
| 7 | 3.732 | 0.223 | 1.54 | 59.46 | −1.03E+01 | −1.53E−01 | 1.25E−01 |
| | 4.201 | 2.893 | | | −5.53E+00 | 8.53E−03 | −1.41E−02 |
| 8 | −4.903 | 0.200 | 1.53 | 55.75 | −3.05E+00 | 9.49E−03 | 4.57E−03 |
| | −49.818 | 0.080 | | | −1.19E+00 | 2.98E−03 | −1.25E−03 |
| 9 | 10.337 | 0.626 | 1.77 | 47.17 | 3.58E−02 | −1.31E−02 | −7.01E−03 |
| | −2.745 | 0.000 | | | −1.51E+00 | 5.66E−02 | −2.07E−02 |
| 10 | −3.158 | 0.811 | 1.53 | 55.75 | −7.68E+00 | 5.67E−02 | 1.10E−02 |
| | −10.479 | 0.238 | | | 1.14E+01 | −1.85E−02 | 2.33E−02 |
| 11 | −2.837 | 0.200 | 1.63 | 23.43 | −1.96E+00 | 4.81E−02 | −1.07E−02 |
| | −13.231 | 0.000 | | | −5.55E+00 | 5.99E−02 | −2.39E−02 |
| 12 | 9.353 | 1.691 | 1.50 | 81.56 | 1.17E+00 | −2.36E−03 | 2.89E−04 |
| | −2.320 | 0.096 | | | −3.12E+00 | −1.53E−02 | 2.09E−03 |
| 13 | −1.527 | 0.200 | 1.59 | 29.90 | −4.56E+00 | −1.99E−02 | 4.82E−04 |
| | −28.243 | 0.013 | | | 2.43E+01 | 1.41E−02 | −4.01E−03 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | −6.37E−06 | 1.69E−07 | −2.21E−09 | 1.11E−11 | 0.00E+00 |
| | 2.50E−05 | −1.54E−06 | 3.75E−08 | −3.14E−10 | 0.00E+00 |
| 2 | 2.14E−06 | 5.01E−07 | −1.46E−08 | 1.27E−10 | 0.00E+00 |
| | −4.39E−06 | 2.30E−07 | 3.50E−08 | −8.97E−10 | 0.00E+00 |
| 3 | −7.97E−03 | 1.35E−03 | −1.00E−04 | 1.36E−06 | 0.00E+00 |
| | −2.24E−02 | 4.02E−03 | −2.81E−04 | 1.56E−06 | 0.00E+00 |
| 4 | −1.71E−02 | 3.41E−03 | −2.64E−04 | 3.96E−06 | 0.00E+00 |
| | −5.90E−02 | 1.19E−02 | −1.34E−03 | 5.92E−05 | 0.00E+00 |
| 5 | −3.81E−02 | 5.74E−03 | −4.41E−04 | 1.42E−05 | 0.00E+00 |
| | 8.33E−03 | −4.91E−03 | 9.95E−04 | −6.05E−05 | 0.00E+00 |
| 6 | −4.70E−03 | −4.42E−04 | 2.12E−04 | −1.66E−05 | 0.00E+00 |
| | −5.63E−02 | 1.24E−02 | −1.59E−03 | 8.89E−05 | 0.00E+00 |
| 7 | −4.98E−02 | 9.16E−03 | −7.45E−04 | 2.07E−05 | 0.00E+00 |
| | 7.55E−03 | −3.40E−03 | 7.67E−04 | −6.01E−05 | 0.00E+00 |
| 8 | −5.06E−03 | 1.26E−03 | −1.26E−04 | 4.75E−06 | 0.00E+00 |
| | −1.66E−03 | 1.59E−04 | 2.54E−05 | −2.65E−06 | 0.00E+00 |
| 9 | 3.18E−05 | 2.92E−04 | −5.36E−05 | 3.50E−06 | 0.00E+00 |
| | 1.37E−03 | 4.04E−04 | −6.55E−05 | 2.63E−06 | 0.00E+00 |
| 10 | −7.55E−04 | 4.30E−04 | −4.36E−05 | 1.34E−06 | 0.00E+00 |
| | −9.30E−03 | 1.51E−03 | −1.10E−04 | 3.00E−06 | 0.00E+00 |
| 11 | −1.36E−03 | 6.31E−04 | −6.72E−05 | 2.20E−06 | 0.00E+00 |
| | 4.01E−03 | −3.53E−04 | 1.66E−05 | −3.08E−07 | 0.00E+00 |
| 12 | −1.32E−03 | 2.64E−04 | −1.79E−05 | 3.98E−07 | 0.00E+00 |
| | −6.39E−04 | 1.08E−04 | −6.88E−06 | 1.60E−07 | 0.00E+00 |
| 13 | 4.71E−04 | −8.33E−05 | 5.82E−06 | −1.07E−07 | 0.00E+00 |
| | 5.38E−04 | −3.97E−05 | 1.47E−06 | −2.02E−08 | 0.00E+00 |

FIGS. 33A and 33B show lens shapes and placement for this embodiment, when it is operating in main mode. It also shows sample light rays through the embodiment for this mode. In main mode, the field-of-view (FOV) is approximately 85.3 degrees, the F-number is approximately 1.83, and the effective focal length (EFL) is approximately 4.3 mm.

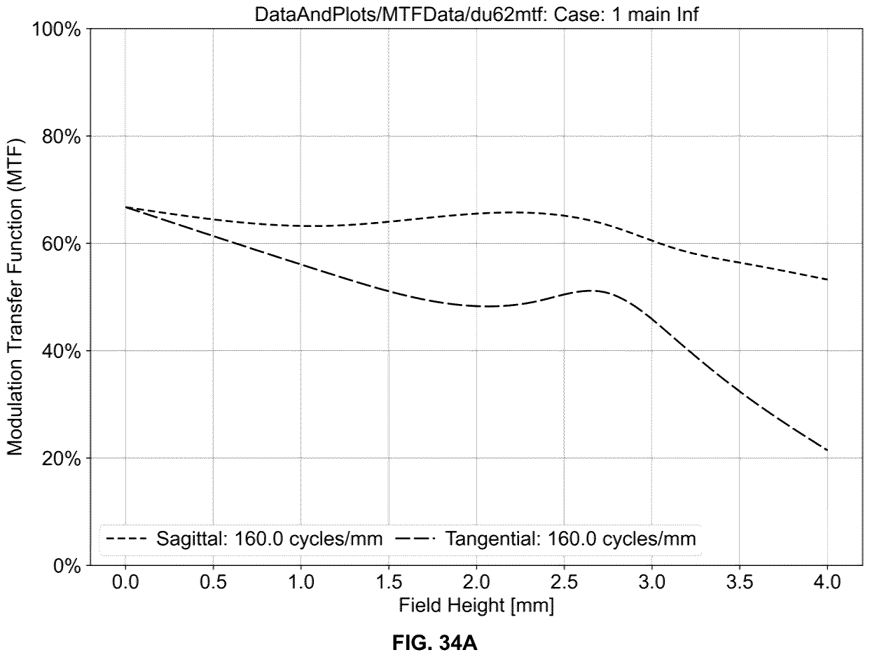

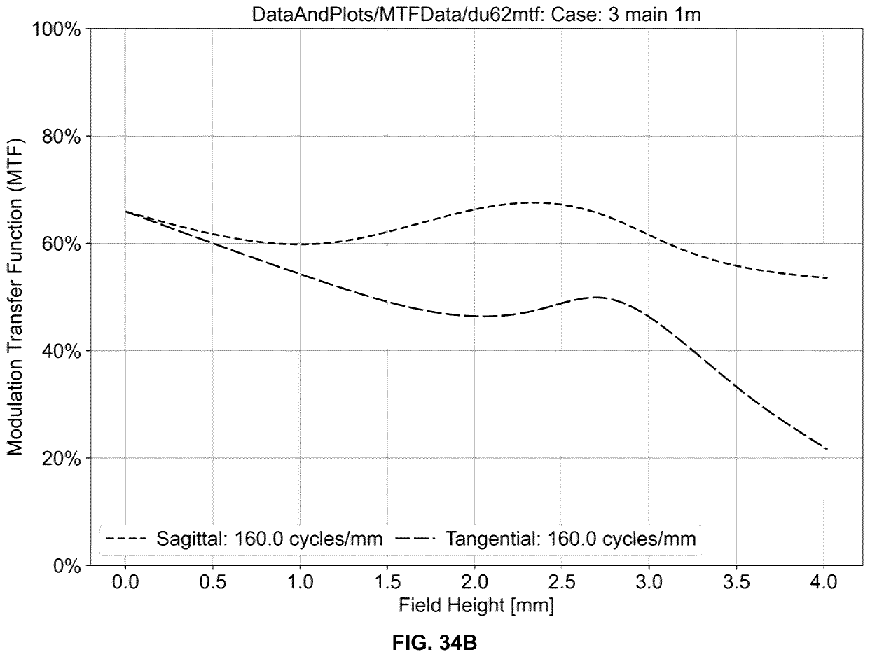

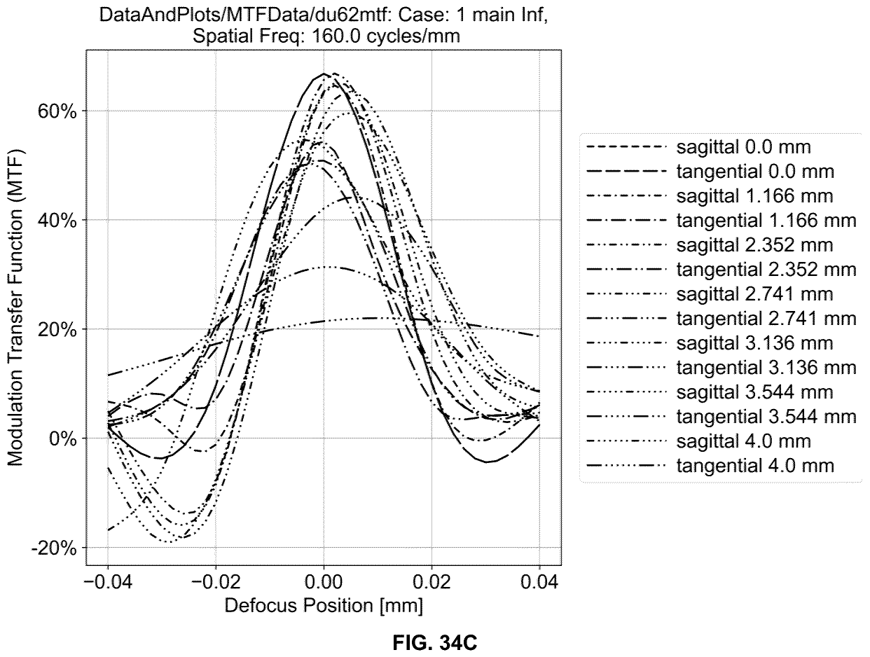

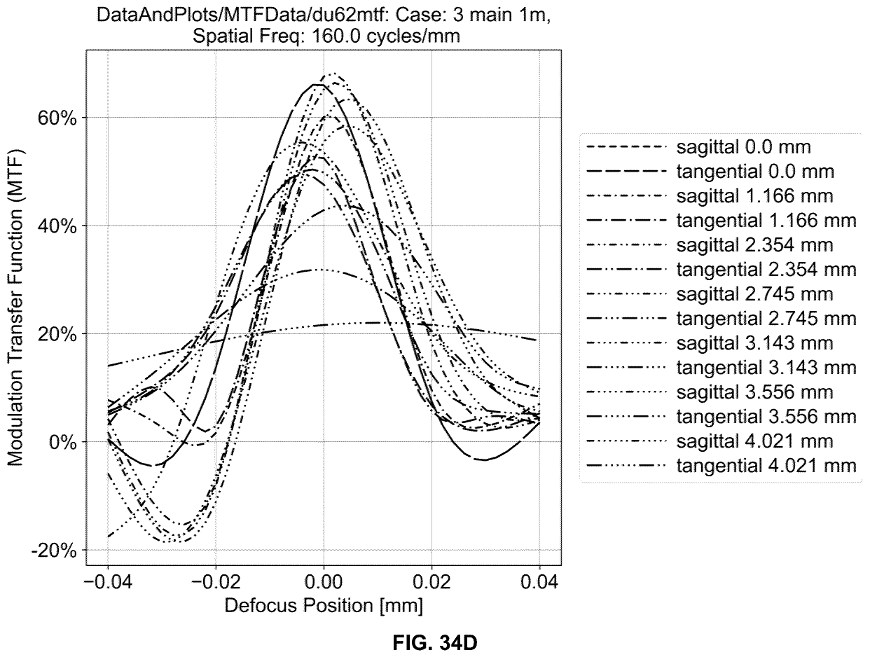

For main mode, FIG. 34A is an MTF (modulation transfer function) performance diagram versus field height for this embodiment, for an object plane located away at infinity. FIG. 34B is an MTF performance diagram versus field height, for an object plane located at 1 meter. FIG. 34C is an MTF versus defocus position, for an object plane located at infinity. And FIG. 34D is an MTF versus defocus position, for an object plane at 10 centimeters.

FIGS. 35A and 35B show lens placement for this embodiment, when it is operating in ultra-wide mode. It also shows sample light rays through the embodiment for this mode. In ultra-wide mode, the field-of-view (FOV) is approximately 122.1 degrees, the F-number is approximately 2.06, and the effective focal length (EFL) is approximately 2.79 mm.

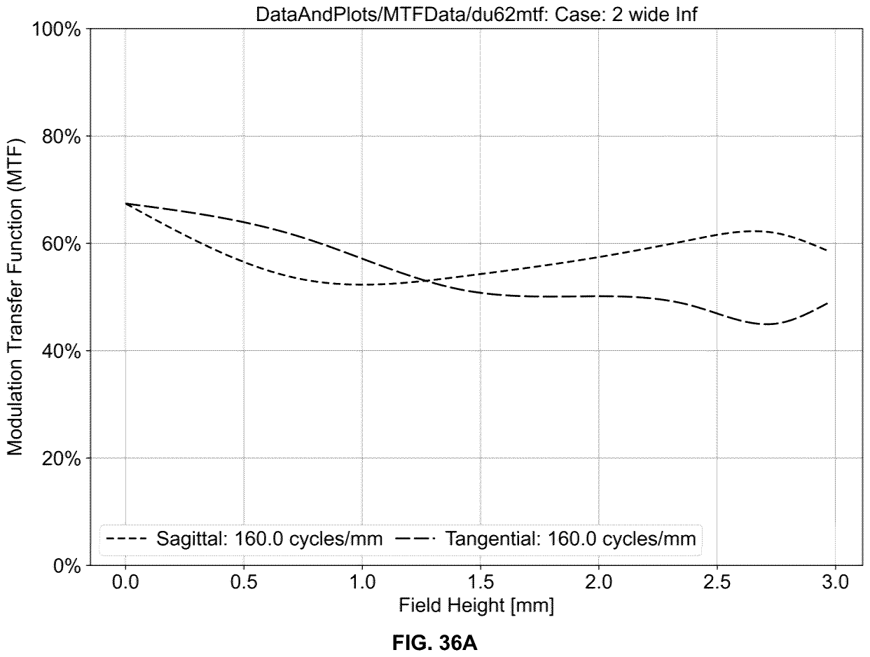

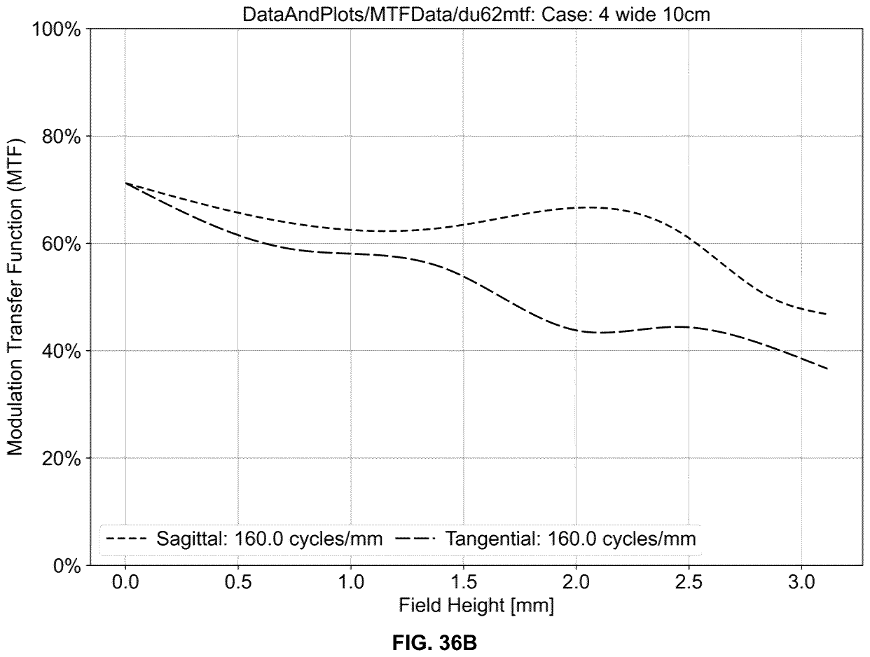

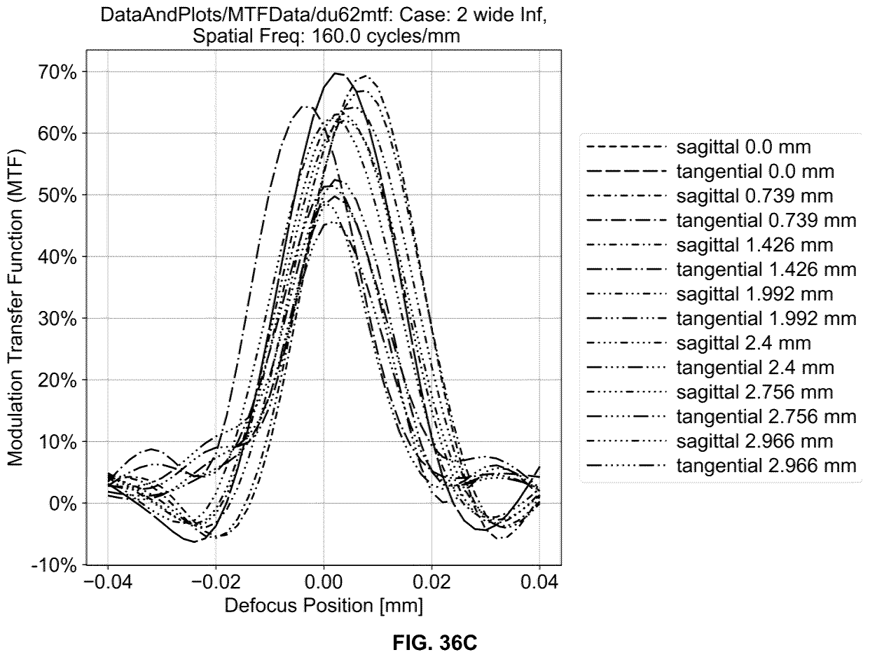

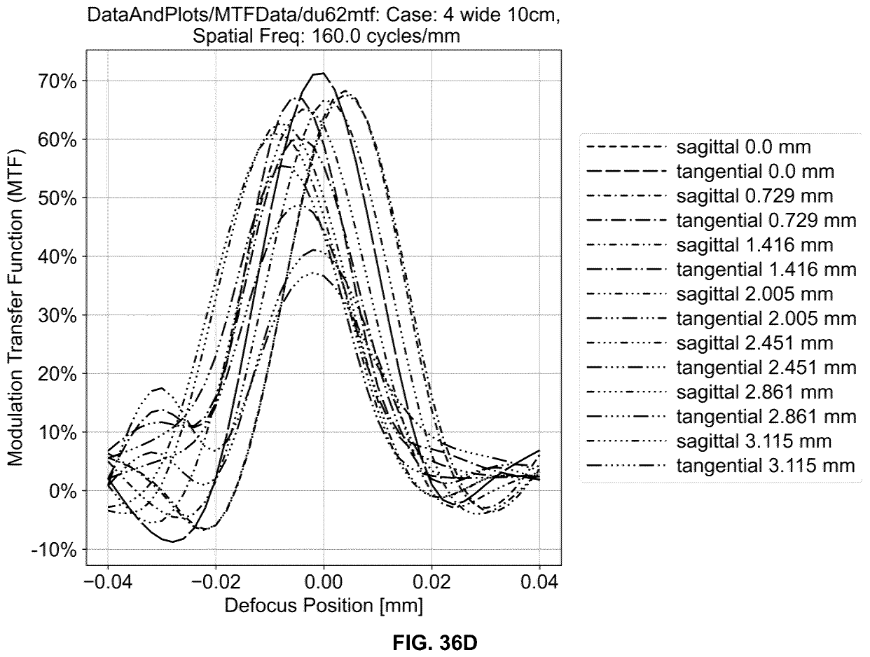

For ultra-wide mode, FIG. 36A is an MTF performance diagram for this embodiment versus field height, for an object plane located away at infinity. FIG. 36B is an MTF performance diagram versus field height, for an object plane located at 10 centimeters. FIG. 36C is an MTF versus defocus position, for an object plane located at infinity. And FIG. 36D is an MTF versus defocus position, for an object plane at 10 centimeters.

### Embodiment #10

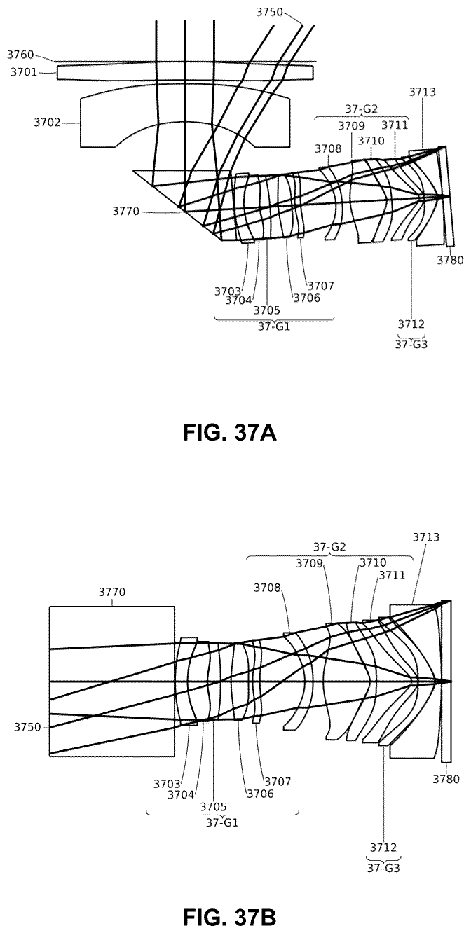

This embodiment (FIGS. 37A-40D) can have a periscope arrangement, with a turning optic that may be a mirror or a prism. The total size of the optics can be approximately 15.59 mm (X length)×14.01 mm (Y width)×8.64 mm (Z height).

The embodiment can have 13 lenses (13 aspherical and 0 spherical). The turning optic may be positioned before the third lens, before the remaining lenses in the periscope arm. There may be 3 moving lens groups, with 5 lenses in the first group, and 4 lenses in the second group, and 1 lens in the third group. The power of these groups may be positive, negative, and positive. The motion of the first lens group may also be used for auto-focusing.

Table 10 states possible lens shapes and placement for this embodiment, for both

TABLE 10
Lens shape parameters for embodiment #10.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 22.356 | 0.891 | 1.7495 | 35.28 | −4.01E+00 | −1.03E−03 | 2.32E−05 |
| | 48.265 | 0.189 | | | 7.78E+00 | −1.02E−03 | 2.69E−05 |
| 2 | 26.948 | 1.821 | 1.5311 | 55.75 | −4.09E+01 | 3.30E−03 | −1.70E−04 |
| | 4.810 | 2.350 | | | −2.86E+00 | 9.64E−03 | −2.84E−04 |
| | | 3.956 | 1.5168 | 64.2 | | | |
| | | 0.024 | | | | | |
| 3 | 8.629 | 0.388 | 1.6322 | 23.43 | 1.56E+01 | 9.55E−03 | −5.85E−03 |
| | 4.485 | 0.000 | | | 4.43E+00 | 1.34E−03 | 2.82E−03 |
| 4 | 3.545 | 0.624 | 1.5311 | 55.75 | 2.33E+00 | −2.81E−02 | 1.44E−02 |
| | 2.288 | 0.012 | | | 2.84E−01 | −2.37E−01 | 1.93E−01 |
| 5 | 2.352 | 0.408 | 1.5311 | 55.75 | −1.56E+00 | −2.22E−01 | 1.96E−01 |
| | −46.108 | 0.334 | | | 3.05E+01 | −4.22E−02 | 2.85E−02 |
| 6 | 5.328 | 0.550 | 1.4971 | 81.56 | 4.73E+00 | −4.93E−02 | 2.45E−02 |
| | 13.745 | 0.131 | | | −1.98E+00 | −1.17E−01 | 5.57E−02 |
| 7 | 3.301 | 0.230 | 1.5284 | 76.45 | −1.55E+00 | −8.14E−02 | 2.32E−03 |
| | 6.654 | 1.423 | | | −6.03E+00 | 7.70E−03 | −4.78E−02 |
| 8 | −2.530 | 0.259 | 1.5311 | 55.75 | 4.06E−01 | −6.76E−03 | 1.69E−02 |
| | −5.774 | 0.323 | | | −4.38E+00 | −6.23E−02 | 2.48E−02 |
| 9 | 3.471 | 1.484 | 1.552 | 70.7 | 5.88E−02 | −3.66E−02 | 7.83E−03 |
| | −0.632 | 0.000 | | | −5.41E+00 | 2.44E−02 | −7.21E−03 |
| 10 | −0.703 | 0.200 | 1.5311 | 55.75 | −6.98E+00 | −1.22E−02 | 3.09E−03 |
| | −10.745 | 1.116 | | | 7.81E+00 | −4.91E−02 | 1.10E−02 |
| 11 | −0.259 | 0.200 | 1.6322 | 23.43 | −2.23E+00 | 4.52E−02 | −8.52E−03 |
| | −0.496 | 0.002 | | | −2.07E+00 | 7.81E−02 | −2.15E−02 |
| 12 | −6.465 | 0.536 | 1.8514 | 40.1 | −2.18E−01 | −7.37E−02 | 1.24E−02 |
| | −0.480 | 0.005 | | | −7.02E+00 | −3.78E−02 | 3.66E−03 |
| 13 | −0.717 | 0.200 | 1.6161 | 25.79 | −4.55E+00 | −6.94E−03 | −3.10E−03 |
| | −24.079 | 0.000 | | | 1.05E+01 | −2.48E−03 | 1.68E−03 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | −1.05E−07 | −1.20E−09 | 1.25E−11 | −2.71E−14 | 0.00E+00 |
| | −1.77E−07 | −9.60E−10 | 1.41E−11 | −3.39E−14 | 0.00E+00 |
| 2 | 4.57E−06 | −7.66E−08 | 7.35E−10 | −3.05E−12 | 0.00E+00 |
| | 4.27E−06 | 3.51E−07 | −2.35E−08 | 6.45E−10 | 0.00E+00 |
| 3 | 1.20E−03 | −4.72E−04 | 8.87E−05 | −5.97E−06 | 0.00E+00 |
| | −1.34E−03 | −1.74E−03 | 6.29E−04 | −5.70E−05 | 0.00E+00 |
| 4 | −5.64E−03 | −1.22E−04 | 3.59E−04 | −4.15E−05 | 0.00E+00 |
| | −1.56E−01 | 6.83E−02 | −1.37E−02 | 9.95E−04 | 0.00E+00 |
| 5 | −1.55E−01 | 6.78E−02 | −1.36E−02 | 1.00E−03 | 0.00E+00 |
| | −1.36E−02 | 5.33E−03 | −1.14E−03 | 1.03E−04 | 0.00E+00 |
| 6 | −1.16E−02 | 2.80E−03 | −1.17E−04 | −2.89E−05 | 0.00E+00 |
| | −2.09E−02 | 4.38E−03 | −1.64E−04 | −3.66E−05 | 0.00E+00 |
| 7 | 1.13E−03 | 1.56E−03 | −4.65E−04 | 3.63E−05 | 0.00E+00 |
| | 2.44E−02 | −6.55E−03 | 9.86E−04 | −6.22E−05 | 0.00E+00 |
| 8 | −2.52E−03 | −8.91E−04 | 2.37E−04 | −1.50E−05 | 0.00E+00 |
| | −2.74E−03 | −7.38E−04 | 1.73E−04 | −9.41E−06 | 0.00E+00 |
| 9 | −1.97E−03 | 7.49E−05 | 1.27E−05 | −4.69E−07 | 0.00E+00 |
| | 7.38E−04 | −1.31E−04 | 1.42E−05 | −3.83E−07 | 0.00E+00 |
| 10 | 4.27E−04 | −1.38E−04 | 1.09E−05 | −3.42E−07 | 0.00E+00 |
| | −1.01E−03 | 4.35E−05 | 1.13E−06 | −2.32E−07 | 0.00E+00 |
| 11 | −1.50E−04 | 2.34E−04 | −2.97E−05 | 9.99E−07 | 0.00E+00 |
| | 3.21E−03 | −2.90E−04 | 1.45E−05 | −2.89E−07 | 0.00E+00 |
| 12 | −5.91E−04 | −1.23E−05 | 1.80E−06 | −4.75E−08 | 0.00E+00 |
| | 7.59E−04 | −1.85E−04 | 1.33E−05 | −2.95E−07 | 0.00E+00 |
| 13 | 1.47E−03 | −2.44E−04 | 1.64E−05 | −3.40E−07 | 0.00E+00 |
| | −3.19E−04 | 2.41E−05 | −8.17E−07 | 1.12E−08 | 0.00E+00 |

FIGS. 37A and 37B show lens shapes and placement for this embodiment, when it is operating in main mode. It also shows sample light rays through the embodiment for this mode. In main mode, the field-of-view (FOV) is approximately 85.3 degrees, the F-number is approximately 1.83, and the effective focal length (EFL) is approximately 4.33 mm.

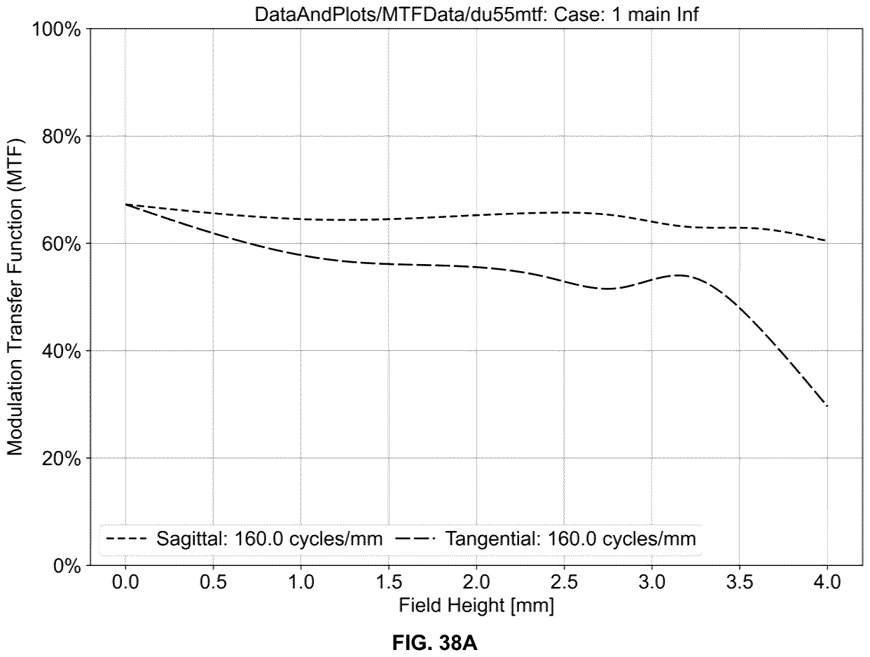

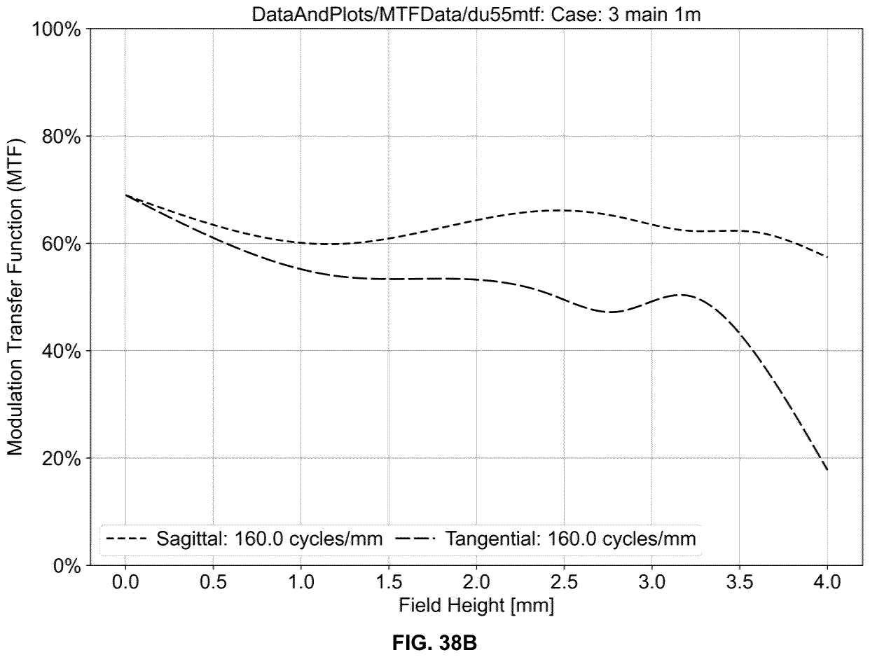

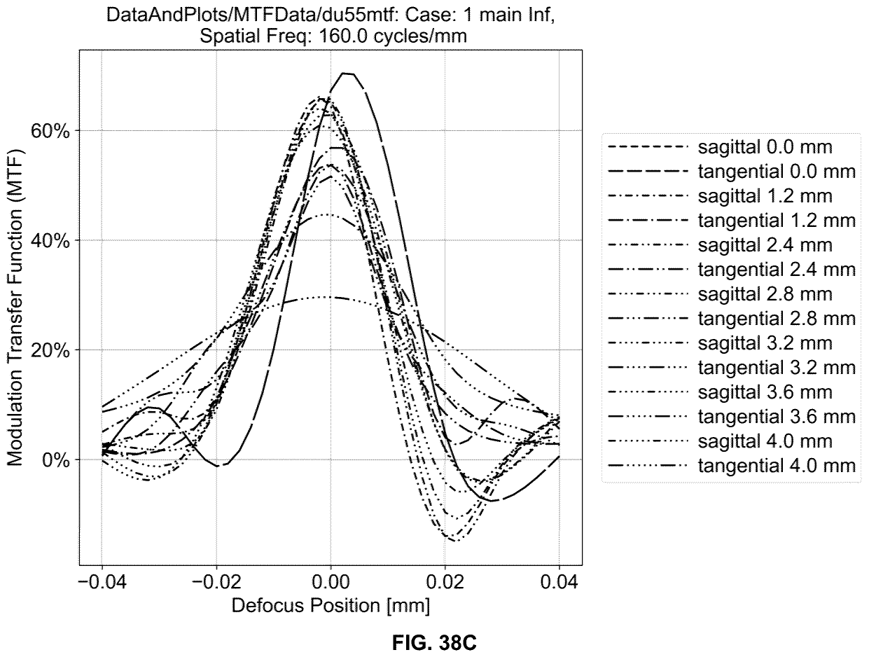

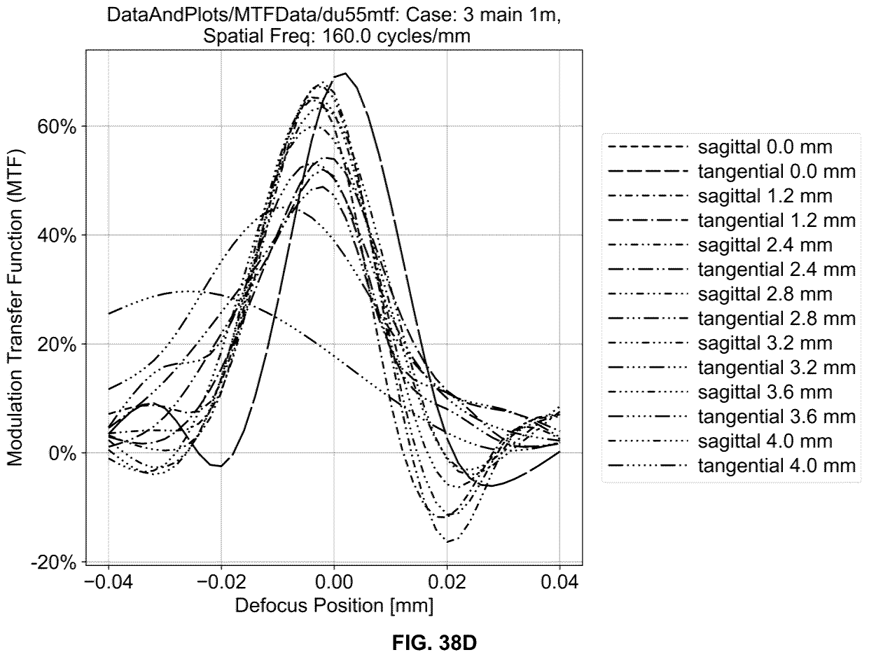

For main mode, FIG. 38A is an MTF (modulation transfer function) performance diagram versus field height for this embodiment, for an object plane located away at infinity. FIG. 38B is an MTF performance diagram versus field height, for an object plane located at 1 meter. FIG. 38C is an MTF versus defocus position, for an object plane located at infinity. And FIG. 38D is an MTF versus defocus position, for an object plane at 10 centimeters.

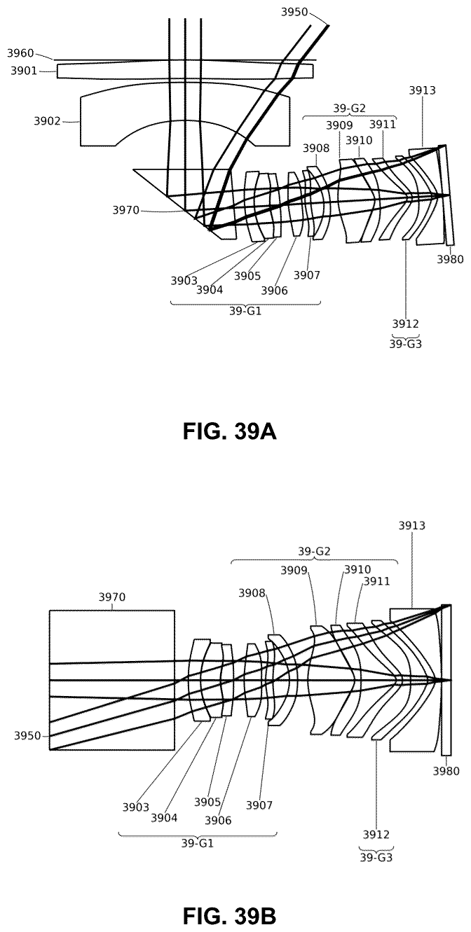

FIGS. 39A and 39B show lens placement for this embodiment, when it is operating in ultra-wide mode. It also shows sample light rays through the embodiment for this mode. In ultra-wide mode, the field-of-view (FOV) is approximately 122.1 degrees, the F-number is approximately 2.06, and the effective focal length (EFL) is approximately 2.44 mm.

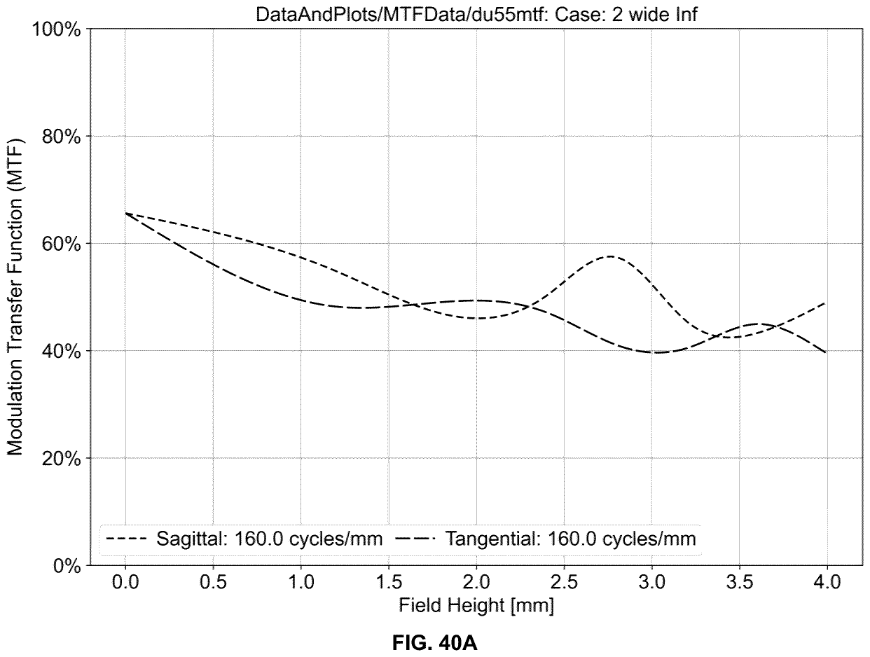

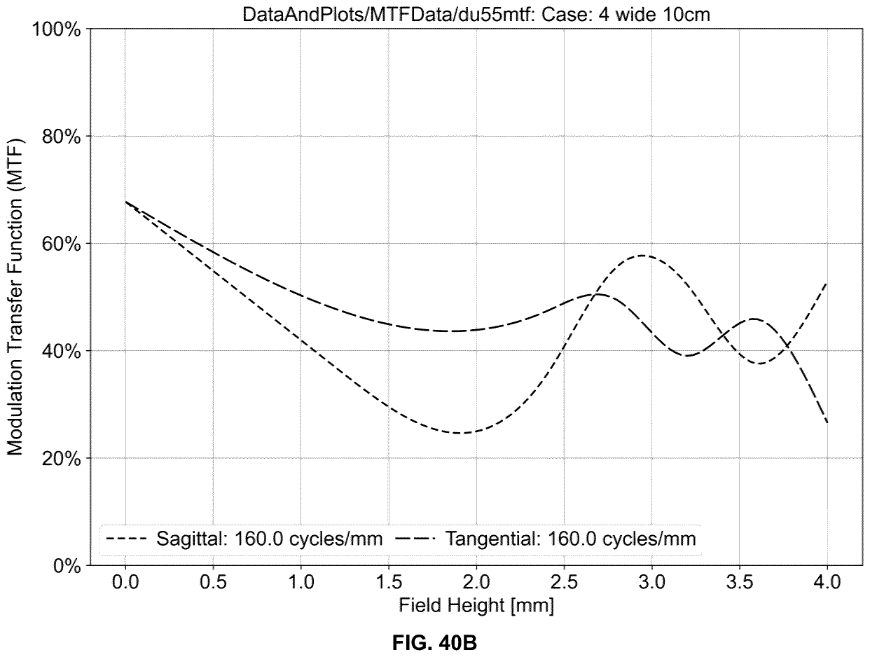

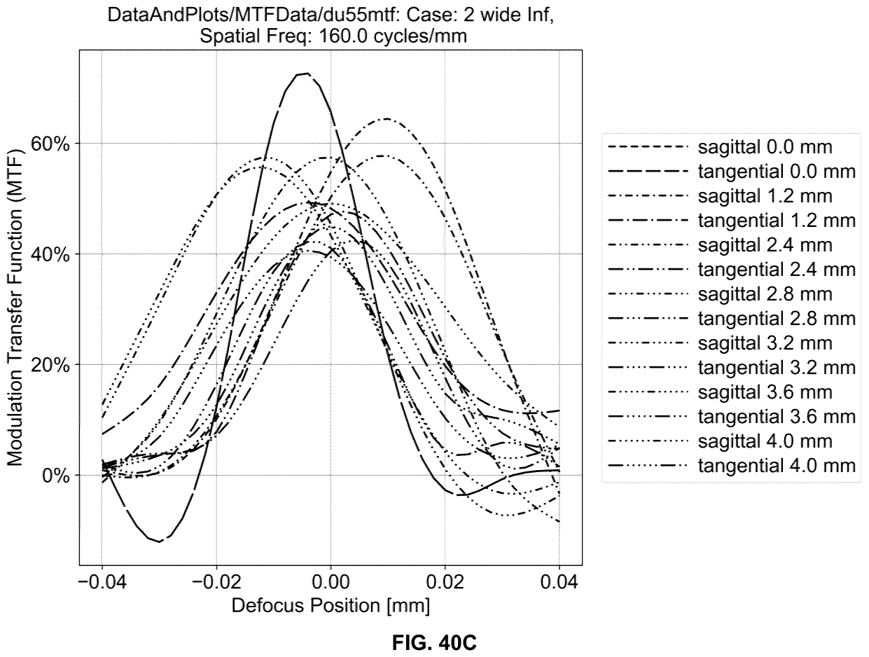

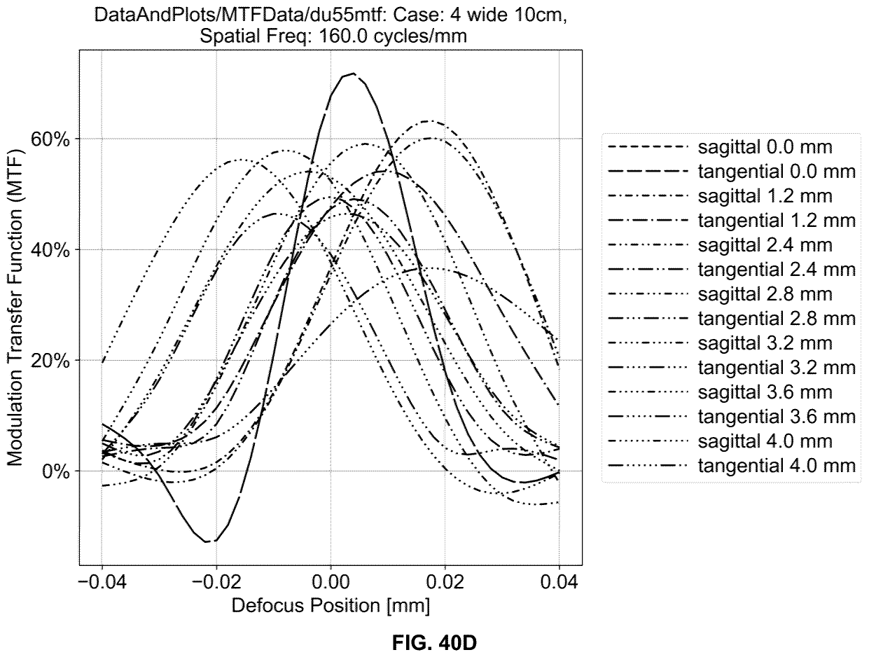

For ultra-wide mode, FIG. 40A is an MTF performance diagram for this embodiment versus field height, for an object plane located away at infinity. FIG. 40B is an MTF performance diagram versus field height, for an object plane located at 10 centimeters. FIG. 40C is an MTF versus defocus position, for an object plane located at infinity. And FIG. 40D is an MTF versus defocus position, for an object plane at 10 centimeters.

### Embodiment #11

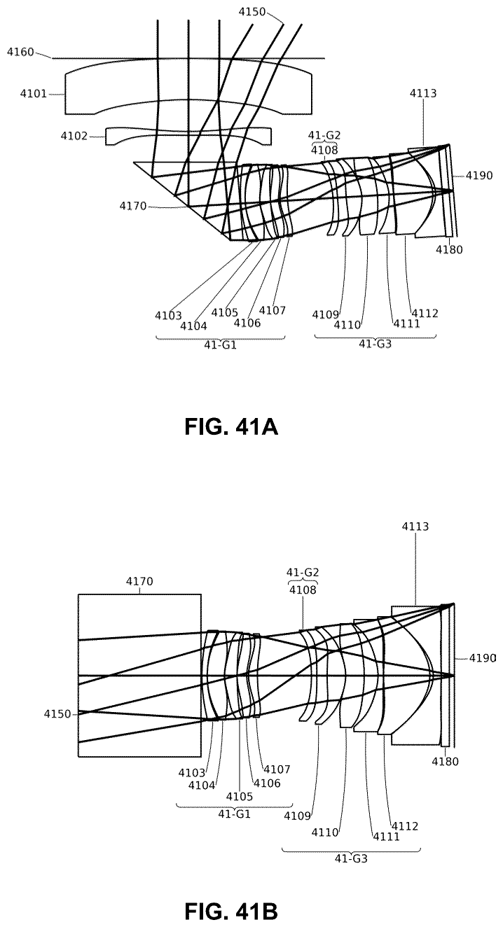

This embodiment (FIGS. 41A-44D) can have a periscope arrangement, with a turning optic that may be a mirror or a prism. The total size of the optics can be approximately 16.53 mm (X length)×13.42 mm (Y width)×9.28 mm (Z height).

The embodiment can have 13 lenses (13 aspherical and 0 spherical). The turning optic may be positioned before the third lens, before the remaining lenses in the periscope arm. There may be 3 moving lens groups, with 5 lenses in the first group, and 1 lens in the second group, and 4 lenses in the third group. The power of these groups may be positive, negative, and positive. The motion of the first lens group may also be used for auto-focusing.

Table 11 states possible lens shapes and placement for this embodiment, for both

TABLE 11
Lens shape parameters for embodiment #11.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 33.279 | 2.126 | 1.7725 | 49.46 | 1.80E+01 | −2.17E−04 | 3.77E−05 |
| | 11.713 | 1.640 | | | 3.06E+00 | −2.10E−03 | 1.49E−04 |
| 2 | −11.954 | 0.200 | 1.5311 | 55.75 | −4.05E+01 | −7.68E−04 | 3.19E−04 |
| | −41.371 | 1.387 | | | −8.60E+00 | 5.58E−03 | −1.86E−04 |
| | | 4.580 | 1.5168 | 64.2 | | | |
| | | 0.033 | | | | | |
| 3 | 7.444 | 0.201 | 1.6322 | 23.43 | 8.04E+00 | −1.80E−02 | 9.16E−03 |
| | 4.976 | 0.000 | | | 4.22E+00 | −1.83E−02 | 1.02E−02 |
| 4 | 4.318 | 0.640 | 1.5311 | 55.75 | 3.08E+00 | −4.00E−03 | −1.16E−03 |
| | 2.243 | 0.008 | | | 5.15E−02 | −2.05E−01 | 9.21E−02 |
| 5 | 2.084 | 0.466 | 1.5311 | 55.75 | −1.33E+00 | −1.52E−01 | 8.62E−02 |
| | 13.412 | 0.000 | | | 2.93E+01 | −1.06E−02 | 1.33E−02 |
| 6 | 2.848 | 0.361 | 1.4971 | 81.56 | −1.62E+00 | −7.10E−02 | 3.87E−02 |
| | 2.197 | 0.067 | | | −1.15E+01 | −3.91E−02 | −2.17E−03 |
| 7 | 2.128 | 0.332 | 1.4971 | 81.56 | −9.89E+00 | 3.10E−03 | −1.58E−02 |
| | 9.464 | 2.016 | | | −6.78E+00 | 1.62E−02 | −1.84E−03 |
| 8 | −6.794 | 0.200 | 1.5311 | 55.75 | 8.61E+00 | −5.01E−03 | 3.31E−03 |
| | −45.224 | 0.385 | | | −4.25E−01 | −1.72E−02 | 4.10E−03 |
| 9 | 10.960 | 0.691 | 1.7725 | 49.46 | 3.03E+00 | −1.72E−02 | −7.28E−03 |
| | −2.318 | 0.001 | | | −4.15E−01 | 5.71E−02 | −1.99E−02 |
| 10 | −2.161 | 0.693 | 1.5311 | 55.75 | −4.71E+00 | 5.22E−02 | −9.14E−03 |
| | −6.255 | 0.514 | | | 3.96E+00 | 1.63E−02 | 2.15E−03 |
| 11 | −2.377 | 0.200 | 1.6322 | 23.43 | −1.70E+00 | 6.32E−02 | −2.65E−02 |
| | −14.710 | 0.011 | | | −2.66E+01 | 3.45E−02 | −1.48E−02 |
| 12 | 9.877 | 1.726 | 1.4971 | 81.56 | 6.07E+00 | −3.28E−02 | 1.10E−02 |
| | −2.201 | 0.125 | | | −3.74E+00 | −1.78E−02 | 8.86E−04 |
| 13 | −1.654 | 0.296 | 1.5855 | 29.9 | −1.92E+00 | 9.72E−04 | −5.30E−04 |
| | −22.486 | 0.004 | | | 2.93E+01 | 1.03E−02 | −1.13E−03 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | −1.03E−06 | 1.76E−08 | −1.72E−10 | 6.28E−13 | 0.00E+00 |
| | −4.93E−06 | 1.65E−07 | −3.54E−09 | 2.66E−11 | 0.00E+00 |
| 2 | −2.03E−05 | 6.45E−07 | −1.10E−08 | 7.51E−11 | 0.00E+00 |
| | 3.07E−05 | −2.15E−06 | 7.83E−08 | −9.48E−10 | 0.00E+00 |
| 3 | −2.95E−03 | 4.60E−04 | −3.92E−05 | 1.35E−06 | 0.00E+00 |
| | −2.50E−03 | 1.08E−04 | 5.56E−06 | −9.18E−07 | 0.00E+00 |
| 4 | 5.58E−04 | −3.14E−04 | 3.49E−05 | −1.44E−06 | 0.00E+00 |
| | −3.07E−02 | 6.36E−03 | −7.45E−04 | 3.41E−05 | 0.00E+00 |
| 5 | −2.92E−02 | 6.07E−03 | −6.37E−04 | 2.65E−05 | 0.00E+00 |
| | −8.75E−03 | 2.44E−03 | −2.34E−04 | 1.02E−05 | 0.00E+00 |
| 6 | −1.91E−02 | 5.33E−03 | −6.99E−04 | 3.59E−05 | 0.00E+00 |
| | 5.30E−03 | −1.93E−03 | 3.16E−04 | −1.76E−05 | 0.00E+00 |
| 7 | 4.78E−03 | −1.17E−03 | 1.78E−04 | −8.07E−06 | 0.00E+00 |
| | −7.06E−03 | 2.78E−03 | −4.30E−04 | 2.40E−05 | 0.00E+00 |
| 8 | −2.54E−03 | 7.92E−04 | −1.30E−04 | 8.13E−06 | 0.00E+00 |
| | −2.96E−03 | 7.45E−04 | −1.08E−04 | 6.38E−06 | 0.00E+00 |
| 9 | 1.91E−04 | 2.38E−04 | −4.14E−05 | 2.72E−06 | 0.00E+00 |
| | 2.86E−03 | −1.21E−04 | −5.33E−06 | 3.75E−07 | 0.00E+00 |
| 10 | 6.32E−04 | 1.58E−07 | −3.21E−06 | 1.14E−07 | 0.00E+00 |
| | −3.31E−03 | 7.19E−04 | −5.87E−05 | 1.55E−06 | 0.00E+00 |
| 11 | 4.23E−03 | −3.51E−04 | 1.89E−05 | −6.93E−07 | 0.00E+00 |
| | 2.57E−03 | −2.55E−04 | 1.46E−05 | −3.35E−07 | 0.00E+00 |
| 12 | −2.89E−03 | 3.59E−04 | −1.91E−05 | 3.59E−07 | 0.00E+00 |
| | 3.25E−04 | −9.55E−05 | 9.25E−06 | −2.64E−07 | 0.00E+00 |
| 13 | −1.83E−04 | 5.62E−05 | −5.52E−06 | 2.06E−07 | 0.00E+00 |
| | −2.98E−05 | 1.06E−05 | −5.88E−07 | 1.08E−08 | 0.00E+00 |

FIGS. 41A and 41B show lens shapes and placement for this embodiment, when it is operating in main mode. It also shows sample light rays through the embodiment for this mode. In main mode, the field-of-view (FOV) is approximately 81 degrees, the F-number is approximately 1.7, and the effective focal length (EFL) is approximately 4.64 mm.

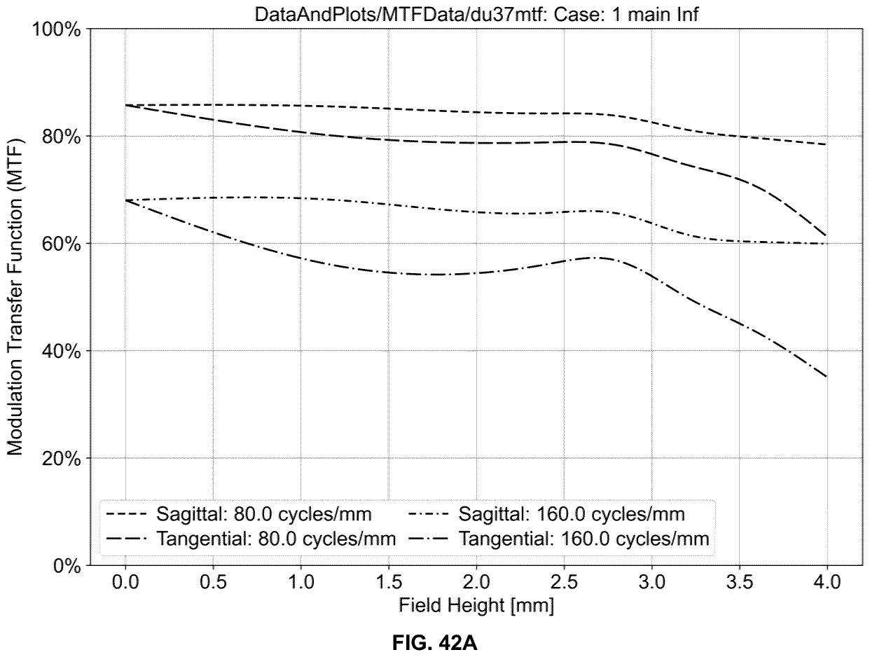

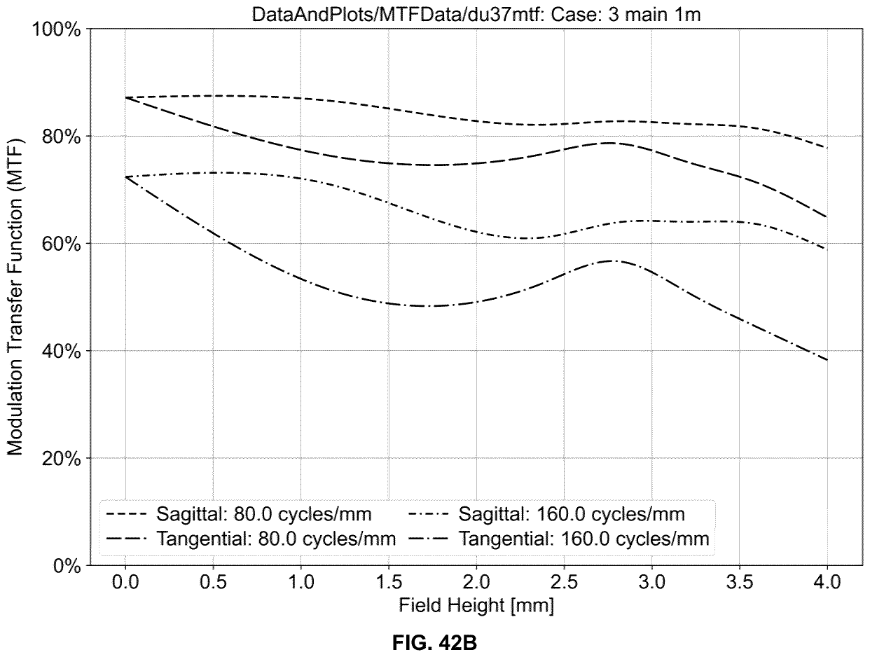

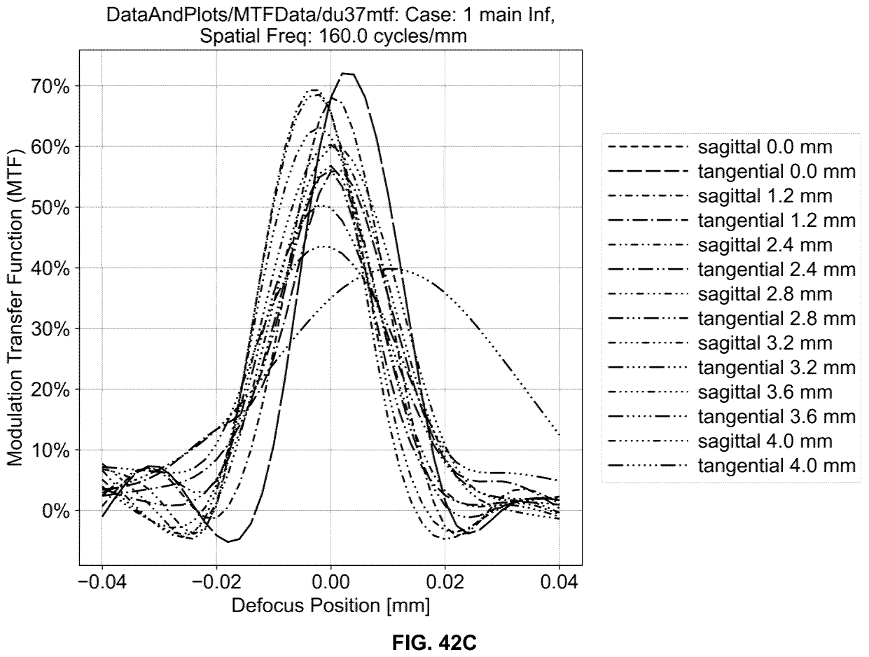

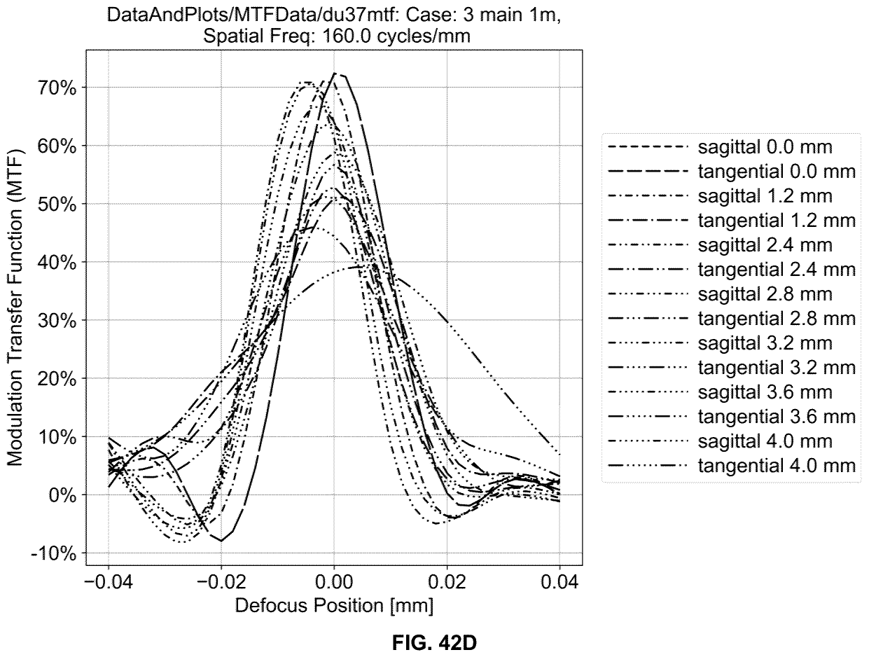

For main mode, FIG. 42A is an MTF (modulation transfer function) performance diagram versus field height for this embodiment, for an object plane located away at infinity. FIG. 42B is an MTF performance diagram versus field height, for an object plane located at 1 meter. FIG. 42C is an MTF versus defocus position, for an object plane located at infinity. And FIG. 42D is an MTF versus defocus position, for an object plane at 10 centimeters.

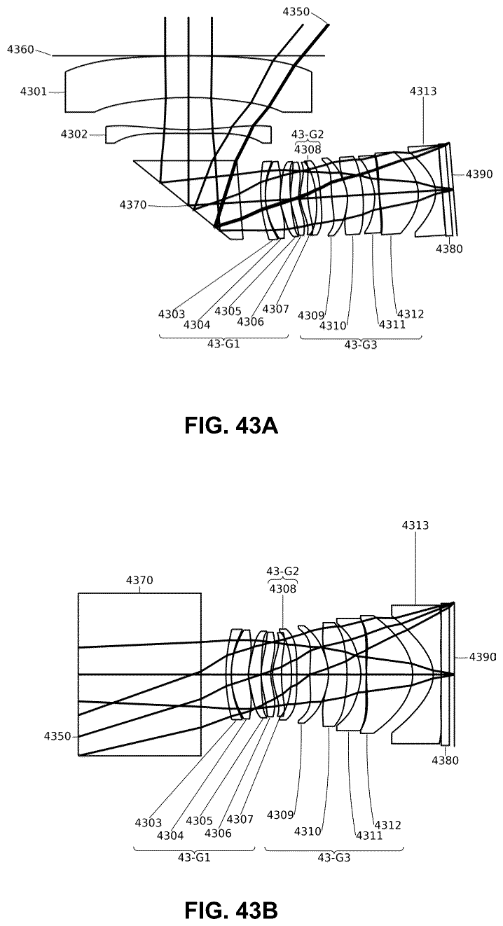

FIGS. 43A and 43B show lens placement for this embodiment, when it is operating in ultra-wide mode. It also shows sample light rays through the embodiment for this mode. In ultra-wide mode, the field-of-view (FOV) is approximately 123 degrees, the F-number is approximately 1.7, and the effective focal length (EFL) is approximately 3.52 mm.

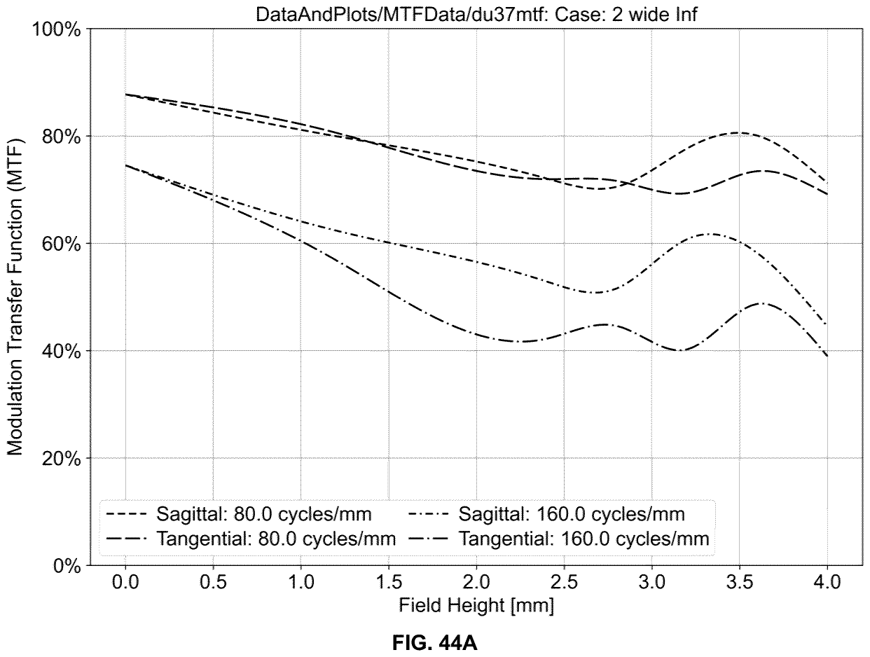

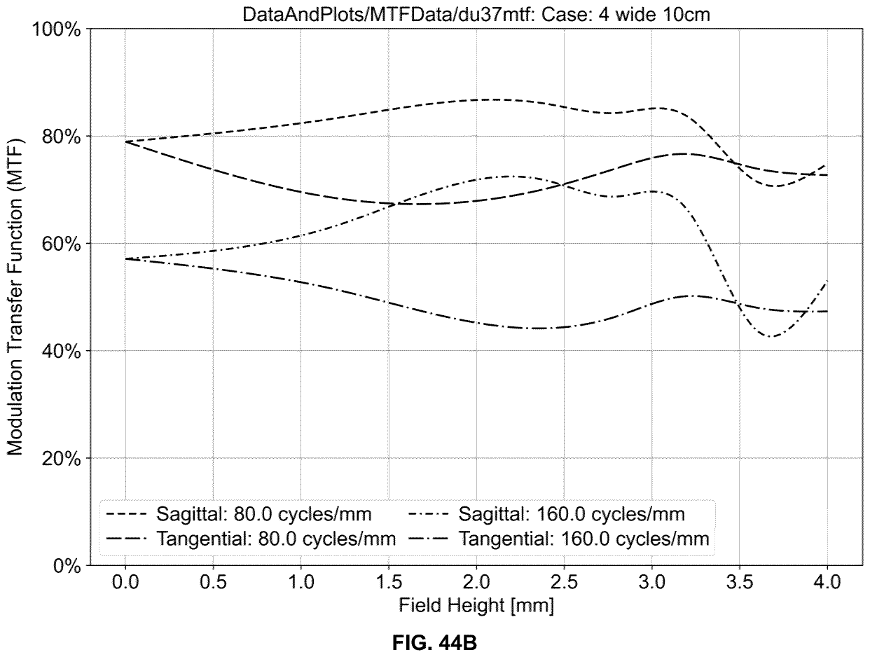

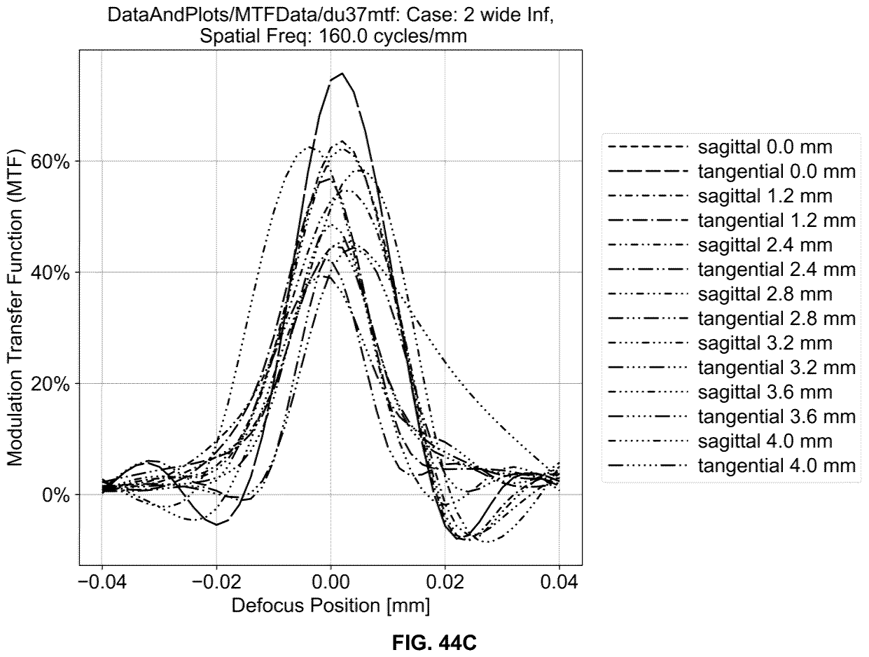

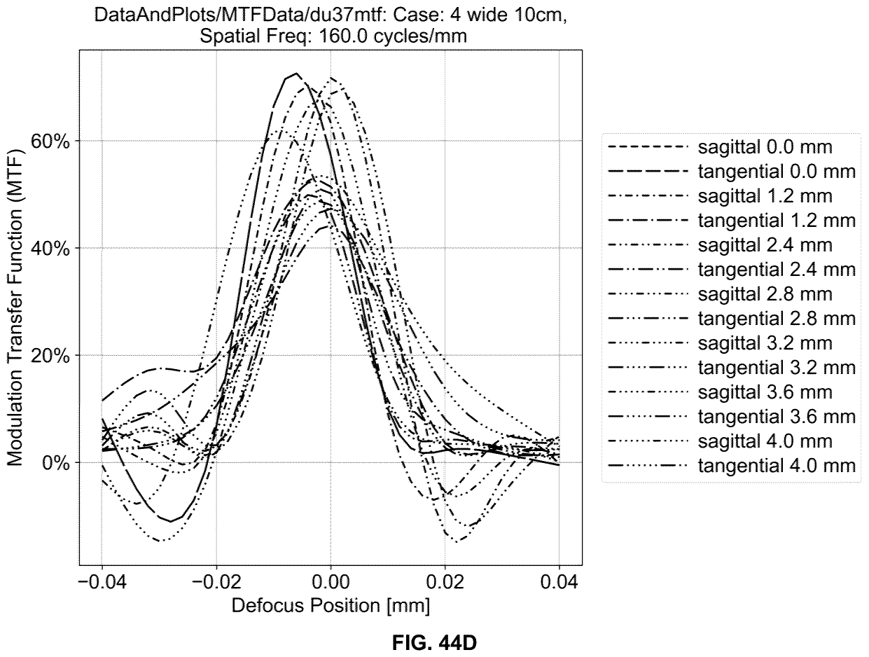

For ultra-wide mode, FIG. 44A is an MTF performance diagram for this embodiment versus field height, for an object plane located away at infinity. FIG. 44B is an MTF performance diagram versus field height, for an object plane located at 10 centimeters. FIG. 44C is an MTF versus defocus position, for an object plane located at infinity. And FIG. 44D is an MTF versus defocus position, for an object plane at 10 centimeters.

### Embodiment #12

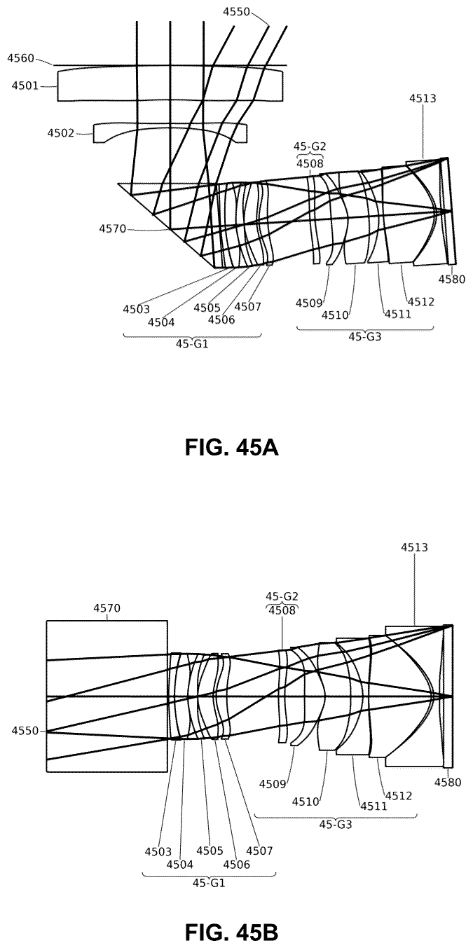

This embodiment (FIGS. 45A-48D) can have a periscope arrangement, with a turning optic that may be a mirror or a prism. The total size of the optics can be approximately 16.76 mm (X length)×14.01 mm (Y width)×9.1 mm (Z height).

The embodiment can have 13 lenses (13 aspherical and 0 spherical). The turning optic may be positioned before the third lens, before the remaining lenses in the periscope arm. There may be 3 moving lens groups, with 5 lenses in the first group, and 1 lens in the second group, and 4 lenses in the third group. The power of these groups may be positive, negative, and positive. The motion of the first lens group may also be used for auto-focusing.

Table 12 states possible lens shapes and placement for this embodiment, for both modes of operation (for main and for ultra-wide mode)

TABLE 12
Lens shape parameters for embodiment #12.

| | Radius | Thickness | | | | AS4 | AS6 | AS8 |
|---|---|---|---|---|---|---|---|---|
| | [mm] | [mm] | Nd | Abbe | K | [1/mm\hat{ }3] | [1/mm\hat{ }5] | [1/mm\hat{ }7] |
| 1 | 32.064 | 1.553 | 1.8014 | 45.45 | 5.95E+00 | −1.62E−03 | 1.37E−04 | −4.97E−06 |
| | 18.866 | 1.065 | | | −3.36E+00 | −5.74E−03 | 5.31E−04 | −2.50E−05 |
| 2 | 87.592 | 0.200 | 1.5311 | 55.75 | −4.19E+01 | −8.37E−03 | 2.16E−03 | −2.42E−04 |
| | 10.638 | 2.505 | | | 8.94E−01 | −9.83E−05 | 1.29E−03 | −1.18E−04 |
| | | 4.144 | 1.5168 | 64.2 | | | | |
| | | 0.042 | | | | | | |
| 3 | 9.518 | 0.200 | 1.6322 | 23.43 | 1.32E+01 | −1.58E−02 | −1.87E−02 | 2.44E−02 |
| | 6.683 | 0.004 | | | 8.13E+00 | −7.01E−03 | −5.94E−02 | 9.97E−02 |
| 4 | 7.649 | 0.451 | 1.5311 | 55.75 | 9.44E+00 | −1.54E−02 | −1.72E−02 | 6.12E−02 |
| | 2.898 | 0.006 | | | 3.61E−01 | −1.21E−01 | 1.90E−02 | 7.69E−03 |
| 5 | 3.959 | 0.339 | 1.5311 | 55.75 | −3.59E+00 | −1.81E−02 | −1.79E−03 | 1.85E−02 |
| | −14.718 | 0.000 | | | 3.53E+01 | 7.73E−02 | −3.22E−02 | 1.93E−02 |
| 6 | 2.744 | 0.529 | 1.4971 | 81.56 | −4.51E−01 | −3.70E−03 | −3.38E−02 | 1.96E−02 |
| | 2.766 | 0.101 | | | −7.95E+00 | −4.17E−02 | 5.60E−02 | −7.48E−02 |
| 7 | 2.524 | 0.365 | 1.4971 | 81.56 | −4.94E+00 | −1.94E−02 | 3.22E−02 | −3.59E−02 |
| | 7.892 | 1.774 | | | −6.38E+00 | 9.42E−03 | −6.34E−03 | 1.43E−02 |
| 8 | 10.757 | 0.214 | 1.5311 | 55.75 | −3.72E+00 | −1.31E−02 | −3.12E−03 | 2.77E−03 |
| | 6.920 | 0.679 | | | −2.78E−01 | −1.46E−02 | −2.82E−03 | 1.39E−03 |
| 9 | 32.541 | 0.705 | 1.755 | 51.16 | 1.09E+00 | −8.21E−03 | −8.08E−03 | 1.24E−04 |
| | −1.603 | 0.000 | | | −1.63E+00 | 8.86E−02 | −3.35E−02 | 5.92E−03 |
| 10 | −1.610 | 0.881 | 1.5311 | 55.75 | −4.50E+00 | 4.24E−02 | 1.70E−02 | −1.54E−02 |
| | −10.734 | 0.413 | | | 1.22E+01 | −2.33E−02 | 2.13E−02 | −1.21E−02 |
| 11 | −2.704 | 0.200 | 1.6322 | 23.43 | −5.31E+00 | 1.10E−02 | 1.80E−03 | −8.68E−03 |
| | 64.961 | 0.000 | | | 3.89E−01 | 2.73E−02 | −1.60E−02 | 4.43E−03 |
| 12 | 8.602 | 2.141 | 1.4971 | 81.56 | 5.29E+00 | −1.76E−02 | 4.34E−03 | −1.40E−03 |
| | −1.667 | 0.093 | | | −2.61E+00 | −8.92E−03 | 7.17E−03 | −3.76E−03 |
| 13 | −1.529 | 0.200 | 1.5311 | 55.75 | −1.51E+00 | 4.26E−02 | −2.45E−02 | 9.18E−03 |
| | −21.275 | 0.135 | | | 2.75E+01 | 6.39E−02 | −3.29E−02 | 8.54E−03 |

| | AS10 | AS12 | AS14 | AS16 | AS18 | AS20 |
|---|---|---|---|---|---|---|
| | [1/mm\hat{ }9] | [1/mm\hat{ }11] | [1/mm\hat{ }13] | [1/mm\hat{ }15] | [1/mm\hat{ }17] | [1/mm\hat{ }19] |
| 1 | 9.83E−08 | −8.17E−10 | −2.94E−12 | 1.06E−13 | −7.23E−16 | 1.67E−18 |
| | 6.81E−07 | −9.45E−09 | 3.31E−11 | 7.05E−13 | −8.60E−15 | 2.92E−17 |
| 2 | 1.63E−05 | −6.86E−07 | 1.83E−08 | −2.98E−10 | 2.72E−12 | −1.06E−14 |
| | 8.73E−06 | −1.31E−06 | 1.60E−07 | −9.45E−09 | 2.57E−10 | −2.62E−12 |
| 3 | −1.43E−02 | 5.32E−03 | −1.32E−03 | 2.09E−04 | −1.87E−05 | 6.99E−07 |
| | −8.41E−02 | 4.21E−02 | −1.28E−02 | 2.29E−03 | −2.20E−04 | 8.74E−06 |
| 4 | −6.55E−02 | 3.61E−02 | −1.14E−02 | 2.07E−03 | −2.00E−04 | 7.93E−06 |
| | −6.93E−03 | 2.54E−03 | −5.17E−04 | 6.03E−05 | −4.04E−06 | 1.22E−07 |
| 5 | −1.72E−02 | 7.67E−03 | −1.83E−03 | 2.29E−04 | −1.29E−05 | 1.75E−07 |
| | −9.85E−03 | 1.78E−03 | 4.66E−04 | −2.56E−04 | 4.00E−05 | −2.13E−06 |
| 6 | −1.10E−03 | −3.61E−03 | 1.77E−03 | −3.76E−04 | 3.87E−05 | −1.57E−06 |
| | 5.33E−02 | −2.26E−02 | 5.92E−03 | −9.24E−04 | 7.83E−05 | −2.76E−06 |
| 7 | 1.78E−02 | −6.44E−03 | 1.89E−03 | −3.81E−04 | 4.24E−05 | −1.92E−06 |
| | −1.87E−02 | 1.00E−02 | −2.82E−03 | 4.40E−04 | −3.60E−05 | 1.21E−06 |
| 8 | −4.82E−04 | −1.94E−04 | 1.05E−04 | −1.97E−05 | 1.70E−06 | −5.59E−08 |
| | 2.42E−04 | −3.44E−04 | 1.05E−04 | −1.51E−05 | 1.08E−06 | −2.99E−08 |
| 9 | 1.33E−03 | −7.00E−04 | 1.72E−04 | −2.29E−05 | 1.59E−06 | −4.40E−08 |
| | −3.81E−04 | −1.88E−04 | 7.27E−05 | −1.11E−05 | 7.99E−07 | −2.22E−08 |
| 10 | 4.99E−03 | −9.32E−04 | 1.09E−04 | −7.86E−06 | 3.21E−07 | −5.68E−09 |
| | 4.60E−03 | −1.19E−03 | 1.89E−04 | −1.73E−05 | 8.25E−07 | −1.58E−08 |
| 11 | 4.77E−03 | −1.32E−03 | 2.07E−04 | −1.83E−05 | 8.44E−07 | −1.58E−08 |
| | −7.15E−04 | 6.50E−05 | −2.89E−06 | 1.97E−08 | 3.30E−09 | −9.38E−11 |
| 12 | 4.65E−04 | −1.11E−04 | 1.49E−05 | −1.08E−06 | 3.95E−08 | −5.71E−10 |
| | 1.03E−03 | −1.59E−04 | 1.40E−05 | −6.92E−07 | 1.76E−08 | −1.81E−10 |
| 13 | −2.36E−03 | 3.95E−04 | −4.11E−05 | 2.54E−06 | −8.42E−08 | 1.16E−09 |
| | −1.27E−03 | 1.15E−04 | −6.36E−06 | 2.11E−07 | −3.85E−09 | 2.97E−11 |

FIGS. 45A and 45B show lens shapes and placement for this embodiment, when it is operating in main mode. It also shows sample light rays through the embodiment for this mode. In main mode, the field-of-view (FOV) is approximately 80 degrees, the F-number is approximately 1.7, and the effective focal length (EFL) is approximately 4.77 mm.

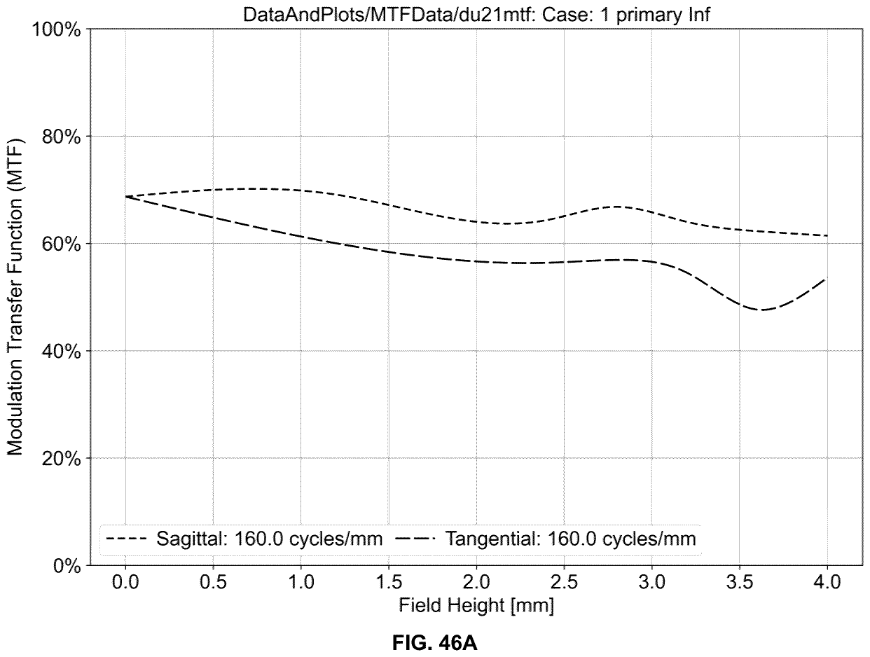

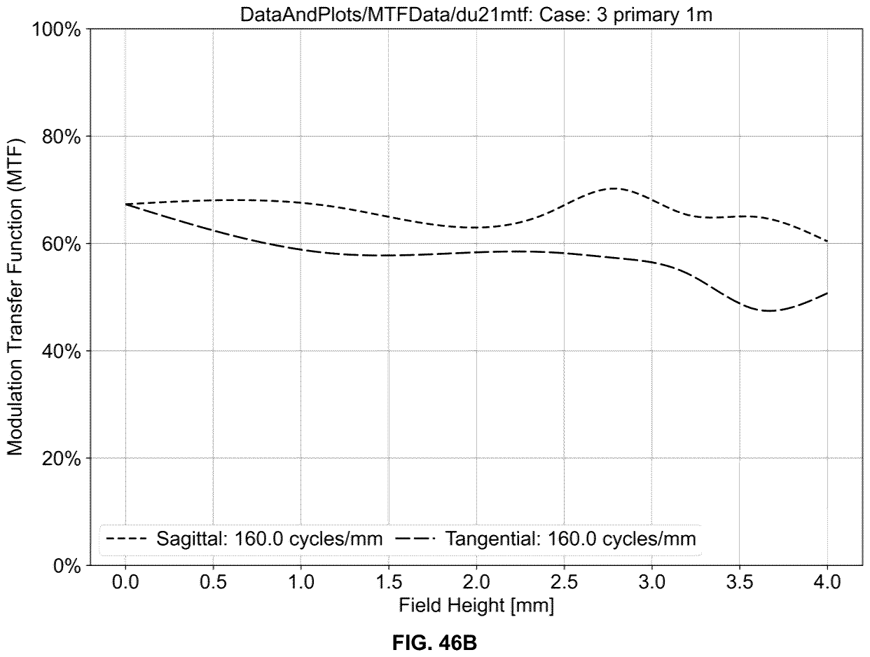

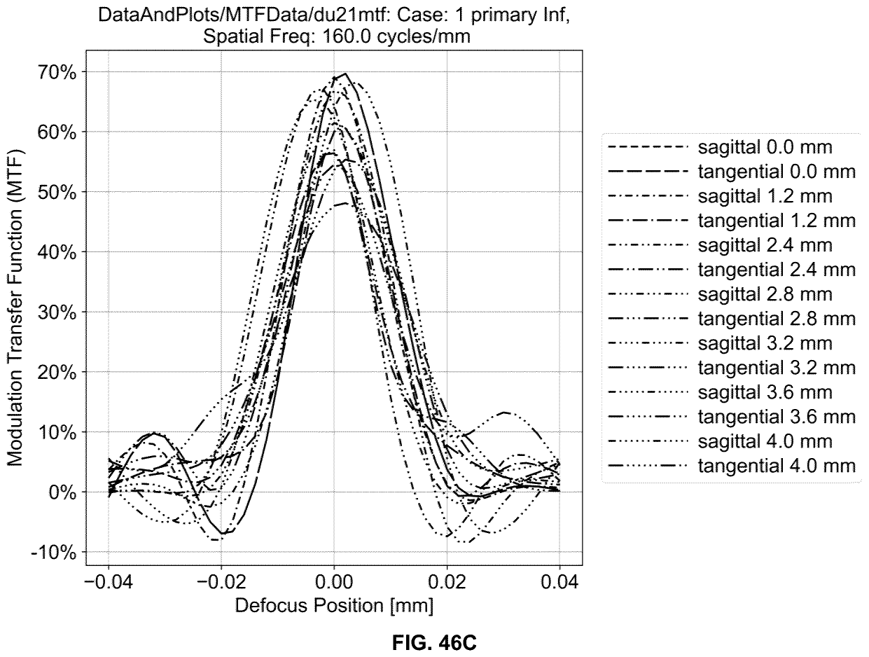

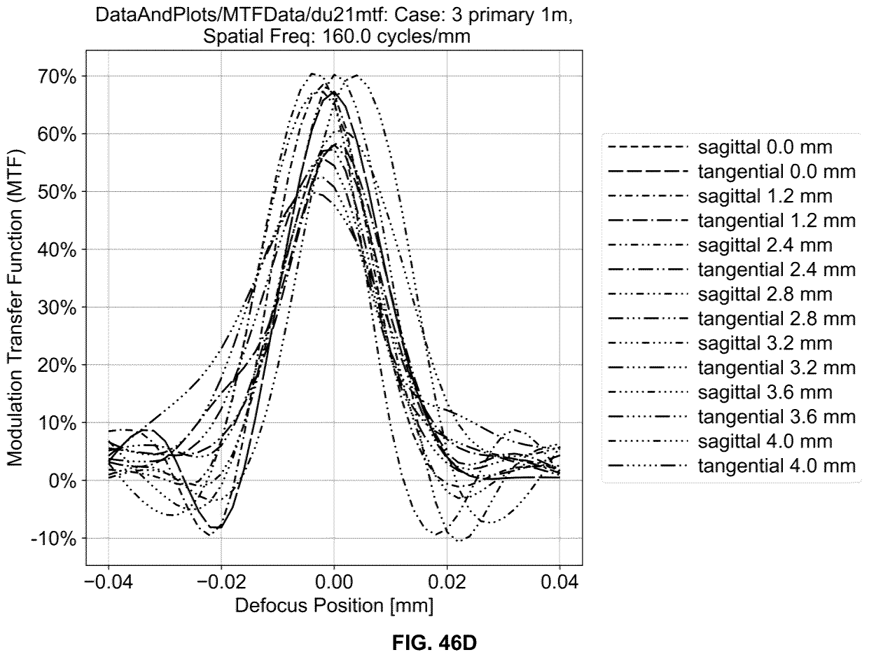

For main mode, FIG. 46A is an MTF (modulation transfer function) performance diagram versus field height for this embodiment, for an object plane located away at infinity. FIG. 46B is an MTF performance diagram versus field height, for an object plane located at 1 meter. FIG. 46C is an MTF versus defocus position, for an object plane located at infinity. And FIG. 46D is an MTF versus defocus position, for an object plane at 10 centimeters.

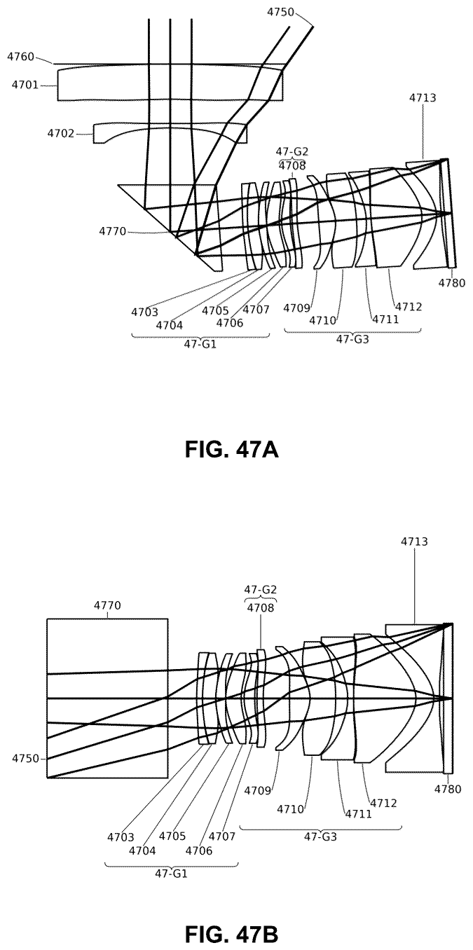

FIGS. 47A and 47B show lens placement for this embodiment, when it is operating in ultra-wide mode. It also shows sample light rays through the embodiment for this mode. In ultra-wide mode, the field-of-view (FOV) is approximately 126 degrees, the F-number is approximately 2, and the effective focal length (EFL) is approximately 3.59 mm.

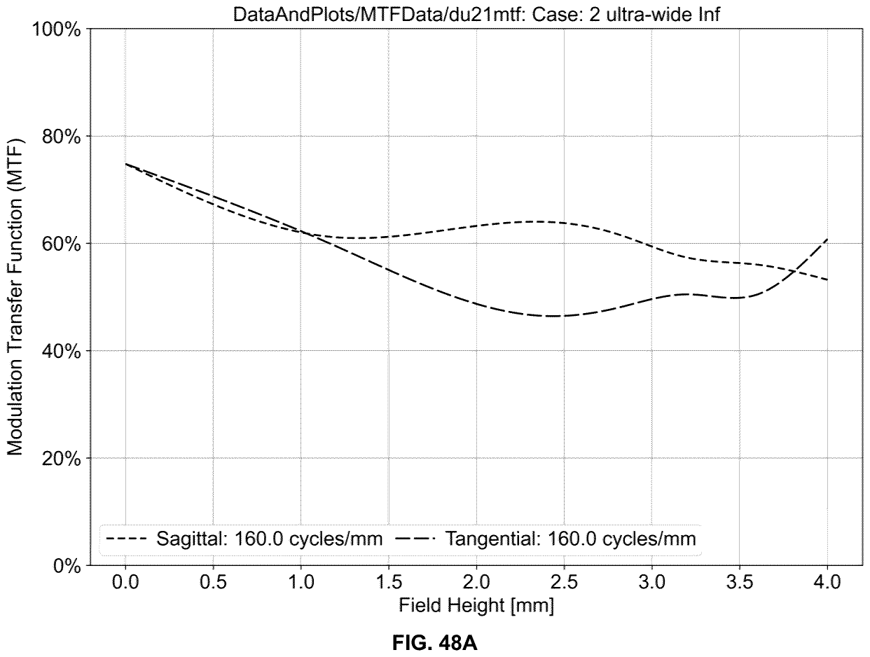

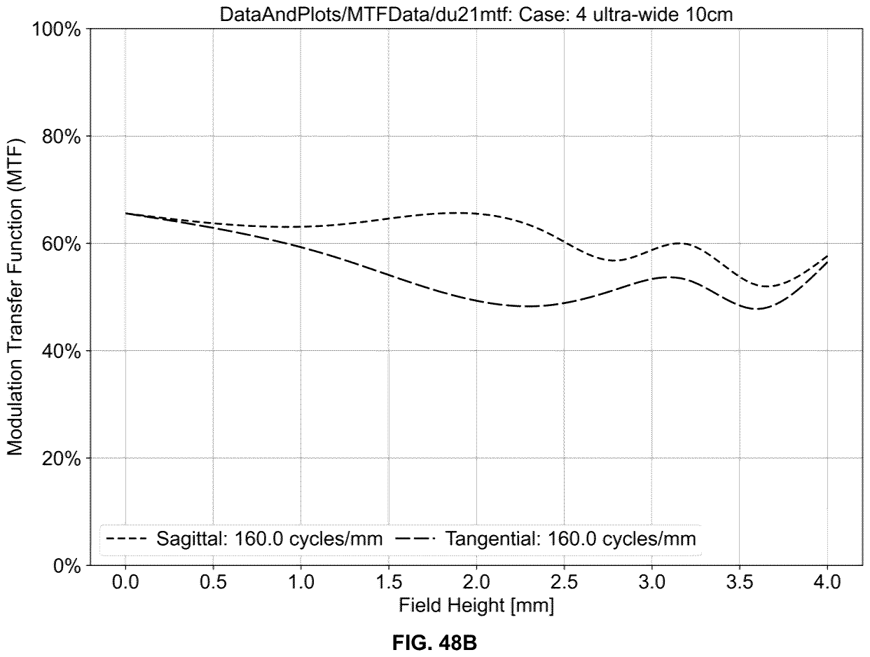

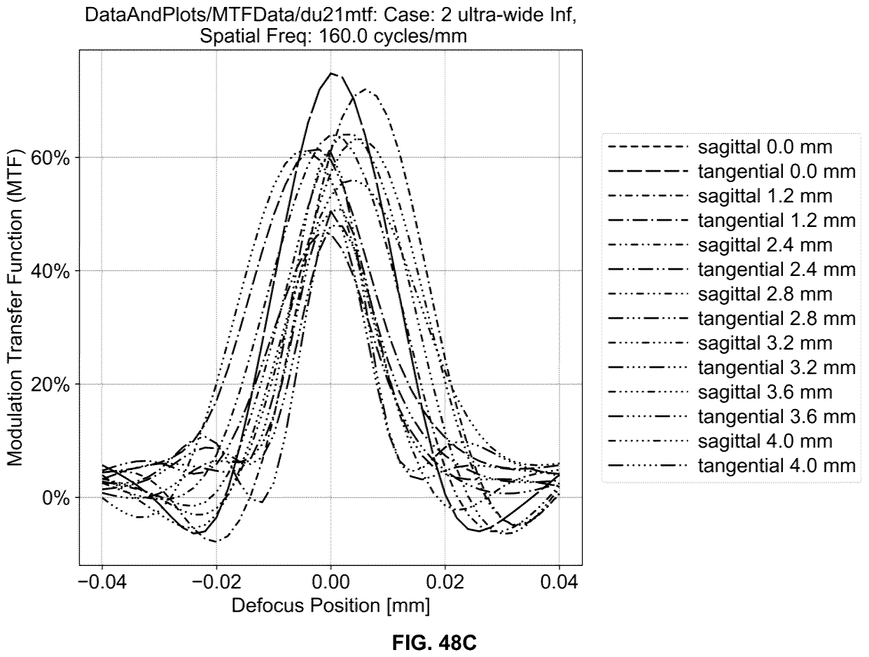

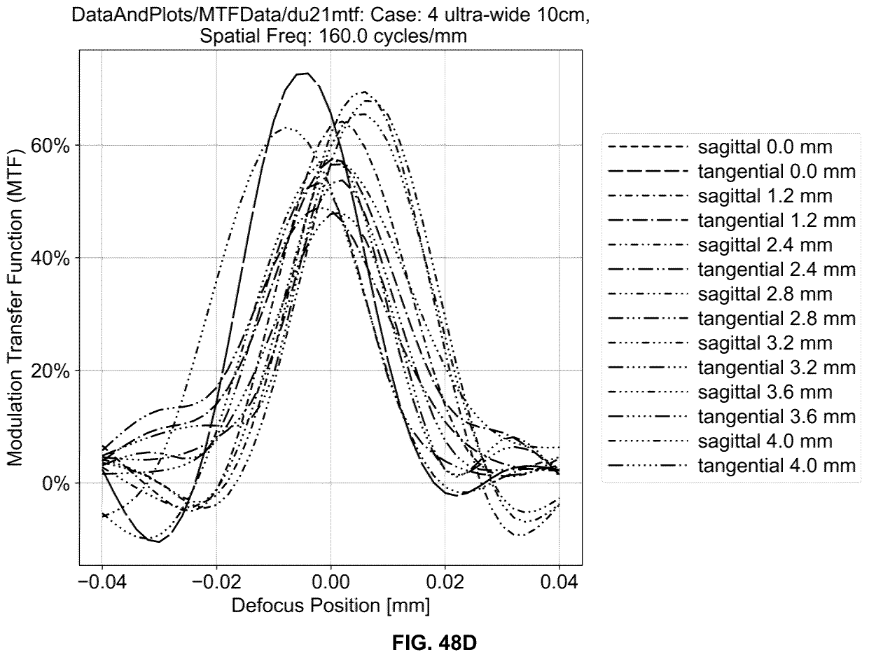

For ultra-wide mode, FIG. 48A is an MTF performance diagram for this embodiment versus field height, for an object plane located away at infinity. FIG. 48B is an MTF performance diagram versus field height, for an object plane located at 10 centimeters. FIG. 48C is an MTF versus defocus position, for an object plane located at infinity. And FIG. 48D is an MTF versus defocus position, for an object plane at 10 centimeters.

### Embodiment #13

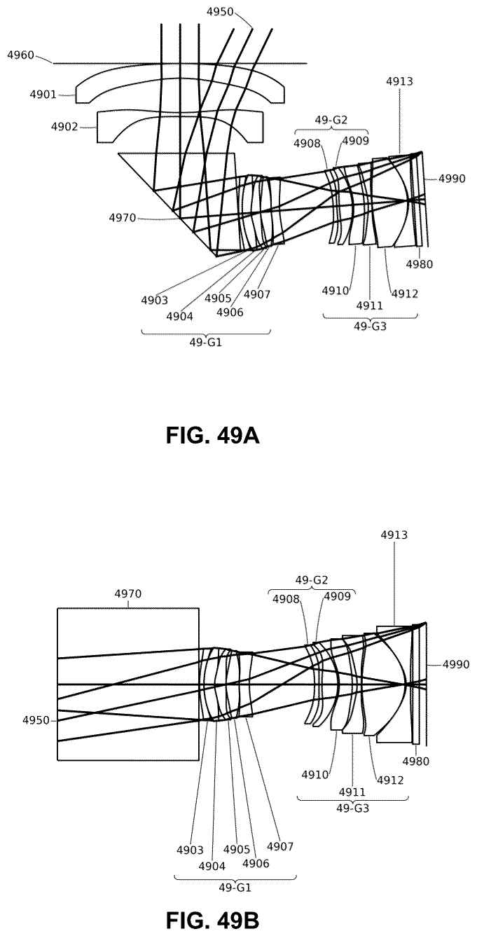

This embodiment (FIGS. 49A-52D) can have a periscope arrangement, with a turning optic that may be a mirror or a prism. The total size of the optics can be approximately 19.28 mm (X length)×12.61 mm (Y width)×9.46 mm (Z height).

The embodiment can have 13 lenses (13 aspherical and 0 spherical). The turning optic may be positioned before the third lens, before the remaining lenses in the periscope arm. There may be 3 moving lens groups, with 5 lenses in the first group, 2 lenses in the second group, and 3 lenses in the third group. The power of these groups may be positive, positive, and positive. The motion of the first lens group may also be used for auto-focusing.

Table 13 states possible lens shapes and placement for this embodiment, for both modes of operation (for main and ultra-wide mode).

TABLE 13
Lens shape parameters for embodiment #13.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 31.337 | 0.733 | 1.77 | 49.46 | 1.85E+01 | 2.54E−04 | −2.12E−05 |
| | 9.395 | 1.716 | | | −2.31E−02 | −2.29E−03 | 8.54E−05 |
| 2 | −15.260 | 0.200 | 1.53 | 55.75 | −4.10E+01 | −8.01E−05 | 2.67E−04 |
| | 136.529 | 1.829 | | | −9.02E+00 | 7.98E−03 | −6.48E−04 |
| | | 6.506 | 1.52 | 64.20 | | | |
| | | 0.030 | | | | | |
| 3 | 5.380 | 0.202 | 1.63 | 23.43 | 3.67E+00 | −2.79E−02 | 1.20E−02 |
| | 4.189 | 0.004 | | | 3.09E+00 | −1.83E−02 | 1.03E−03 |
| 4 | 4.921 | 0.490 | 1.53 | 55.75 | 4.93E+00 | 9.60E−03 | −1.38E−02 |
| | 1.535 | 0.001 | | | −5.98E−01 | −2.93E−01 | 1.41E−01 |
| 5 | 1.585 | 0.523 | 1.53 | 55.75 | −1.25E+00 | −2.54E−01 | 1.56E−01 |
| | 10.194 | 0.000 | | | 2.90E+01 | −1.01E−01 | 8.61E−02 |
| 6 | 2.454 | 0.601 | 1.50 | 81.56 | −4.88E−01 | −9.47E−02 | 2.73E−02 |
| | 4.273 | 0.001 | | | −9.62E+00 | −2.43E−01 | 1.95E−01 |
| 7 | 2.970 | 0.470 | 1.50 | 81.56 | −1.31E+01 | −2.49E−01 | 2.28E−01 |
| | 5.354 | 2.999 | | | −5.17E+00 | −1.64E−02 | 9.40E−03 |
| 8 | −7.298 | 0.200 | 1.53 | 55.75 | 1.02E+01 | −1.34E−02 | −8.92E−03 |
| | 15.018 | 0.142 | | | −1.09E+00 | −3.12E−02 | −3.05E−02 |
| 9 | 8.676 | 0.730 | 1.77 | 49.46 | 7.48E−01 | −1.43E−02 | −1.58E−02 |
| | −2.992 | 0.065 | | | 2.83E−01 | −1.10E−02 | 1.73E−02 |
| 10 | −2.968 | 0.600 | 1.53 | 55.75 | −3.37E+00 | −2.49E−02 | 2.03E−02 |
| | −5.056 | 0.222 | | | 8.44E−01 | 4.48E−03 | 1.45E−02 |
| 11 | −2.608 | 0.200 | 1.63 | 23.43 | −4.37E+00 | 4.13E−02 | −5.76E−03 |
| | −14.253 | 0.019 | | | −3.05E+01 | 5.31E−02 | −1.58E−02 |
| 12 | 7.248 | 1.985 | 1.50 | 81.56 | 3.44E+00 | −1.66E−02 | 6.55E−03 |
| | −2.397 | 0.050 | | | −3.17E+00 | −1.11E−02 | −7.40E−04 |
| 13 | −1.838 | 0.200 | 1.59 | 29.90 | −3.96E+00 | −1.97E−02 | 4.84E−03 |
| | 2308.039 | 0.106 | | | 2.80E+01 | 7.59E−03 | −1.87E−03 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | 1.96E−06 | −5.27E−08 | 6.32E−10 | −3.07E−12 | 0.00E+00 |
| | −1.94E−06 | 1.39E−07 | −4.01E−09 | 3.30E−11 | 0.00E+00 |
| 2 | −2.02E−05 | 6.39E−07 | −9.42E−09 | 5.25E−11 | 0.00E+00 |
| | 1.28E−04 | −1.16E−05 | 4.52E−07 | −5.97E−09 | 0.00E+00 |
| 3 | −4.40E−03 | 5.55E−04 | 1.19E−05 | −4.11E−06 | 0.00E+00 |
| | 3.34E−03 | −2.41E−03 | 5.08E−04 | −3.45E−05 | 0.00E+00 |
| 4 | 6.17E−03 | −1.40E−03 | 1.40E−04 | −6.07E−06 | 0.00E+00 |
| | −4.49E−02 | 8.63E−03 | −9.18E−04 | 3.88E−05 | 0.00E+00 |
| 5 | −5.12E−02 | 1.00E−02 | −1.05E−03 | 4.56E−05 | 0.00E+00 |
| | −4.05E−02 | 1.22E−02 | −1.88E−03 | 1.15E−04 | 0.00E+00 |
| 6 | −6.34E−03 | 1.46E−03 | −1.78E−04 | 9.61E−06 | 0.00E+00 |
| | −8.62E−02 | 2.10E−02 | −2.57E−03 | 1.26E−04 | 0.00E+00 |
| 7 | −1.06E−01 | 2.62E−02 | −3.26E−03 | 1.62E−04 | 0.00E+00 |
| | −5.02E−03 | 9.73E−04 | −5.91E−05 | −1.27E−06 | 0.00E+00 |
| 8 | 7.88E−03 | −1.97E−03 | 2.02E−04 | −7.24E−06 | 0.00E+00 |
| | 1.98E−02 | −4.68E−03 | 4.76E−04 | −1.72E−05 | 0.00E+00 |
| 9 | 5.54E−03 | −1.18E−03 | 1.25E−04 | −4.37E−06 | 0.00E+00 |
| | −7.23E−03 | 1.40E−03 | −1.23E−04 | 3.93E−06 | 0.00E+00 |
| 10 | −4.17E−03 | 3.93E−04 | −1.77E−05 | 2.65E−07 | 0.00E+00 |
| | −6.34E−03 | 1.01E−03 | −7.01E−05 | 1.68E−06 | 0.00E+00 |
| 11 | −2.62E−03 | 7.01E−04 | −5.76E−05 | 1.44E−06 | 0.00E+00 |
| | 1.97E−03 | −1.35E−04 | 6.07E−06 | −1.24E−07 | 0.00E+00 |
| 12 | −1.60E−03 | 1.34E−04 | −2.49E−06 | −6.06E−08 | 0.00E+00 |
| | 4.09E−04 | −6.89E−05 | 5.58E−06 | −1.40E−07 | 0.00E+00 |
| 13 | −6.17E−04 | 1.97E−05 | 1.24E−06 | −2.96E−08 | 0.00E+00 |
| | 2.34E−04 | −1.75E−05 | 6.54E−07 | −8.54E−09 | 0.00E+00 |

FIGS. 49A and 49B show lens shapes and placement for this embodiment, when it is operating in main mode. It also shows sample light rays through the embodiment for this mode. In main mode, the field-of-view (FOV) is approximately 81 degrees, the F-number is approximately 1.7, and the effective focal length (EFL) is approximately 4.4 mm.

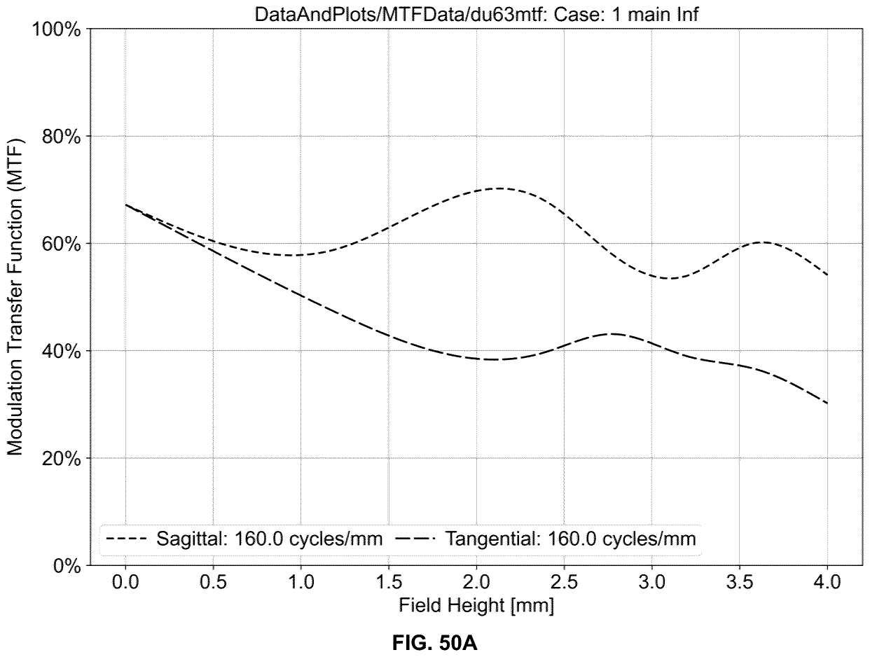

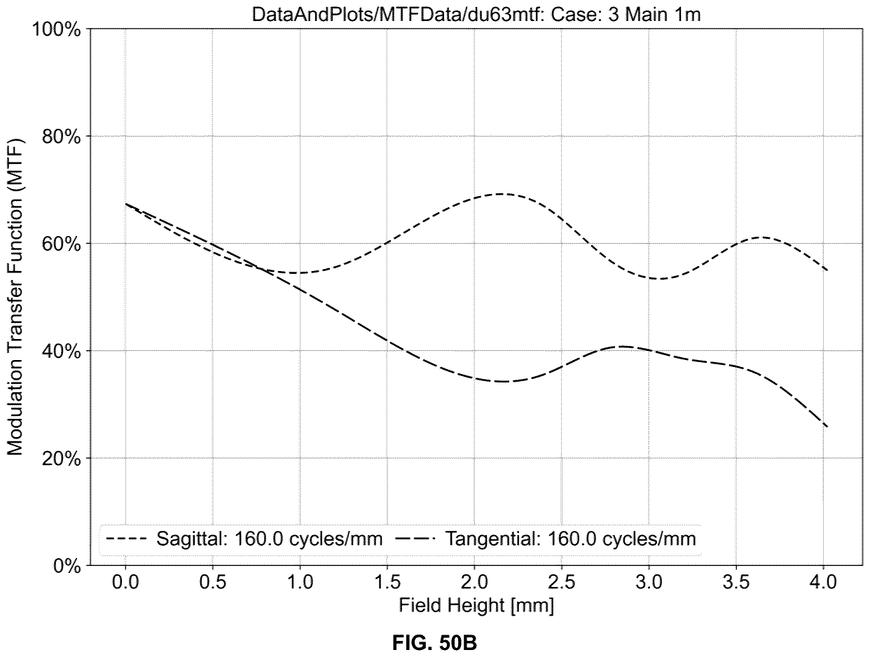

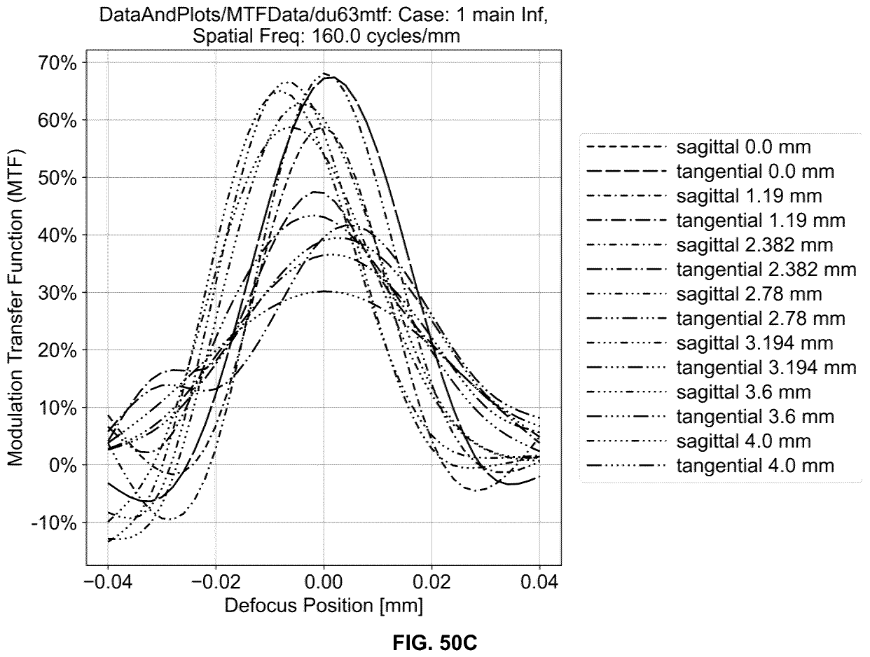

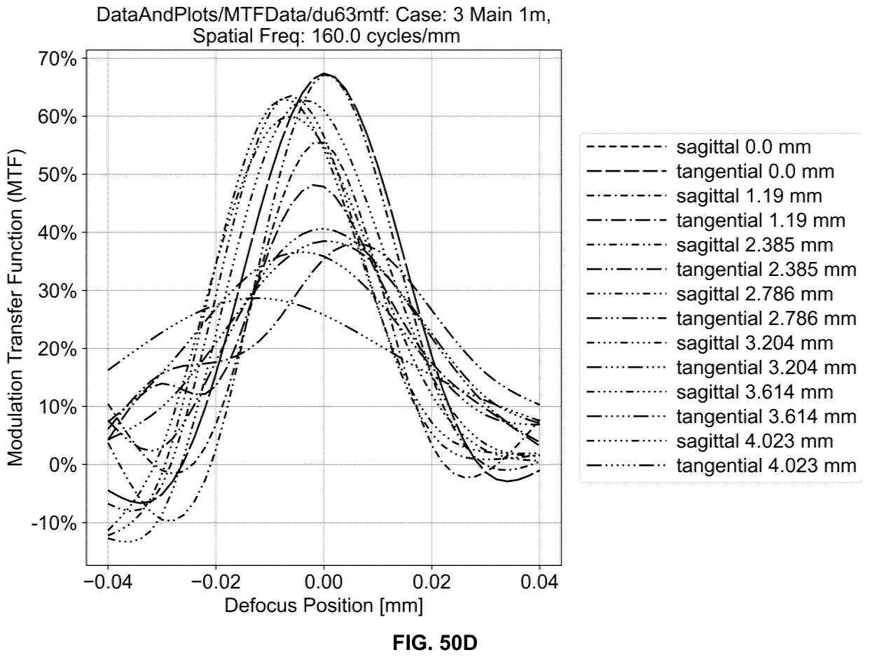

For main mode, FIG. 50A is an MTF (modulation transfer function) performance diagram versus field height for this embodiment, for an object plane located away at infinity. FIG. 50B is an MTF performance diagram versus field height, for an object plane located at 1 meter. FIG. 50C is an MTF versus defocus position, for an object plane located at infinity. And FIG. 50D is an MTF versus defocus position, for an object plane at 10 centimeters.

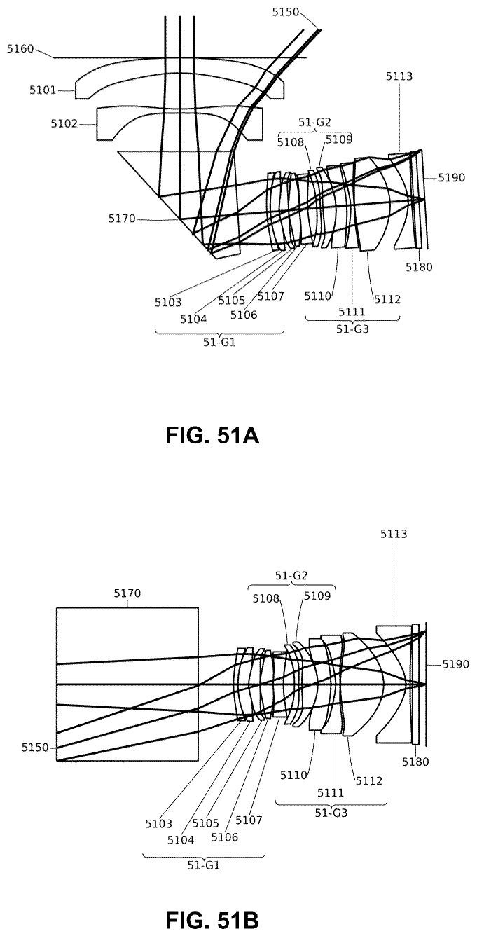

FIGS. 51A and 51B show lens placement for this embodiment, when it is operating in ultra-wide mode. It also shows sample light rays through the embodiment for this mode. In ultra-wide mode, the field-of-view (FOV) is approximately 123 degrees, the F-number is approximately 1.7, and the effective focal length (EFL) is approximately 2.8 mm.

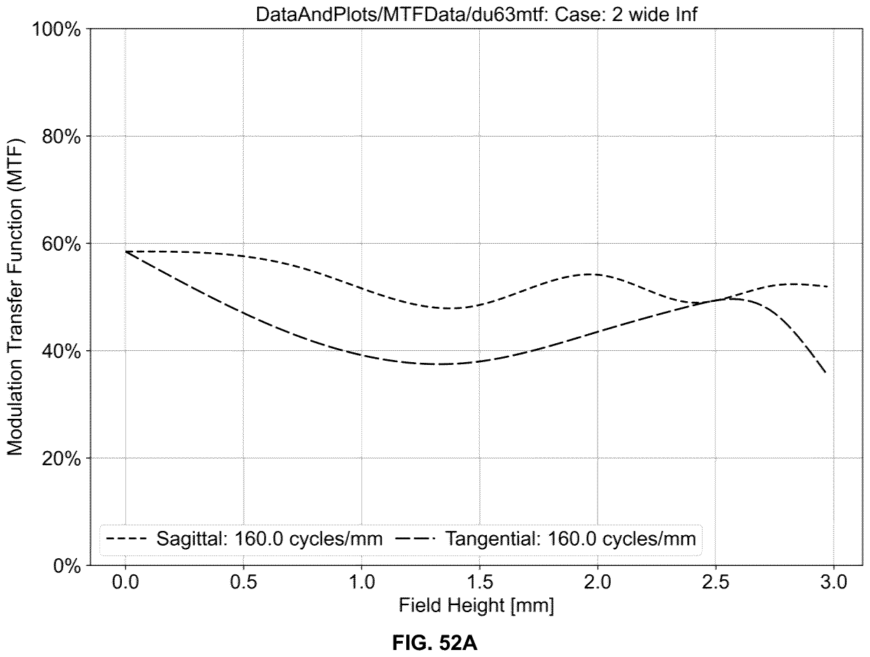

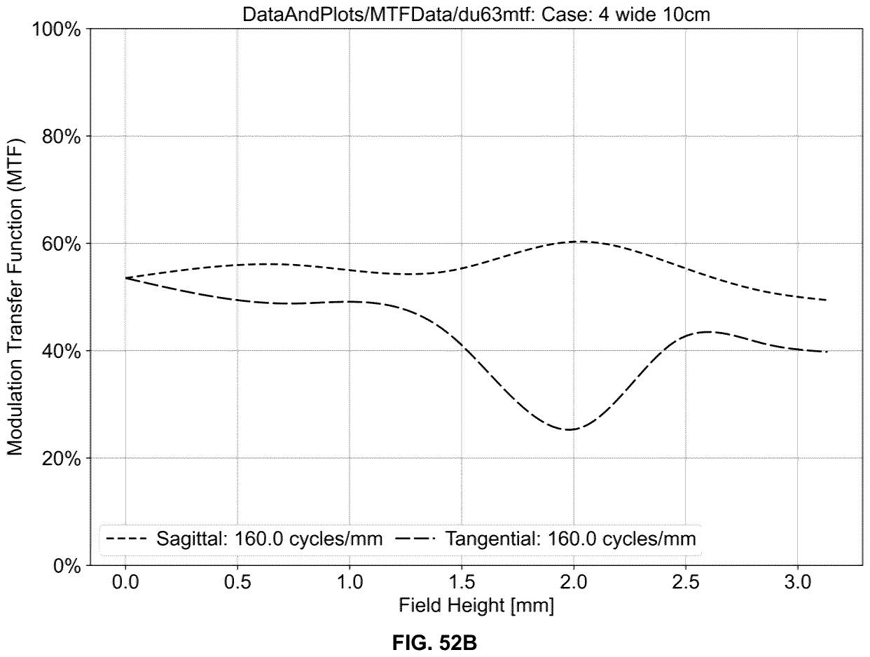

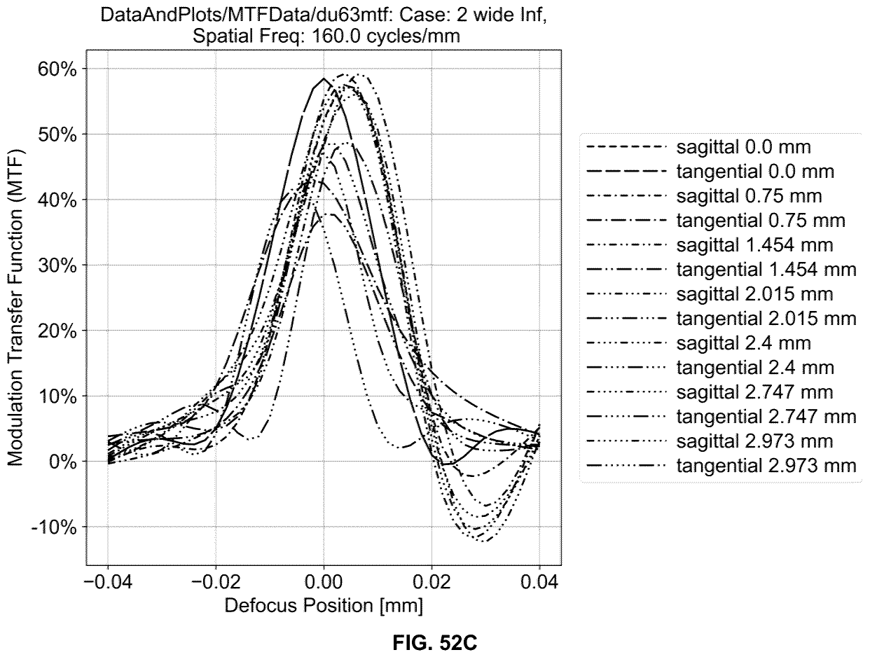

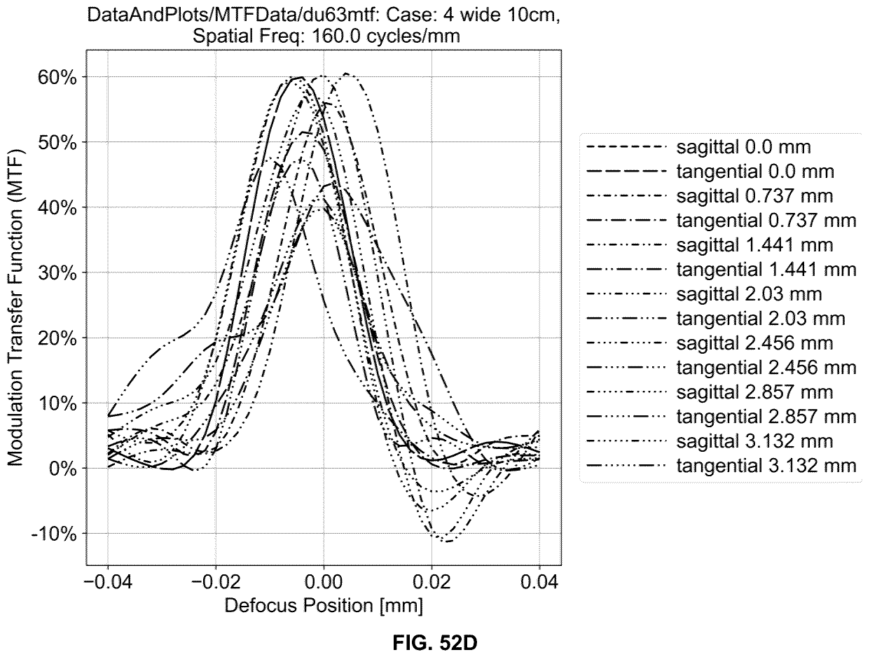

For ultra-wide mode, FIG. 52A is an MTF performance diagram for this embodiment versus field height, for an object plane located away at infinity. FIG. 52B is an MTF performance diagram versus field height, for an object plane located at 10 centimeters. FIG. 52C is an MTF versus defocus position, for an object plane located at infinity. And FIG. 52D is an MTF versus defocus position, for an object plane at 10 centimeters.

### Embodiment #14

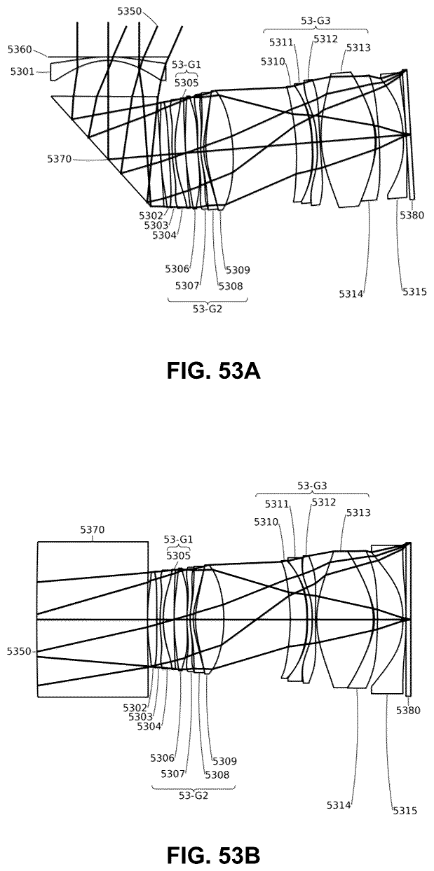

This embodiment (FIGS. 53A-56D) can have a periscope arrangement, with a turning optic that may be a mirror or a prism. The total size of the optics can be approximately 25.27 mm (X length)×12.03 mm (Y width)×8.56 mm (Z height).

The embodiment can have 15 lenses (15 aspherical and 0 spherical). The turning optic may be positioned before the second lens, before the remaining lenses in the periscope arm. There may be 3 moving lens groups, with 1 lens in the first group, and 4 lenses in the second group, and 4 lenses in the third group. The power of these groups may be positive, positive, and positive. The motion of the third lens group may also be used for auto-focusing.

Table 14 states possible lens shapes and placement for this embodiment, for both

TABLE 14
Lens shape parameters for embodiment #14.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 11.906 | 0.200 | 1.62 | 58.17 | −1.13E+01 | −8.06E−04 | 9.61E−06 |
| | 4.927 | 2.036 | | | −1.00E+00 | −8.66E−04 | 6.66E−06 |
| | 190.249 | 7.098 | 1.88 | 40.81 | | | |
| | 126.687 | 0.000 | | | | | |
| 2 | 12.502 | 0.587 | 1.63 | 23.43 | 6.57E+00 | −8.10E−04 | −2.90E−04 |
| | 76.564 | 0.019 | | | −5.31E+00 | −2.25E−03 | −1.83E−04 |
| 3 | −31.707 | 0.200 | 1.53 | 55.75 | −5.20E+00 | 7.66E−03 | −2.61E−03 |
| | 12.065 | 0.002 | | | 1.00E+01 | 1.79E−02 | −1.25E−02 |
| 4 | 11.181 | 0.201 | 1.53 | 55.75 | −6.78E+00 | 1.82E−02 | −1.20E−02 |
| | 8.007 | 0.003 | | | −5.96E−01 | 9.10E−03 | −2.66E−03 |
| 5 | 6.362 | 0.692 | 1.53 | 55.75 | 1.17E+00 | −1.50E−03 | −2.35E−04 |
| | 70.502 | 0.000 | | | −2.82E+00 | −8.71E−04 | 2.17E−04 |
| 6 | 11.637 | 0.824 | 1.53 | 55.75 | 6.89E+00 | −1.30E−03 | −3.57E−04 |
| | 18.607 | 0.000 | | | 7.64E−01 | −8.28E−03 | −1.14E−03 |
| 7 | 6.477 | 0.201 | 1.63 | 23.43 | −8.42E−02 | −2.26E−02 | 1.62E−03 |
| | 4.230 | 0.000 | | | −2.22E+00 | −3.30E−02 | 4.40E−03 |
| 8 | 3.672 | 0.205 | 1.63 | 23.43 | −3.38E+00 | −2.67E−02 | 3.22E−03 |
| | 3.251 | 0.141 | | | −1.25E+00 | −2.21E−02 | 2.75E−03 |
| 9 | 4.780 | 1.816 | 1.50 | 81.56 | −7.35E+00 | −3.20E−03 | −2.63E−05 |
| | −8.308 | 4.258 | | | 3.50E+00 | 8.00E−04 | −8.99E−05 |
| 10 | −9.909 | 1.066 | 1.57 | 37.67 | −2.33E+00 | 5.21E−03 | −1.07E−03 |
| | −10.730 | 0.038 | | | 4.94E+00 | −5.94E−03 | 3.85E−04 |
| 11 | −22.674 | 0.294 | 1.90 | 37.37 | 8.24E−01 | −1.84E−02 | 2.44E−03 |
| | −17.130 | 0.018 | | | −9.31E+00 | −3.01E−02 | 5.76E−03 |
| 12 | −12.250 | 0.200 | 1.57 | 37.67 | 6.15E+00 | −2.70E−02 | 5.62E−03 |
| | 115.832 | 0.081 | | | −7.77E+00 | 1.91E−03 | −9.76E−04 |
| 13 | 5.679 | 3.624 | 1.50 | 81.56 | −2.94E+00 | −6.60E−04 | −5.77E−05 |
| | −4.253 | 0.070 | | | −2.94E+00 | −7.55E−04 | 2.97E−05 |
| 14 | −3.171 | 0.200 | 1.53 | 55.75 | −2.72E+00 | 5.15E−03 | −8.57E−04 |
| | −16.600 | 1.627 | | | −1.76E+00 | 5.14E−03 | −1.07E−03 |
| 15 | −7.147 | 0.200 | 1.77 | 49.5 | 7.37E−01 | −1.25E−02 | 1.44E−03 |
| | −26.045 | 0.000 | | | 3.73E+00 | −2.30E−03 | 4.77E−04 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | 1.38E−09 | 4.79E−09 | −1.90E−10 | 1.90E−12 | 0.00E+00 |
| | −1.85E−06 | 1.22E−07 | −3.20E−09 | 3.29E−11 | 0.00E+00 |
| 2 | 6.96E−05 | −1.50E−05 | 1.40E−06 | −3.99E−08 | 0.00E+00 |
| | 9.47E−05 | −2.23E−05 | 2.10E−06 | −6.05E−08 | 0.00E+00 |
| 3 | 4.87E−04 | −5.69E−05 | 3.39E−06 | −7.60E−08 | 0.00E+00 |
| | 2.27E−03 | −1.86E−04 | 7.65E−06 | −1.35E−07 | 0.00E+00 |
| 4 | 2.13E−03 | −1.63E−04 | 5.72E−06 | −7.35E−08 | 0.00E+00 |
| | 5.00E−04 | −6.65E−05 | 4.31E−06 | −9.81E−08 | 0.00E+00 |
| 5 | 1.43E−04 | −3.76E−05 | 3.25E−06 | −8.85E−08 | 0.00E+00 |
| | −4.42E−07 | −2.65E−06 | 2.84E−07 | −1.26E−08 | 0.00E+00 |
| 6 | 2.78E−05 | 1.45E−06 | −2.30E−07 | 6.81E−09 | 0.00E+00 |
| | 3.54E−04 | −3.81E−05 | 2.01E−06 | −3.49E−08 | 0.00E+00 |
| 7 | 1.82E−05 | −6.94E−06 | 4.46E−07 | −1.05E−08 | 0.00E+00 |
| | −3.03E−04 | 1.52E−05 | −4.52E−07 | 5.96E−09 | 0.00E+00 |
| 8 | −4.96E−05 | −2.21E−05 | 1.85E−06 | −4.45E−08 | 0.00E+00 |
| | −1.39E−04 | −4.61E−06 | 7.47E−07 | −2.01E−08 | 0.00E+00 |
| 9 | 8.82E−05 | −1.35E−05 | 8.33E−07 | −1.78E−08 | 0.00E+00 |
| | 3.91E−06 | −1.06E−06 | 1.01E−07 | −2.46E−09 | 0.00E+00 |
| 10 | 1.49E−04 | −1.24E−05 | 4.91E−07 | −7.35E−09 | 0.00E+00 |
| | 4.88E−06 | −2.18E−06 | 8.99E−08 | −7.51E−10 | 0.00E+00 |
| 11 | −1.94E−04 | 8.49E−06 | −1.88E−07 | 2.01E−09 | 0.00E+00 |
| | −4.83E−04 | 2.23E−05 | −5.68E−07 | 6.46E−09 | 0.00E+00 |
| 12 | −4.88E−04 | 2.37E−05 | −6.46E−07 | 8.18E−09 | 0.00E+00 |
| | 1.15E−04 | −8.18E−06 | 3.12E−07 | −4.38E−09 | 0.00E+00 |
| 13 | 1.01E−05 | −6.91E−07 | 2.11E−08 | −2.22E−10 | 0.00E+00 |
| | 3.99E−06 | −3.35E−07 | 5.98E−09 | 1.42E−11 | 0.00E+00 |
| 14 | 7.69E−05 | −3.82E−06 | 9.40E−08 | −8.75E−10 | 0.00E+00 |
| | 8.72E−05 | −3.80E−06 | 8.57E−08 | −7.57E−10 | 0.00E+00 |
| 15 | −8.33E−05 | 2.95E−06 | −5.63E−08 | 4.22E−10 | 0.00E+00 |
| | −3.23E−05 | 1.08E−06 | −1.74E−08 | 1.05E−10 | 0.00E+00 |

FIGS. 53A and 53B show lens shapes and placement for this embodiment, when it is operating in main mode. It also shows sample light rays through the embodiment for this mode. In main mode, the field-of-view (FOV) is approximately 82 degrees, the F-number is approximately 1.68, and the effective focal length (EFL) is approximately 6.99 mm.

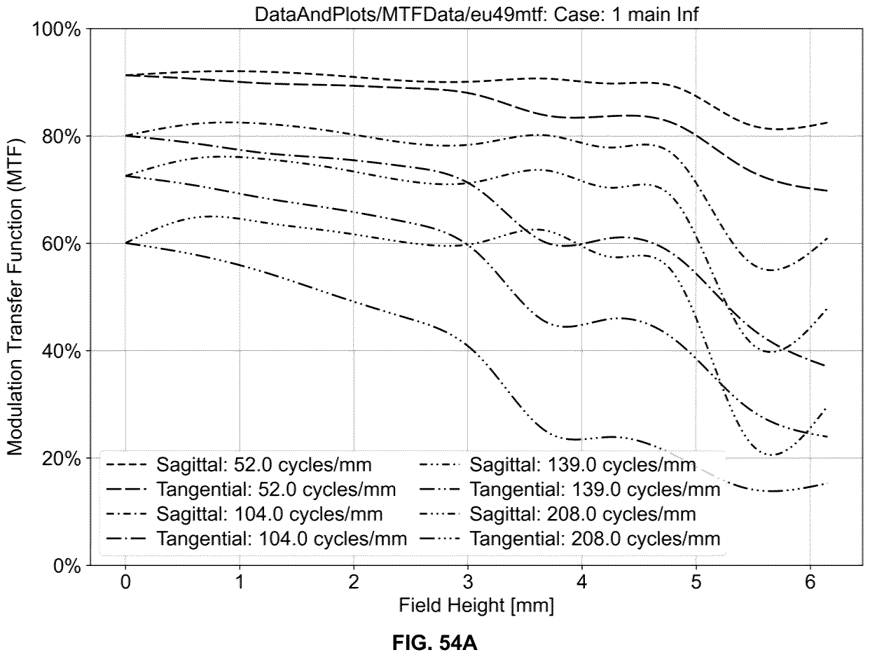

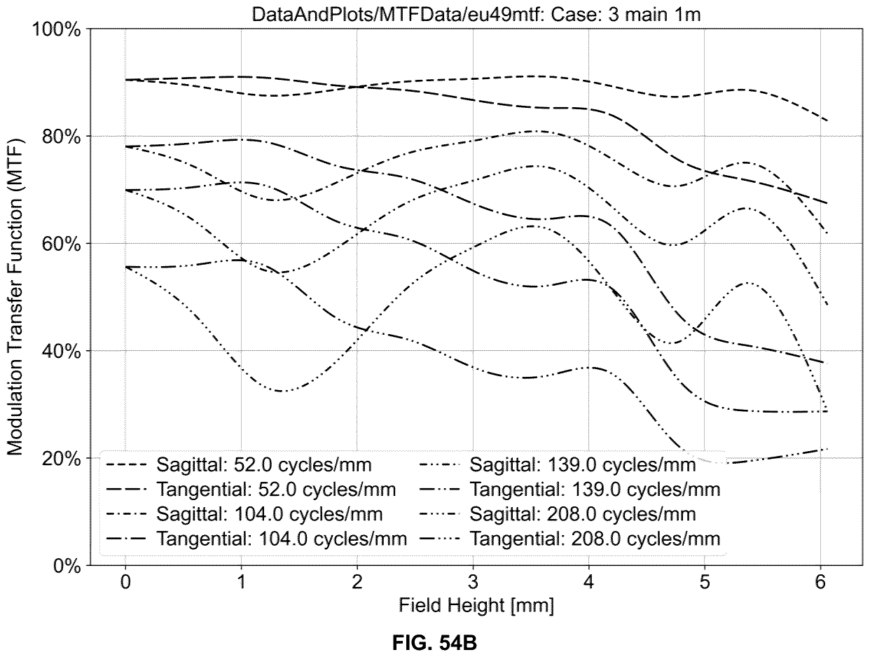

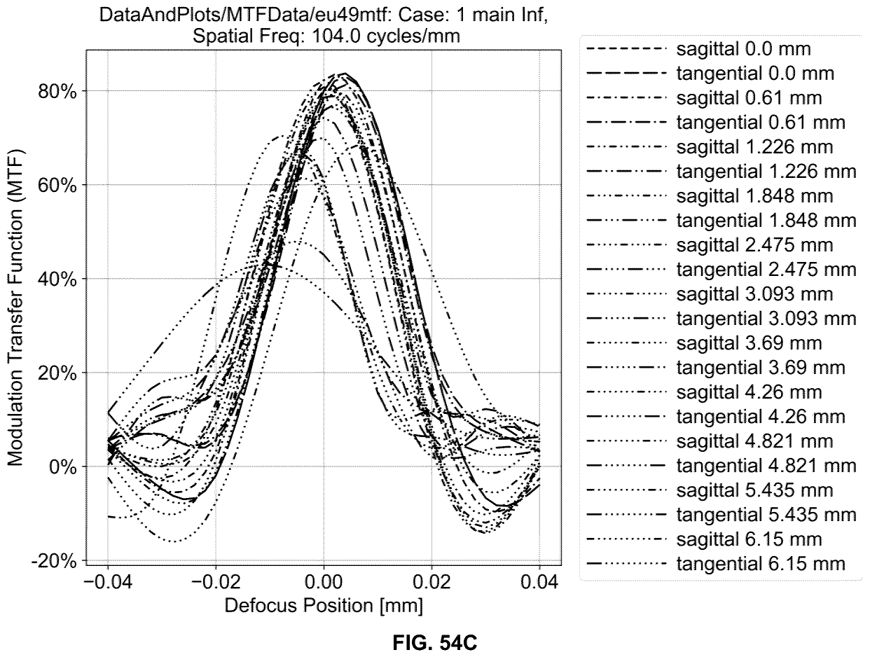

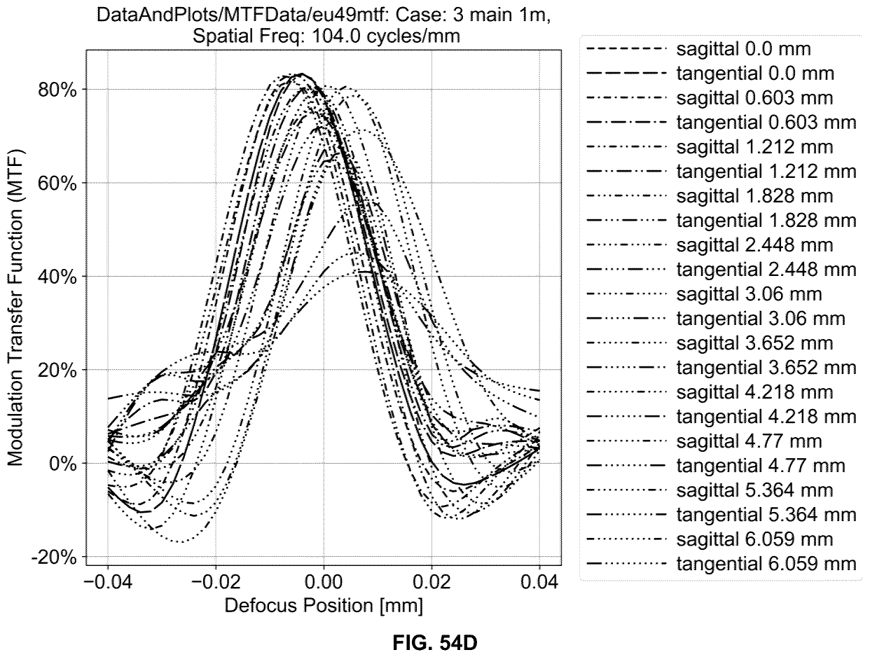

For main mode, FIG. 54A is an MTF (modulation transfer function) performance diagram versus field height for this embodiment, for an object plane located away at infinity. FIG. 54B is an MTF performance diagram versus field height, for an object plane located at 1 meter. FIG. 54C is an MTF versus defocus position, for an object plane located at infinity. And FIG. 54D is an MTF versus defocus position, for an object plane at 10 centimeters.

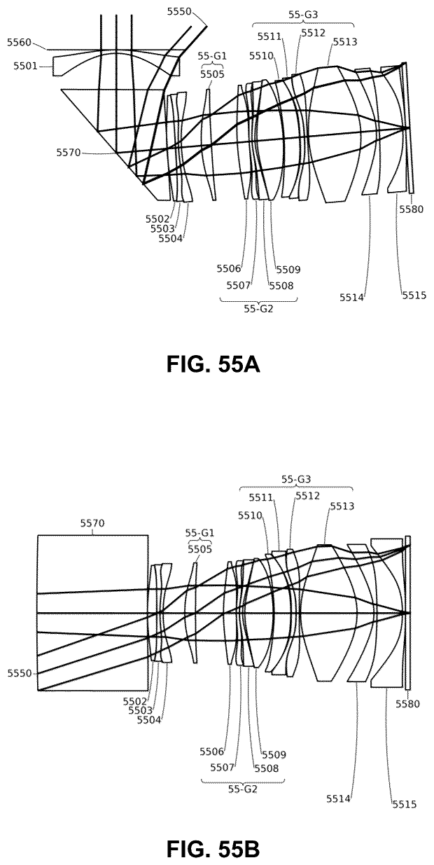

FIGS. 55A and 55B show lens placement for this embodiment, when it is operating in ultra-wide mode. It also shows sample light rays through the embodiment for this mode. In ultra-wide mode, the field-of-view (FOV) is approximately 122.7 degrees, the F-number is approximately 2, and the effective focal length (EFL) is approximately 4.24 mm.

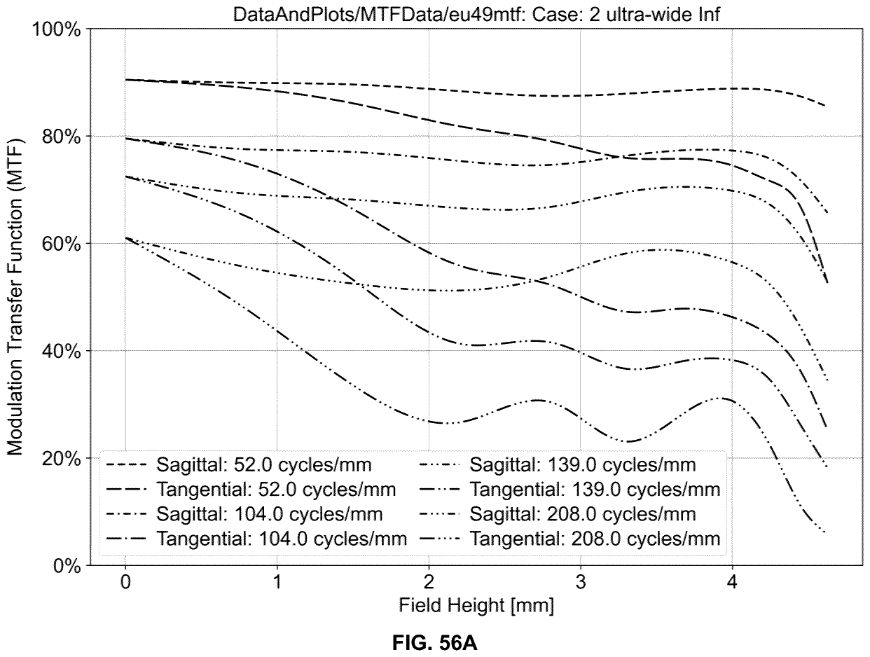

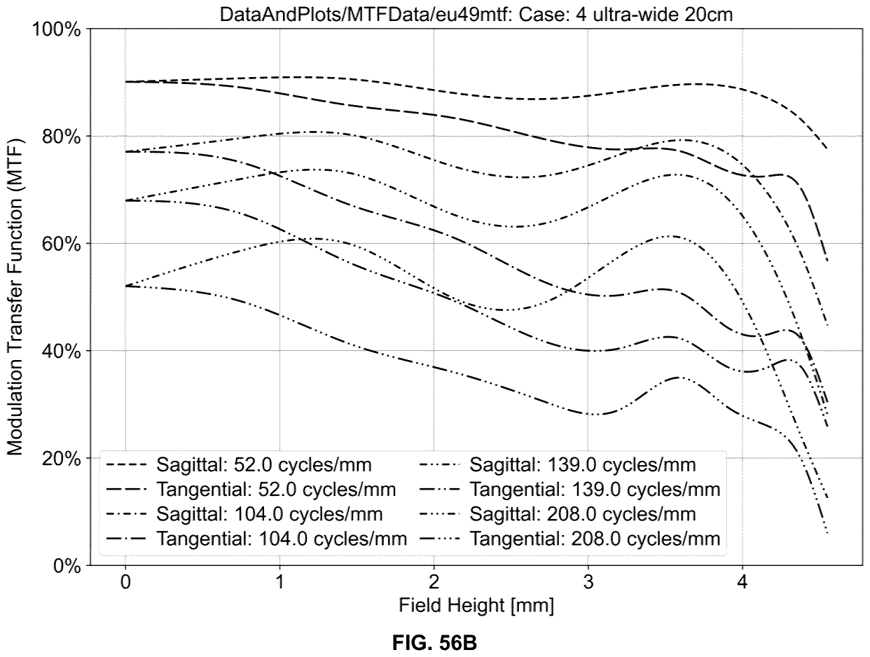

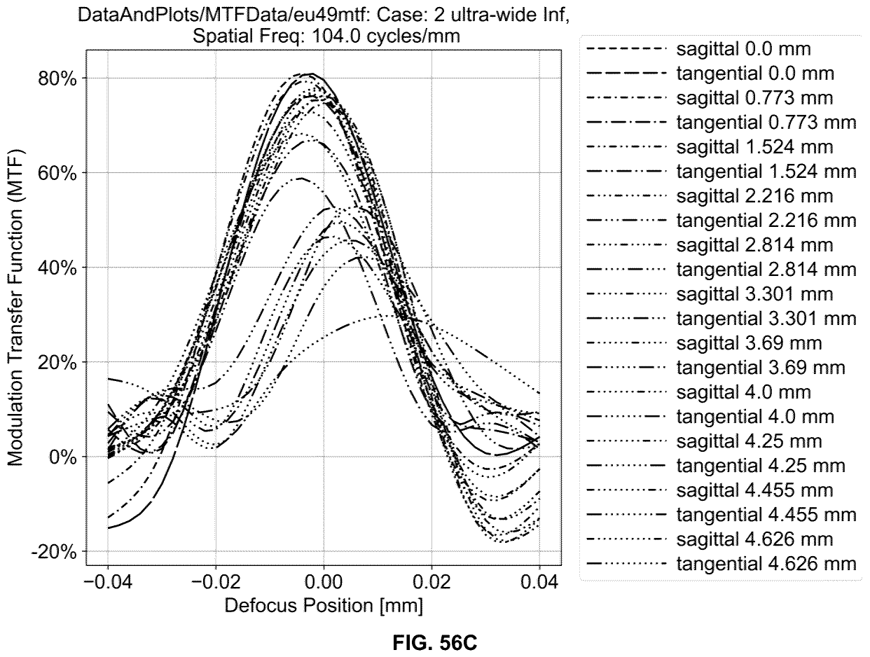

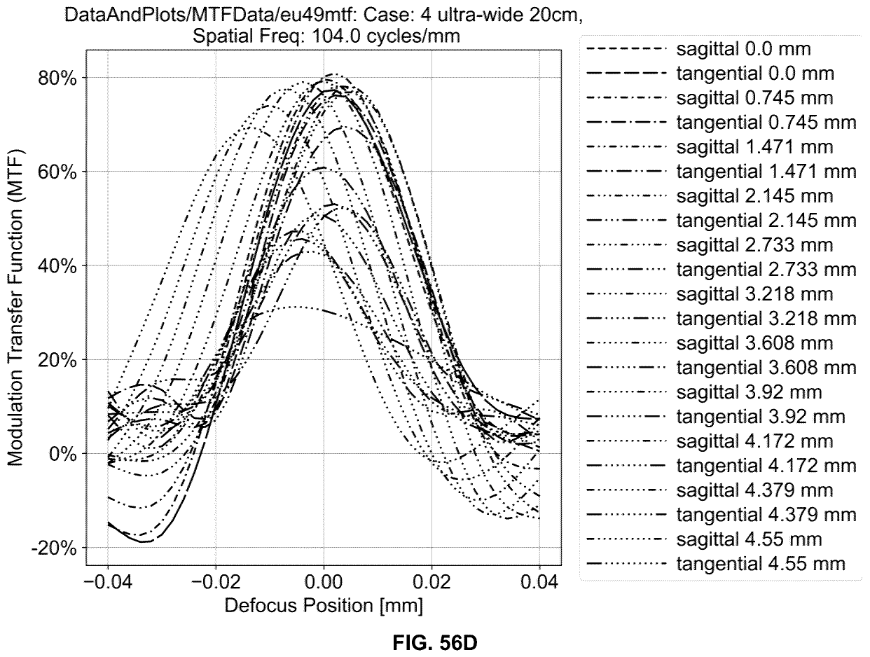

For ultra-wide mode, FIG. 56A is an MTF performance diagram for this embodiment versus field height, for an object plane located away at infinity. FIG. 56B is an MTF performance diagram versus field height, for an object plane located at 10 centimeters. FIG. 56C is an MTF versus defocus position, for an object plane located at infinity. And FIG. 56D is an MTF versus defocus position, for an object plane at 10 centimeters.

### Embodiment #15

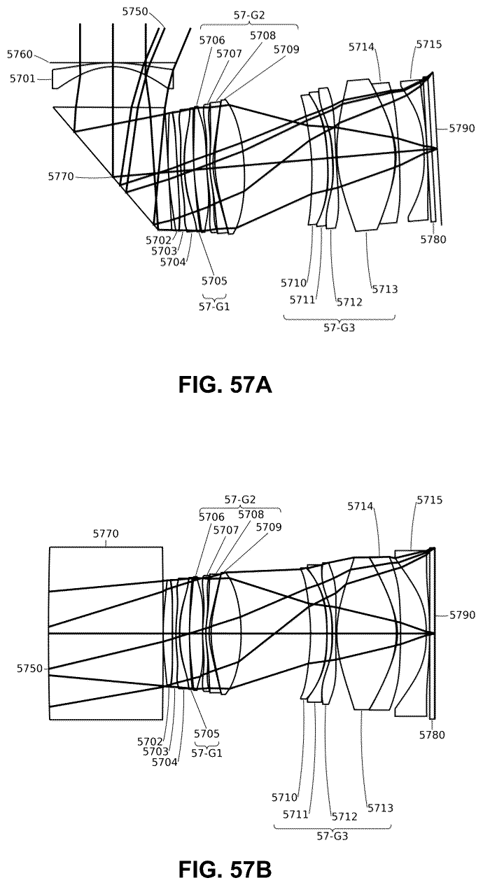

This embodiment (FIGS. 57A-60D) can have a periscope arrangement, with a turning optic that may be a mirror or a prism. The total size of the optics can be approximately 24.91 mm (X length)×11.89 mm (Y width)×8.74 mm (Z height).

The embodiment can have 15 lenses (15 aspherical and 0 spherical). The turning optic may be positioned before the second lens, before the remaining lenses in the periscope arm. There may be 3 moving lens groups, with 1 lens in the first group, and 4 lenses in the second group, and 4 lenses in the third group. The power of these groups may be positive, positive, and positive. The motion of the third lens group may also be used for auto-focusing.

Table 15 states possible lens shapes and placement for this embodiment, for both

TABLE 15
Lens shape parameters for embodiment #15.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 12.369 | 0.200 | 1.6226 | 58.17 | −1.16E+01 | −8.79E−04 | 1.73E−05 |
| | 4.956 | 2.048 | | | −9.59E−01 | −9.54E−04 | 1.93E−05 |
| | 167.662 | 7.059 | 1.883 | 40.81 | | | |
| | −282.118 | 0.000 | | | | | |
| 2 | 12.566 | 0.561 | 1.6322 | 23.43 | 6.34E+00 | −1.31E−03 | −3.11E−04 |
| | 62.474 | 0.018 | | | −5.31E+00 | −2.47E−03 | −9.93E−05 |
| 3 | −32.621 | 0.208 | 1.5311 | 55.75 | −5.18E+00 | 9.46E−03 | −2.81E−03 |
| | 12.115 | 0.008 | | | 1.00E+01 | 1.27E−02 | −9.70E−03 |
| 4 | 11.468 | 0.211 | 1.5311 | 55.75 | −6.82E+00 | 1.43E−02 | −9.89E−03 |
| | 7.928 | 0.016 | | | −7.00E−01 | 1.22E−02 | −3.69E−03 |
| 5 | 6.047 | 0.599 | 1.5311 | 55.75 | 8.62E−01 | −1.68E−03 | −4.81E−04 |
| | 25.171 | 0.000 | | | −2.87E+00 | −1.39E−03 | 6.33E−05 |
| 6 | 12.055 | 0.809 | 1.5311 | 55.75 | 6.16E+00 | −9.92E−04 | −2.57E−04 |
| | 20.558 | 0.000 | | | 7.76E−01 | −7.85E−03 | −1.15E−03 |
| 7 | 6.136 | 0.201 | 1.6322 | 23.43 | −6.39E−01 | −2.34E−02 | 1.44E−03 |
| | 4.393 | 0.000 | | | −2.25E+00 | −3.64E−02 | 4.99E−03 |
| 8 | 4.038 | 0.203 | 1.6322 | 23.43 | −2.84E+00 | −2.96E−02 | 3.62E−03 |
| | 3.349 | 0.120 | | | −1.16E+00 | −2.06E−02 | 2.07E−03 |
| 9 | 4.740 | 1.848 | 1.4971 | 81.56 | −7.34E+00 | −2.77E−03 | −1.54E−04 |
| | −8.270 | 4.276 | | | 3.43E+00 | 6.93E−04 | −9.03E−05 |
| 10 | −9.438 | 1.002 | 1.5731 | 37.67 | −1.85E+00 | 4.92E−03 | −1.04E−03 |
| | −10.696 | 0.011 | | | 4.95E+00 | −3.55E−03 | −8.82E−05 |
| 11 | −24.937 | 0.306 | 1.9004 | 37.37 | 8.52E−01 | −1.50E−02 | 1.86E−03 |
| | −19.891 | 0.036 | | | −9.25E+00 | −2.82E−02 | 5.14E−03 |
| 12 | −12.248 | 0.201 | 1.5731 | 37.67 | 6.22E+00 | −2.48E−02 | 4.86E−03 |
| | 473.257 | 0.063 | | | −7.76E+00 | 3.55E−03 | −1.25E−03 |
| 13 | 5.530 | 3.667 | 1.4971 | 81.56 | −3.32E+00 | −1.26E−03 | 7.02E−05 |
| | −4.138 | 0.063 | | | −2.84E+00 | −1.02E−03 | 1.07E−04 |
| 14 | −3.148 | 0.200 | 1.5311 | 55.75 | −2.69E+00 | 5.48E−03 | −1.01E−03 |
| | −17.236 | 1.582 | | | −2.04E+00 | 6.41E−03 | −1.48E−03 |
| 15 | −7.513 | 0.200 | 1.7725 | 49.5 | 8.81E−01 | −1.12E−02 | 1.14E−03 |
| | −26.004 | 0.000 | | | 3.55E+00 | −2.29E−03 | 4.94E−04 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | −3.03E−07 | 1.09E−08 | −2.53E−10 | 2.14E−12 | 0.00E+00 |
| | −2.44E−06 | 1.42E−07 | −3.67E−09 | 3.80E−11 | 0.00E+00 |
| 2 | 9.09E−05 | −1.75E−05 | 1.59E−06 | −4.60E−08 | 0.00E+00 |
| | 6.93E−05 | −1.80E−05 | 1.83E−06 | −5.58E−08 | 0.00E+00 |
| 3 | 4.57E−04 | −4.92E−05 | 2.84E−06 | −6.28E−08 | 0.00E+00 |
| | 1.74E−03 | −1.36E−04 | 5.22E−06 | −8.78E−08 | 0.00E+00 |
| 4 | 1.75E−03 | −1.29E−04 | 4.21E−06 | −4.45E−08 | 0.00E+00 |
| | 6.91E−04 | −8.82E−05 | 5.56E−06 | −1.25E−07 | 0.00E+00 |
| 5 | 2.42E−04 | −5.44E−05 | 4.46E−06 | −1.18E−07 | 0.00E+00 |
| | 5.04E−05 | −8.74E−06 | 6.17E−07 | −1.93E−08 | 0.00E+00 |
| 6 | −4.51E−05 | 1.34E−05 | −9.85E−07 | 2.31E−08 | 0.00E+00 |
| | 3.21E−04 | −3.27E−05 | 1.69E−06 | −2.89E−08 | 0.00E+00 |
| 7 | 1.37E−04 | −2.36E−05 | 1.38E−06 | −2.92E−08 | 0.00E+00 |
| | −2.59E−04 | 1.02E−06 | 4.85E−07 | −1.39E−08 | 0.00E+00 |
| 8 | −1.68E−05 | −3.09E−05 | 2.39E−06 | −5.49E−08 | 0.00E+00 |
| | −1.13E−05 | −1.63E−05 | 1.26E−06 | −2.86E−08 | 0.00E+00 |
| 9 | 1.12E−04 | −1.51E−05 | 8.53E−07 | −1.71E−08 | 0.00E+00 |
| | 8.79E−06 | −1.69E−06 | 1.31E−07 | −2.92E−09 | 0.00E+00 |
| 10 | 1.49E−04 | −1.26E−05 | 5.00E−07 | −7.51E−09 | 0.00E+00 |
| | 4.24E−05 | −3.61E−06 | 1.15E−07 | −9.17E−10 | 0.00E+00 |
| 11 | −1.68E−04 | 9.19E−06 | −2.62E−07 | 3.37E−09 | 0.00E+00 |
| | −4.18E−04 | 1.91E−05 | −4.93E−07 | 5.75E−09 | 0.00E+00 |
| 12 | −3.98E−04 | 1.88E−05 | −5.19E−07 | 6.90E−09 | 0.00E+00 |
| | 1.33E−04 | −8.63E−06 | 3.12E−07 | −4.27E−09 | 0.00E+00 |
| 13 | −1.98E−06 | −9.32E−08 | 6.71E−09 | −9.31E−11 | 0.00E+00 |
| | −3.82E−06 | 5.46E−08 | −3.37E−09 | 9.85E−11 | 0.00E+00 |
| 14 | 9.66E−05 | −4.85E−06 | 1.18E−07 | −1.08E−09 | 0.00E+00 |
| | 1.32E−04 | −5.91E−06 | 1.31E−07 | −1.11E−09 | 0.00E+00 |
| 15 | −5.43E−05 | 1.57E−06 | −2.57E−08 | 1.70E−10 | 0.00E+00 |
| | −3.37E−05 | 1.12E−06 | −1.81E−08 | 1.09E−10 | 0.00E+00 |

FIGS. 57A and 57B show lens shapes and placement for this embodiment, when it is operating in main mode. It also shows sample light rays through the embodiment for this mode. In main mode, the field-of-view (FOV) is approximately 82 degrees, the F-number is approximately 1.68, and the effective focal length (EFL) is approximately 7 mm.

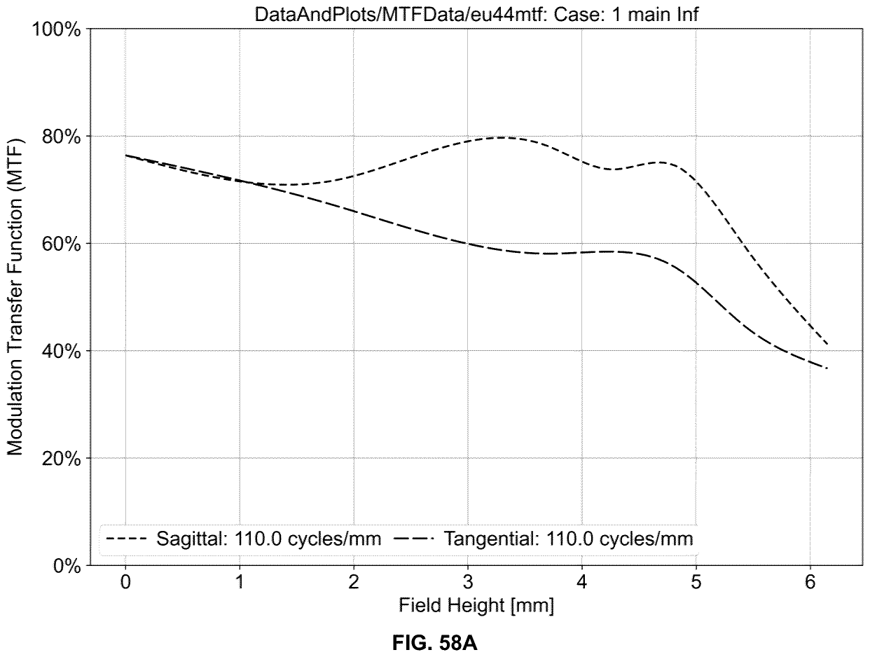

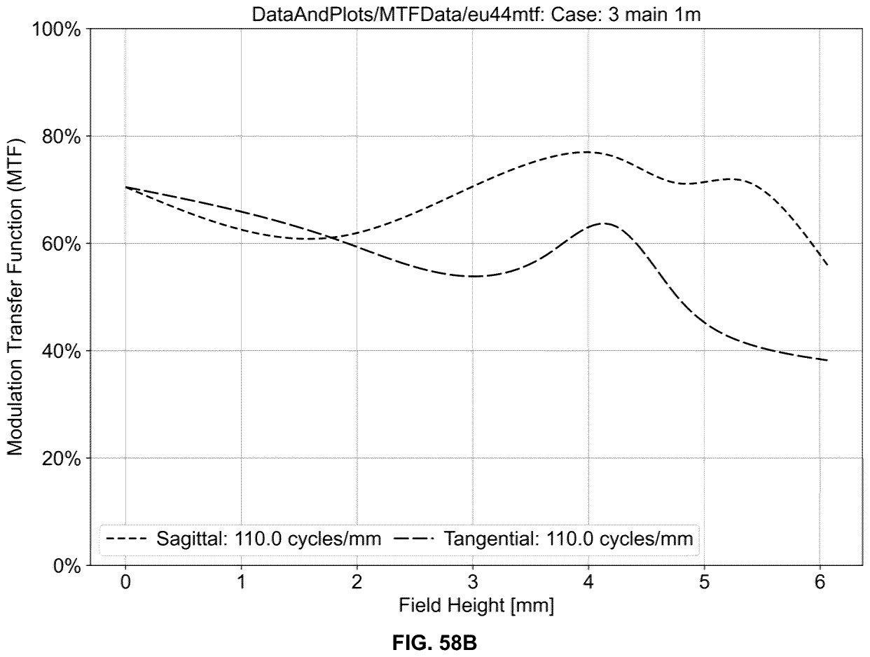

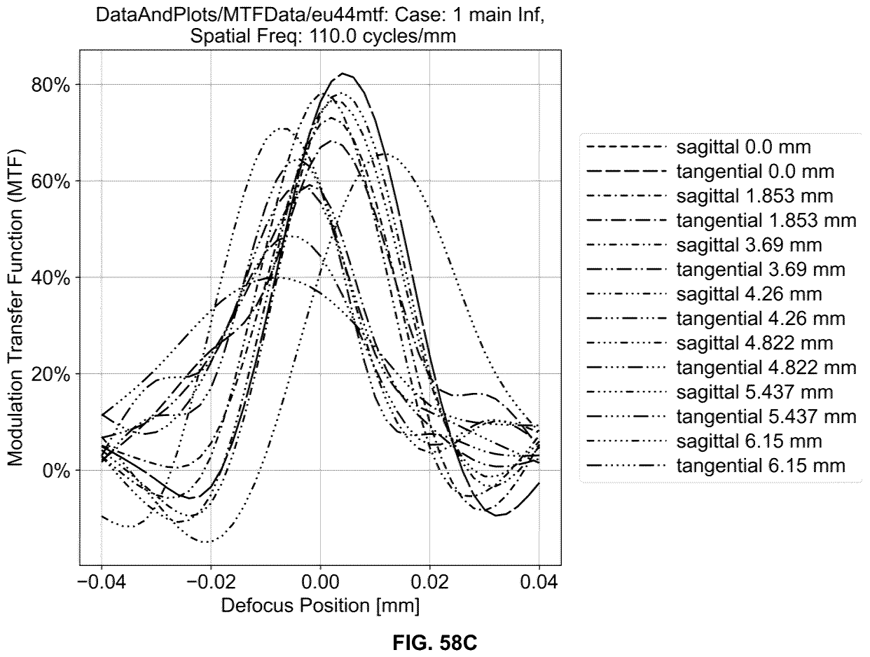

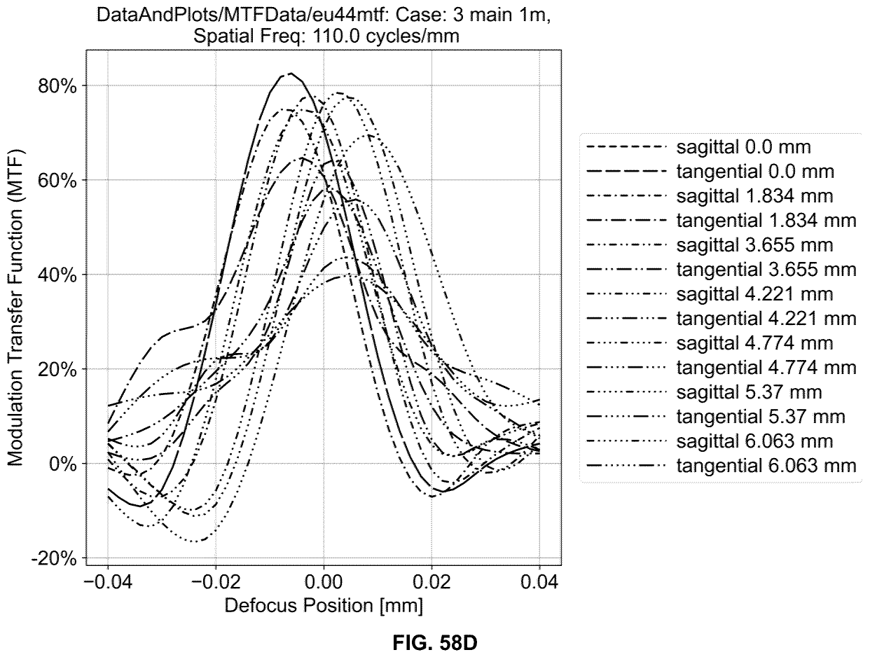

For main mode, FIG. 58A is an MTF (modulation transfer function) performance diagram versus field height for this embodiment, for an object plane located away at infinity. FIG. 58B is an MTF performance diagram versus field height, for an object plane located at 1 meter. FIG. 58C is an MTF versus defocus position, for an object plane located at infinity. And FIG. 58D is an MTF versus defocus position, for an object plane at 10 centimeters.

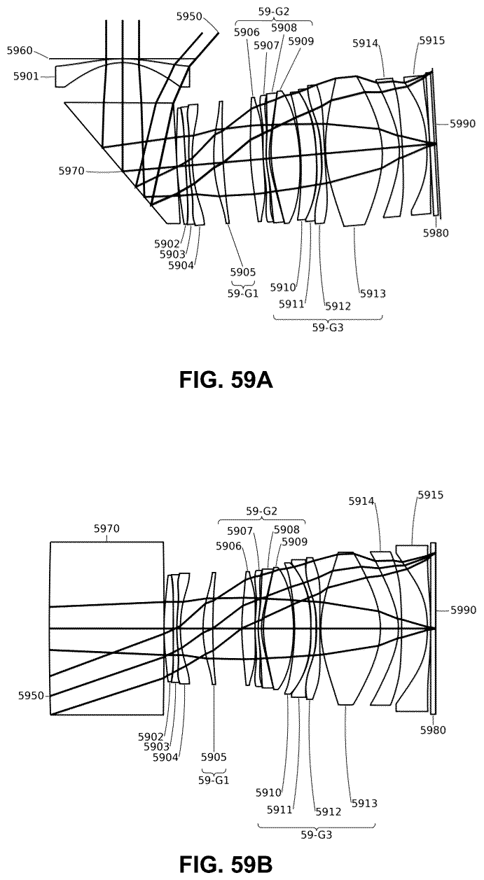

FIGS. 59A and 59B show lens placement for this embodiment, when it is operating in ultra-wide mode. It also shows sample light rays through the embodiment for this mode. In ultra-wide mode, the field-of-view (FOV) is approximately 122.7 degrees, the F-number is approximately 2, and the effective focal length (EFL) is approximately 4.22 mm.

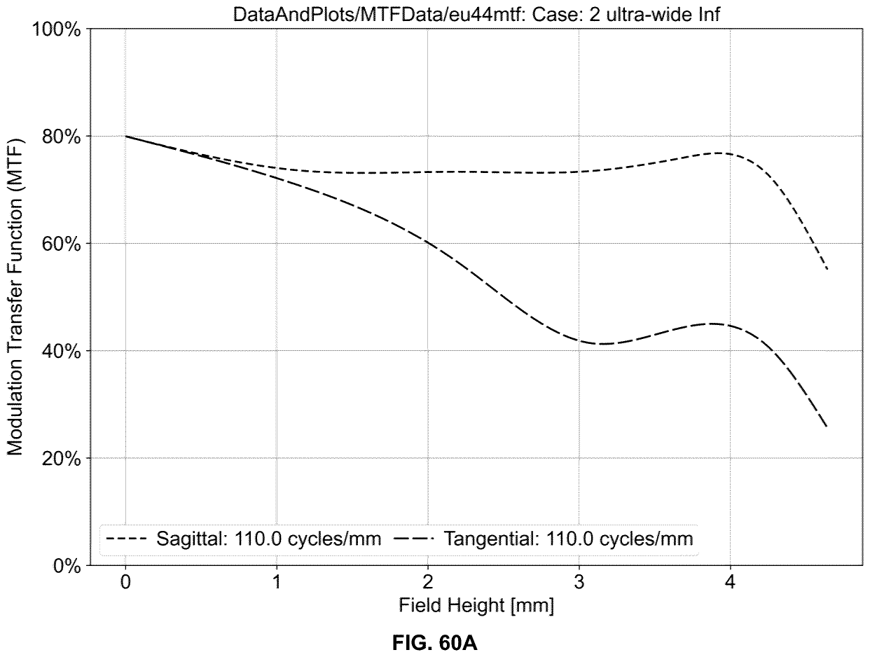

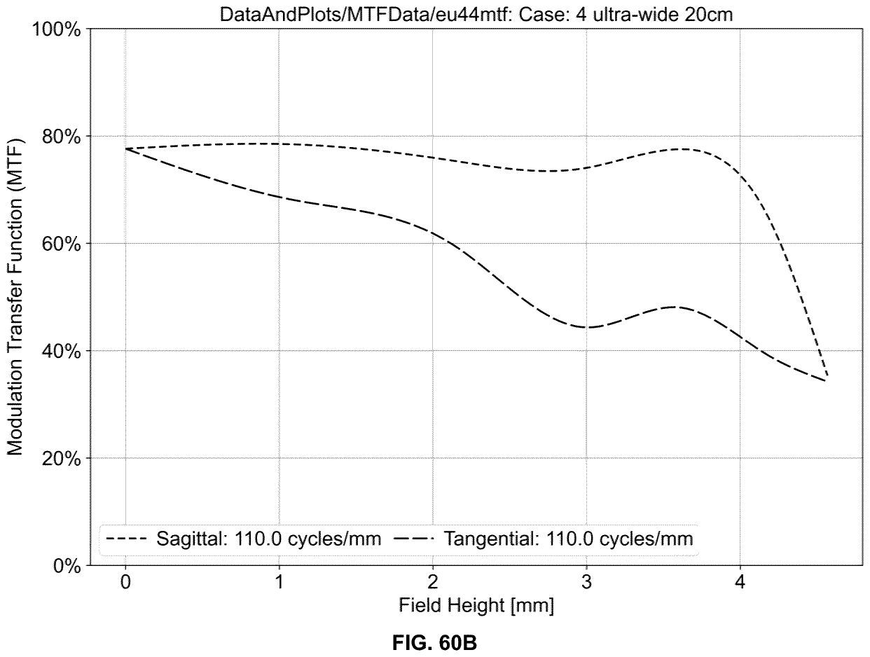

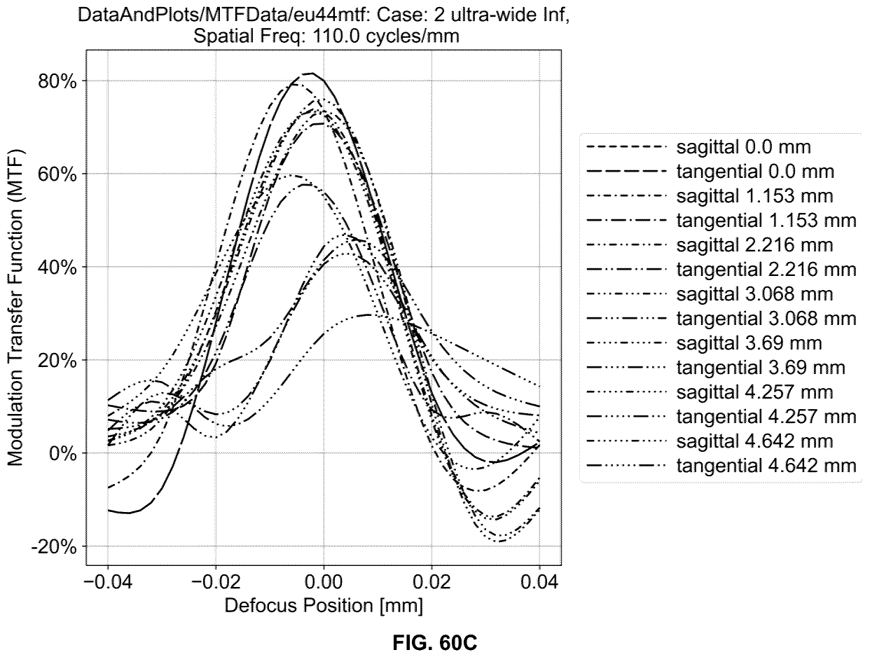

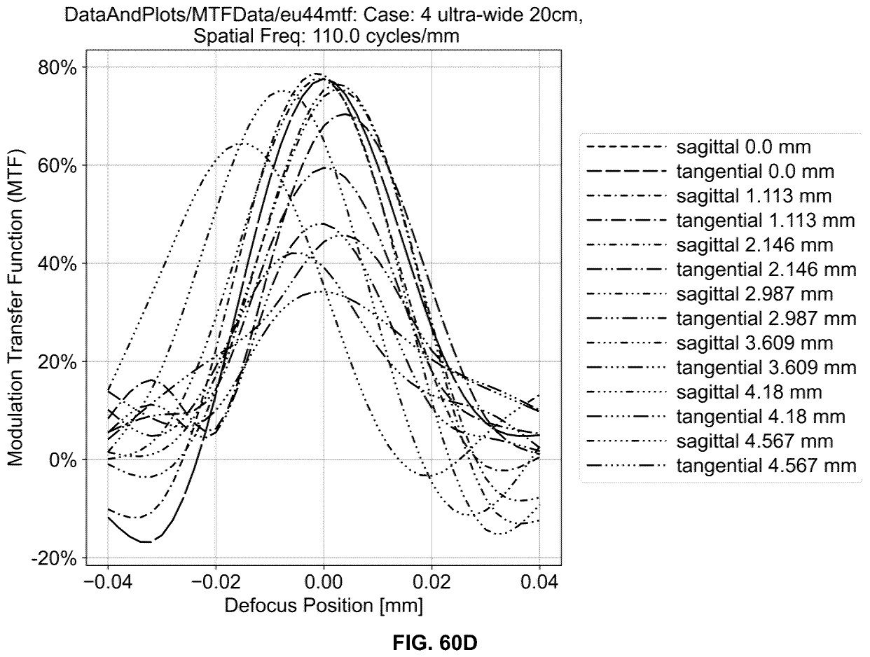

For ultra-wide mode, FIG. 60A is an MTF performance diagram for this embodiment versus field height, for an object plane located away at infinity. FIG. 60B is an MTF performance diagram versus field height, for an object plane located at 10 centimeters. FIG. 60C is an MTF versus defocus position, for an object plane located at infinity. And FIG. 60D is an MTF versus defocus position, for an object plane at 10 centimeters.

### Embodiment #16

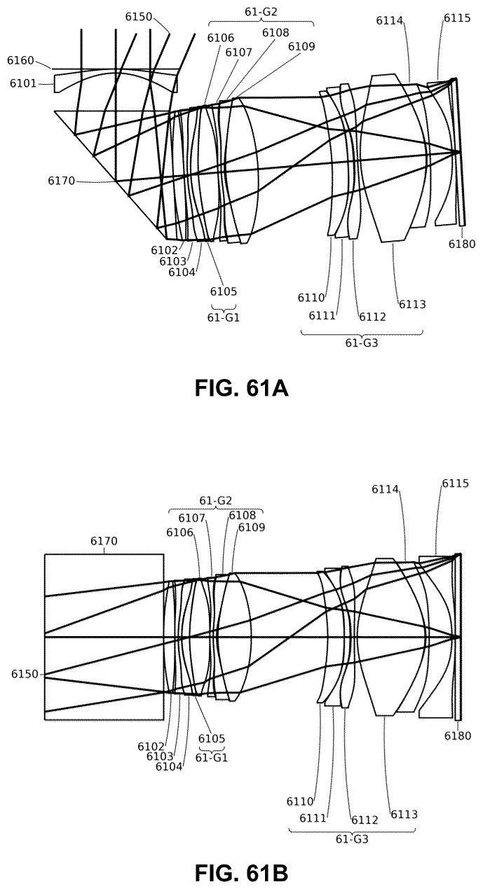

This embodiment (FIGS. 61A-64D) can have a periscope arrangement, with a turning optic that may be a mirror or a prism. The total size of the optics can be approximately 25.41 mm (X length)×11.49 mm (Y width)×8.65 mm (Z height).

The embodiment can have 15 lenses (15 aspherical and 0 spherical). The turning optic may be positioned before the second lens, before the remaining lenses in the periscope arm. There may be 3 moving lens groups, with 1 lens in the first group, and 4 lenses in the second group, and 4 lenses in the third group. The power of these groups may be positive, positive, and positive. The motion of the third lens group may also be used for auto-focusing.

Table 16 states possible lens shapes and placement for this embodiment, for both

TABLE 16
Lens shape parameters for embodiment #16.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| 1 | 14.901 | 0.200 | 1.6968 | 55.46 | −1.14E+01 | −1.00E−03 | 2.07E−05 |
| | 5.532 | 1.884 | | | −6.99E−01 | −1.08E−03 | 6.06E−06 |
| | | 6.967 | 1.5168 | 64.2 | | | |
| | | 0.000 | | | | | |
| 2 | 15.712 | 0.669 | 1.6322 | 23.43 | 5.69E+00 | 9.97E−04 | 1.23E−04 |
| | −90.862 | 0.000 | | | −5.31E+00 | 7.71E−03 | −3.65E−03 |
| 3 | −120.760 | 0.200 | 1.5311 | 55.75 | −5.19E+00 | 2.35E−02 | −9.54E−03 |
| | 12.072 | 0.000 | | | 1.02E+01 | 2.81E−02 | −1.51E−02 |
| 4 | 9.757 | 0.202 | 1.5731 | 37.67 | −6.94E+00 | 2.09E−02 | −1.17E−02 |
| | 6.896 | 0.003 | | | −1.60E+00 | 9.97E−03 | −3.06E−03 |
| 5 | 5.250 | 0.470 | 1.5731 | 37.67 | −5.65E−01 | −3.06E−03 | −1.50E−04 |
| | 9.368 | 0.000 | | | −3.36E+00 | −4.46E−03 | 4.24E−04 |
| 6 | 9.138 | 1.207 | 1.5311 | 55.75 | 4.72E+00 | −3.61E−03 | 1.59E−04 |
| | 448.164 | 0.000 | | | 8.02E−01 | −9.26E−03 | 6.42E−04 |
| 7 | 7.980 | 0.208 | 1.6322 | 23.43 | −2.40E+00 | −1.61E−02 | 9.01E−04 |
| | 5.973 | 0.000 | | | −2.75E+00 | −2.65E−02 | 1.95E−03 |
| 8 | 6.132 | 0.201 | 1.6322 | 23.43 | −1.48E+00 | −2.25E−02 | 1.19E−03 |
| | 3.893 | 0.086 | | | −9.98E−01 | −1.33E−02 | 6.71E−04 |
| 9 | 5.393 | 1.975 | 1.4971 | 81.56 | −1.04E+01 | −1.38E−03 | −2.16E−04 |
| | −9.017 | 4.494 | | | 3.73E+00 | 2.13E−04 | −8.75E−06 |
| 10 | −10.153 | 0.998 | 1.5731 | 37.67 | −1.61E+00 | 4.66E−03 | −1.05E−03 |
| | −11.281 | 0.008 | | | 5.20E+00 | 6.22E−03 | −3.00E−03 |
| 11 | −32.946 | 0.338 | 1.9108 | 35.25 | 8.52E−01 | −1.10E−02 | 6.66E−04 |
| | −24.845 | 0.059 | | | −9.21E+00 | −3.10E−02 | 5.88E−03 |
| 12 | −12.527 | 0.226 | 1.5731 | 37.67 | 6.49E+00 | −2.74E−02 | 5.54E−03 |
| | 172.581 | 0.174 | | | −7.76E+00 | 3.35E−03 | −1.11E−03 |
| 13 | 6.005 | 4.000 | 1.4971 | 81.56 | −3.39E+00 | −4.53E−04 | −8.38E−06 |
| | −4.348 | 0.036 | | | −2.61E+00 | −5.02E−04 | 8.78E−05 |
| 14 | −3.515 | 0.200 | 1.5731 | 37.67 | −2.66E+00 | 5.78E−03 | −1.14E−03 |
| | −13.638 | 1.360 | | | −2.33E+00 | 6.64E−03 | −1.60E−03 |
| 15 | −7.640 | 0.200 | 1.8014 | 45.45 | 9.73E−01 | −1.16E−02 | 1.21E−03 |
| | −26.353 | 0.000 | | | 3.45E+00 | −2.83E−03 | 5.53E−04 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | −1.95E−07 | 5.36E−09 | −1.59E−10 | 1.56E−12 | 0.00E+00 |
| | −8.99E−07 | 7.31E−08 | −2.02E−09 | 2.25E−11 | 0.00E+00 |
| 2 | −5.52E−05 | 5.04E−06 | −1.64E−07 | 1.43E−09 | 0.00E+00 |
| | 6.93E−04 | −6.68E−05 | 3.22E−06 | −6.00E−08 | 0.00E+00 |
| 3 | 1.77E−03 | −1.73E−04 | 8.41E−06 | −1.60E−07 | 0.00E+00 |
| | 2.91E−03 | −2.74E−04 | 1.28E−05 | −2.39E−07 | 0.00E+00 |
| 4 | 2.24E−03 | −1.99E−04 | 8.48E−06 | −1.35E−07 | 0.00E+00 |
| | 5.46E−04 | −6.70E−05 | 4.16E−06 | −9.31E−08 | 0.00E+00 |
| 5 | 2.18E−04 | −5.21E−05 | 4.24E−06 | −1.12E−07 | 0.00E+00 |
| | 8.93E−05 | −2.24E−05 | 1.71E−06 | −4.59E−08 | 0.00E+00 |
| 6 | −5.71E−05 | 9.27E−06 | −5.36E−07 | 1.06E−08 | 0.00E+00 |
| | −2.89E−05 | 8.41E−07 | −2.09E−08 | 6.19E−09 | 0.00E+00 |
| 7 | 1.40E−04 | −2.87E−05 | 1.89E−06 | −4.06E−08 | 0.00E+00 |
| | 3.18E−04 | −5.93E−05 | 3.44E−06 | −6.69E−08 | 0.00E+00 |
| 8 | 3.55E−04 | −5.59E−05 | 3.06E−06 | −5.92E−08 | 0.00E+00 |
| | 5.99E−05 | −1.04E−05 | 5.68E−07 | −1.13E−08 | 0.00E+00 |
| 9 | 9.08E−05 | −9.38E−06 | 4.02E−07 | −6.25E−09 | 0.00E+00 |
| | 3.39E−06 | −2.52E−07 | 5.06E−09 | 1.98E−11 | 0.00E+00 |
| 10 | 1.63E−04 | −1.39E−05 | 5.44E−07 | −8.04E−09 | 0.00E+00 |
| | 3.93E−04 | −2.41E−05 | 6.91E−07 | −7.09E−09 | 0.00E+00 |
| 11 | −2.26E−05 | 6.75E−07 | −2.60E−08 | 8.70E−10 | 0.00E+00 |
| | −4.88E−04 | 2.23E−05 | −5.64E−07 | 6.36E−09 | 0.00E+00 |
| 12 | −4.60E−04 | 2.14E−05 | −5.71E−07 | 7.30E−09 | 0.00E+00 |
| | 1.13E−04 | −7.34E−06 | 2.75E−07 | −3.87E−09 | 0.00E+00 |
| 13 | −1.67E−06 | 1.04E−07 | −4.78E−10 | −1.98E−11 | 0.00E+00 |
| | −8.60E−06 | 4.70E−07 | −1.50E−08 | 2.06E−10 | 0.00E+00 |
| 14 | 1.09E−04 | −5.39E−06 | 1.29E−07 | −1.17E−09 | 0.00E+00 |
| | 1.42E−04 | −6.23E−06 | 1.35E−07 | −1.13E−09 | 0.00E+00 |
| 15 | −5.94E−05 | 1.78E−06 | −3.04E−08 | 2.11E−10 | 0.00E+00 |
| | −3.59E−05 | 1.15E−06 | −1.81E−08 | 1.08E−10 | 0.00E+00 |

FIGS. 61A and 61B show lens shapes and placement for this embodiment, when it is operating in main mode. It also shows sample light rays through the embodiment for this mode. In main mode, the field-of-view (FOV) is approximately 82 degrees, the F-number is approximately 1.68, and the effective focal length (EFL) is approximately 7 mm.

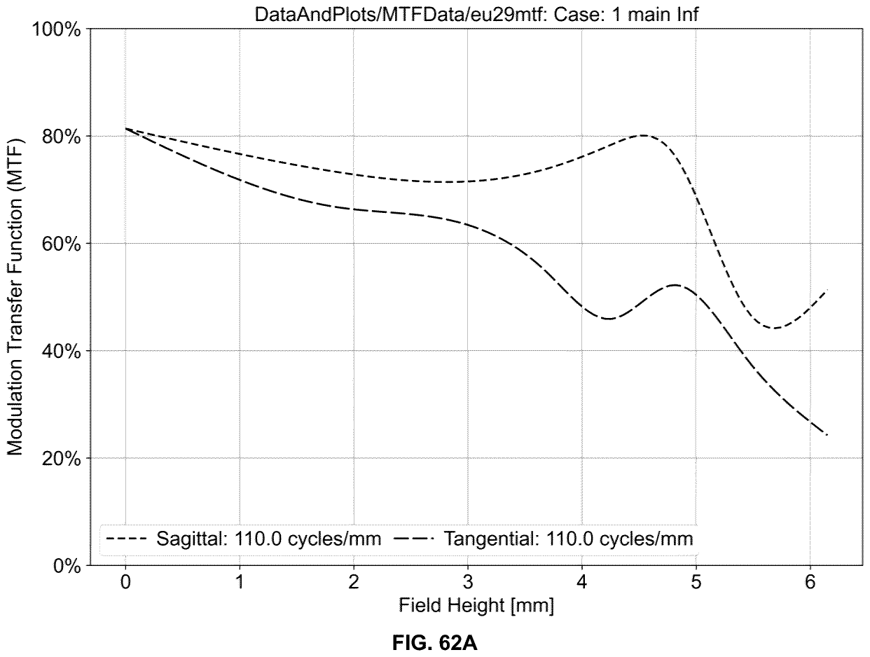

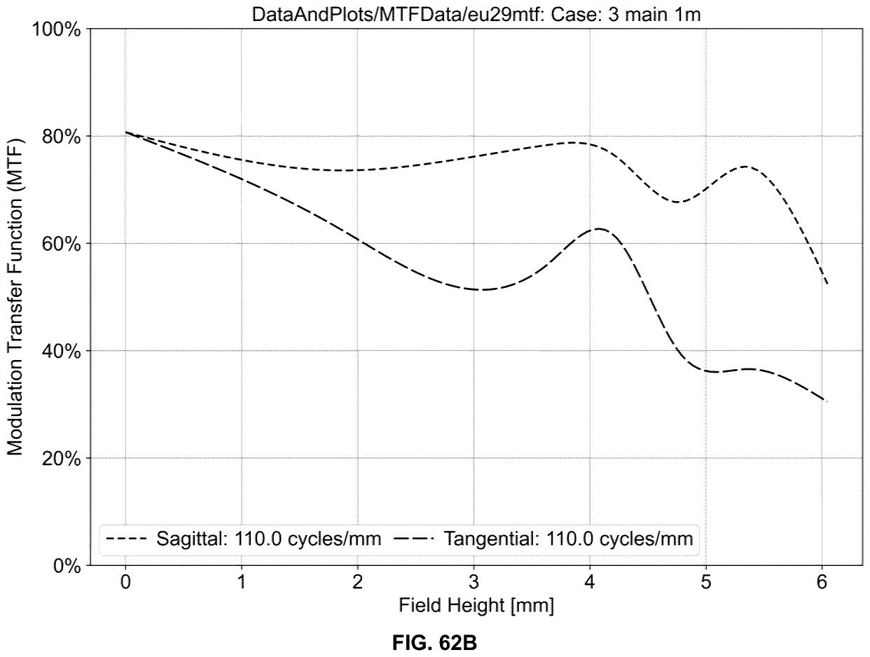

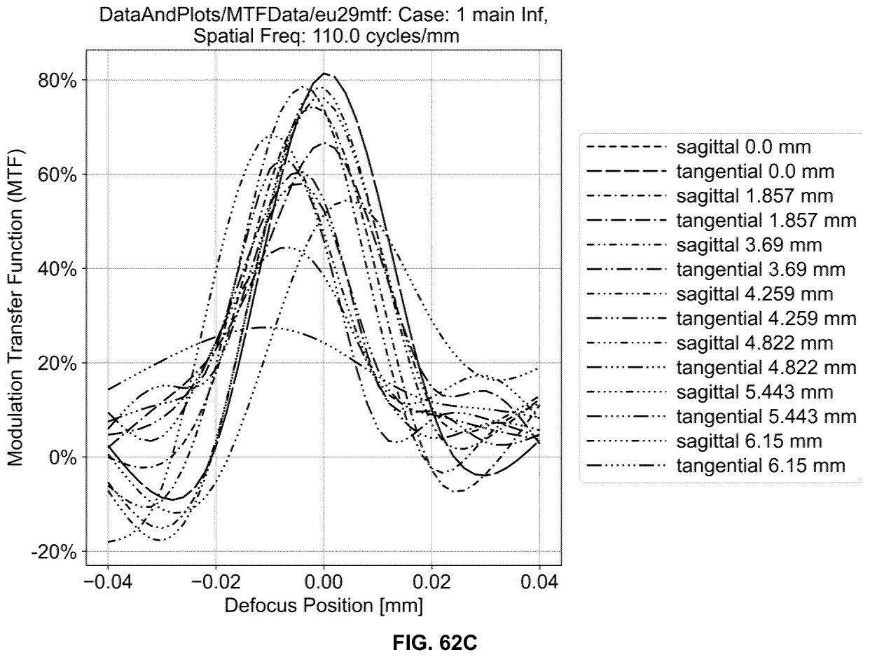

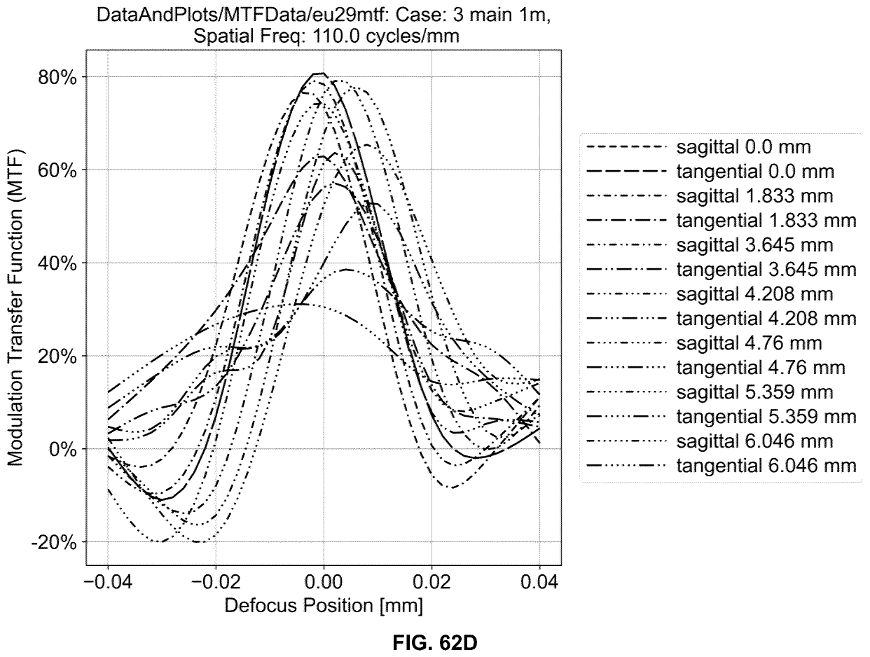

For main mode, FIG. 62A is an MTF (modulation transfer function) performance diagram versus field height for this embodiment, for an object plane located away at infinity. FIG. 62B is an MTF performance diagram versus field height, for an object plane located at 1 meter. FIG. 62C is an MTF versus defocus position, for an object plane located at infinity. And FIG. 62D is an MTF versus defocus position, for an object plane at 10 centimeters.

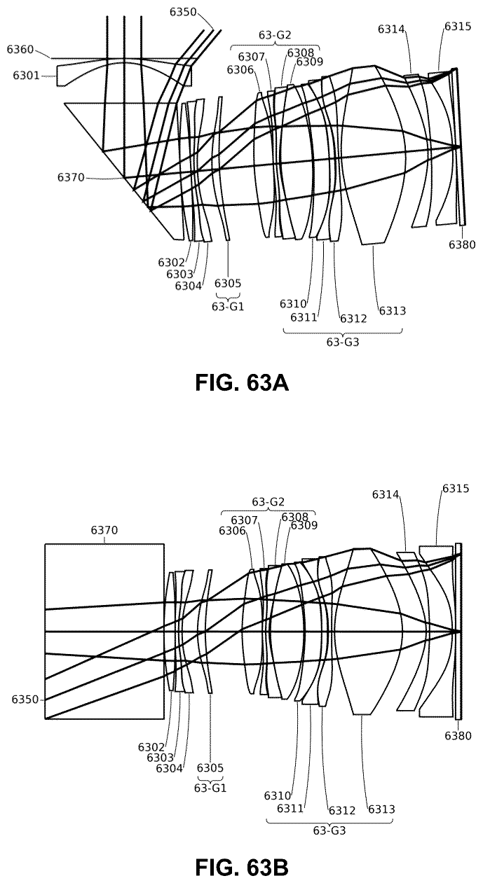

FIGS. 63A and 63B show lens placement for this embodiment, when it is operating in ultra-wide mode. It also shows sample light rays through the embodiment for this mode. In ultra-wide mode, the field-of-view (FOV) is approximately 122.7 degrees, the F-number is approximately 2, and the effective focal length (EFL) is approximately 4.22 mm.

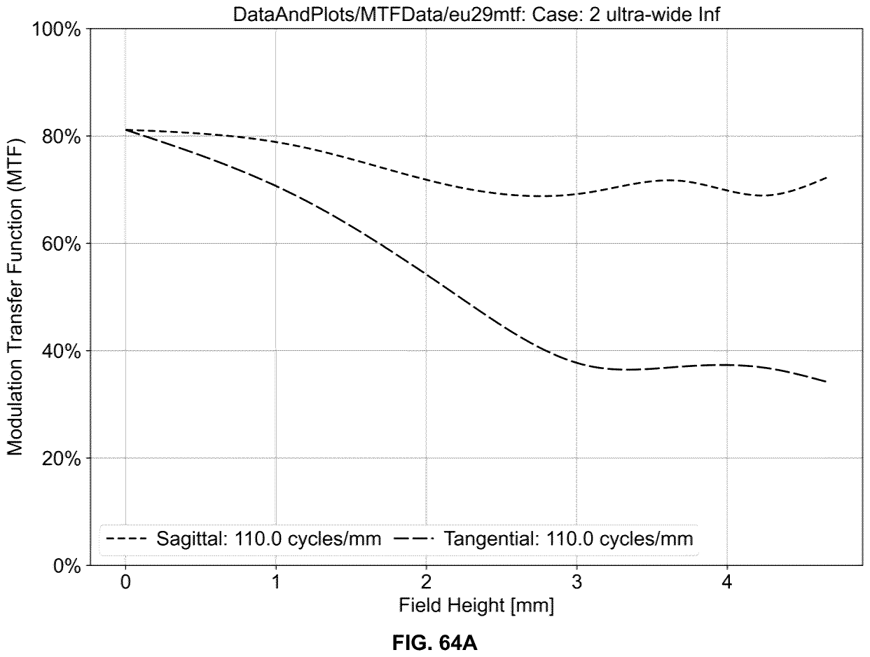

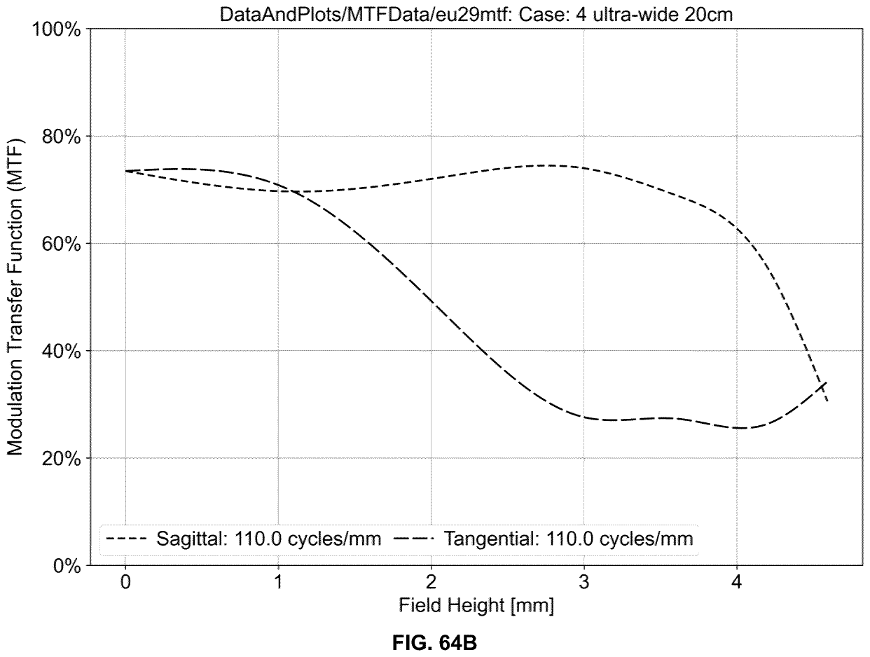

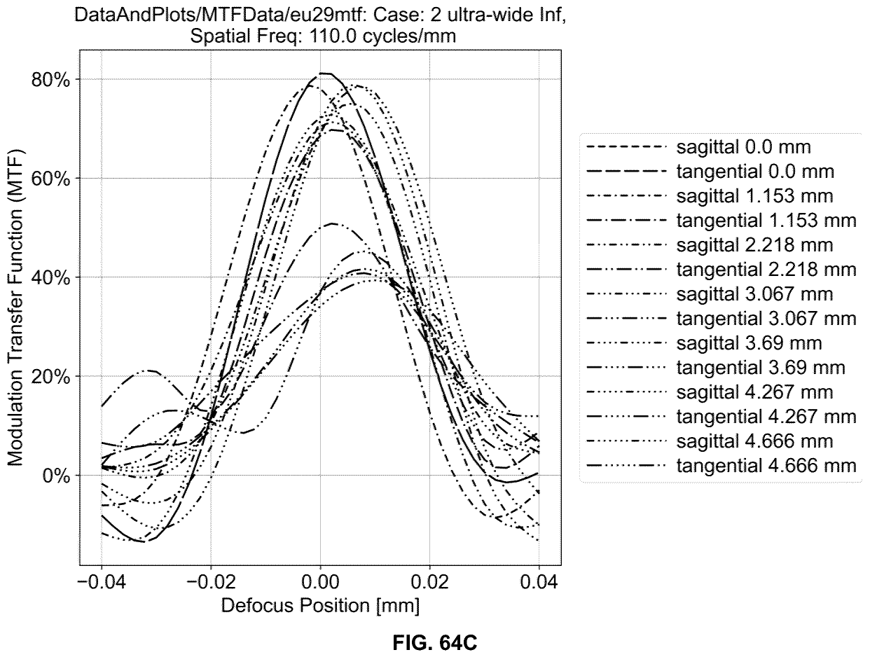

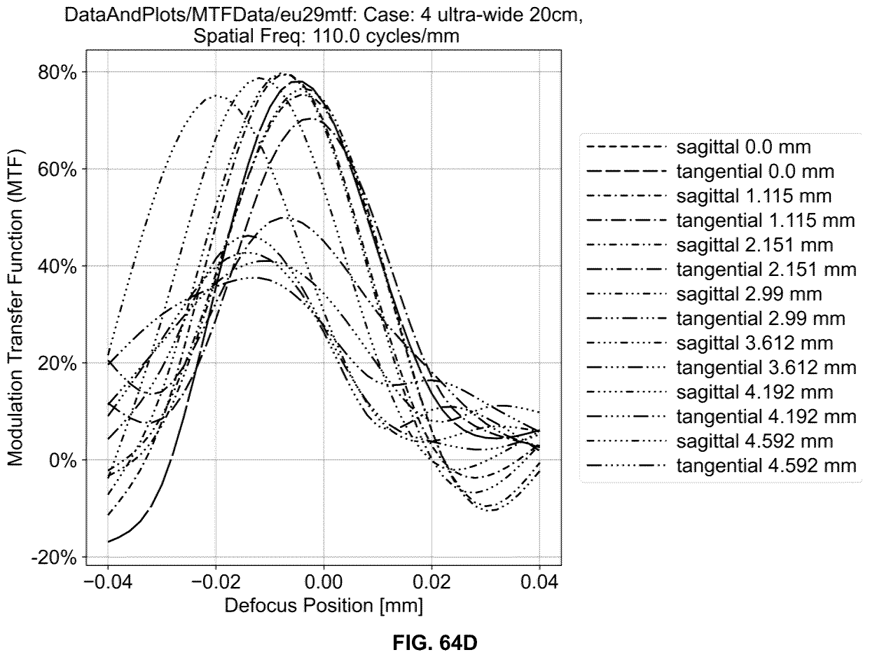

For ultra-wide mode, FIG. 64A is an MTF performance diagram for this embodiment versus field height, for an object plane located away at infinity. FIG. 64B is an MTF performance diagram versus field height, for an object plane located at 10 centimeters. FIG. 64C is an MTF versus defocus position, for an object plane located at infinity. And FIG. 64D is an MTF versus defocus position, for an object plane at 10 centimeters.

### Embodiment #17

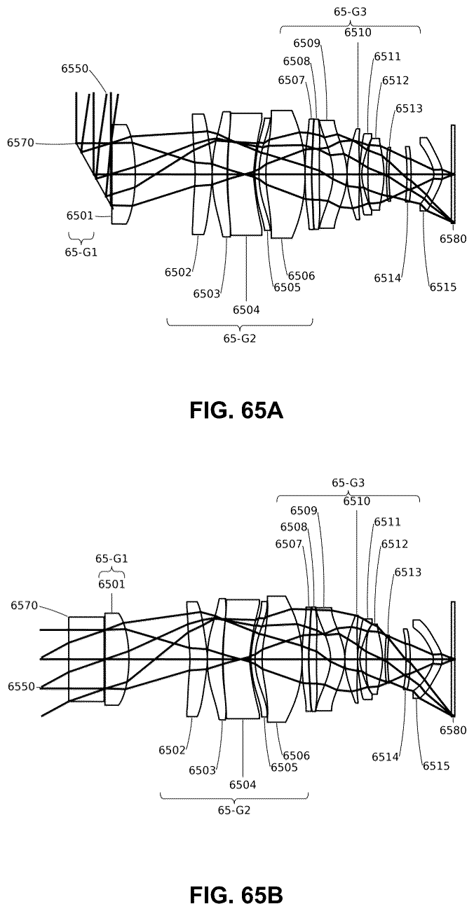

This embodiment (FIGS. 65A-68D) can have a periscope arrangement, with a turning optic that may be a mirror or a prism. The total size of the optics can be approximately 33.22 mm (X length)×6.98 mm (Y width)×6.19 mm (Z height).

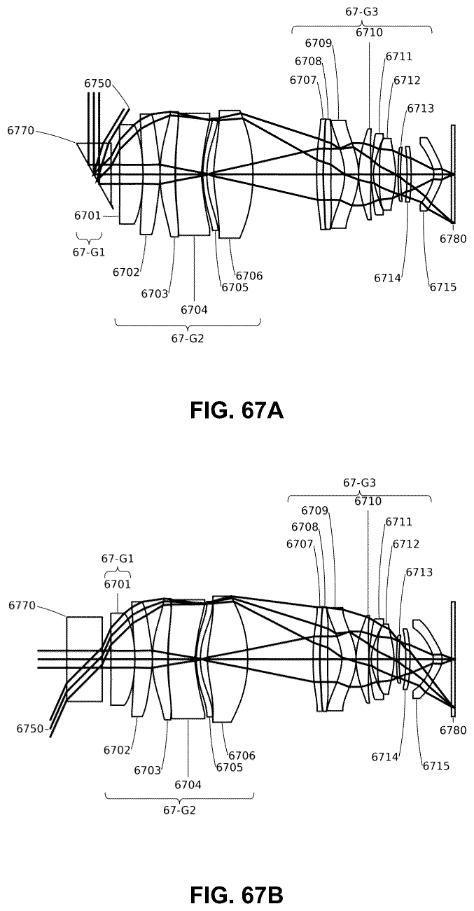

The embodiment can have 14 lenses (14 aspherical and 0 spherical). The turning optic may be positioned before the first lens, before the remaining lenses in the periscope arm. There may be 3 moving lens groups, with 1 lens in the first group, and 5 lenses in the second group, and 7 lenses in the third group. The power of these groups may be positive, positive, and positive. The motion of the first lens group may also be used for auto-focusing. The light rays may progress in such a manner that they cross over between the turning optic and the sensor, as apparent in FIGS. 65A-65B and 67A-67B at approximately the 4th lens. Thus an intermediate image may be formed between the turning optic and the sensor.

Table 17 states possible lens shapes and placement for this embodiment, for both

TABLE 17
Lens shape parameters for embodiment #17.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| | | 3.028 | 1.5168 | 64.2 | | | |
| | | 0.087 | | | | | |
| 1 | 38.163 | 2.047 | 1.5257 | 76.04 | −4.17E+00 | −2.04E−03 | −4.27E−03 |
| | −4.857 | 5.229 | | | −4.99E+00 | −6.47E−03 | 1.02E−03 |
| 2 | −4.362 | 1.493 | 1.8698 | 41.02 | −1.46E+01 | 1.41E−02 | −1.31E−03 |
| | −2.650 | 0.000 | | | −8.11E+00 | 9.26E−03 | −9.47E−04 |
| 3 | 4.188 | 1.311 | 1.7162 | 55.69 | −1.89E+00 | 7.79E−03 | −1.68E−03 |
| | 15.227 | 0.045 | | | −1.58E+00 | 1.22E−02 | −2.72E−03 |
| 4 | 12.889 | 2.272 | 1.9989 | 19.15 | 9.42E+00 | 1.83E−03 | −9.08E−04 |
| | 1.396 | 0.100 | | | −2.31E+01 | 1.08E−02 | −1.81E−03 |
| 5 | 0.849 | 0.365 | 1.7907 | 25.46 | −4.24E+01 | 3.99E−02 | −8.39E−03 |
| | 2.620 | 0.603 | | | −5.95E−01 | 2.47E−03 | −4.00E−03 |
| 6 | 3.368 | 3.427 | 1.4903 | 81.49 | −4.16E+00 | −2.51E−03 | −2.85E−03 |
| | −4.747 | 0.000 | | | −2.08E+00 | −3.57E−03 | 2.32E−04 |
| 7 | 11.891 | 0.561 | 1.7783 | 27.99 | −1.45E+00 | 1.01E−02 | −1.65E−03 |
| | 10.243 | 0.030 | | | 8.07E+00 | 6.20E−03 | −7.34E−03 |
| 8 | 11.891 | 0.654 | 2 | 22.93 | −3.63E+00 | 1.56E−02 | −9.49E−03 |
| | −40.157 | 1.203 | | | −1.21E+01 | 2.42E−02 | −7.63E−03 |
| 9 | −1.510 | 1.219 | 1.7437 | 53.63 | −3.46E+00 | −1.60E−02 | 4.02E−03 |
| | −1.622 | 0.000 | | | −3.07E+00 | −1.10E−02 | 2.71E−03 |
| 10 | 2.384 | 1.091 | 1.49 | 81.53 | −1.21E+00 | −1.04E−02 | 4.82E−04 |
| | −10.972 | 0.000 | | | 7.19E−01 | 1.27E−02 | −2.43E−03 |
| 11 | 2.440 | 0.203 | 1.7782 | 26.16 | −9.85E+00 | −1.65E−02 | 1.17E−03 |
| | 1.066 | 0.539 | | | −2.98E+00 | −2.89E−03 | −2.02E−03 |
| 12 | −67.921 | 1.398 | 1.4901 | 81.52 | 9.48E+00 | 5.21E−02 | −9.94E−03 |
| | −2.316 | 0.221 | | | −8.36E+00 | −2.76E−02 | 2.12E−02 |
| 13 | 4.589 | 0.205 | 1.5938 | 38.62 | 6.06E+00 | −1.29E−01 | 1.07E−01 |
| | 3.178 | 1.591 | | | 1.71E+00 | −1.74E−01 | 1.30E−01 |
| 14 | −7.385 | 0.359 | 1.6145 | 38.78 | −4.21E+00 | 3.36E−03 | −1.68E−02 |
| | −5.995 | 1.988 | | | 8.24E+00 | 2.01E−02 | −1.34E−02 |
| 15 | −0.447 | 0.751 | 1.7028 | 56.36 | −3.05E+00 | −2.65E−01 | 2.43E−01 |
| | −0.620 | 0.786 | | | −9.41E−01 | 3.07E−01 | −8.20E−02 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| 1 | 3.33E−03 | −1.44E−03 | 2.94E−04 | −2.32E−05 | 0.00E+00 |
| | −6.57E−04 | 1.59E−04 | −1.87E−05 | 7.26E−07 | 0.00E+00 |
| 2 | −1.44E−04 | 3.22E−05 | −2.01E−06 | 3.90E−08 | 0.00E+00 |
| | −9.49E−05 | 1.63E−05 | −7.50E−07 | 9.12E−09 | 0.00E+00 |
| 3 | 8.91E−05 | −3.58E−07 | −7.32E−08 | 1.28E−09 | 0.00E+00 |
| | 2.11E−04 | −7.92E−06 | 1.17E−07 | 7.27E−10 | 0.00E+00 |
| 4 | 1.16E−04 | −9.30E−06 | 3.30E−07 | −4.25E−09 | 0.00E+00 |
| | 2.12E−04 | −1.77E−05 | 7.44E−07 | −1.04E−08 | 0.00E+00 |
| 5 | 8.70E−04 | −5.49E−05 | 1.88E−06 | −2.35E−08 | 0.00E+00 |
| | 4.75E−04 | −3.25E−05 | 1.09E−06 | −1.33E−08 | 0.00E+00 |
| 6 | 6.49E−04 | −5.99E−05 | 2.36E−06 | −2.99E−08 | 0.00E+00 |
| | −4.48E−05 | 5.51E−06 | −2.50E−07 | 3.47E−09 | 0.00E+00 |
| 7 | 1.28E−04 | −2.18E−05 | 1.89E−06 | −4.97E−08 | 0.00E+00 |
| | 1.59E−03 | −1.42E−04 | 5.39E−06 | −8.73E−08 | 0.00E+00 |
| 8 | 1.73E−03 | −1.30E−04 | 3.90E−06 | −4.00E−08 | 0.00E+00 |
| | 7.83E−04 | −1.87E−05 | −1.36E−06 | 5.88E−08 | 0.00E+00 |
| 9 | −4.10E−04 | 3.04E−05 | −1.62E−06 | 3.91E−08 | 0.00E+00 |
| | −2.61E−04 | 3.62E−05 | −3.13E−06 | 1.00E−07 | 0.00E+00 |
| 10 | 2.84E−04 | −9.74E−05 | 1.05E−05 | −3.42E−07 | 0.00E+00 |
| | 1.17E−03 | −2.62E−04 | 2.68E−05 | −1.15E−06 | 0.00E+00 |
| 11 | 1.08E−03 | −1.48E−04 | 1.23E−06 | 1.92E−07 | 0.00E+00 |
| | −1.71E−03 | 2.34E−03 | −5.31E−04 | 3.40E−05 | 0.00E+00 |
| 12 | −9.81E−04 | 2.03E−03 | −4.44E−04 | 2.77E−05 | 0.00E+00 |
| | −8.26E−03 | 1.88E−03 | −2.28E−04 | 1.13E−05 | 0.00E+00 |
| 13 | −4.93E−02 | 1.56E−02 | −2.14E−03 | 2.02E−06 | 0.00E+00 |
| | −5.31E−02 | 1.30E−02 | −2.43E−04 | −2.18E−04 | 0.00E+00 |
| 14 | 9.44E−03 | −1.40E−03 | −2.52E−04 | 1.76E−05 | 0.00E+00 |
| | 3.12E−03 | 1.13E−03 | −6.08E−04 | 4.54E−05 | 0.00E+00 |
| 15 | −1.22E−01 | 2.91E−02 | −3.27E−03 | 1.62E−04 | 0.00E+00 |
| | 1.87E−02 | −3.50E−03 | 3.98E−04 | −1.32E−05 | 0.00E+00 |

FIGS. 65A and 65B show lens shapes and placement for this embodiment, when it is operating in main mode. It also shows sample light rays through the embodiment for this mode. In main mode, the field-of-view (FOV) is approximately 47 degrees, the F-number is approximately 2, and the effective focal length (EFL) is approximately 9.11 mm.

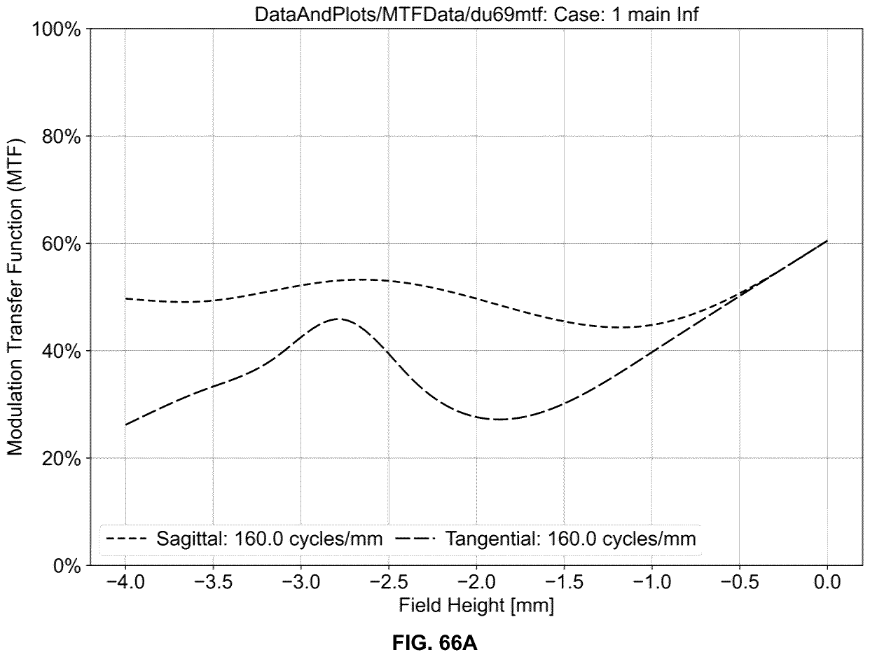

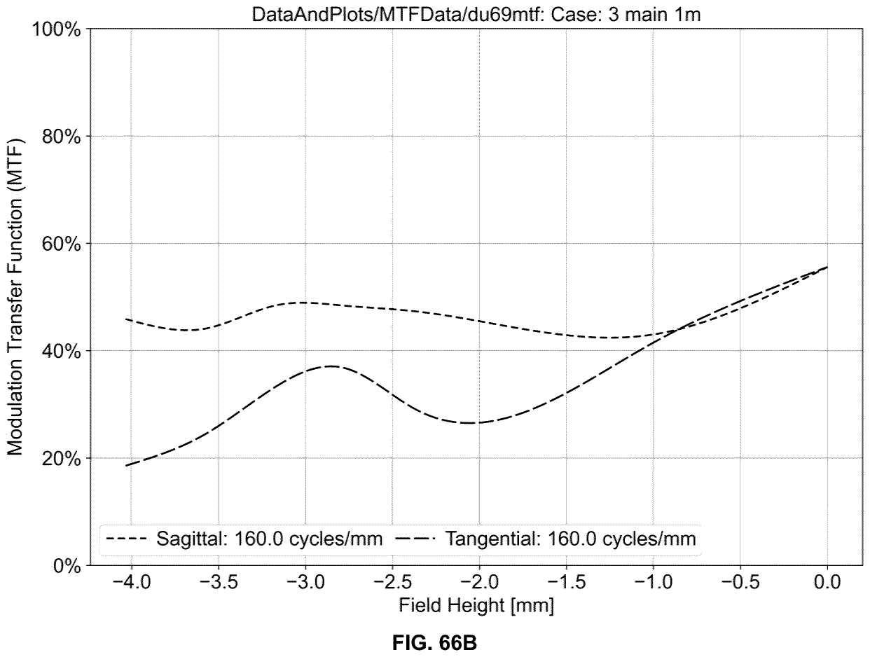

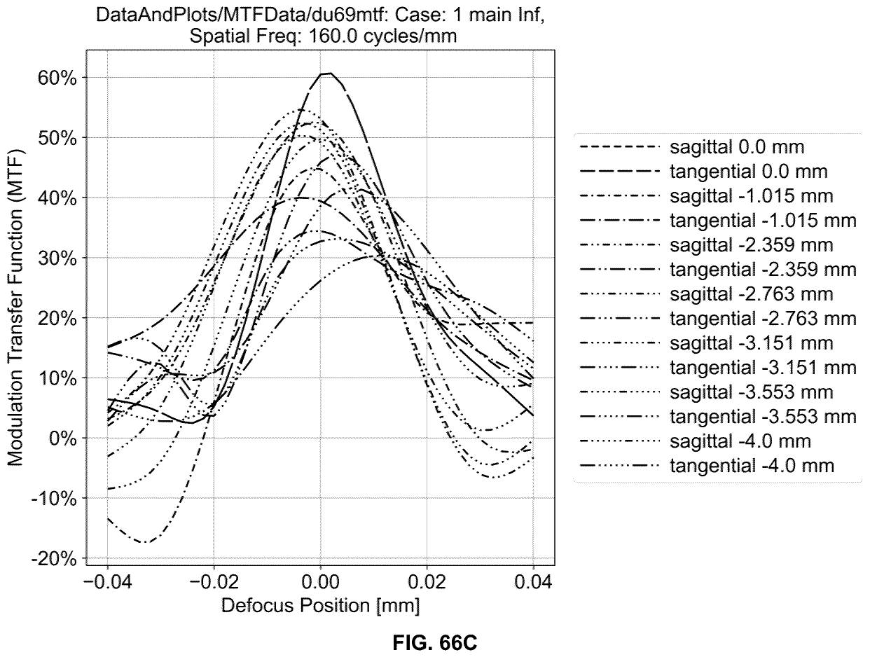

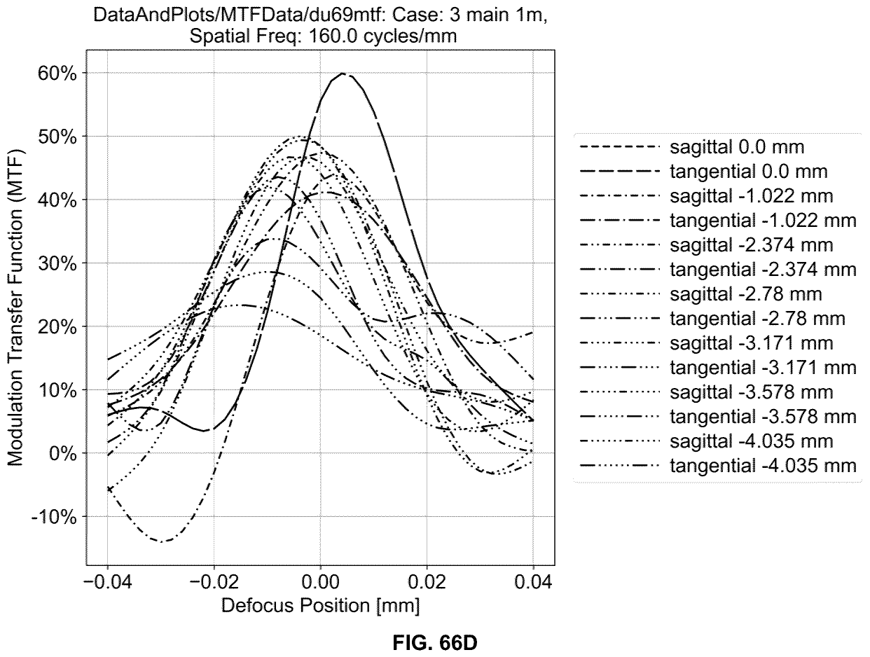

For main mode, FIG. 66A is an MTF (modulation transfer function) performance diagram versus field height for this embodiment, for an object plane located away at infinity. FIG. 66B is an MTF performance diagram versus field height, for an object plane located at 1 meter. FIG. 66C is an MTF versus defocus position, for an object plane located at infinity. And FIG. 66D is an MTF versus defocus position, for an object plane at 10 centimeters.

FIGS. 67A and 67B show lens placement for this embodiment, when it is operating in ultra-wide mode. It also shows sample light rays through the embodiment for this mode. In ultra-wide mode, the field-of-view (FOV) is approximately 122.1 degrees, the F-number is approximately 2.06, and the effective focal length (EFL) is approximately 2.06 mm.

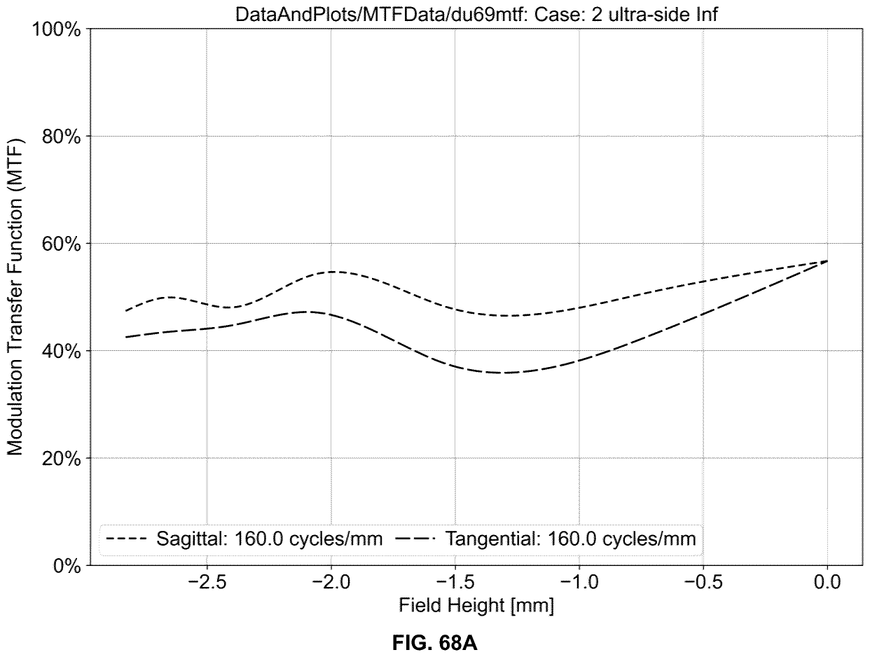

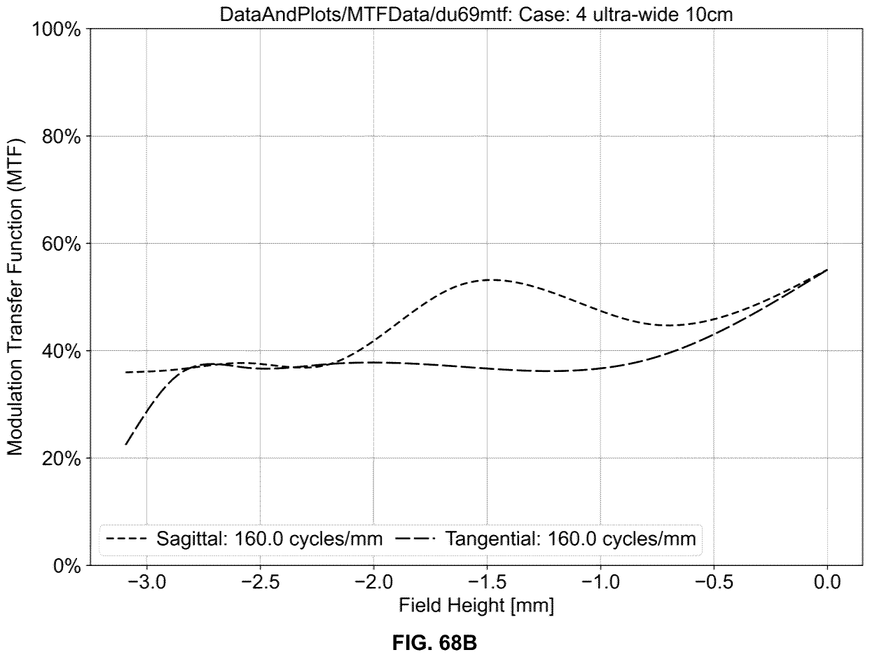

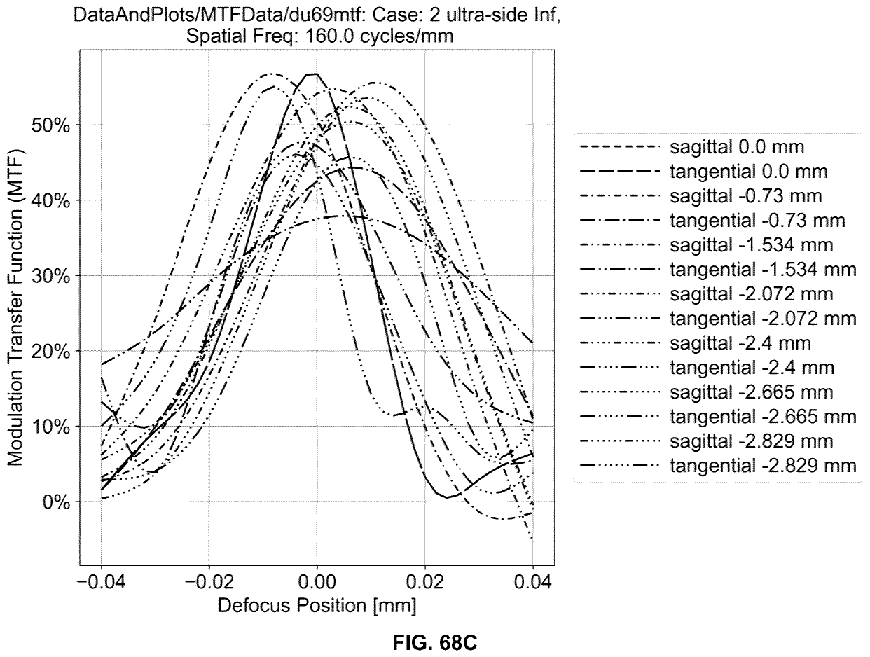

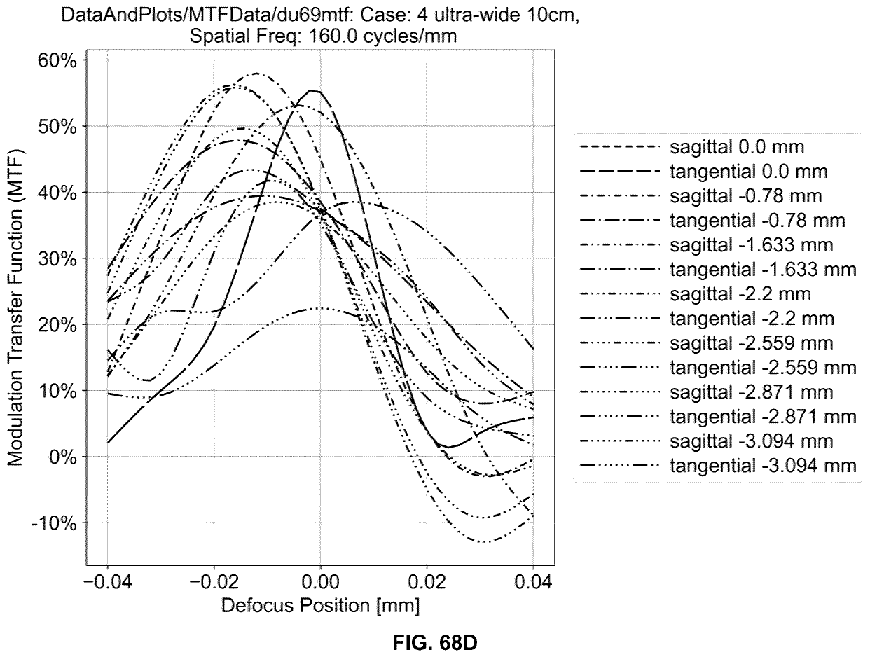

For ultra-wide mode, FIG. 68A is an MTF performance diagram for this embodiment versus field height, for an object plane located away at infinity. FIG. 68B is an MTF performance diagram versus field height, for an object plane located at 10 centimeters. FIG. 68C is an MTF versus defocus position, for an object plane located at infinity. And FIG. 68D is an MTF versus defocus position, for an object plane at 10 centimeters.

### Embodiment #18

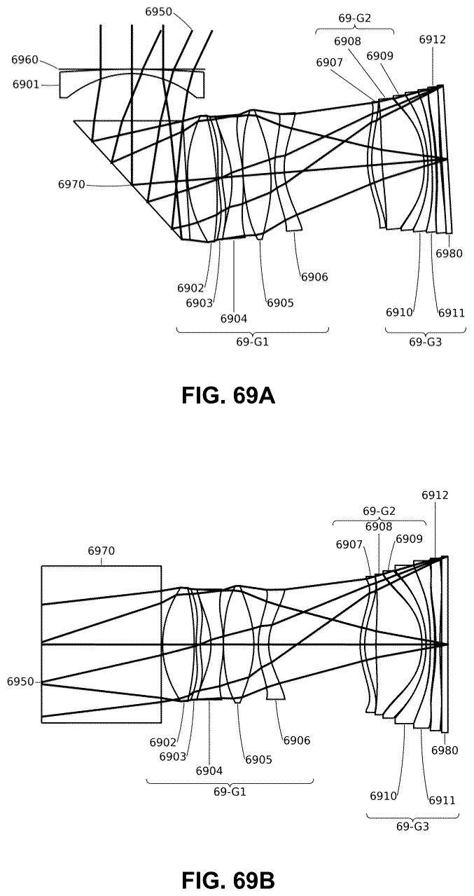

This embodiment (FIGS. 69A-72D) can have a periscope arrangement, with a turning optic that may be a mirror or a prism. The total size of the optics can be approximately 15.77 mm (X length)×9.86 mm (Y width)×8.11 mm (Z height).

The embodiment can have 12 lenses (12 aspherical and 0 spherical). The turning optic may be positioned before the second lens, before the remaining lenses in the periscope arm. There may be 3 moving lens groups, with 5 lenses in the first group, and 3 lenses in the second group, and 2 lenses in the third group. The power of these groups may be positive, positive, and negative The motion of the first lens group may also be used for auto-focusing.

Table 18 states possible lens shapes and placement for this embodiment, for both

TABLE 18
Lens shape parameters for embodiment #18.

| | Radius | Thickness | | | | AS4 | AS6 |
|---|---|---|---|---|---|---|---|
| | [mm] | [mm] | Nd | Abbe | K | [1/mm\hat{ }3] | [1/mm\hat{ }5] |
| | 32.038 | 0.200 | 1.6775 | 57.62 | 2.31E+01 | −1.17E−03 | 7.71E−05 |
| | 5.478 | 2.114 | | | −3.50E+00 | 1.43E−03 | −8.56E−06 |
| 1 | | 5.745 | 1.5168 | 64.2 | | | |
| | | 0.065 | | | | | |
| 2 | 4.928 | 1.515 | 1.5537 | 71.74 | −1.52E+00 | 2.00E−03 | −1.30E−04 |
| | −15.072 | 0.094 | | | −9.02E+00 | −3.37E−04 | −9.52E−04 |
| 3 | 5.980 | 0.201 | 1.5311 | 55.75 | 1.85E+00 | −4.07E−02 | 5.44E−03 |
| | 4.384 | 0.509 | | | 5.49E−01 | −4.81E−02 | 6.96E−03 |
| 4 | −3.635 | 0.597 | 1.6099 | 58.27 | −1.15E+01 | −2.10E−02 | 7.81E−03 |
| | −5.971 | 0.000 | | | −2.97E+01 | −1.23E−02 | 7.25E−03 |
| 5 | 8.200 | 1.463 | 1.49 | 81.54 | −3.11E−03 | −7.48E−03 | 2.33E−03 |
| | −5.251 | 0.214 | | | −5.30E+00 | −2.09E−03 | 3.57E−04 |
| 6 | 3.771 | 0.496 | 1.6322 | 23.43 | −5.84E+00 | −4.81E−03 | 1.52E−03 |
| | 2.683 | 4.388 | | | −3.76E+00 | −2.47E−03 | 9.99E−04 |
| 7 | 3.796 | 0.221 | 1.6322 | 23.43 | −7.50E+00 | −3.74E−03 | 1.04E−03 |
| | 3.502 | 0.545 | | | −5.27E+00 | −8.04E−03 | 2.07E−03 |
| 8 | 19.103 | 2.200 | 1.49 | 81.54 | −1.30E+00 | −3.25E−03 | −1.50E−04 |
| | −4.123 | 0.000 | | | −1.78E+00 | −1.28E−02 | −5.50E−04 |
| 9 | −4.343 | 0.200 | 1.6294 | 24.32 | −4.13E+00 | −2.25E−02 | 2.36E−03 |
| | −6.052 | 0.005 | | | −4.84E+00 | −1.15E−02 | 2.17E−03 |
| 10 | −5.555 | 0.200 | 1.6319 | 23.53 | −8.02E−02 | −4.43E−03 | 1.01E−03 |
| | −14.213 | 0.000 | | | −4.21E+00 | 9.12E−05 | −6.64E−04 |
| 11 | −25.950 | 0.205 | 1.5311 | 55.75 | 5.68E+00 | −6.04E−03 | 3.55E−04 |
| | −32.903 | 0.056 | | | 1.48E+01 | −1.00E−02 | 2.09E−03 |
| 12 | −18.614 | 0.200 | 1.5636 | 45.36 | −1.55E+01 | −7.31E−03 | 1.57E−03 |
| | 28.383 | 0.078 | | | −1.19E+01 | −3.91E−04 | −1.13E−04 |

| | AS8 | AS10 | AS12 | AS14 | AS16 |
|---|---|---|---|---|---|
| | [1/mm\hat{ }7] | [1/mm\hat{ }9] | [1/mm\hat{ }11] | [1/mm\hat{ }13] | [1/mm\hat{ }15] |
| | −3.21E−06 | 6.76E−08 | −6.59E−10 | 1.13E−12 | 0.00E+00 |
| | 2.60E−06 | −1.55E−07 | 2.71E−09 | −1.12E−11 | 0.00E+00 |
| 1 | | | | | |
| 2 | 1.54E−05 | 2.90E−07 | −3.13E−07 | 1.29E−08 | 0.00E+00 |
| | 3.44E−04 | −5.50E−05 | 4.04E−06 | −1.05E−07 | 0.00E+00 |
| 3 | −3.94E−04 | 5.98E−06 | 5.05E−07 | −3.02E−09 | 0.00E+00 |
| | −8.63E−04 | 8.67E−05 | −5.50E−06 | 1.58E−07 | 0.00E+00 |
| 4 | −1.48E−03 | 1.53E−04 | −7.46E−06 | 1.35E−07 | 0.00E+00 |
| | −1.22E−03 | 1.00E−04 | −3.98E−06 | 5.63E−08 | 0.00E+00 |
| 5 | −2.89E−04 | 2.31E−05 | −1.19E−06 | 2.70E−08 | 0.00E+00 |
| | −5.91E−05 | 1.22E−05 | −1.20E−06 | 3.80E−08 | 0.00E+00 |
| 6 | −4.36E−04 | 5.10E−05 | −3.46E−06 | 9.09E−08 | 0.00E+00 |
| | −3.15E−04 | 3.59E−05 | −2.07E−06 | 5.02E−08 | 0.00E+00 |
| 7 | −2.11E−04 | 1.28E−05 | −3.02E−07 | 2.16E−09 | 0.00E+00 |
| | −3.37E−04 | 2.37E−05 | −7.46E−07 | 8.92E−09 | 0.00E+00 |
| 8 | 5.39E−05 | −4.76E−06 | 1.65E−07 | −1.87E−09 | 0.00E+00 |
| | 2.94E−04 | −2.30E−05 | 7.17E−07 | −7.97E−09 | 0.00E+00 |
| 9 | −1.30E−04 | 6.73E−06 | −2.64E−07 | 4.07E−09 | 0.00E+00 |
| | −2.70E−04 | 1.67E−05 | −4.81E−07 | 5.23E−09 | 0.00E+00 |
| 10 | −1.27E−04 | 8.25E−06 | −2.50E−07 | 2.84E−09 | 0.00E+00 |
| | 7.52E−05 | −3.37E−06 | 6.96E−08 | −5.52E−10 | 0.00E+00 |
| 11 | −6.50E−06 | 8.19E−10 | 1.89E−09 | −2.55E−11 | 0.00E+00 |
| | −1.53E−04 | 4.90E−06 | −7.04E−08 | 3.75E−10 | 0.00E+00 |
| 12 | −1.13E−04 | 3.65E−06 | −5.30E−08 | 2.80E−10 | 0.00E+00 |
| | 6.93E−06 | −1.42E−07 | 1.24E−09 | −4.09E−12 | 0.00E+00 |

FIGS. 69A and 69B shows lens shapes and placement for this embodiment, when it is operating in main mode. It also shows sample light rays through the embodiment for this mode. In main mode, the field-of-view (FOV) is approximately 85.3 degrees, the F-number is approximately 1.83, and the effective focal length (EFL) is approximately 6.02 mm.

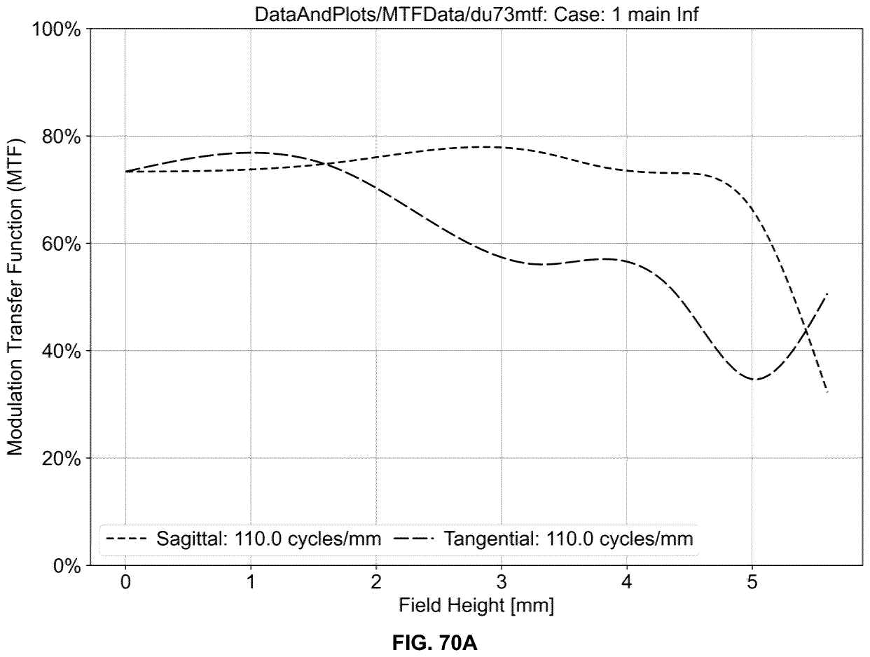

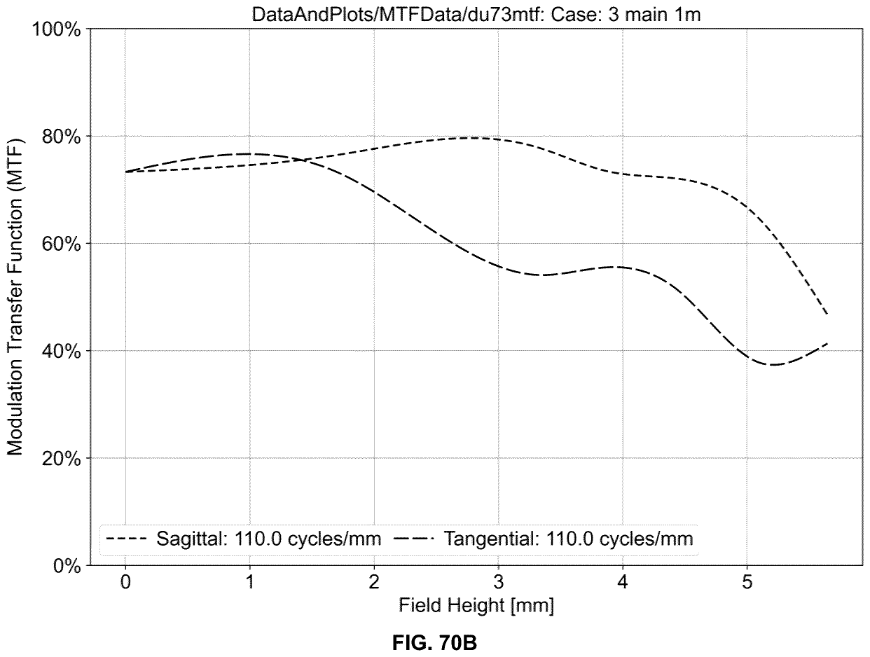

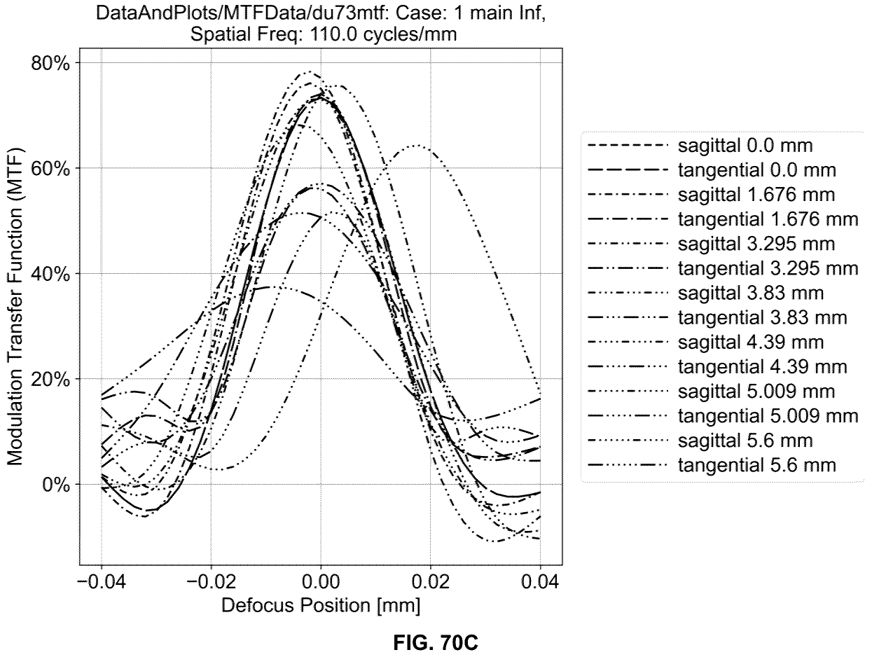

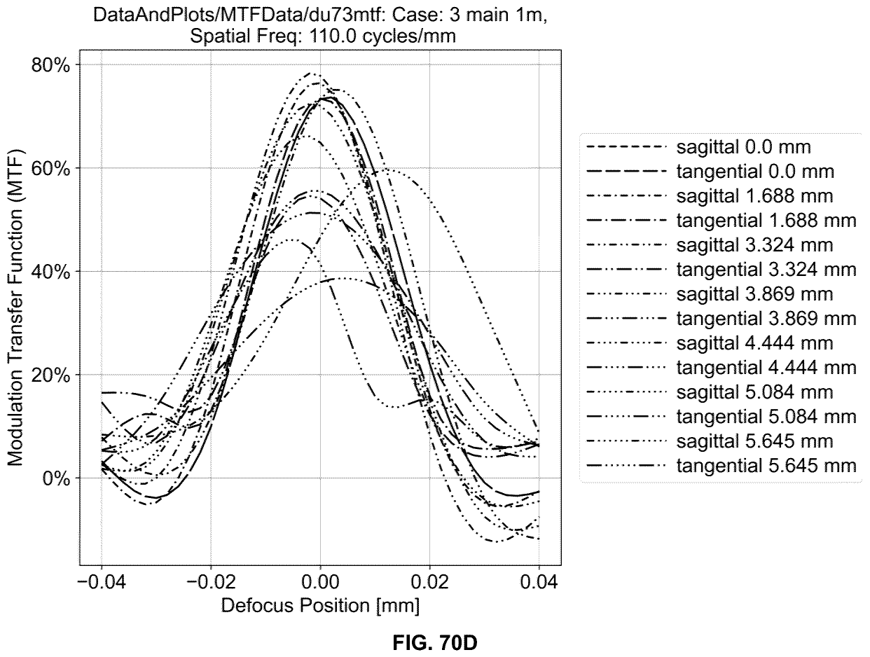

For main mode, FIG. 70A is an MTF (modulation transfer function) performance diagram versus field height for this embodiment, for an object plane located away at infinity. FIG. 70B is an MTF performance diagram versus field height, for an object plane located at 1 meter. FIG. 70C is an MTF versus defocus position, for an object plane located at infinity. And FIG. 70D is an MTF versus defocus position, for an object plane at 10 centimeters.

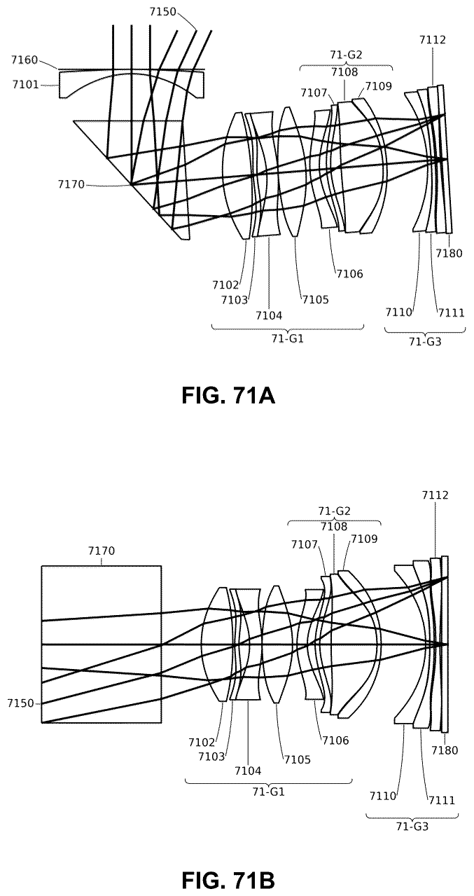

FIGS. 71A and 71B show lens placement for this embodiment, when it is operating in ultra-wide mode. It also shows sample light rays through the embodiment for this mode. In ultra-wide mode, the field-of-view (FOV) is approximately 122.1 degrees, the F-number is approximately 2.06, and the effective focal length (EFL) is approximately 3.99 mm.

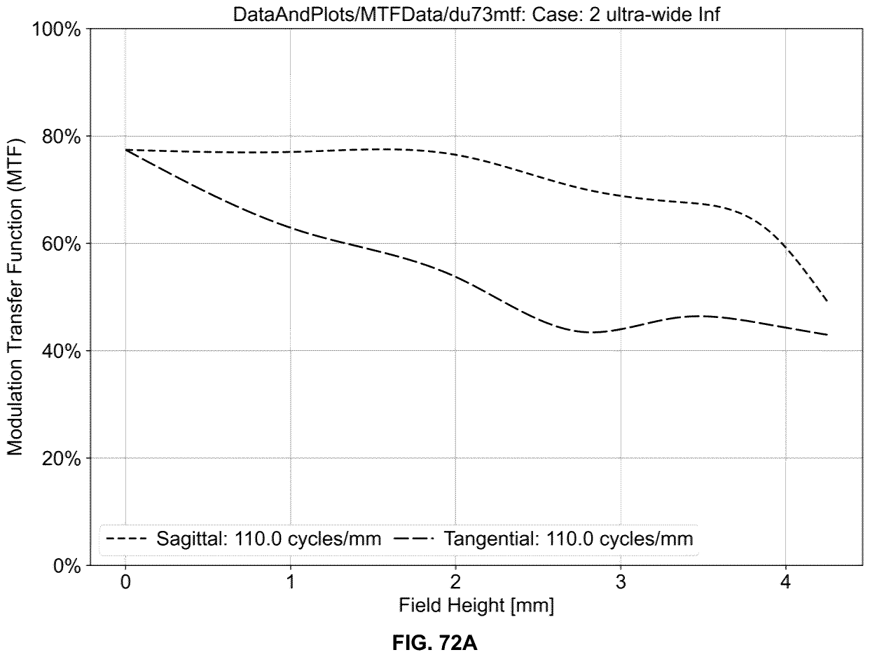

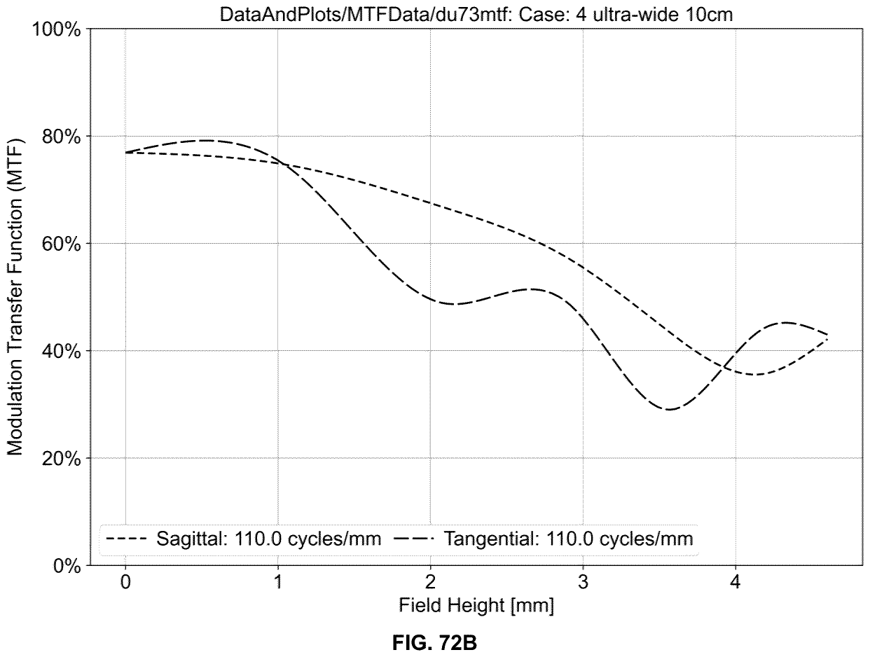

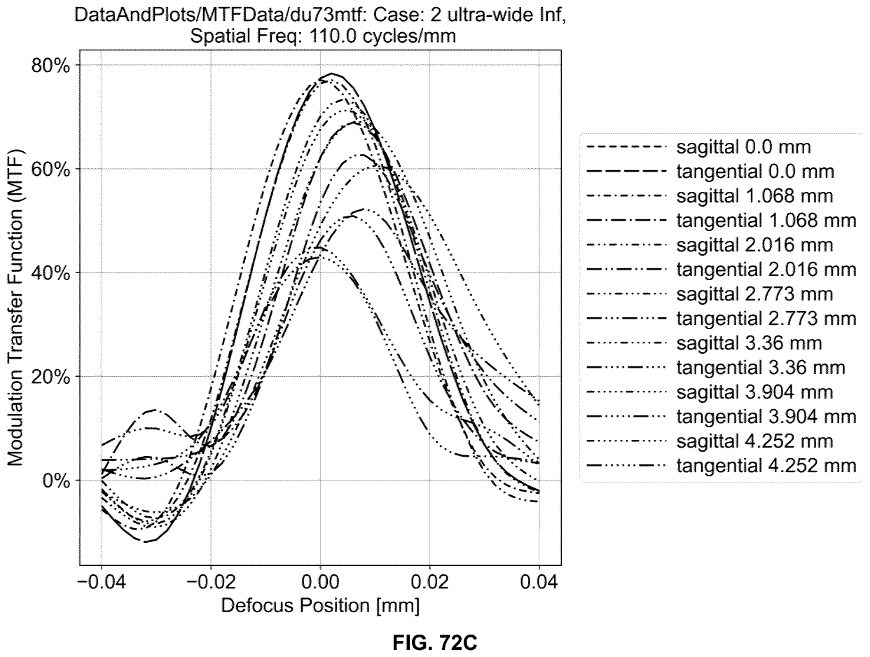

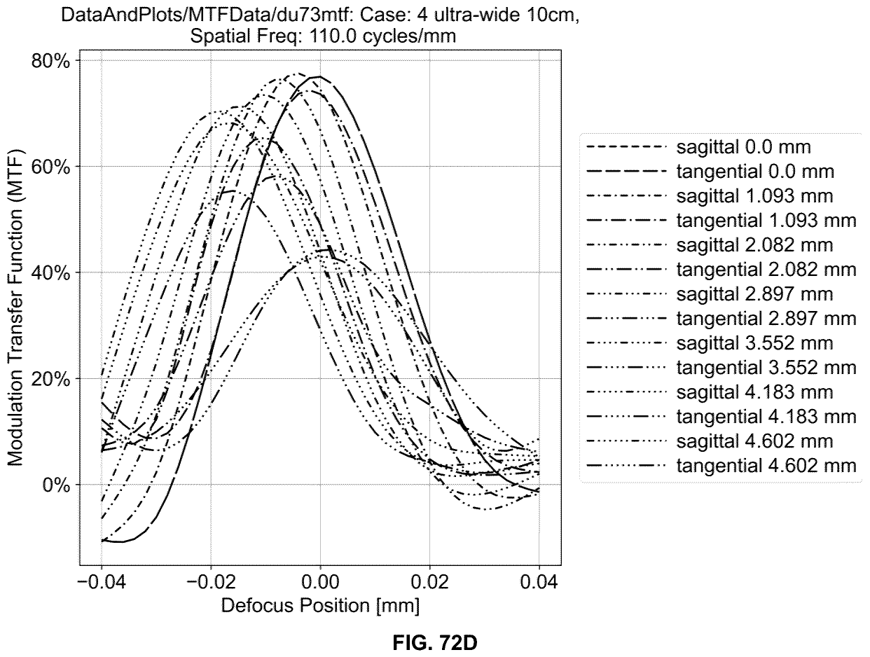

For ultra-wide mode, FIG. 72A is an MTF performance diagram for this embodiment versus field height, for an object plane located away at infinity. FIG. 72B is an MTF performance diagram versus field height, for an object plane located at 10 centimeters. FIG. 72C is an MTF versus defocus position, for an object plane located at infinity. And FIG. 72D is an MTF versus defocus position, for an object plane at 10 centimeters.

### Embodiment #19

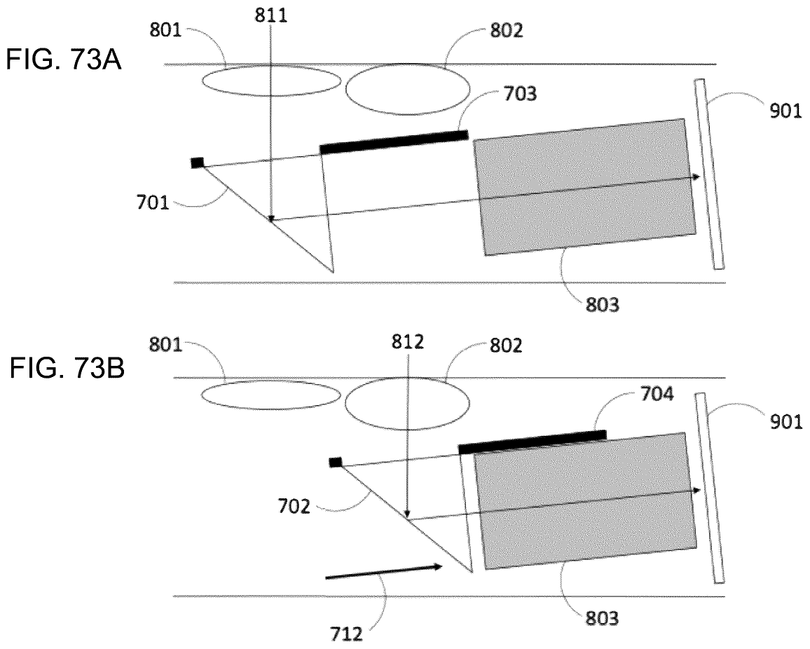

This embodiment is shown in FIGS. 73A-73B. A turning optic, e.g. a prism or mirror, may be moved in such a way as to switch from one set of entry lens or lenses to another. For example, there may be two entry lenses on one side of the phone, for main and ultra-wide or for main and tele operation.

This can allow additional flexibility in camera mode selection, and is illustrated in FIGS. 73A-73B. In this exemplary figure, a periscope camera has two entry apertures or lenses (801 and 802), and the angled mirror or prism can be moved from a first location (FIG. 73A, 701) to a second location (FIG. 73B, 702). In the first location (701), the path of light 811 is through lens 801, then is reflected by the prism (or mirror), and then the light progresses through the other lenses. In the second location (702), the path of light 812 is through lens 802, then is reflected by the prism (or mirror), and then the light progresses through the other lenses. These other lenses (803) may have moving groups, as disclosed above, to further change field-of-view.

A light blocking element may be used, and may be attached to the turning element if desired. Such an aperture can block or reduce light for the undesired path. The entry lenses can be one lens each, or can be a group of lenses. There can be one or multiple lenses after the prism (or mirror), in the periscope arm. Those lenses can also be moved from one configuration to another, either singly or in groups. They can be similar to the lens arrangement and powers described above, or can be modified based on lens shapes chosen for the lenses before the prism (or angled mirror).

### Embodiment #20

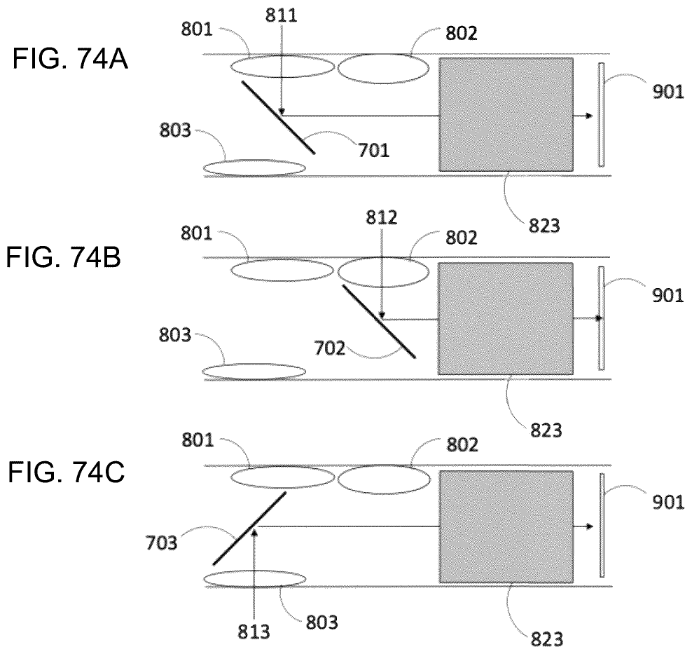

This embodiment is shown in FIGS. 74A-74C. Further to embodiment #19, the turning optic can be both moved and flipped, as illustrated in FIGS. 74A-74C. There may be two apertures or lenses on the front of the phone (e.g. main and tele or main and ultra-wide) and an additional aperture or lens on the back of the phone (selfie). The turning optic may be a mirror and could have three configurations. Configuration FIG. 74A, 701 in front of aperture or lens 801, for path of light 811. Configuration FIG. 74B, 702 in front of aperture or lens 802, for path of light 812. And flipped configuration FIG. 74C, 703 in behind aperture or lens 813, for path of light 813. In such a configuration, one camera may be able to cover 3 modes, e.g. main, ultra-wide, and selfie, or main, tele, and selfie. The lenses in the periscope arm (823) may be similar to embodiments described above.

In some embodiments herein: a first lens group having at least one lens, disposed before the optical axis bending means, and having negative power; a second lens group having at least one lens, disposed behind the first lens group, and having positive power; and a third lens group having at least one lens, disposed behind the second lens group, and having positive power; wherein, the second lens group and the third lens group move along the optical axis, thereby switching between the first field of view and the second field of view. Additionally, a fixed lens may be present after the optical axis bending. Additionally, to further improve performance, the third lens group may be divided into a negative lens sub-group and a positive lens sub-group, wherein the power of the negative lens sub-group is smaller than the power of the positive lens sub-group (thus the overall power of the third lens group remains positive). Likewise, the second lens group can also be divided into sub-groups.

Fixed lenses or lens groups may be employed. A fixed (not moving) lens or lens group can be disposed in front of the turning optic (before optical axis bending), after the turning optic, or in front of or adjacent to the sensor. Moving lenses and or groups and fixed lenses or groups may be disposed in various orders, for example a fixed lens may or may not be present before, between, or after moving groups.

Furthermore, lens groups may move along the optical axis, thereby switching between the first field of view and the second field of view. Lens group motion may also be used to perform focus adjustment, e.g. for auto-focus in smartphones.

Furthermore, at least a portion of the lenses of the second lens group can have a D-cut parallel to the longitudinal direction of the imaging element. This can allow the camera to be thinner.

In some embodiments, the optical axis bending (of the periscope arm) can be selected to be other than a 90 degree bend. For example, the optical axis can be bent by more than 90 degrees, so that the periscope arm of the camera is tiled up. This can be enabled either by including a turning mirror that is tilted more than 45 degrees. Or by using an internally-reflecting turning prism whose angled face is tilted by more than 45 degrees. For such a turning prism, we further disclose that the exit face of the prism can be tilted away from vertical, for example to retain axial symmetry along the path of light, or to minimize aberrations. Such a tilted-arm design can enable a larger sensor to be used, without having the bottom of that sensor extend outside the thickness of the phone. A larger sensor can be advantageous for collecting more light and for decreasing signal-to-noise ratio (SNR).

In some cases, the light rays may progress in such a manner that they cross over between the turning optic and the sensor. Thus an intermediate image may be formed between the turning optic and the sensor.

It is understood that there can be one, two, three, or more moving lens groups, to achieve mode-switching (changing field-of-view) and auto-focus, in a periscope form factor. These lens groups can contain from one to five lenses each. The power of these groups can be positive (+) or negative (−). For example, if there are two moving lens groups, they could both be positive. If there are three moving lens groups, different effective combinations are possible, for example ++− or +−+ or +++ may be effective, as may other combinations. The number of lenses and/or their shape can be changed in a manner to retain intended function. For example, a group of lenses with a positive or negative power may also be implemented with a lesser or greater number of lenses, in such a way as to retain intended function. Lenses may be split, in such a manner that the intended function of the lens or lens group remains as intended. The number of lenses for a group can be increased by +4, +3, +2, or +1 lenses, or it can be decreased by −1, −2, −3, −4 lenses until there are, for example, 3, 2, or 1 lenses remaining in that group.

Two-in-one (2-in-1) mode-switching operation may cover main and ultra-wide, or it may cover main and tele operation, or it may cover two types of tele operation, e.g. 2× and 5× or 5× and 10× or any other two different magnifications. Such varied operation is anticipated in the current disclosure.

While subject matter of the present disclosure has been illustrated and described in detail in the drawings and foregoing description, such illustration and description are to be considered illustrative or exemplary and not restrictive. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A lens system for forming a photographic image, the lens system comprising:
a turning optic; and
a plurality of lenses, the plurality of lenses comprising a first movable lens group, a second movable lens group, and a third movable lens group, arranged successively from an object side of the lens system to an image side of the lens system;
wherein the first movable lens group comprises one lens and has a first positive refractive power, the second movable lens group comprises four lenses and has a second positive refractive power, and the third lens group comprises four lenses and has a third positive refractive power;
wherein in a first position of the first movable lens group, the second movable lens group, and the third movable lens group, the lens system operates in a main mode having a first field of view; and
wherein in a second position of the first movable lens group, the second movable lens group, and the third movable lens group, the lens system operates in an ultra-wide mode having a second field of view greater than the first field of view.
